(19) United States
(12) Patent Application Publication
(10) Pub. No.: US 2026/0349261 A1
(43) Pub. Date: Nov. 5, 2026

(54) OPTICAL APPARATUS

(71) Applicant: UNIVERSITY OF SOUTHAMPTON, Southampton (GB)

(72) Inventors: Peter George Robin SMITH, Southampton (GB); James GATES, Southampton (GB); Glen CHURCHILL, Southampton (GB); Goronwy TAWY, Southampton (GB); Rex Hugh Seton BANNERMAN, Southampton (GB)

(73) Assignee: UNIVERSITY OF SOUTHAMPTON, Southampton (GB)

(21) Appl. No.: 19/707,758

(22) Filed: Jun. 15, 2026

Related U.S. Application Data
(63) Continuation of application No. PCT/EP2024/085341, filed on Dec. 9, 2024.

(30) Foreign Application Priority Data
Dec. 15, 2023 (GB) 2319269.3
Dec. 15, 2023 (GB) 2319273.5
Dec. 15, 2023 (GB) 2319275.0
Dec. 15, 2023 (GB) 2319276.8
Dec. 15, 2023 (GB) 2319277.6
Dec. 15, 2023 (GB) 2319278.4
Dec. 15, 2023 (GB) 2319280.0
Dec. 15, 2023 (GB) 2319282.6
Dec. 15, 2023 (GB) 2319285.9
Dec. 15, 2023 (GB) 2319288.3
Dec. 15, 2023 (GB) 2319289.1
Dec. 15, 2023 (GB) 2319291.7
Dec. 15, 2023 (GB) 2319293.3
Dec. 15, 2023 (GB) 2319296.6
Dec. 15, 2023 (GB) 2319299.0
Dec. 15, 2023 (GB) 2319300.6

(51) Int. Cl. G02B 27/01

(52) U.S. Cl. CPC G02B 27/0172; G02B 27/0176; G02B 27/0179; G02B 2027/0178; G02B 2027/0187

(57) ABSTRACT

An apparatus that displays synthetic scene images for augmented reality, virtual reality and other display types. One or more pairs of input beams are injected into a display panel incorporating a layer of phase matched nonlinear optical (NLO) material. The input beams of each pair are brought to cross each other in the NLO material in a noncollinear geometry to generate a product beam by sum frequency generation that is directed to the eye of a viewer. The synthetic scene image information is impressed on each input beam pair by amplitude and phase modulation to set the amplitude (i.e. brightness), wavevector (i.e. direction) and wavefront radius of curvature (i.e. depth) of the synthetic scene image. For colour display, three pairs of input beams with respective sum frequencies in three primary colours are used.

### CROSS-REFERENCE TO RELATED APPLICATIONS

This application is a continuation of International Application No. PCT/EP2024/085341, filed Dec. 9, 2024, and published as WO 2025/125176, which claims priority of United Kingdom Applications GB2319276.8, GB2319277.6, GB2319280.0, GB2319282.6, GB2319289.1, GB2319293.3, GB2319296.6, GB2319299.0, GB2319275.0, GB2319278.4, GB2319288.3, GB2319300.6, GB2319285.9, GB2319269.3, GB2319273.5, GB2319291.7, all of which were filed Dec. 15, 2023. All of the foregoing applications are incorporated herein by reference in their entireties. Also incorporated herein by reference in its entirety is International Application No. PCT/EP2023/065021, filed Jun. 5, 2023, and published as WO 2023/241985.

### FIELD OF THE INVENTION

The invention relates to optical apparatus.

### BACKGROUND OF THE INVENTION

Displays for different purposes vary in size from a few millimetres mm up to 10 metres or more.

Example smaller displays are for smart watches or AR spectacles or VR goggles. Augmented reality (AR) and virtual reality (VR) displays have been incorporated into a variety of wearable formats including headsets. For AR headsets a glasses (i.e. spectacles) format is common. For VR headsets, a ski goggles format is common. A recent review article on AR and VR display technologies is the paper by Zhan, Yin, Xiong, He and Wu “Augmented Reality and Virtual Reality Displays: Perspectives and Challenges” Perspective, Vol. 23, Issue 8, 101397 (2020) at https://doi.org/10.1016/j.isci.2020.101397.

In AR, an image of a synthetic scene is superimposed on a natural scene that is simultaneously viewed by the viewer. AR spectacle lenses lie at a vertex distance of about 12-15 mm, which is much closer than the eye's near point, which is gradually increases with age from about 7 cm for a youth to over 50 cm for an old person. (The eye's near point is the closest distance which the eye can bring into focus.) In AR, the synthetic scene is therefore be represented by a virtual image arranged further away from the eye than the AR spectacle lenses. VR image formation is simpler than AR, since there is no natural scene and only a synthetic scene is generated. For an AR headset in spectacles format, the most common technology approach at present is to use a microprojector system. A virtual image reproducing a synthetic scene is routed onto one or both of the spectacle lenses. (We use the term ‘lens’ for linguistic convenience but it will be understood that the lenses may be blanks, i.e. have no focusing effect in the sense of normal vision correction for long or short sightedness etc.) The lenses of the AR spectacles are used as a medium to route the light representing the synthetic scene into the path of the natural scene light via suitable beam combiners. AR beam combiners can be subclassified into reflective (e.g. a mirror or prism) or diffractive (i.e. some kind of grating). The virtual image of the synthetic scene should give the impression of portraying one or more objects at the correct location in the natural scene, which means not only at the correct position (essentially angle) in the visual field but preferably also at the correct distance from the eye.

Compared with AR/VR displays, displays for smart phones and tablets are somewhat larger. Computer monitors and television screens are larger still, perhaps 10 inch to 90 inch diagonal length (25 cm to 225 cm). Even larger displays are found in cinemas, advertising hoardings and arenas, such as indoor and outdoor sport stadiums. Many different display technologies are used depending on the required brightness, the cost, the colour gamut, etc. These include liquid crystals, organic LED (light emitting diodes), and DLPs (digital light processors). Historical technologies include plasma TV, cathode ray tubes and laser back-projection.

Lack of brightness for outdoor use is an issue with both current AR spectacles and large area displays such as televisions that are placed outdoors or very large area displays for sports stadiums.

### SUMMARY OF THE INVENTION

Various aspects of the invention are as specified in the attached claims.

The nonlinear optical (NLO) material is phase matched to first and second selected combinations of the frequencies of the first and second input beams, and to a frequency equal to the sum or difference of the selected combinations.

The simplest combination of the frequencies of the first and second input beams is to take those frequencies themselves, so that the product beam has a frequency equal to the sum of the first and second frequencies. Other frequency combinations that can be selected include an integer multiple of either or both of the first and second frequencies, and a sum or difference frequency between the first and second frequencies. For example, the product beam may be derived from mixing twice the frequency of the first input beam with the frequency of the second input beam. Another example would be that the product beam is derived from mixing the difference frequency between the first and second frequencies and the second frequency.

The above can be expressed scientifically as follows. The first and second input beams have two wavelengths λ_1 and λ_2. We label the more energetic one as λ_1 (shorter wavelength). They will have associated frequencies v_1 and v_2. The selected combination of λ_1 and λ_2 output a product beam with wavelength λ_0 as follows:

$${λ}_{0} = \frac{1}{( \frac{m}{{λ}_{1}} \pm \frac{n}{{λ}_{2}} )}$$

or frequency v_0 as follows:

$${v}_{0} = \frac{m \cdot c}{{λ}_{1}} \pm \frac{n \cdot c}{{λ}_{2}}$$

where m, n are integer values in the series: 1, 2, 3 . . .

The simplest combination with the product beam having a frequency equal to the sum of the first and second frequencies is m=n=1. A first specific embodiment of the invention is with m=n=1. Another group of embodiments excludes the first specific embodiment and can be defined by at least one of m and n being not equal to 1.

Selection of a suitable frequency combination from any of the above theoretically possible frequency combinations must also have regard to the absorption properties of the material, so large values of m, n-especially if the minus is used—can mean wavelengths that will be absorbed by the UV edge of the material and therefore be unsuitable in practice.

The type of device into which a display panel according to the invention is incorporated will determine the vertex distance. A wearable headset will typically have a vertex distance of between 10 mm and 100 mm. A vertex distance range of between 10 mm and 20 mm is typical for spectacles, including AR spectacles, and a vertex distance range of between 50 mm and 80 mm is typical for a helmet visor. In a window panel structure aligned vertically, the vertex distance may typically be in the range 5 cm to 70 cm for a person standing or seated in front of the window panel and the viewer may have a fixation point that is relatively close, e.g., at a distance of 50 cm to 200 cm in the case of a fume cupboard, or a fixation point at any distance up to infinity, such as when driving and looking through the windscreen of a vehicle or aircraft.

### BRIEF DESCRIPTION OF THE DRAWINGS

This invention will now be further described, by way of example only, with reference to the accompanying drawings.

FIG. 1 is an explanation of how imaging of a distant object requires wavefront information.

FIG. 2 is a diagram showing how imaging through a lens element and into the eye relies on both wavefront direction and wavefront curvature.

FIG. 3 is a diagram explaining why a point light emitter cannot be used in a near-to-eye display.

FIG. 4 shows a nonlinear optical approach for generating near-to-eye artificial images that can be superimposed onto natural scene light.

FIG. 5 shows the concept of quasi phase matching.

FIG. 6 shows two-dimensional phase matching and different grating vectors can be constructed.

FIG. 7 shows an implementation of NLO mixing for generating synthetic scene light with bouncing paths within a lens.

FIG. 8 shows non-collinear phase matching.

FIG. 9 shows a more detailed figure showing nonlinear wavefronts overlapping in a layered NLO quasi-phase matching (QPM) material to create image information.

FIG. 10 shows routes to allowing beams with different pairs of intersection angles relative to a QPM structure to overlap in a common place.

FIG. 11 shows a scheme for steering beams into a device.

FIG. 12a shows a scheme for deflecting a beam without angular change.

FIG. 12b shows components to direct light to a desired point within a NLO material layer while altering the angles that the light approaches that spot.

FIG. 13 shows a lens structure with input beams and emitters capable of creating image with desired apparent focus depth.

FIG. 14 shows imprinting a desired wavefront through nonlinear mixing of amplitude and phase structured beams.

FIG. 15 shows a system for creating a far field pattern from an image to allow conversion via an NLO material.

FIG. 16 shows a multi-layered optical composite to create a display system.

FIG. 17 shows altering the local Kg position across a spectacle type display system.

FIG. 18 shows different lens designs in terms of cross-section with appropriate advantages.

FIG. 19 shows a spectacle lens AR system incorporating multiple sensors and communications to an external computing device.

FIG. 20 shows a spectacle system incorporating a series of diode elements around the outside to detect damage to the system.

FIG. 21 shows an electrically controlled light dimming system incorporated into a lens.

FIG. 22 shows a display device incorporating sub regions of NLO material, and with separate red, green and blue generating regions.

FIG. 23 shows QPM period as a function of crossing angle for a simple second harmonic process, indicating why it is advantageous to use larger crossing angles.

FIG. 24 shows an approach for creating a lens in which beams enter from one side but maintain crossing in opposing directions.

FIG. 25 shows a time sequenced displays to provide RGB and different ROC images to create a convincing full colour, and depth of field realistic display.

FIG. 26 shows inwardly facing cameras to track pupil position.

FIG. 27 shows how blanking based upon the inwardly facing cameras can be used to reduce unwanted visual effects.

FIG. 28 shows a lens with an absorbing layer dispersed around the edge to prevent unwanted reflections of light.

FIG. 29 shows a lens with sub regions of NLO material where each sub region contains elements capable of generating Red, Green and Blue.

FIG. 30 shows that the beam crossing angles across a lens requires local control of the QPM grating direction.

FIG. 31 shows a Virtual Reality (VR) configuration according to this invention, in which a near-to-eye image is created without the complexity of using a thin lens.

FIG. 32 is a schematic diagram of image generation in an NLO material layer using an incoherent emitter array to generate one of the input beams.

FIG. 33a shows various options for modulating the two beams that interact in the NLO material.

FIG. 33b shows various options for phase controlling across an input beam to impart radius of curvature information.

FIG. 34 shows a schematic of the control system showing the inputs and outputs.

FIG. 35 shows a multi-layered optical composite to create a display system.

FIG. 36A is a schematic view of the front of a computing device with a display panel according to embodiments of the disclosure.

FIG. 36B is a schematic view of the rear of the computing device of FIG. 36A.

FIG. 37 is a block diagram of the functional components of the computing device of FIG. 36A and FIG. 36B.

FIG. 38 shows the differing principles of operation of a conventional NCTE display panel 910 (upper drawing) and an example NCTE display panel 911 embodying the invention (lower drawing).

FIG. 39A is a schematic drawing of one example display apparatus according to the invention employing a variable focal length lens for phase control.

FIG. 39B shows an example optical design to explain how apparent size of synthetic scene objects is determined.

FIGS. 39C and 39D shows, in more detail than in FIG. 39A and FIG. 39B, a 4f imaging system for a phase modulated input beam.

FIG. 40A, FIG. 40B, FIG. 40C and FIG. 40D are schematic drawings of different options for selecting the apparent depth in relation to the physical position of the display panel.

FIG. 41 is a schematic drawing of an NCTE display panel according to an embodiment of the invention employing a spatial light modulator (SLM) for amplitude modulation overlaid on a NLO material layer, thereby forming a hybrid NLO/SLM display panel.

FIG. 42 illustrates use of the hybrid NLO/SLM display panel of FIG. 41 to serve different display images to the left and right eyes of a viewer.

FIGS. 43A and 43B illustrate the comparative optical efficiency of the hybrid NLO/SLM display of FIG. 41 (FIG. 43B) and a conventional backlit LCD display panel (FIG. 43A).

FIG. 43C shows an example display stack of a an NLO/SLM display panel using an LCD as the SLM together with a touch sensor stack.

FIG. 44 illustrates a person with a hand-held device being operated in a virtual depth display mode as shown in FIG. 40C.

FIG. 45 illustrates further design considerations for operating in a virtual depth display mode as shown in FIG. 40C.

FIG. 46 and FIG. 47 are schematic drawings in perspective and plan view respectively of a first example video conferencing configuration.

FIG. 48 is a schematic plan view of a second example video conferencing configuration.

FIG. 49 is a schematic plan view of a third example video conferencing configuration.

FIG. 50 is a schematic plan view of a fourth example video conferencing configuration.

FIG. 51 shows a real-world video conference configuration (upper drawing) with an associated virtual video conference configuration (lower drawing) placing the participants on either side of a rectangular virtual table.

FIG. 52 shows a real-world video conference configuration (upper drawing) with an associated virtual video conference configuration (lower drawing) placing the participants on three sides of a triangular virtual table.

FIG. 53 shows a real-world video conference configuration (upper drawing) with an associated virtual video conference configuration (lower drawing) placing the participants around a round virtual table.

FIG. 54 shows an example spectacles frame design for routing an input beam to the nose side of a lens rim.

FIG. 55 shows a composite spectacle lens with an inset display panel section according to embodiments of the invention.

FIG. 56 is a schematic perspective view of a section of a composite spectacle lens as shown in FIG. 55 with an inset display panel section.

FIG. 57A shows an example display panel according to the invention as suitable for an AR spectacle lens.

FIG. 57B shows a further example display panel according to the invention as suitable for an AR spectacle lens together with an inset showing a wafer from which pieces for the display panel can be cut.

FIG. 58 illustrates two different modes of image stabilisation through a collection of schematic diagrams of an AR spectacle frame 26 with a synthetic scene element shown as a five-pointed star.

FIG. 59 is a schematic drawing of an AR spectacles frame with inbuilt light sources to mimic synthetic scene features that appear in the peripheral vision.

FIG. 60A shows a set-up using display panels according to the invention in a contact lens format for AR representation of a synthetic scene combined with spectacles to provide the contact lenses with input beam pairs.

FIGS. 60B to 60E show further details of contact lens embodiments.

FIG. 61 shows a display panel according to the invention set in a window of a fume cupboard.

FIG. 62 is a schematic drawing of an apparatus for manufacturing a display panel using vapour phase deposition.

FIG. 63 shows a layer stack for a phase matched grating in which first and second NLO material layers of opposite domain orientation are interposed with electrode layers formed of a conductive organic material to allow application of an electric field to the NLO material layers.

FIG. 64 is a schematic drawing of an apparatus for rolling a display panel layer structure (upper drawing) to reduce its thickness and increase its area (lower drawing).

FIG. 65 is a schematic drawing of an apparatus for manufacturing a display panel using a spin-coating process.

FIG. 66 is a schematic drawing of an apparatus for manufacturing a display panel using a Langmuir Blodgett film process.

FIG. 67 is a schematic drawing of a display panel in which the nonlinear optical layers for forming the phase matched grating are made of liquid crystal cells.

FIGS. 68A to 68F show different possible poling arrangements for NLO materials according to the invention.

FIG. 69 shows one half of a pair of spectacles according to an embodiment of the invention.

FIG. 70 shows different view of the spectacles of FIG. 69.

FIG. 71 shows a mirror array structure and related components of the spectacles of FIG. 69.

FIG. 72 shows in plan view the mirror array structure of FIG. 71 and related components.

FIG. 73 shows an alternative optical arrangement for creating input beam illumination from the temple of the spectacles of FIG. 69.

FIG. 74 is a schematic drawing of a pair of spectacles according to an embodiment of the invention.

FIG. 75 is a schematic plan view of the spectacles of FIG. 74.

FIG. 76 shows an enlarged version of a part of FIG. 75.

FIG. 77 show an optical arrangement for beam forming by noncollinear sum frequency mixing (or SHG) in a phase-matched region of material.

FIG. 78 shows the same optical configuration as in FIG. 77 but with the addition of a beam splitter 1251 arranged in the output beam path.

FIG. 79 shows a concatenated pair of the previously described configurations, i.e., a two-stage beam combiner.

FIG. 80 shows a hexagonal cross-section NLO material being used to combine 3 pairs of input beams.

FIG. 81 is a schematic diagram of a communication system including a headset or other device according to the invention.

FIG. 82 is a block diagram illustrating an example computing apparatus that may be used in connection with various embodiments described herein.

### DETAILED DESCRIPTION

### Introduction

There are some problems with one or more of the existing AR and VR display technologies.

One problem is how to avoid unwanted light scattering on the spectacle lenses caused by the projected beams, which detracts from the appearance of the scene and results in the AR spectacles not giving the impression of being fully transparent. For example, since spectacle lenses are placed around 12-15 mm from the eyeball and since this distance is similar to the focal length of the eye, any unwanted light scattering from the spectacles becomes collimated by the eye and spreads widely across the retina. In bright ambient light conditions, such scattering is perceived as glare. In low ambient light conditions, such scattering can be much brighter than the light from the natural scene and hence severely impair vision. Light scatter artefacts, such as rainbow effects, are a particularly acute problem when a grating-based beam combiner is used.

Another problem, which is relevant for both AR and VR, is how to avoid vergence-accommodation conflict, which is a characteristic of binocular vision where the normal relationship between accommodation and vergence that exists when viewing a natural scene is broken by the rendering of the synthetic scene, resulting in headaches and nausea. A vergence-accommodation conflict arises when an object in a synthetic scene is perceived to be arranged at one distance (and the vergence locks to that distance) whereas the light representing that object originates from a different distance (and accommodation locks to that distance). Even in monocular vision the brain has an accommodation expectation based on the brain's understanding of the juxtaposition of objects in a familiar scene, so that headaches and nausea can also arise from monocular vision of a synthetic scene that causes the eye to accommodate at a certain distance when viewing an object, where the distance is different from the brain's expectation of the object's distance.

Some problems are specific to AR displays.

One of the major technical limitations of current AR display technology is the use of AR outdoors. Ambient luminance on a sunny day is typically 3,000 candela per square metre (nit) or 1,000 lux. To be of sufficient contrast to be readable, text needs to be three times brighter than its background. The ratio for AR scene content is higher. Therefore, text information overlaid on an AR display panel needs a brightness of at least 30,000 nits or 10,000 lux to be readable by the wearer. These brightnesses are not readily achievable with current AR technology based on LED sources, such as micro-LEDs or LED plus modulator sources. Lack of brightness is therefore holding back widespread adoption of AR displays in daylight conditions. For example, a pilot may wish to use an AR display in a headset (e.g. helmet visor or glasses) or as part of a head-up display. An AR display using LED sources may be perfectly visible below cloud and then become effectively invisible when the pilot breaks through the cloud into sunlight. The challenge in bright ambient light is thus to ensure that the synthetic scene information is visible against the bright natural light scene.

Another problem with current AR display technology is stray light leakage out of the front of the display, which is undesirable in certain applications, such as when the wearer of AR glasses needs to remain unseen. An application example here is for infantry soldiers who need to remain undetectable when on night operations.

### Optical Characteristics of the Human Eye and Human Vision

When designing a display apparatus, it is important to have regard to the optical characteristics of the eye as well as how the eyes are controlled individually and jointly by the brain, and also how the brain processes image information from the eyes.

To enter the eyeball, light passes through the eye pupil, through the cornea, through the eye lens and thence to the back of the eyeball where the retina is located. The effective radius of the pupil is controlled by the iris (pupillae muscle). The pupil dilates and contracts according to ambient brightness to increase and decrease the amount of light entering the eye. The pupil diameter varies over a range of a few millimetres, with a range of 2-4 mm being the most common. The eyeball diameter is about 25 mm.

If spectacles are worn, then the light from a distant object that passes into the eye passes through an area of the spectacle lens which is essentially similar in size to the iris diameter. The distance from a spectacle lens to the front of the eyeball is about 12-15 mm and is referred to as the back vertex distance or vertex distance.

The visual field of a single eye is referred to as the monocular visual field and is usually defined in terms of the angular range of what can be seen by the eye when the eye is pointing in a particular direction to fix its vision to a certain point. The monocular visual field in relation to the eye's vertical meridian extends laterally inward (towards the nose) by approximately 60 degrees and laterally outward by approximately 107 degrees. In relation to the eye's horizontal meridian, it extends vertically upwards by approximately 70 degrees and vertically downward by about 80 degrees. The binocular visual field is the superposition of the monocular fields of the left eye and right eye, so is appreciably greater laterally. In this document, references to ‘the visual field’ refer to the monocular visual field. If the binocular visual field is referred to, this will be expressly stated.

Normal human vision involves a series of movements of the head from the spine and swivelling of the eyes in their sockets. Head movements can be thought of corresponding to roll, pitch and yaw angles in relation to straight ahead, where yaw is produced by the normal left-to-right head swivel, pitch by the up-and-down head nodding motion and roll by side-to-side motion of the head. Eyeball swivel range for the human eye is about +25 degrees up, −30 degrees down, and about +45 degrees left and right. Eyeball swivelling is used to place the retinal image of the natural scene location that is of the most interest on the fovea, which is the subarea of the retina with the highest resolution, the fovea providing an angular range of about 1-2 degrees in the visual field (compared with about 18 degrees for the visual field of the whole retina, i.e. macula lutea). Furthermore, the eye moves around naturally (saccadic motion) which keeps the eyes moving to avoid effects of saturation and unresponsiveness. Thus, the eye is constantly roving the scene, with the brain carrying out image processing which cancels out the blurring effects of eye motion.

For monocular vision, if one considers light emanating from a given point in a natural scene, the light will effectively be a spherical wave with an origin at that point. The spherical wave impacts on the front of the eye, passes through the cornea, pupil and eye lens and onto the retina. The refractive power of the eye lens is adjusted by the ciliary muscles to form a focused image of the scene light on the retina. The eye lens receives a wavefront, this wavefront having a particular central angle and radius of curvature. In the case of light from a distant point in the natural scene (effectively infinite distance), the waves can be treated as entering the eye as plane waves, i.e. the wavefront is a planar wavefront. For monocular vision perception of most individuals, infinite distance is any distance above about 4 or 5 metres. The angle which light incident from such a distant point makes to the axis of the eye determines the position on the retina where that light falls. In the case of light from a closer point in the natural scene, then the waves enter the eye with a finite radius of curvature, which is perceived in monocular vision by an eye's accommodation. The eye will accommodate, i.e. adjust its focus, to bring the light from the closer point to a sharp focus on the retina. The human brain links the amount of accommodation to object distance, so a distance perception arises. (Distance perception also takes account of the vergence effect from binocular vision.)

For monocular vision, we can therefore consider the natural scene to be an aggregate of point light sources at different positions in the monocular visual field, in which the three-dimensional (3D) location information of each point is encoded by the light's input angle, i.e., two-dimensional (2D) position in the monocular visual field, and the light's radius of curvature at the eye (i.e. depth). As well as 3D location information, it is of course the case that the light from each point additionally carries intensity information and colour information.

In near-eye display systems, such as AR, VR and contact lenses, the term ‘eyebox’ (or eye motion box) is used to refer to a volume within which the eye receives an acceptable view of an image, whether that be a real image or a virtual image. A simple definition of the eyebox is the 3D volume over which the entire field of view (FOV) is visible for a standard pupil size taking account of the fact that in human vision the eye is continually moving to focus on different areas within the FOV. The specified dimensions of the eyebox in AR or VR goggles are typically larger than the theoretical movement range of the eye pupil to cover for alignment tolerances and person-to-person variation in pupil distances.

### Overview

This invention proposes a display apparatus based on a display panel which hosts phase-matched nonlinear mixing of pairs of input beams that cross in the display panel in a non-collinear geometry. The crossing takes place in a region of NLO material within the display panel. Each crossing input beam pair produces a product beam by sum frequency generation (SFG), or other nonlinear mixing process in the NLO material.

Display apparatus according to this design can be provided for close-to-eye image formation; both for AR and VR. Display apparatus according to this design can also be provided for large format displays such as large screens for video conferencing or television.

According to one aspect of the invention, there is provided a display apparatus for displaying synthetic scene images responsive to input of image information, the display apparatus comprising:
a first beam source for providing a first input beam of a first frequency and bandwidth;
a second beam source for providing a second input beam of a second frequency and bandwidth;
a display panel containing NLO material that is phase matched to the first and second input beams and to a product beam of a sum frequency that is equal to the sum of the first and second frequencies;
input beam routing components arranged to introduce the first and second input beams into the display panel so that they traverse the display panel in first and second paths that cross each other in the NLO material in a non-collinear geometry to define an intersection volume where the product beam is generated by sum frequency generation; and
a controller operable responsive to the input of the image information to form the synthetic scene images by amplitude modulating at least one of the first and second input beams and by phase modulating at least one of the first and second input beams to set each of amplitude, wavevector and wavefront radius of curvature of the product beam.

In some embodiments, the first input beam encodes image intensity information that defines the intensity of the product beam generated at each intersection volume of a given synthetic scene image and the second input beam encodes image depth information that defines the wavefront radius of curvature in the product beam generated at all intersection volumes for a given synthetic scene image. This is a convenient arrangement for allowing each synthetic scene image that is formed to be associated with a different perceived depth through setting its wavefront radius of curvature. Specifically, when the second input beam has a substantially planar wavefront, by which is meant a wavefront radius of curvature of greater than 5 metres, the synthetic scene image is formed at a distance perceived to be infinite, whereas when the second input beam has a wavefront radius of curvature of less than 5 metres, the synthetic scene image is formed at a distance perceived to be finite. It is thus possible to form several synthetic scene images in quick succession to build up different layers of scenery in an image frame, e.g. a background at infinity and one or more closer layers on which specific image elements are represented.

In some embodiments, the controller is operable to group the synthetic scene images into image frames, the different synthetic scene images of a given image frame having different wavefront radii of curvature to represent image elements that lie at different respective perceived distances.

In other embodiments, the display apparatus is for displaying a synthetic scene image in colour and comprises a plurality of beam sources which includes the first and second input beam sources, wherein the first and second input beams form one of three input beam pairs generated by the plurality of beam sources, the first to third input beam pairs combining to generate first to third product beams with first to third sum frequencies which provide first to third primary colours. In such embodiments, the plurality of beam sources to form the three input beam pairs may comprise an emitter array and first to third lasers, wherein the emitter array provides one of the input beams for all three input beam pairs, the other input beam of each pair being provided by one of the first to third lasers, the first to third primary colours being provided by time slicing so that the first to third product beams are generated sequentially. In particular, the emitter array may be driven to amplitude modulate the input beam which it generates. For example, the NLO material may comprise first to third spatially modulated regions to provide quasi-phase matching for the first to third input beam pairs respectively. One option here is when the first to third spatially modulated regions are formed in the NLO material at first to third depth portions in the display panel. Another option here is when the first to third spatially modulated regions are formed in the NLO material as an array of spot clusters, each spot cluster comprising adjacent spots of each of the first to third spatially modulated regions.

For colour display in some embodiments, the controller may be operable to group the synthetic scene images into image frames, the different synthetic scene images of a given image frame being in each of the first to third primary colours.

For colour display in some embodiments, the controller may be operable to group the synthetic scene images into image frames, the different synthetic scene images of a given image frame being in each of the first to third primary colours and having different wavefront radii of curvature, thereby to represent colour image elements that lie at different respective perceived distances.

In some embodiments, the input beam routing components are adjustable to provide for variation of at least one of the first and second paths to vary the angle at which the first and second input beams cross in the NLO material and thereby vary the wavevector direction of the product beam.

In some embodiments, the input beam routing components are adjustable to provide for variation of at least one of the first and second paths to vary the location where the first and second paths cross in the NLO material.

In some embodiments, the display apparatus further comprises an amplitude modulator arranged to amplitude modulate the first input beam and a phase modulator arranged to phase modulate the second input beam. In other embodiments, the display apparatus further comprises a combined amplitude and phase modulator to amplitude and phase modulate one of the first and second input beams.

In some embodiments, the NLO material is spatially modulated in respect of its second order nonlinearity to provide phase matching through quasi-phase matching. In other embodiments, the NLO material is homogeneous in respect of its second order nonlinearity to provide phase matching through birefringent phase matching.

Regarding the first and second frequencies and their sum frequency: The sum frequency is preferably in the visible range, i.e. ca. 790-405 THz/380-740 nm. The first and second frequencies are in the infrared range, i.e. ca. 400-150 THz/750 nm to 2 μm. The ratio of the first and second frequencies is between 0.5 and 2.0.

For AR, the display panel, including the NLO material, is made transparent across the visible range, i.e. ca. 790-405 THz/380-740 nm, so that natural scene light can pass through to the eyes of the viewer.

In some embodiments, the display panel has a peripheral region containing a material that is absorbent to light at the first and second frequencies so that the first and second input beams are absorbed after the first and second paths have crossed each other in the NLO material when they reach the peripheral region.

In some embodiments, the display apparatus further comprises one or more light sensors arranged outside the display panel to detect for abnormal leakage of input beam light out of the display panel indicative of structural damage of the display panel.

The NLO material may be contained in the display panel in a NLO material layer. In one specific implementation, the display panel comprises a back filter layer arranged to the back of the NLO material layer, the back filter layer being opaque to the first and second frequencies and transparent to the sum frequency, to block emission of light from the first and second input beams out of the display panel in an outward direction. In another specific implementation, the display panel comprises a front filter layer arranged to the front of the NLO material layer, the front filter layer being opaque to the first and second frequencies, to block emission of light from the first and second input beams out of the display panel in an inward direction. The front filter layer may be transparent to visible frequencies. One option is for the NLO material to be distributed across the NLO material layer continuously such that phase matching and hence product beam generation can occur at any location in the NLO material layer. Another option is for the NLO material to be distributed across the NLO material layer as an array of spots such that phase matching and hence product beam generation is confined to the locations of those spots.

In some embodiments, the display panel comprises a light blocking layer comprising an array of pixels which are individually addressable by electric control lines in order to switch the pixels between a first state which is opaque to visible frequencies and a second state which is transmissive to visible frequencies, so that natural scene light can be blended out of selected areas of the light blocking layer.

In some embodiments, the first and second paths traverse the display panel by successive reflections. The successive reflections may be from front and back surfaces of the display panel by total internal reflection. Alternatively, the successive reflections may be from front and back mirror layers arranged in the display panel that are respectively disposed to the front and back of the NLO material. Specifically, the front and back mirror layers may be reflective at the frequencies of the input beams and transmissive across visible frequencies.

In some embodiments, the NLO material is transparent across the visible.

In some embodiments, the first and second frequencies are different. In other embodiments, the first and second frequencies are equal so that the sum frequency generation is second harmonic generation. When the first and second frequencies are equal, the first and second input beam sources can be one and the same beam source and the first and second input beams are both derived from that beam source.

The above-specified display apparatus may be incorporated into a wearable headset such that the display panel is arranged in front of a wearer's eyes at a vertex distance of less than 30 mm for close-to-eye image formation.

Assuming SFG is the nonlinear process that is exploited and also assuming the product beams are to be formed at visible wavelengths/frequencies (ca. 380-740 nm/790-405 THz) to create a synthetic scene image that is visible to the human eye, the input beams of each pair will both lie in the infrared (e.g. 750 nm to 2 μm/400-150 THz), at least provided that they are not too dissimilar in wavelength/frequency (e.g. have a ratio of less than 2:1).

As an alternative nonlinear mixing process of SFG, three photon summative mixing could be provided by a combination of collinear mixing second harmonic generation (SHG) in one of the input beams and non-collinear mixing of the second harmonic with the other input beam of the pair.

The phase matching in the NLO material may occur without structuring the material, e.g. by using a sufficiently thin layer of NLO material with a high birefringence. However, the use of QPM will be convenient in many embodiments. To achieve QPM, the NLO material is structured to spatially modulate its nonlinear properties. Most commonly periodic poling is used to create a grating structure characterised by a single periodicity and alternating signs of the second order nonlinearity χ(2).

The two input beams of a pair are directed to traverse the NLO material at angles which ensure that the wavevector of the product beam has a direction that propagates into the viewer's eye, i.e. through the pupil.

The non-collinear mixing of first and second input beams in the NLO material allows a product beam to be generated whose properties are controlled in amplitude (i.e. image brightness), in wavevector (i.e. to direct the generated light towards the pupil), in wavefront curvature (i.e. to control perceived distance of the image) and image element location in the visual field (i.e. position on the NLO material).

To create a realistic impression of binocular vision, it is possible to exploit the ability to control the wavevector direction and image element location in order to present slightly different images of the same synthetic object to the left and right eyes of a viewer, e.g. on each lens of a pair of AR spectacles, so that the natural vergence and the associated perception of depth (stereopsis) for the synthetic object is provided for. For synthetic objects that are close enough for monocular vision depth perception (i.e. less than about 4-5 metres), the vergence simulation can be combined with setting the wavefront curvature of the synthetic object so that the focus of the eye (accommodation) is matched exactly or at least approximately to the same distance as associated with the vergence, thereby avoiding vergence-accommodation conflict. For synthetic objects at greater distances, a planar wavefront can be used.

The nonlinear process creates an oscillating polarisation at the frequency of the product beam, i.e. in the visible. This process is inherently a wave-mixing phenomenon, which means that the product beam has transverse (i.e. spatial) coherence with a defined phase relationship between different parts of the emitted wave. The product beam thus creates a wavefront which has a specific curvature. This is fundamental property not possessed by light generated by pixel emitters in a conventional microdisplay as used in current VR headsets, or point emitters as used in current AR spectacles. Rather, the product beam generated by the non-collinear mixing of the pair of input beams in the NLO material has properties that are more associated with a conventional diffractive optics approach which also emits a wavefront through diffraction. A transversely coherent approach to generating the light for the synthetic scene image is what allows the radius of curvature of the wavefront to be set, thereby allowing the synthetic scene image to be placed at a certain distance which can be varied by varying the radius of curvature of one of the input beam's wavefront. A natural depth perception can therefore be impressed on the synthetic scene image. Different synthetic objects can be given different depth appearances so they appear at appropriate depths relative to each other and, in the case of AR, in relation to objects in the natural scene. This not only contributes to the perceived realism of the synthetic scene image but also allows convergence-accommodation conflicts to be avoided.

A display apparatus can be provided that is able to direct light for the synthetic scene image into the eye from across a wide range of angles (i.e. from a large range of positions across the visual field). This property is beneficial, since it takes account of the large angular swivel range of the eye. This property is also beneficial, since it allows creation of a synthetic scene image that appears to emanate from an appropriate position within the visual field when the eye is pointing in a certain direction. Moreover, as mentioned above, the product beam light that forms the synthetic scene image can be emitted from the display panel with a defined radius of curvature so the different parts of the synthetic scene image can be placed in the synthetic scene at appropriate perceived distances.

For an AR headset, the display panel can be realized in a lens format. In a traditional spectacles format, in which a pair of lenses are set in a frame for the left and right eyes, there will be a physically separate display panel for each lens. In a ski goggles format with a single lens sheet, a single display panel could be used. For AR, the NLO material in the display panel is preferably transparent (in the visible) so that it can be incorporated into the display panel without reducing the transmission of light travelling from the natural scene, through the display panel into the eye. An AR display panel can thus be provided that appears truly transparent to the viewer, not only since the NLO material is itself transparent but also since the wavelengths of the input beams are outside the visible range (or at least can be easily chosen to be). Not only is the light from the input beams invisible to the human eye but more importantly it is easy to prevent input beam light at non-visible frequencies/wavelengths from entering the viewer's eye by arranging a layer of a suitable filter material (e.g. as a bandpass or edge filter) between the NLO material layer and the viewer's eye. The filter material is chosen to be opaque to the input beam wavelengths and transparent across the visible range of wavelengths. For an AR headset, it is also possible to adjust the brightness of objects in the synthetic scene image. This may be done simply by adjusting the intensity of one or both of the input beams of a beam pair. For a VR headset, the NLO material need not be transparent (in the visible), i.e. could be opaque (in the visible).

A display panel according to the invention can be thought of as a transparent microdisplay in the sense that, like a microdisplay, the visible light is created in localised regions capable of creating wavefronts across the display (the crossing input beam intersection volumes). Because of the feature of the invention whereby the only visible light is that generated for the image, problems associated with stray light and scattering in conventional microprojection systems for AR (or VR) do not arise. Instead of having visible beams traversing the lens to form the image in the visual field of the eye, we have infrared beams, i.e. input beams that are at wavelengths outside the visible range and which can in any case be prevented from entering the eye by arranging a suitable filter layer between the eye and the NLO material layer. Consequently, there is no glare and no bright scattering artefacts to disturb night-time vision. A display apparatus can therefore be realised that in terms of its light generation is analogous to a microdisplay VR display apparatus but unlike a microdisplay is transparent (in the visible) so that it can be used for AR.

### Colour Displays

The above discussion of the invention has been confined to considering the generation of a single product beam from a single pair of input beams. This can be thought of in terms of describing a monochrome display or alternatively one of three colour components of a colour display. For a colour display, three product beams are needed, one for each of the three primary colours, so there will be three pairs of input beams.

According to another aspect of the invention for colour display, there is provided a display apparatus for displaying synthetic scene images responsive to input of image information, the display apparatus comprising:
a plurality of beam sources with respective frequencies and bandwidths to provide first to third input beam pairs of two input beams, each input beam pair having a pair of frequencies that sum to first to third primary colour frequencies;
a display panel containing NLO material that is phase matched to the first to third pairs of input beams and to first to third product beams at first to third primary colour frequencies which are equal to the sum of the frequencies of the first to third pairs of input beams;
input beam routing components arranged to introduce the two input beams of each input beam pair into the display panel so that the input beams of each pair traverse the display panel in first and second paths that cross each other in the NLO material in a non-collinear geometry to define an intersection volume where the product beam for that input beam pair is generated by sum frequency generation;
an amplitude modulator operable to amplitude modulate at least one beam of each input beam pair;
a phase modulator operable to phase modulate at least one beam of each input beam pair; and
a controller operable to form colour image frames, each image frame comprising first to third synthetic scene images generated by the first to third input beam pairs respectively, wherein the controller is operable to form each of the first to third synthetic scene images by controlling the amplitude and phase modulators responsive to the input of the image information to set product beam amplitude, product beam wavevector and product beam wavefront radius of curvature.

For colour display, the plurality of beam sources may comprise an emitter array and first to third lasers, wherein the emitter array provides one of the input beams for all three input beam pairs, the other input beam of each pair being provided by one of the first to third lasers, the first to third primary colours being provided by time slicing so that the first to third product beams are generated sequentially.

While the need to have three pairs of input beams implies there will be six input beams in total, this does not equate to a need to have six independently generated input beams. Firstly, the same wavelength can be shared between different input beam pairs, so the total number of wavelengths needed to form three pairs need not be as high as six but rather can be reduced to five, four or three, with three being the minimum possible number. Secondly, time slicing (i.e. multiplexing) can be used so that a common first input beam is used to generate all three colours in combination with dedicated second input beams, one for each colour, thereby reducing the total number of independently generated input beams that is required to four.

For colour display, if QPM is used, the NLO material can be structured with a single grating period that is used for all three colours. The lack of exact phase matching that will exist for at least two of the three colours can be tolerated and, if needed or desired, compensated for by changing the overall intensity of one or both of the input beams of each beam pair. The angles at which the input beams traverse the QPM NLO material can also be selected to be different for the different colours, so that exact phase matching (or at least closer to exact phase matching) is provided for all three beam pairs (i.e. all three colours). Alternatively, to provide quasi-phase matching, the NLO material can be periodically poled (or equivalently orientation patterned in the case of nonbirefringent materials) with three different periods so there are three regions of QPM NLO material with different grating periods, each period being optimized for one of the three colours. Another alternative is to create a single synthesised QPM structure with three phase matching peaks optimised for the desired three colours of the display. The three colour-specific QPM regions can be distributed in the image generation plane, e.g. across the display panel, in a regular or irregular 2D array of spot clusters, where each spot cluster contains three laterally adjacent colour-specific QPM regions, i.e. spots. The spots in each cluster are so close together that the fact they are not at the same position in the visual field will be imperceptible. Alternatively, the three colour-specific QPM regions can be distributed along an axis perpendicular to the image generation plane, e.g. over three different depth portions of the display panel. Here the colour-specific QPM regions could, like the above-described clusters, be arranged in a 2D array or could be continuous areas across the display panel as needed to cover the required visual field for synthetic scene image formation.

In the following, we mainly describe the invention in terms of generating a single product beam, i.e. in terms of generating a monochrome image or one colour component of a colour image. Nevertheless, it will be understood that a colour image can be generated from three such product beams from three pairs of input beams.

### Image Information for Close-to-Eye Synthetic Scene Image Formation

To create a convincing virtual image of a synthetic scene in an image generation plane close to the eye, as is needed for AR spectacles in particular, it is necessary to accurately reproduce the image location information that would be encoded in light from an equivalent natural scene. The image location information is a subset of the overall image information and is what defines the perception of 3D placement of an object in a scene. As discussed in more detail below, for monocular vision, the image location information in a natural scene is essentially a combination of where the light from different parts of the natural scene appear in the visual field (i.e. the light's input angle into the eye) and the radius of curvature possessed by the light wave from each point in the natural scene when it reaches the eye. For close objects, the wavefront curvature is appreciable whereas for distant objects there is no appreciable curvature, i.e. the wavefront is effectively a plane wave. For synthetic scene image formation in a display panel that is close to the eye (e.g. at the vertex distance, which is ca. 12-15 mm, where a spectacle lens is typically situated), the input angle and radius of curvature information from a natural scene can be mimicked by generating light at a particular location on the image generation plane (so it appears in the correct point in the visual field) and with a particular direction of light propagation from that location (so the light generated at that location in the image generation plane enters the eye). As well as carrying the correct image location information, the light generated on the image generation plane must also have the correct intensity and, for a colour image, the correct colour.

In the context of the present invention, correctly encoding the image location information for the synthetic virtual image involves generating the product beam light in the NLO material at the correct locations (visual field angles), with the correct wavevector directions and with the correct radii of wavefront curvature. To generate the image, the image intensity information must of course also be reproduced, which can be done in a straightforward manner through appropriate amplitude modulation of one or both of the first and second input beams. For colour images, the image colour information also needs to be reproduced, which is done by producing three product beams of three primary colours (e.g. RGB) in the QPM NLO material at each location in the visual field, i.e. to provide an appropriate colour gamut in the same way as for any colour projection system.

To give a convincing binocular vision perception of the synthetic scene, the respective images formed for each of the left eye and right eye will correspond but will not be the same. In particular, for the left and right eyes, light from the same point in the synthetic scene is formed at different locations in the monocular visual fields of each eye and with a different wavevector direction, thereby to mimic the natural vergence and the associated perception of depth (stereopsis). It will be appreciated that, for any parts of the synthetic scene that can be ascribed infinite distance, the images formed for each of the left eye and right eye can be made the same, since in the equivalent natural scene light from distant objects will arrive at both the left eye and the right eye as plane waves and at the same location in the respective monocular visual fields of the left eye and right eye. Although it should be realised that in creating a realistic visual scene any intermediate distance objects can block or occlude differently between the left and right eye scenes, so although both are plane wave, they emanate from different direction to the two eyes.

### Image Formation of the Synthetic Scene

We disclose two basic approaches for forming a synthetic virtual image in an image generation plane close to the eye. The first is a scanning approach to build up each image frame pixel-by-pixel, e.g. by rastering. The second forms a whole image frame simultaneously.

Image Formation in Angular Space (Input Beam Scanning/Retinal Scanning): First and second input beams are moved in both angle and position in respect of their traversal of the NLO region to create a product beam that is scanned across the monocular visual field of the viewer to form an image encoded in angular space with a retinal scan approach. An image frame is thus built up by rapidly scanning the visible light over the retina. In more detail, first and second input beams are provided which have respective beam cross-sections that are dimensioned so that where the first and second input beams cross in the NLO region their intersection volume is small to provide a plane wave that is not diffractively limited and which maps onto a point on the retina (through eye focusing), so the intersection volume at any location in the image generation plane corresponds to angular field single emission (as a wavefront) for building up the synthetic virtual image on the eye. For each intersection volume, the first and second angles at which the first and second input beams traverse the NLO region define the wavevector direction of the product beam. The wavevector direction is set to ensure that the product beam is directed to the pupil of the eye. To build up a whole image (for one eye), one or both of the first and second input beams are altered in angle, so that while the input beam intersection volume, i.e. where the product beam is generated, stays essentially constant the angle of the nonlinear generated light changes to a different angular position in the (monocular) visual field of the viewer's eye. At the same, the intensity of the product beam is varied to reproduce the image intensity information, which can be done by amplitude modulation of the first and/or second input beams, preferably also taking account of any variation in conversion efficiency of the nonlinear mixing as a result of the input beam traversal angles changing as the intersection angles alter over the image generation plane, so that over time a complete image frame is built up. As the input angles into the intersection volume are altered, the wavevector direction is also altered to ensure that the product beam remains directed to the pupil of the eye at all times. This can be done by appropriate adjustment of the angles at which the first and second input beams traverse the NLO material. The scanning of the intersection volume across the monocular visual field to build up each image frame may, for example, follow a line-by-line raster pattern. The raster may involve a back-and-forth movement meandering from left-to-right, then right-to-left etc. in a serpentine.

Whole Image Formation (upconversion analogy): This approach to image formation can be partially understood by analogy to a conventional up-conversion imaging system. A first input beam (e.g. at 1064 nm) contains the image intensity information and a second input beam (e.g. at 1550 nm) crosses with the first input beam in the NLO material to cause an upconverted version of the first input beam to be reproduced (as the product beam). This analogy is helpful but not complete, since it does not take account of the fact that the non-collinear phase matching according to the invention also allows control of the wavefront curvature of the product beam so that image depth information is incorporated into the synthetic virtual image. The image depth information is thus “added” to the “upconverted version” of the intensity modulated first input beam (i.e. the product beam) by phase modulation of the second input beam. This wavefront engineering feature of the present invention has no analogue in a conventional up-conversion imaging system.

In one embodiment of the invention, there is a implementation example which is closest to the up-conversion imaging analogue. The first input beam is amplitude modulated across its beam cross-section to carry the image intensity information that defines the intersection-volume-specific brightness in the product beam. The second input beam is phase modulated across its beam cross-section to carry image depth information that defines the intersection-volume-specific wavefront curvature in the product beam. In other implementation examples, which move further away from the up-conversion imaging analogue, both amplitude and phase are modulated in one or both of the first and second input beams across their beam cross-sections. For example, the first beam may be amplitude modulated and the second beam may be amplitude and phase modulated.

In a first specific example, both the first and second input beams are highly coherent transversely (i.e. in the cross-section of the beam). This is the case if the beam sources for both the first and second input beams are lasers and beam modulation is performed either with a SLM in transmission or a liquid crystal on silicon (LCOS) device in reflection. Here we note that both SLMs and LCOS devices can be operated to modulate amplitude (only), to modulate phase (only) or to modulate both amplitude and phase.

In a second specific example, the first input beam is incoherent and generated by a 2D array of incoherent emitters (e.g. an LED or OLED array) which provides amplitude modulation through the ability to drive each emitter independently. The second input beam is coherent, as is a requirement for phase modulation, being based on a laser source whose laser beam is phase modulated (e.g. by an SLM or LCOS device) and optionally also amplitude modulated as mentioned already for the first specific example.

In the context of an RGB display, which requires three input beam pairs for generating the three colours, the same incoherent emitter array can be used to generate a first input beam that is used for all three colours whereas each colour has its own dedicated second input beam, the three second input beams being generated by three different laser sources with three different wavelengths that sum with the wavelength of the incoherent emitter array to produce red, green and blue light respectively. Time division multiplexing (i.e. slicing) can then be used to sequence through red, green and blue synthetic scene image generation through appropriate drive electronics that synchronizes the outputs of the IR emitter array and the three laser sources. This kind of sequential driving (or ON/OFF modulation) of the three laser sources provides a kind of temporal RGB image formation analogous to the colour wheel approach in desktop projectors. Provided the refresh rate of the three colours is sufficiently high, then the viewer perceives a full colour palette RGB image.

Since it is possible to impress both phase modulation and amplitude modulation onto one beam to produce a combined phase and amplitude modulated single beam (e.g. with an SLM or LCOS device), further embodiments are also possible in which the other input beam is not spatially modulated at all.

### Other Features

Some other features of certain embodiments are now briefly summarized.

For input beam delivery into the display panel, a convenient approach is to introduce the first input beam at or close to one end of the display panel, e.g. the left end, and the second input beam at or close to the other end of the display panel, e.g. the right. However, it would also be possible to introduce both first and second input beams into the same end of the display panel. This could be enabled by a more complex phase matching scheme that uses appropriate reciprocal lattice vectors for the non-collinear phase matching. This could also be enabled by reflecting one of the first and second input beams from the other end of the display panel so that they cross in the same non-collinear geometry as for opposite end introduction of the first and second input beams.

There are various options for distribution of NLO material within the NLO material layer. In some configurations of the device the NLO material is distributed continuously over the NLO material layer, while in others it can be attractive to have a spots of the NLO material arranged in a grid over the NLO material layer. In the context of a grid-of-spots approach, it is noted that by NLO material we mean the NLO material that is phase matched to facilitate the nonlinear mixing, so that if QPM is used, then the spots could be localized regions that have been spatial structured for QPM within a layer of the same NLO material that is unstructured. With a grid-of-spots approach with confined localized regions of product beam generating NLO material, it is still possible to generate a convincing image, since the eye is continually swivelling. So long as the localized regions are close enough together so that light from at least one such region can be directed into the eye pupil, a convincing image can be formed.

In certain embodiments of the invention, the first and second input beams are each introduced at or close to one end of the display panel at a certain angle relative to the front and back faces of the display panel. Each input beam then propagates across the display panel to where the non-collinear mixing occurs by one or more reflections. In some embodiments, total internal reflection (TIR) from the display-panel-to-air interfaces is used to walk each input beams across the display panel from where it is introduced to where it crosses with the other input beam of its pair in order to generate the product beam. In other embodiments, reflective mirror layers are provided to the front and back of the NLO material layer to reflect at the wavelengths of the input beams, so that the input beams traverse the display panel by successive mirror reflections. One or both of the front and back mirror layers may be respectively at the front or back face of the display panel or be buried layers within the display panel. Mirror reflection allows for reflection at larger angles (i.e. closer to the normal) compared with TIR, which is beneficial if quasi-phase matching is used, since then the poling period can be larger, which is easier for fabrication.

Further functional layers can be added to the display panel. For example, it may be attractive to add a front filter layer to the front of the NLO material layer, which absorbs at the wavelengths of the input beams (and transmits at the wavelength of the product beam), so that any scattered input beam light is prevented from reaching the eye. In the case either of both of the input beams are laser beams, this will also help ensure laser safety requirements are met. A similar back filter layer can be added to the back of the NLO material layer to prevent input beam light escaping into the environment. If the display panel is for AR, then both the front and back filter layers should also be transparent across visible frequencies, so the natural scene light propagates through the display panel to the eye without attenuation.

A further safety measure is to provide one or more light sensors, such as photodiodes, outside the display panel to detect for abnormal leakage of input beam light out of the display panel that is indicative of the display panel being structural damaged. The light sensors may be arranged around the rim or outer edge of the display panel. Operation of the display apparatus can then be shut off if needed, e.g. when the display panel is damaged with a deep scratch.

A further possibility for AR is to include a photochromic or electrochromic layer so that the transmission of natural scene light can be reduced, e.g. in bright ambient light conditions, so that the synthetic scene light blends with the natural scene light appropriately. The darkening operation can either be automatic (as in photochromic lenses) or electrically operated. Moreover, the darkening can either be uniform darkening across the whole lens area or localized, e.g. to attenuate light from bright spots in the natural scene. Vision correction lens layers can also be provided, either to the front of or to the back of the NLO material layer (or both if two correction lenses are desired). If a correction lens layer is provided, there is preferably an input beam mirror layer interposed between the NLO material layer and the vision correction lens layer, so that the input beam light does not enter the vision correction lens layer and hence the input beam paths are not affected. In other words, the TIR solution is not preferred when vision correction lenses are included.

### Nonlinear Optical (NLO) Material

One kind of nonlinear mixing in a NLO material exploits the second-order nonlinearity χ(2). With nonlinear mixing there is conservation of energy, which means that the energy of the photons that are generated by the nonlinear mixing depends on addition of the energies of the photons of the input beams, which, given the Planck relation, means that the product light frequency is given by the sum or difference of the frequencies of the input beam frequencies.

Phase matching arises because of the wavelength dependence of the refractive index of a NLO material. The type of phase matching used in embodiments of the invention is known as non-collinear phase matching. Non-collinear phase matching occurs when two (or more) light beams with different directions of propagation cross to form a beam intersection region that lies in a phase matched NLO material. Phase matching ensures that the wavevector of the product beam generated by the nonlinear mixing is the vector sum of the wavevectors of the input light beams (and the compensating grating k-vector). The term non-collinear phase matching is used in contradistinction to the term collinear phase matching, which refers to the situation in which two input beams overlap in space and co-propagate so that the wavevectors of the input beams and the product beam are all in the same direction. Non-collinear mixing of two input beams can be characterized by the two angles subtended between the product beam and each of the two input beams which together sum to the crossing angle between the two input beams, i.e. the beam crossing angle. In the case of two input beams with wavevectors of equal magnitude, i.e. equal wavelengths, the two angles are equal and it is possible to refer to this angle as the beam crossing half-angle.

In practice, phase matching is commonly implemented with QPM, which overcomes the fact that the phase mismatch of the dispersion of the refractive index in a birefringent material does not permit phase matching unless the birefringent material is very thin. A NLO material is structured to spatially modulate its nonlinear properties, typically periodic poling is used to create a linear grating structure with alternating signs of the second order nonlinearity χ(2). For non-collinear mixing, the phase matching requirement of a QPM NLO material needs to take account of the angles at which each of the input beams traverse the QPM NLO material. Here it is noted that the poling period that is required for noncollinear mixing will be smaller than for collinear mixing, since only a component of the wavevector of each of the input beams will be in the poling direction.

Conventional birefringent NLO materials can be used. If the NLO material is quasi-phase matched then conventional inorganic NLO materials can be used, in particular oxides that are ferroelectric and which can be patterned by periodic poling. Examples are lithium niobate (LN) to create periodically poled (PP) lithium niobate (PPLN), magnesium oxide doped periodically poled lithium niobate (PPMgOLN), lithium tantalate (LT) to create PPLT and potassium titanyl phosphate (KTP) to create PPKTP. As is well known, microstructuring a ferroelectric NLO material with a QPM structure, e.g. a linear grating, is achieved by electric field poling. Some non-ferroelectric materials can also be processed to spatially modulate their nonlinear properties using a recently developed technique called orientation patterning, such as III-V Zincblende semiconductor crystals, e.g. GaAs. While orientation patterned GaAs is not transparent in the visible, other materials which are transparent could be used (e.g. orientation patterned GaN) could be used. Moreover, as well as using inorganic material such as the above, the poled NLO material may also be an organic material (or layers of an appropriately non-centrosymmetric organic material).

### Description of Figures

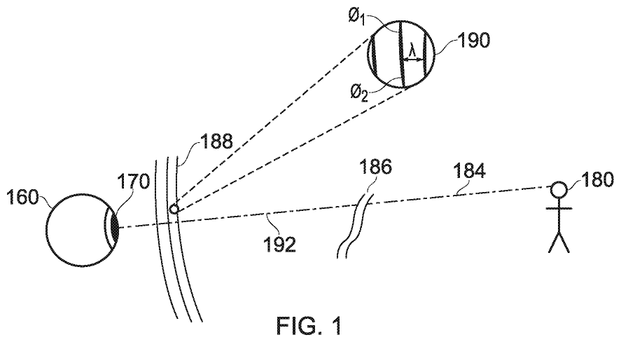

FIG. 1 shows a diagram of how an image is received by the human eye showing an eyeball 160 with a pupil 170. The eye receives an image of an object 180 illustrated as a ‘stick man’. The light scattered from the object 180 is received at the pupil 170 and is then focused by the eye's lens to the retina at the back of the eyeball where it is detected by rod and cone cells. The light can be considered as rays of light 184. Typically, the distance between the eyeball 180 and the object is at least 15 cm (or so), representing the near point of the eye. The distance can be much larger; in the case of starlight for example this is millions of kilometres or greater. The fact that this distance may be ‘large’ is indicated by the lines 186 to represent a discontinuity of scale in the figure. The light scattered from the object may be represented by wavefronts 188, an inset of which is shown as 190. Each wavefront is separated by one wavelength A of the light. There is a defined phase relationship between any two points on a given wavefront (indicated here as φ_1 and φ_2. In this diagram the wavefronts are shown to be curved with a wavefront curvature that corresponds to the distance 192 from the object 180. The lens of the human eye changes shape under muscular control (the ciliary muscles), and the shape taken creates a focusing of the incoming (generally curved wavefront) such that a desired part of the field of view is brought to a sharp focus on the retina.

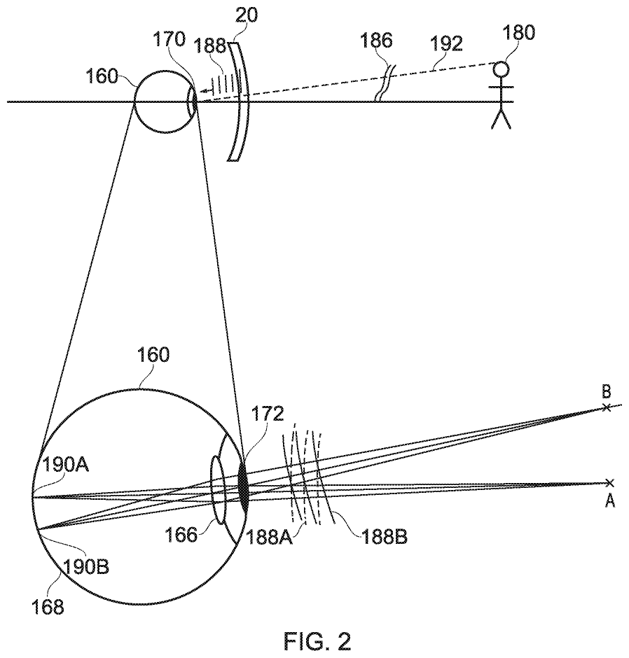

FIG. 2 shows an eye 160, an object 180, which is arranged at a distance 192 from the eye 160, this distance being large. A spectacle lens 20 is arranged in front of the eye. The light scattered from the object 180 that has passed through the spectacle lens is associated with a wavefront 188. Two sets of optical rays are shown emanating from points A and B. Point A is on-axis and Point B is off-axis in respect of the principal optical axis of the eye 160. The light incident on the eye enters the eye through the pupil as controlled by the iris 172. Light rays emanating from Points A and B are associated with respective wavefronts 188A and 188B and are focused at two different points 190A and 190B respectively on the retina 168 by the eye lens 166. The angle that the light rays make to the optical axis of the eye determines where on the retina the image is formed, while the wavefront curvature determines the position of focus.

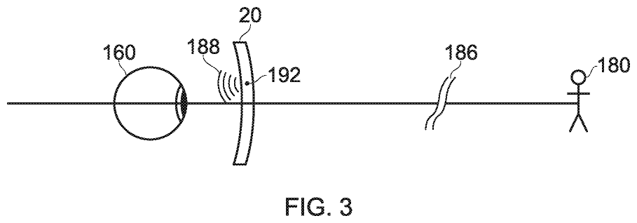

FIG. 3 shows that light emitted from a point source close to the eyeball will have a wavefront curvature that cannot match the wavefront curvature of light from a natural scene. An eyeball 160 and a distant object 180 are shown. The wavefront curvature of the light from the object 180 corresponds to the distance from the object, which is ‘large’. A piece of optical material (a spectacle lens) 20 is located close to the eyeball and is shown as hosting a point source of light 192. This point source 192 could be fluorescence from the optical material (such as a dye or a rare-earth element) or a scattering point (such as from a dust particle). The point source will create wavefronts 188 centred at the point source 192 with an associated radius of curvature. Because the point source is located very close to the eyeball (e.g. of the order 1 cm), the radius of curvature of the light will be small when it enters the eye. This creates two problems to be solved. Firstly, the wavefront emanating from the point source 192 is too divergent to be focused by the eye lens (i.e. the eye cannot create a sharp image on the retina). Secondly, the radius of curvature of the wavefront emanating from the point source 188 will be very different from that of the natural scene light from, for example, the object 180. To solve the first problem, the radius curvature must have a value above the threshold needed for the eye to be able to focus the image onto the retina. To solve the second problem, if the AR light source creates an object on the optical material, then, in order to obtain a convincing visual effect, it is necessary to make the radius of curvature of the light representing the virtual object the same, or approximately the same, as it would be if the virtual object were a real object. For example, if the real scene is of a golf course green with a hole, and the virtual object is a golf ball that is putted into the hole, then the radius of curvature of the wavefront representing the golf ball needs to be matched to the radii of curvature from the real scene in the proximity of where the golf ball is being presented. Such matching is what makes the distance perception realistic for the viewer. Such matching is also important for a pleasant viewing experience, since large discrepancies between wavefront curvatures presented to a viewer in a single scene is known to be unpleasant, since the natural match between the point on which the eye focuses (accommodation) and the point where the optical axes of the two eyes cross for binocular vision (vergence) is broken. This is referred to as the vergence-accommodation conflict which induces headaches and feelings of nausea similar to motion sickness. In this context, it is noted that in an AR (or MR) system outward facing cameras in combination with distance-measuring devices, such as LiDAR, can be used to survey the scene and obtain relevant information on an appropriate placement of virtual objects in the scene. An AR headset may wish to overlay an image of a new object onto a natural scene. This may be to overlay an object that is not present in the natural scene (e.g. to show two tennis players playing a match overlaid onto a natural scene of an empty tennis court). An AR headset may also wish to replace the image of a real object in a scene with a virtual object (e.g. to replace images of farm animals in the natural scene with images of dinosaurs).

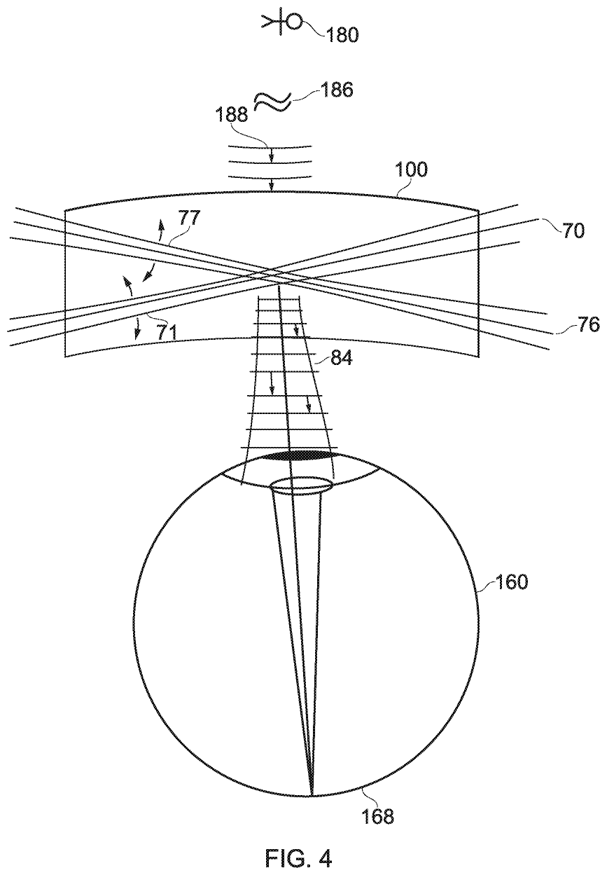

FIG. 4 is a schematic drawing illustrating operating principles used by embodiments of the invention. An eye 160 with retina 168 is shown. A piece of transparent (in the visible) NLO material 100 in the format of a spectacle lens with a front (proximal) face and a back (distal) face is arranged in front of the eye at a vertex distance. Light leaving the spectral lens from the front face towards the eye of the wearer travels in a proximal or inward direction. Light leaving the spectral lens from the back face away into the environment travels in a distal or outward direction. We refer to the lens as a spectacle lens by virtue of its format but this does not imply the lens has any vision correction function.

First and second input beams 70 and 76 are input into the NLO material 100 and cross so that an intersection region is formed within the NLO material 100. This is a non-collinear geometry. The first and second input beams 70, 76 have respective first and second frequencies. The first and second frequencies may be the same as each other or different. In the intersection region, nonlinear mixing occurs by sum frequency generation (SFG) and a product beam is generated. The product beam has a sum frequency that is equal to the sum of the first and second frequencies.

The product beam generated in the intersection region by the nonlinear mixing is effectively a point source and, as such, creates its own wavefront 84 with a wavevector direction that will send the product beam light to the pupil. The product beam is only generated where the beams overlap, i.e. in the intersection region. The NLO material can be chosen to be transparent to visible light and so the viewer can ‘see through’ the material, as would be needed for AR to allow a synthetic scene image to be superimposed onto the natural scene, as shown schematically by object 180 with wavefront 188, which is distant (represented by the discontinuity 186.

The physics of an extended source generated by nonlinear mixing, as proposed, is different from that of an extended source created by projection or emission from a fluorescent material in that nonlinear mixing by crossed beams allows for wavefront generation and phase matching, which can for example be realized with quasi-phase matching, so that the product beam can be generated in the intersection region with, in principle, any desired radius of curvature.

The synthetic scene image can be produced in the NLO material in a number of different ways. One option is to move the first and second input beams, as indicated by reference numerals 71 and 77, so that the angle of beam crossing is a function of position across the image generation area to “write” the synthetic scene image into the NLO material. To achieve this, the point of entry of the input beams into the NLO material may need to be varied. If the first and second input beams are appropriately modulated in intersection angle and amplitude, then a synthetic scene image can be built up, e.g. using some kind of rastering. Another option is to provide one or both input beams with a patterned cross-section, e.g. a 2D amplitude modulation, such that when the two input beams mix in the intersection region a complete object is created by the static overlay of the two input beam cross-sections and their angular spectrum. A combination of these two approaches may be used with a hybrid of scanning and beam-profile modulation. Within the general concept of generating the light of the synthetic scene image by a phase matched nonlinear process, it is further noted that the wavefront 84 generated by such nonlinear mixing can be given a desired direction as well as a desired radius of curvature, the desired direction being towards the eyeball as illustrated.

In summary, an image is created on the retina 168 which combines a wavefront 188 from the natural scene and a wavefront 84 of a synthetic scene image generated in the lens, wherein both wavefronts have the same or similar radii of curvature.

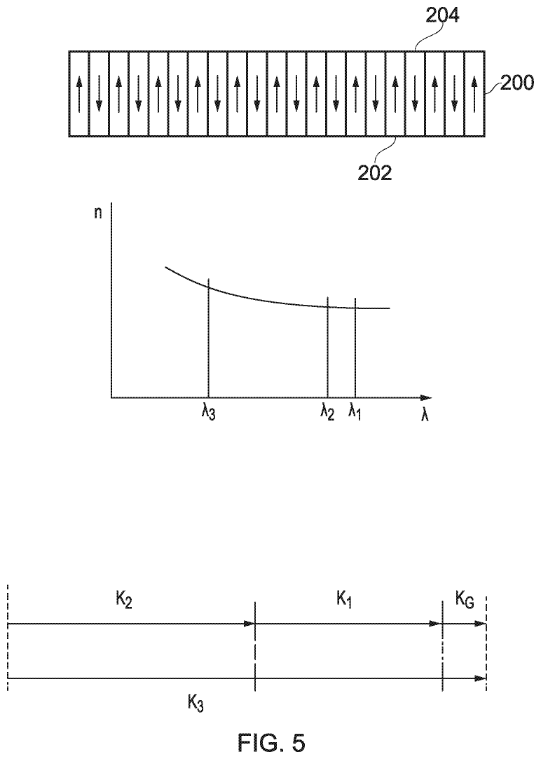

FIG. 5 shows key concepts of QPM. QPM is a property that can be impressed in certain nonlinear crystals through a method known as periodic poling. A ferroelectric nonlinear crystal is processed by periodic poling in order to create a periodic domain structure which modulates the sign of the crystal's nonlinear susceptibility so that it alternates positive and negative when light propagates along a certain direction within the crystal. Periodic poling thus mimics the effect of bonding slices of a birefringent material together into a stack with alternating crystallographic orientations, which is of course not practical, at least not for anything other than extremely long wavelengths in the very far infrared or microwave regions. A ferroelectric material most commonly used for periodic poling is lithium niobate, which after periodic poling is referred to as periodically poled lithium niobate (PPLN). Another material is periodically poled potassium titanyl phosphate (PPKTP). More recently, a technique called orientation patterning has been developed to allow periodic poling of non-ferroelectric materials, such as III-V Zincblende semiconductor crystals such as GaAs. As well as using inorganic material such as the above, the poled NLO material may also be an organic material.

As illustrated in the upper portion of the figure, a QPM NLO material 200 comprises an alternative series of layers with ‘up’ and ‘down’ domains 202 and 204 respectively. The material is structured this way because the dispersion of the material (the variation of refractive index with wavelength) prevents efficient nonlinear mixing due to a phase mismatch. This is shown in the middle part of the figure, which shows how the refractive index, n, depends upon wavelength, A. In general, the refractive index of a usual NLO material decreases with increasing wavelength (called normal dispersion). In SFG, three wavelengths are involved. First and second wavelengths λ_1 and λ_2 mix to create a third wavelength λ_3 with a wavelength such that energy is conserved. The wavelength of the nonlinear mixing (in this case sum frequency mixing) is set such that

1/λ_3=1/λ_1+1/λ_2

which corresponds to conservation of energy.

Because refractive index varies with wavelength, there is a phase mismatch between the three optical wavevectors. The wavevectors are given by

K_i=2*πn_i/λ_i
where
n_i is the refractive index of the NLO material at wavelength i, and
λ_i is wavelength.

A wavevector matching diagram is shown in the lower part of the figure in which K_3 (is longer than the vector sum of K_1 and K_2. This difference occurs because the refractive index at λ_3, n_3, is greater than the refractive indices n_1 and n_2 at wavelengths λ_1 and λ_2. The k_vector mismatch is K_G. In quasi-phase matching, the period of the QPM structure 200 is set such that

Lg=2*π/K_G.

where Lg is the QPM period. It should be emphasised that in this discussion it is assumed that the waves are co-propagating in the same direction.

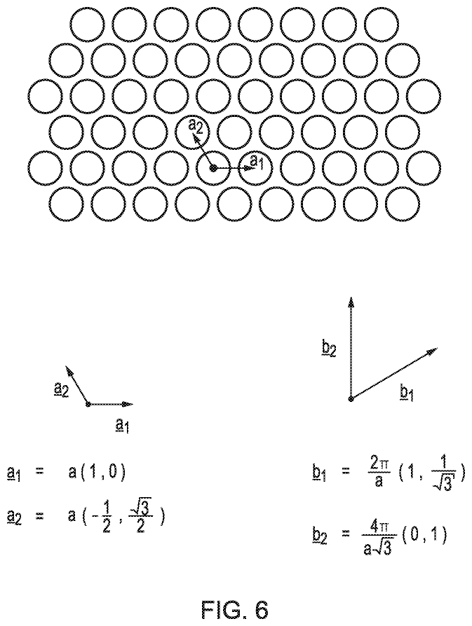

FIG. 6 shows a more complex geometry of a poled NLO material. Instead of the quasi-phase matching structure being a simple linear grating structure, the nonlinear crystal is processed by poling local regions to cause their domains to point upwards out the plane of the drawing (‘up’ domains) in the nonlinear crystal that naturally has ‘down’ domains pointing in the opposite direction. The shape of the poled regions may advantageously follow the crystal symmetry of the NLO material, so for example may be hexagonal in the case of LiNbO3. The illustrated pattern is of circular poled domains in a hexagonal close packing (HCP) pattern, but any other distribution may be chosen, e.g. a square or rectangular packing of square or rectangular domains. Moreover, the patterning could be aperiodic. The diagram shows the physical structure as having two vectors a_1 and a_2 which represent the period of the 2D poling. Also shown are the two associated K_G basis vectors b_1 and b_2. It should be noted that these can be used to phase match interactions in non-collinear wave mixing, so that other choices of angle can be used. All that is needed is for suitable nonlinear grating vectors to exist which permit the phase matching diagram to create a product beam that is appropriately directed, i.e. into the pupil of the eye.

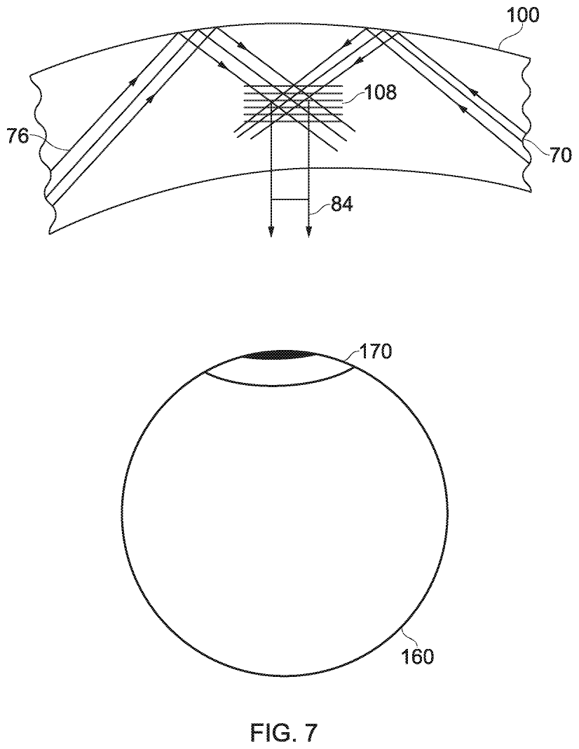

FIG. 7 is a schematic drawing of part of a piece of NLO material 100, wherein the NLO material is spatially modulated in a region 108 in respect of its second order nonlinearity to provide quasi-phase matching to the crossing input beams 70, 76. The QPM region 108 is schematically illustrated as a linear grating. The first and second input beams 70 and 76 are introduced into the lens from opposite ends and propagate via one or more reflections, e.g. total internal reflections from the inner and outer surfaces of the NLO material 100 (one reflection from the outer surface is illustrated for each of the first and second input beams 70, 76 until they cross in the intersection region which overlaps with the QPM region 108. The quasi-phase matching condition is satisfied in the QPM region 108 and product beam 84 is generated by the nonlinear wave mixing to generate a wavefront that propagates towards the pupil 170 of the eyeball 160.

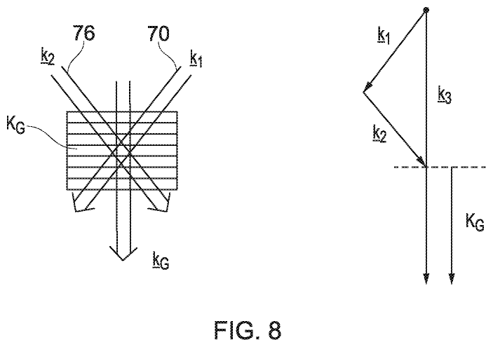

FIG. 8 shows another representation of the input beam intersection region. The first and second input beams 84 and 85 have respective wavevectors k_1 and k_2 producing a product beam having a wavevector k_g which is the vector sum of k_1 and k_2. Ideally the vector sum of k_1 and k_2, i.e. k_g, should be exactly equal to the wavevector associated with the QPM grating period, K_G, in order for greatest conversion efficiency. The phase matching vector diagram is shown in the right-hand figure. It is noted that the period of the QPM grating period that is needed can be calculated by simple trigonometry from the input wavevectors k_1 and k_2 and taking account of the dispersion characteristics of the NLO material.

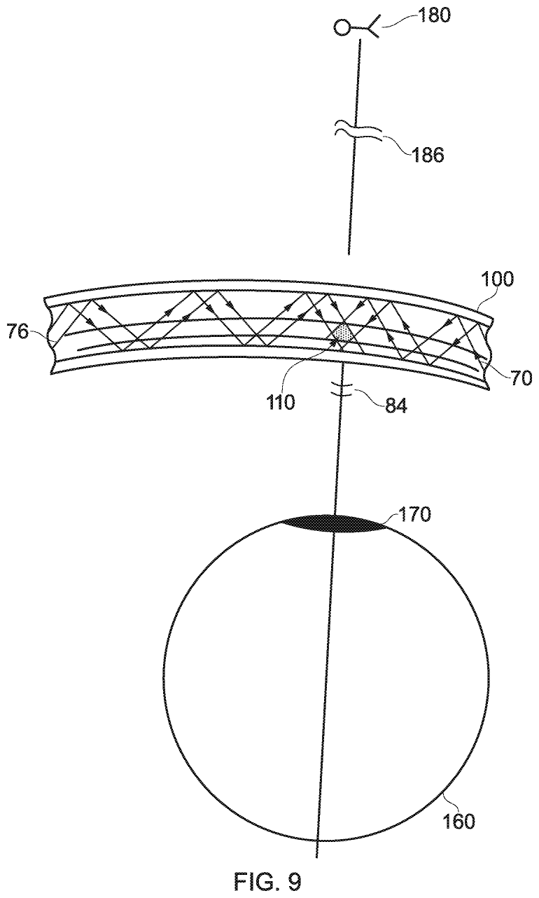

FIG. 9 is a schematic drawing of a display panel incorporating a NLO material layer 100. It can be seen that first and second input beams 70, 76 are directed to traverse the display panel 100 by multiple reflections from mirror layers formed to the front and back of the NLO material layer so that the beams 70, 76 cross each other in an intersection region 110 and generate a product beam wavefront 84 by nonlinear mixing. It will be understood also that the beams 70, 76 are brought to a focus at the intersection region 110. A distant object 180 is arranged some metres from the eye, indicated by the discontinuity 186. Natural light is scattered from the distant object 180 towards the eye 160. The product beam light representing a synthetic scene is therefore superimposed onto the light from the natural scene light. The light passes through the pupil 170 and into the eye 160 to form a fused synthetic/natural scene image on the retina.

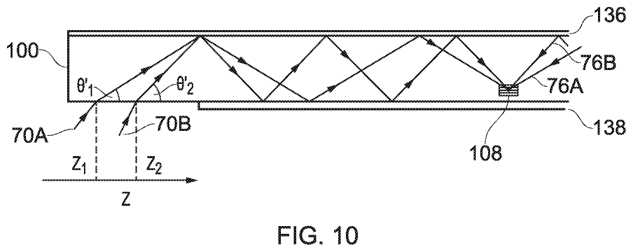

FIG. 10 shows a display panel with a multilayer structure comprising a NLO material layer 100, a front mirror layer 136 and a back mirror layer 130. The front and back mirror layers are reflective at the frequencies of the input beams and transmissive across visible frequencies. Two different input beam paths 70A, 70B for a first input beam are shown to illustrate how the angle and position (θ, z) at which an input beam is introduced into the display panel can be varied to vary the angle at which an input beam crosses the intersection region. The back mirror layer 138 covers a central part of the display panel but not a left end portion of the display panel's front face. The first input beam is introduced into this left end portion at an angle and position (θ1, z1) or alternatively (θ2, z2). The first input beam is then scattered from the front mirror layer 136 onto the back mirror layer 138 etc. and thereby traverses the display panel to an intersection region containing a QPM grating structure 108. A second input beam is introduced similarly at a right end portion of the display panel (not shown) and arrives at the intersection region 108 along beam paths 76A or 76B. The first and second input beams then cross each other in a non-collinear geometry at the QPM region 108 and generate the product beam by sum frequency generation. The desired position and angle for introducing the input beam can be calculated simply by ray tracing back from the point where the intersection region 108 is desired and what angle the input beam should cross the QPM region 108. As the path length of each beam changes as a consequence of varying the angle and position of the injection of each beam into the display panel, lenses or other focusing elements external to the display panel (not shown) can be adjusted to ensure that both beams 70, 76 remain focused in the intersection region 108.

Provision of mirror layers 136, 138 allows for reflection over a wider range of angles than is possible when total internal reflection from the panel-to-air interface is relied upon. Here it is noted that, if the nonlinear mixing process is by frequency addition, and assuming the usual case where the image is formed in the visible region, and further assuming the frequencies of the light beams that mix are either the same or not too dissimilar, then the light beams will be in the infrared (IR) wavelength region, so that the reflective coatings will be designed to efficiently reflect light at the infrared wavelength (or wavelengths) of the light beams.

Alternatively, both the first and second input beams could be inserted from the same end of the lens and the lens structure could be designed so that the second beam is reflected from a reflective element to the right of the figure and thus bounce back along the paths 76A or 76B as illustrated. It will thus be appreciated that by appropriate routing and/or scanning of the first and second input beams they can be introduced to propagate in the lens at different angles where changes in the angle necessitate different points of introduction to ensure the intersection region does not move.

It will be appreciated that the first and second input beams can only be exactly phase matched to the QPM NLO material at one specific combination of their respective angles. Therefore, scanning the input beams to vary their angles will cause the phase matching of the crossed input beams with the QPM NLO material to become gradually less exact with increasing divergence of the angles from the specified perfect phase matching angles. The conversion efficiency, and hence the intensity of the mixed product beam light, will thus gradually reduce as these angles moves away from the specified angles. Since the conversion efficiency is a function of beam angle and will therefore vary while scanning each beam, e.g. by rastering, this can be compensated for by a temporal variation of the beam intensity during scanning to ensure a non-varying intensity scale for the product beam light generation across the synthetic scene image.

It is also generally preferred to make the distance between the front and back mirror layers sufficiently large that the number of reflections (bounces) is kept to a relatively low number while at the same time allowing relatively large bounce angles θ. This reduces overlap between spots (i.e. beam intersection regions) which in turn reduces unwanted waveguiding and modal excitation effects.

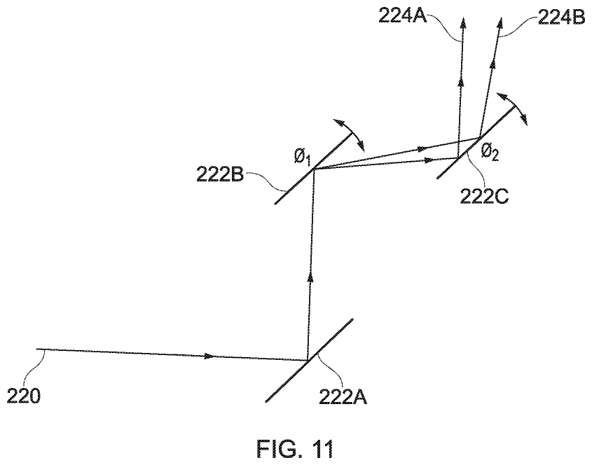

FIG. 11 shows example optical components for routing an input beam from a beam source (not shown) to the display panel (not shown). A beam 220 from the beam source strikes a first mirror 222A and passes onto a second mirror 222B, which is rotatable by an angle φ_1, and then onto a third mirror 222C, which is rotatable by an angle φ_2. Different beam paths 224A and 224B can thus be produced which arrive at different angles and positions on the display panel. It will be understood that this is simply one example of optical components capable of carrying out the routing, and other approaches can fulfil the same function.

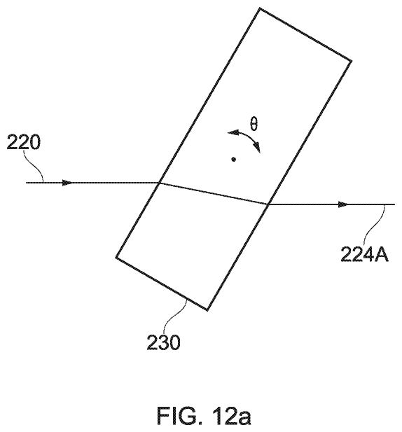

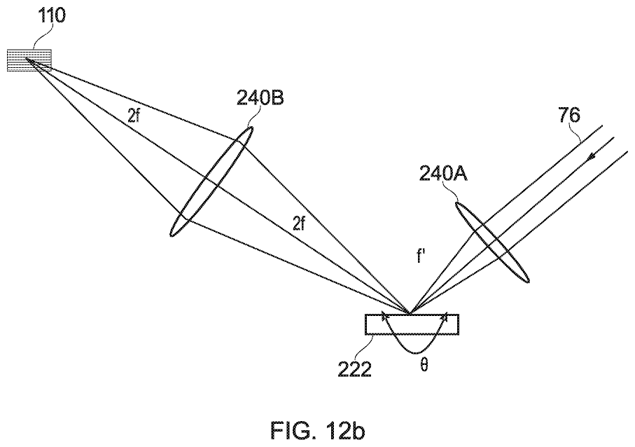

FIG. 12a shows a further example optical component 230 which may be included in the optical components for routing the input beam from a beam source, in the figure the component is a simple optical glass block. The optical component 230 allows for translating a beam, i.e. changing its position, without changing its angle of propagation. The optical component 230 is mounted to be rotatable about an angle θ and is a block of glass or other optical material 230. The optical component 230 is transparent for the beam 220. The beam 220 enters the optical component 230, refracts at the input face and traces the path shown through the block. Upon exit the beam path is translated downwards to beam path 224A which is displaced according to the angle θ but remains parallel to beam path 220. Thus, a displacement with change in angle is achieved. With polarized light the optical element (glass block) 230 may be placed so as to exploit Brewster's angle to minimise unwanted reflections, or alternatively it may be anti-reflection coated. In a miniaturised system various suitable implementation technologies exist, for example microelectromechanical systems (MEMS) mirror technology, electro-optics and other known beam scanning technologies. A desire for miniaturisation and also limiting the number of moving parts makes solid state or MEMS devices attractive.

FIG. 12b shows components to direct light to a desired point within an NLO material layer while altering the angles that the light approaches that spot. The diagram shows an input beam (shown here coming from the right-hand side of the diagram. This input beam, in this case labelled 76 to match other diagrams, passes into a first lens 240A. This first lens 240A is placed one focal length (f′) from a rotatable mirror 222. Assuming the input beam 76 is approximately collimated, the lens 240A will create a small focused spot on the mirror 222. The light reflected from the mirror 222 is directed towards a second lens 240B. The second lens 240B is placed a distance 2f from the mirror 222 and images the small spot from the mirror 222 onto the desired refocused spot labelled 110 since this light beam is to be delivered into the NLO material where it crosses with the other beam. In this example, the distance from lens 240B to the refocused spot is also 2f. These focal length values satisfy the conventional imaging requirement. When the mirror 222 rotates (see rotation angle θ) around either axis, the resultant beam paths will be deflected, but, because of the imaging operation of lens 240B the spot of light will be sent to the same location 110, but will approach with an angle set by the rotation of the mirror 222. Advantageously the mirror 222 will be rotated so that its centre of rotation is coincident with the reflective surface of the mirror. It will be understood that various values of focal length can be used, so long as the mirror is imaged into the beam-crossing interaction region. Moreover, further optical elements may be inserted into the system so as to steer the crossing point to a desired region of the display element (AR spectacle system). Furthermore, additional optical elements may be used to ensure that, wherever within the display system the desired interaction region is placed, it will still have an appropriate size.

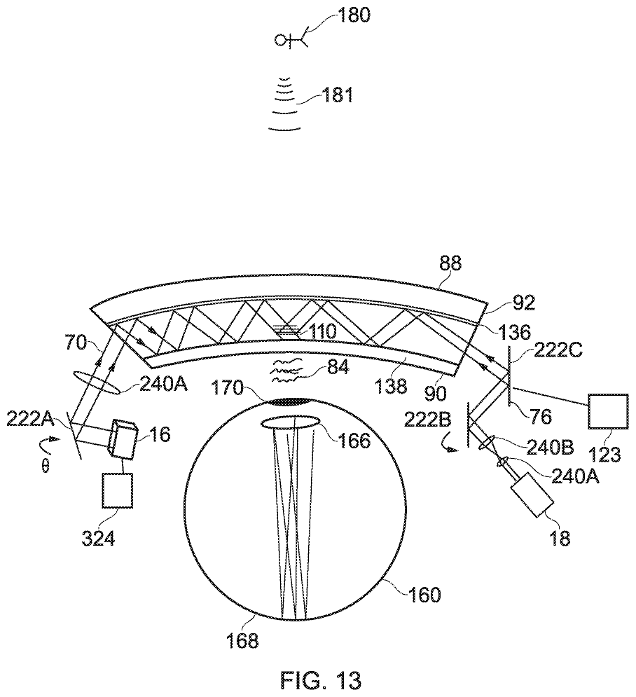

FIG. 13 shows an AR display apparatus according to an embodiment. A first one of the input beams has a beam profile that is phase modulated and the other of the input beams has a beam profile that is amplitude modulated, so that in the intersection region 110 where the two input beams cross both amplitude and phase modulation is encoded into the product beam generated by the nonlinear mixing of the first and second input beams in the phase-matched NLO material layer. The display panel generates an image of a synthetic object. The necessary information for the synthetic scene image is effectively encoded in the angular spectrum of product beam light hitting the eye. The focus requirement of the eye lens 166 is such as to take the curved wavefront 181 from the natural scene object 180 and bring it to a single focus on the retina 168. An eyeball 162 is shown with a pupil 170, an eye lens 166 and a retina 168. The pupil 170 of the eye receives light from a natural scene object 180. The natural scene object 180 scatters incident light, which creates a wavefront 181 with spherical waves. The light of the wavefront 181 passes through the display panel, impinges upon the eye, enters the pupil 170, and is focused by the eye lens 166 to form a sharply focused image on the retina 168. If light were emitted and ray traced from other points on the natural scene object 180 it would present at different angles to the optical axis of the eye and be focused at different positions on the retina 168.

When an AR headset is worn, the display panel 88 is arranged in front of the eye 160. The display panel 88 is transparent to light scattered from the natural scene, such as contained in the wavefront 188, and additionally generates artificial images responsive to crossed pairs of image generating input beams, one pair being shown. Image information is delivered to the display panel 88 through a suitable delivery setup. The display panel 88 is shown as curved, and has an outer surface 92, and an inner surface 90 which from the interfaces from the display panel 88 to air.

The display panel 88 shown has a composite layered construction with a NLO material layer and front and back mirror layers 136, 138. The mirror layers 136, 138 are reflective at the infrared wavelengths of the input beams.

The NLO material layer of the display panel 88 has a QPM region 108 arranged to cover a portion of the display panel 88, which is illustrated as being quite a small portion, although it will be understood that the QPM region 108 could extend over the whole of the eye's visual field when the eye is pointing straight ahead and/or over the whole of the eye's visual field at all possible swivel angles and/or the whole area of the NLO material layer.

Referring to the left-hand side of the figure, a first input beam 70 is provided that is amplitude modulated. The first input beam 70 is generated by an emitter array 16 which encodes image information in the beam cross-section by amplitude, i.e. intensity, modulation by suitable driving of the individual emitters of the array. The first input beam 70 is emitted from the emitter array and then reflected by a mirror 222A and transmitted through a relay lens 240A onto a left end face of the display panel 88. The mirror 222A may be deflectable, e.g. by rotation in one or two axes, to alter the path of the first input beam 70. Similarly, the lens 240A may be translatably and/or rotatably mounted to alter the ray path of the first input beam 70. Moreover, other mirror, lens or other optical components may be included for beam manipulation of the direction, position and divergence of the first input beam 70. The position and angle at which the first input beam 70 is introduced into the end face of the display panel can thus be adjusted. The left end face of the display panel is illustrated as being set at an angle relative to normal, i.e. a 90 degree cut-off of the display panel, to facilitate in-coupling of the first input beam 70. Alternatively, the first input beam 70 could be introduced into the front face of the display panel. Another alternative is to use a grating in-coupling of the first input beam 70, where the grating could cover an area portion of either the front face or the end face of the display panel. After introduction into the display panel, the first input beam 70 traverses the display panel from left to right by successive reflections from the mirror layers 136, 138. Referring to the right-hand side of the figure, a second input beam 76 is provided that is phase modulated. The second input beam 76 is generated by a laser source 18. The second input beam 76 passes from the laser source 18, through beam expanding lenses 240A and 240B, to a first plane mirror 222B where it is reflected onto a second mirror 222C. The second mirror in this beam path 222C is a phase retarding mirror (allowing a spatially varying phase to be imparted on the input), such as a liquid crystal phase modulator, and is used to impress the spatially structured phase modulation onto the laser beam. The same comments apply to the second input beam 76 as made above for the first input beam 70 in terms of its introduction into and propagation across the display panel 88. The second input beam 76 is illustrated as being introduced into a right end face of the display panel. The first and second input beams 70, 76 then cross in the intersection region 110 where the QPM NLO material is located resulting in generation of a product beam with a wavefront 84 and a frequency at the sum frequency of the first and second input beams 76. The wavefront 84 enters the pupil 170 and then is focused onto the retina 168. The product beam light is superimposed on the natural scene light 181 from object 180. By setting the radius of curvature of the wavefront of the second input beam 76 (by imposing a spatially structured phase retardation across the beam), the synthetic scene image can also be given any desired radius of curvature so that the synthetic scene image is a virtual image formed at any desired distance from the eye. The radius of curvature of the second input beam 76 can be altered by using Gaussian beam optics, so reducing the size of the laser beam. Reducing the laser beam's cross-sectional area, will increase the beam divergence of the resulting nonlinear wavefront.

It is thus possible to vary the virtual image distance of a synthetic scene image to provide a fused synthetic and natural scene image on the eye in which the synthetic scene image fits into the natural scene in a realistic manner.

In the above embodiment, it was implicitly assumed that the QPM NLO material is a simple linear grating. However, in further embodiments, the QPM NLO material may have a more complex spatial profile that incorporates some curvature so as to generate a diverging (or converging) product beam. In still further embodiments, it is possible to impress both amplitude information and phase information onto either or both of the first and second input beams 70, 76.

The emitter array 16 may be an OLED array such as a micro-OLED array. There is a controller device 324 which controls the output of the OLED array to create the intensity information in the image. Other options for the emitter array include an inorganic LED array, an array of quantum dot emitters, liquid crystal devices with appropriate back illumination, liquid crystal on silicon (LCOS) with appropriate illumination, VCSEL array, and tilting MEMS display devices of the digital micromirror device (DMD) type such as DLP devices from Texas Instruments. It is noted that the system does not require coherence in the amplitude structured beam and this is advantageous both in allowing incoherent emitter light sources (such as micro-OLED arrays) but also in reducing speckle in the system.

The first input beam 70 is thus formed by imposing a varying phase modulation on a beam generated by a single emitter, such as a laser, with for example a Gaussian intensity profile. The second input beam 76 is generated by an emitter array so as to have a beam cross-section that carries a spatially varying amplitude modulation. In other embodiments, the first input beam 70 could have a cross-section that is spatially modulated in both phase and amplitude while the second input beam 76 may be modulated in either phase or amplitude or both. A suitable source for combined phase and amplitude modulation would be a phase controlled emitter array, such as a VCSEL array with external phase modulation, or an array of independent emitters with appropriate phase control.

An advantage of embodiments which allow both the first and second input beams to have spatial modulation of their intensities is that this can be used to compensate for the fact that different parts of each beam cross-section will be more and less exactly phase matched to the QPM NLO material. The display apparatus may be designed such that light along the principal optical axis of each beam is exactly phase matched with the QPM NLO material where they cross in the QPM region, whereas the phase match of the crossed-beam components with the QPM NLO material will become gradually less exact with increasing distance away from the optical axis of each beam. The conversion efficiency will thus gradually reduce as one moves away from the optical axis of each beam. The intensity profile of the beam can therefore be modified to increase the intensity at the extremities of each beam so that the intensity scale of the product beam light is kept constant across the whole crossing region of the beams.

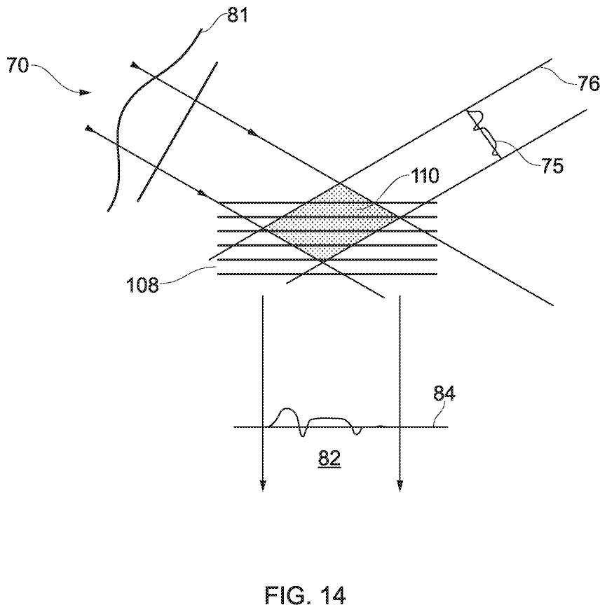

FIG. 14 is a schematic drawing of the beam intersection region 110 where QPM NLO material 108 is located. A first input beam 70 has a beam cross-section with an approximately Gaussian profile 81 to provide a simple planar phase front, i.e. there is no spatial phase variation across the beam, or only that inherent to it being a Gaussian beam. A second input beam 76 has a beam cross-section which, in the general case, is both amplitude and phase modulated according to respective amplitude and phase modulation functions 75. The first and second input beams 70 and 76, which are in the infrared, interact via the second order nonlinearity of the QPM NLO material 108 to exploit a phase matching scheme as described further above with reference to FIG. 8 with an appropriate nonlinear grating K-vector. The nonlinear interaction causes a nonlinear polarisation at a frequency, which in this case is at the sum frequency of the first and second input beams, the sum frequency being in the visible, to generate an output beam 82 having a wavefront 84 which varies in both amplitude and phase in a way determined by the amplitude and phase of the input waves. The information encoded into the second input beam by the amplitude and phase modulation functions 75 is thus transferred to the product beam wavefront 84.

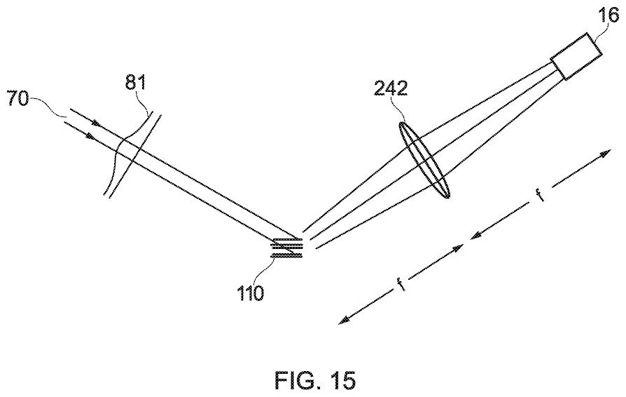

FIG. 15 is a schematic diagram applicable to the setup of FIG. 14. Namely, there is a first input beam 70 with a beam cross-section of an approximately Gaussian profile 81 to provide a plane wave wavefront combined with a second input beam with an amplitude and/or phase modulated wavefront. The second input beam is generated by a suitable emitter array 16 which is located at one focal length, f, from a relay lens 242, which in turn is located one focal length, f, from the intersection region 110. This arrangement places the image information contained in the amplitude and phase modulated wavefront from the emitter array 16 in the Fourier plane of the imaging system. The resulting visible beam generated by the nonlinear mixing of the input beams will therefore contain the same spatial image information as contained in the second input beam, this image information then passing to the eye encoded essentially in plane waves. The visible product beam light generated by the nonlinear mixing will have wavefronts with radii of curvature that follow from the radius of curvature of the first input beam 70 so that the product beam light will have an equivalent imaging position determined by the radius of curvature of the first input beam 70. The foreshortening caused by the finite crossing angles of the two input beams can be compensated for using simple trigonometry, and taken into account in either or both of the beam profiles/and the construction of the image.

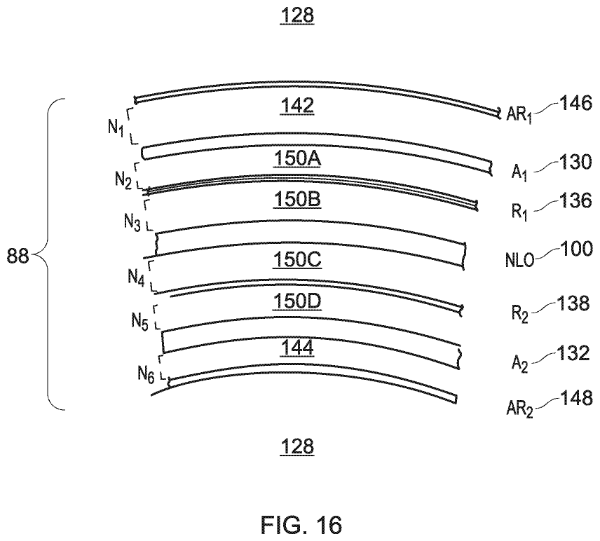

FIG. 16 shows a more complex example layer structure for an AR display panel 88. Air 128 surrounds the display, and this has a refractive index of very close to 1.

The figure shows the distal, outer side of the display panel 88, which is furthest from the eye (also called the ‘back’) which has a surface between air and the display panel. The figure also shows a proximal surface on an inner side of the display panel closest to the eyeball (also called the ‘front.

Referring to each layer in turn in the distal to proximal direction:
Layer 146 is a back surface anti-reflection coating (ARC) layer AR_1 to reduce reflections of visible light propagating in the air 128 from the panel-to-air interface. The outer anti-reflection coating layer 146/AR_1 should preferably be anti-reflective over the full visible range of wavelengths to accept light from natural scene sources. Such ARC coatings are routinely deposited on optical elements such as camera lenses. It is also desirable to make this layer ‘hard’ so as to resist scratches.
Layer 142 is a back vision correction layer. This is made of an optically transparent material (in the visible) which has refractive power in order to correct for vision defects of the wearer, such as short-sightedness, long-sightedness, astigmatism etc. The vision correction may involve altering the curvature of this layer, or to incorporate a polarizing filter as is common in sunglasses. Alternatively, the layer 142 could be optically neutral, i.e. not provide an image enhancement effect, or be omitted. Another possible function of the front vision enhancement layer 142 is to provide dimming responsive to certain natural light conditions. For example, the vision enhancement layer 142 may incorporate UV-sensitive photochromic material, such as a silver halide, as used in conventional dimming display panels. Another option for dimming would be to use an electrochromic switchable material, as are sometimes used for automatic dimming of rear view mirrors in automobiles. For example, the vision enhancement layer 142 may incorporate tungsten trioxide. For an electrochromic material, an electrical source will be needed to be contacted to the vision enhancement layer 142 to power the dimming function.
Layer 130 is a back filter layer (labelled A1). The back filter layer absorbs, i.e. is opaque at, the wavelengths of the input beams, which will generally be in the infrared. This will avoid any light from the input beams being emitted out of the back face of the display panel into the air 128. The provision of a back filter layer 130 may be required to comply with laser safety regulations in case one or both the first and second input beams are generated by a laser source. The back filter layer 130 can be made from an organic material with an absorption at appropriate infrared wavelengths. Moreover, it is desirable for the back filter layer to transmit visible light so as not to attenuate natural scene light. Such filters are sometimes known as heat absorbing filters or ‘short pass’ filters, and can be based on a glass such as Schott KG1. Alternatively, the back filter layer 130 can be based on thin film interference effects, which may be suitable when the light of the input beams is highly monochromatic and narrowband, as generated by lasers.
Layer 150A is a spacing layer of optically transparent material (in the visible) and is provided to separate the IR absorbing layer 130 from the next layer 136.
Layer 136 is a back mirror layer for internally reflecting the input beams as they laterally traverse the display panel 88. Provision of the back mirror layer 136 avoids using total internal reflection at the distal panel-to-air interface 146 and also avoids any possible losses, scattering or other undesired effects from the input beams traversing the outer layers 146 to 150.
Layer 150B is a spacing layer which is optically transparent both in the visible and the infrared (at the wavelengths of the input beams). This spacing layer 150B is provided to increase the thickness of the material traversed by the input beams and thereby reduce the number of internal reflections (‘bounces’) needed for each input beam to reach the intersection region.
Layer 100 is a layer of NLO material which, at least in the area which will be covered by the eye's visual field when pointing straight ahead, is quasi-phase matched to the input beams taking account of the angles with which they will cross each other.
Layer 150C is a spacing layer with similar function and properties to the spacing layer 150B.
Layer 138 is a front mirror layer for internally reflecting the input beams as they laterally traverse the display element 88 with similar function and properties to the back mirror layer 136.
Layer 150D is a spacing layer of an optically transparent material (in the visible and the infrared wavelengths of the input beams) and is provided to separate the front mirror layer 138 from the next layer 132.
Layer 132 is a front filter layer that is configured to absorb any stray light from the input beams, i.e. at the wavelengths of the input beams, which will generally be in the infrared with similar properties to the back filter layer 130. The front filter layer 132 thus prevents light at the wavelengths of the input beams from passing into the air 128 on the proximal side, thereby protecting the wearer's eye.
Layer 144 is a front vision correction layer which can have any of the functions or properties as described above for the back vision correction layer 142.
Layer 148 is a front anti-reflection coating (ARC) layer AR_2 with similar properties to the back ARC layer AR_1/146. Its role is to reduce reflections of visible light propagating in the air 128 from the panel-to-air interface.

One particular advantage of this layer structure is that by confining the optical paths of the input beams to a certain portion of the layer stack between the front and back mirror layers 138, 136, vision correction can be applied independently of managing the input beams and generation of the product beam light nonlinear mixing. Namely, vision correction of refractive errors in the eye lens can be achieved in one or more layers that are situated outside the substack 136-138, preferably outside the substack in the distal (back) direction, e.g. in layer 142 as done in the illustrated layer stack. In particular, the optical paths of the input beams can be managed without taking account of any vision correction layers.

It is noted that some of the above layers could be omitted. The anti-reflection coating layers are optional. Moreover, the proximal reflection of the input beams may be performed by total internal reflection from the back panel-to-air interface in which case the back mirror layer would be omitted. Similarly, if total internal reflection is used for the distal reflection of the input beams, the front mirror layer would be omitted. Depending on the nature of the light sources, e.g. whether the input beams are coherent or not, and their wavelengths and maximum output powers, it may also be that the front filter layer could be omitted, or possibly both the back and front filter layers. The front and back vision correction layers are also optional.

It should be noted that additional layers could be added, for example to provide anti-reflection coatings between the different optical materials involved, although it is worth noting that the greatest unwanted reflections are likely to occur between air and the display panel (due to the large index difference to air) and also between the nonlinear layer 100, which, depending on the choice of NLO material might have a quite large refractive index difference.

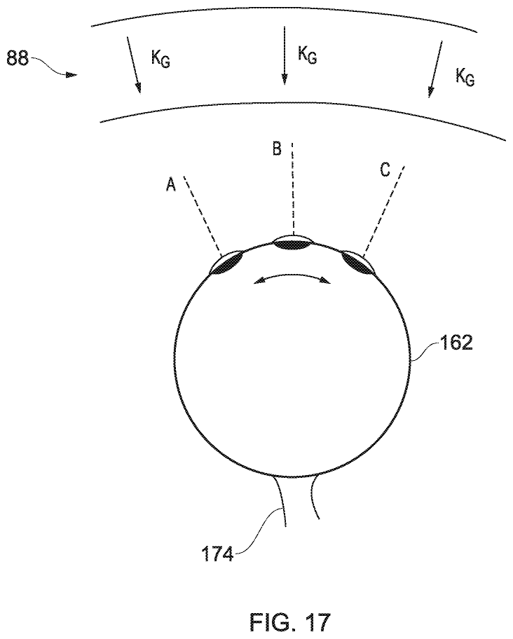

FIG. 17 shows an eyeball 162 which connects to the brain through the optic nerve 174. The eyeball can swivel within the eye socket and thus align its principal optical axis in different directions, for example A, B and C as illustrated. The display panel 88 is constructed in such as way that the quasi-phase matching grating vector Kg varies across the lens so that in all swivel positions of the eyeball, e.g. with its optical axis along A, B or C, the QPM NLO material is oriented so as to create product beam light that will scatter towards the iris. This may be achieved by orienting local sections of NLO material in appropriate positions and orientations within the display panel. Alternatively, this may be achieved by using a display panel with appropriate curvature of its front and back faces. Front and back face curvature will affect both the wavevector direction of the product beam and the paths of the input beams within the display panel. It is noted that depending on how light is introduced into the panel (the relative position within the panel and curvature of the reflecting layers) it may be advantageous to place the Kg in a direction that achieves the optimal local phase matching including the effect of input angles and optic axis.

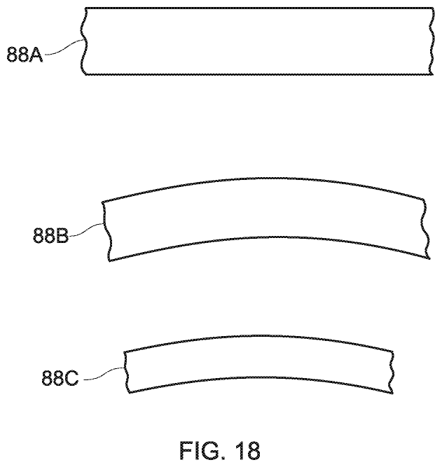

FIG. 18 shows that the display panel can have different shapes. A display panel 88A is planar with parallel and flat front and back faces. This provides input beam paths that are easy to determine. A display panel 88B has front and back faces with the same radii of curvature (i.e. the front and back faces have respective curvatures associated with respective centre points that are offset). A display panel 88C has front and back faces that are curved with different radii of curvature such that both circles have a common centre point, thereby providing a display panel of constant thickness. In all cases, the curvature may be on the surface of a cylinder or the surface of a sphere. Alternatively, there may be different curvatures in two planes to provide more complex curved faces.

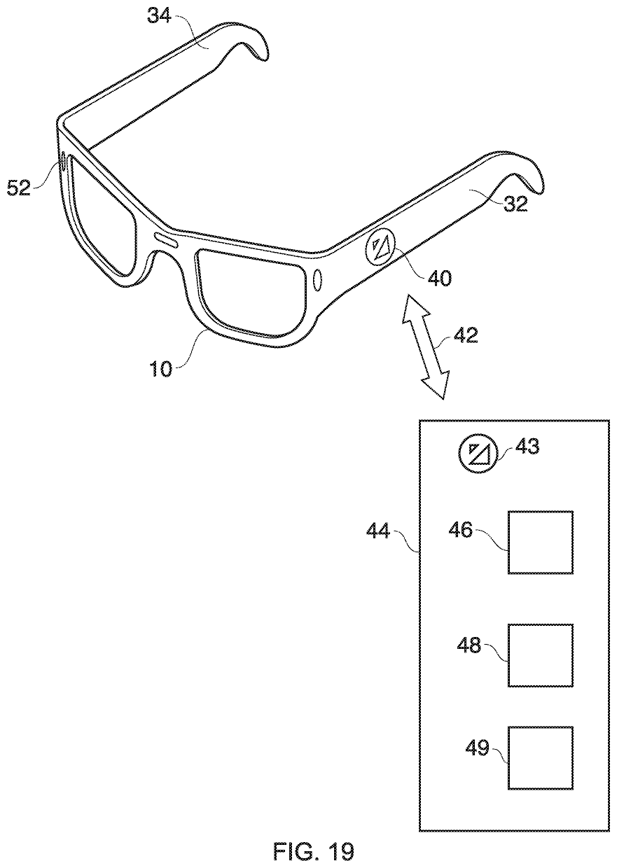

FIG. 19 is a schematic perspective view of a display apparatus in the format of a pair of AR spectacles 10. The spectacles 10 comprise conventional parts including left-hand and right-hand spectacle arms (i.e. temples) 32, 34 and a frame with left and right rims for accommodating left-eye and right-eye lenses. A display panel as described above forms each spectacle lens. The frame including a bridge, nose pad and left-arm and right-arm location points which may be hinged or unhinged. To support its AR functions, the spectacle arms and frame may be modified in comparison to conventional spectacles to accommodate the necessary additional components by internal housing and/or external attachment. These parts may include electronic circuit components, batteries, optical sources and optical elements. A wireless transmitter or transceiver 40 may be included for communicating according to a wireless protocol, such as Bluetooth or a WiFi protocol. The arm-mounted wireless transceiver 40 allows the AR spectacles 10 to communicate wirelessly over a communication path 42 with an external control device 44 which has its own wireless receiver or transceiver 43 as well as a processing capability via a processor 46 as well as associated memory 48 and external network communications 49 which could include WiFi, 4G/5G, optical LAN, wired ethernet, etc. The external control device may also provide location devices, such as via a global positioning sensor (GPS) and position sensing via a map of telecom wireless signals and/or wireless network signals. The external control device may be a dedicated standalone unit specifically for controlling the AR spectacles 10 or it may be a mobile phone, tablet, personal computer etc. running with a suitable app (computer program). In turn, the external control device may be in data communication with further devices and, in particular, may have access to remote computing resources in an ad hoc network (e.g. as provided by cloud computing). Processing intensive tasks for controlling image formation in the AR spectacles may therefore be delegated away from the AR spectacles to the external control device and optionally also more remote computing resources with which the external control device communicates. The processing power on board the AR spectacles themselves, and therefore also the associated power consumption, can therefore be kept low, by confining the processing tasks that are carried out on processors integrated in the spectacles to those which are relatively less processing intensive.

The spectacles frame accommodates left- and right-side outwardly facing cameras 50 and 52 which face outward to view the natural scene. Using a pair of cameras arranged at the same height side-by-side allows a stereoscopic image to be built up, i.e. binocular vision, similar to that of the eyes of the wearer, thereby allowing distance to natural scene objects to be determined, at least when the distance is relatively short. The spectacle frame 10 further accommodates a range finder, such as a LIDAR device or point cloud imaging system 58, for detecting objects in the natural scene and determining their distance from the wearer. In a LiDAR system, the LiDAR device comprises at least one laser and detector and the time of flight of the laser light from the LiDAR device to a scattering source and back is measured. The laser beam can be scanned to build up a map of objects in the natural scene or multiple laser beams can be generated to allow information to be obtained from multiple points in the natural scene in parallel. The movement of the laser beam as a result of the natural swivelling of the wearer's head can also be exploited to scan the natural scene. In a point cloud imaging system laser beams are projected into natural scene which are imaged by the cameras 50, 52 to allow a model to be built of the geometry of the natural scene. The object information collected by the cameras and range finder, in particular the object distance information, has a particular synergy with AR spectacles according to the invention, since the QPM nonlinear mixing process allows the radius of curvature of the wavefront generated in the wavefronts of the synthetic scene image to be set to a desired value in response to the distance (and position) information measured by the range finder (and cameras). For example, if the augmented part of the image is to superimpose features onto (or wholly replace) an object in the natural scene, then the augmented part of the image can be generated with wavefronts that have a radius of curvature equal to those that they would have if the augmented part of the image was at the measured distance of the associated natural scene object. Similarly, the placement of the augmented, synthetic scene image in the natural scene can be done correctly based on the position information obtained from the cameras. The position and distance information may of course also be combined to aid segmentation processing of the natural scene in order to identify objects therein.

One remote computing resource that may be useful is to provide mapping information that is relevant to the wearer's live view of the natural scene, e.g. as an aid to segmenting the natural scene and also to provide realistic lighting when rendering augmented reality objects. Such mapping information may be from a mapping application, live satellite imaging or live flight tracking, for example.

The level of computing resources that is potentially useful is almost limitless. For example, the computing resources could be used to recreate an entire simulated version of the natural scene in real time based on what is observed by the cameras and range finder in combination with extra mapping information obtained from remove computing resources.

The augmented reality objects could then be placed in the simulated version of the natural scene and volume rendered to provide realistic lighting based on textures and so forth.

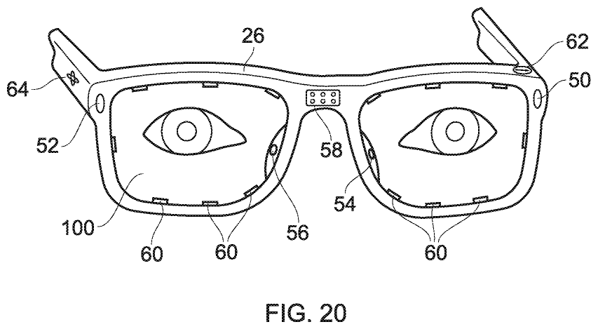

FIG. 20 shows a further view of additional elements that can be combined into a display apparatus in an AR spectacles format.
100 is the transparent or near transparent optical element containing the NLO material and the aforementioned IR beams that create the visible light directed to the eye.
26 is the frame of the spectacles which together with the arms (temples) accommodate the necessary electronics and optics components.
50 and 52 are outward facing left-side and right-side cameras.
58 is a point cloud or LiDAR system.
60 are infrared photodetectors arranged on the rims around the periphery of each lens. A minimum of one photodetector per lens is needed. The infrared photodetectors are provided to detect leakage of light from the input beams, which should be contained substantially wholly within the lenses (and prior to introduction into the lenses in the arms and frame parts of the spectacles). Any measurement of, or increase in, photodetector signal would be an indicator of damage. Damage might be a deep lens scratch or physical damage to the frame or arms which exposes a lens end face. On detection of infrared light leakage, or excessive amounts thereof, the spectacles would be shut down, i.e. the light sources would be switched off, thereby to ensure safety, including laser safety in the case that one or more laser sources are used.
54 and 56 are further cameras that are facing inwardly, i.e. towards the eye, are used to track eyeball position. This can be used to help determine the optical image that needs to be transmitted and to ensure that the light is directed only as required to be picked up by the iris. This saves power and thus prolongs battery life. These cameras may also be able to gather information about the stereo vision of the viewer so that the vergence and accommodation conflict can be dealt with as well as to ensure that artificial images are correctly positioned in relation to the natural scene. Importantly, these two cameras can be used to compensate for different interpupillary distances of different viewers (or equivalently interocular distances), and to ensure that the light from the display is directed to the pupil of the viewer's eyes. This has the effect of automatically increasing the eyebox, and overcomes a major difficulty with grating-based or other implementations of AR.
62 indicates a magnetic compass element that can be included to help determine the compass direction in which the spectacles, and thus the wearer's head, is facing. Again this information can be processed either in the electronics onboard the spectacles or with remote processing and may be fused with mapping information.
64 is a set of accelerometers that can be used to track movement of the spectacles and also determine parameters such as the roll, pitch and yaw angles of the wearer's head assuming that the reference direction for those angles is when the head is held horizontal and with the neck vertebrae untwisted. The accelerometer data can be processed either within the onboard electronics or by external processing in order to track the spectacles motion and thus the wearer's head motion.

The AR spectacles could be provided with an ambient light sensor 55 (not shown but mounted on spectacles frame or temple) to measure the overall (non-directional) brightness of the natural environment, such as a photodetector sensitive across the visible region. The output from the ambient light sensor could be used to adjust the overall brightness of the synthetic scene image so that it remains visible in bright light conditions while at the same time not being too bright in low light conditions, such as when in dimly lit rooms or at night.

The inwardly facing cameras can be used to compensate for the different interpupillary distances of different users, and the attendant variation in the eye position relative to the spectacles to ensure correct 3D synthetic scene creation and to ensure light enters the pupils correctly.

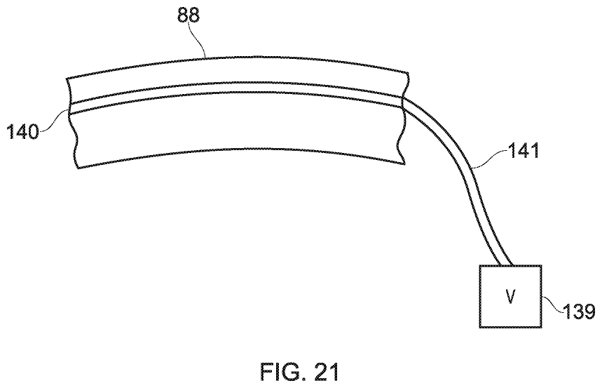

FIG. 21 shows a display panel 88 provided with an additional layer 140 to provide dimming responsive to certain natural light conditions. For example, the dimming layer 140 may incorporate UV-sensitive photochromic material, such as a silver halide, as used in conventional dimming display panels. Another option for dimming would be to use an electrochromic switchable material, as are sometimes used for automatic dimming of rear-view mirrors in automobiles, windows in trains and commercial aircraft. For example, the electrochromic material may be tungsten trioxide. For an electrochromic material, an electrical source 139 (either a voltage source or current source) will be needed to be contacted to the dimming layer 140 via a suitable electrical connection line 141 to power the dimming function. Another option for a dimming layer would be a liquid crystal layer with modulatable transmission, which may be pixel based. The dimming effect can be applied across the whole display panel (as in a photochromic lens). Another interesting approach is for the dimming effect to be applied selectively only in certain areas of the image. A simple example would be to form a dark rectangular area to provide a suitable background for a synthetic scene image component displaying written information, which would otherwise be illegible if superimposed on a part of the natural scene that is bright. A more sophisticated example is to provide selective local dimming based on information obtained from the natural scene, specifically objects that have been identified by segmentation of the natural scene using data collected by the spectacle's forward-facing cameras and range finder and/or other data collecting sources that may be available, e.g. from vehicle systems in the case of driving a car or flying an aircraft. The local dimming may be exactly coincident with the extent of an object in the natural scene, either to attenuate light from that natural scene object (either entirely or partially), where the local area dimming may be done in combination with insertion of a synthetic scene image in the same local area. There are various examples where it is desirable to attenuate overly bright elements in the natural scene that make it impossible or difficult to view the rest of the natural scene. These include attenuating light from oncoming car headlights, from the sun, e.g. when looking upwards. Another example would be to suppress light pollution when viewing the night sky. Another example is when the AR spectacles are configured as a driver aid for night driving. Here further information from cameras and radar that are part of the car can additionally be included in the image processing. A night vision augmented reality driving experience can be created that is able to reveal or enhance natural scene objects that are usually visible in the daytime but at night are either invisible or too dark to be clearly visible, thereby improving road safety.

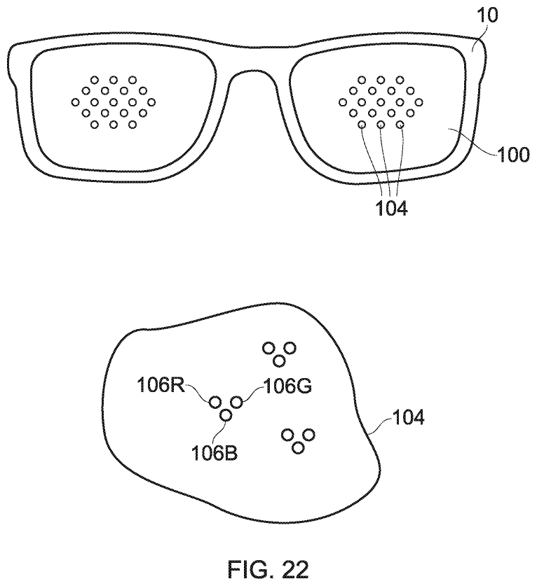

FIG. 22 shows a schematic of a pair of AR spectacles 10 in which the NLO material in the lenses 100 is formed in discrete regions, i.e. spots 104, across the image area, the spots being embedded in areas of material which are either not the NLO material or which is the NLO material but are areas thereof that have not been periodically poled (or otherwise quasi-phase matched to the input beams). Visible light generation is therefore confined to the spots of QPM NLO material with the remaining area between the spots being inactive, i.e. not able to generate any significant flux of visible light by nonlinear mixing of the input beams. As the eye swivels in its socket, it is only necessary to ensure that a quite small amount of synthetic scene image light reaches the eye, and given that the iris can be 4-8 mm across, and the lens surface is only around 12 mm from the eye, the NLO material can be confined to quite small area spots without the image perception degrading compared with full area coverage by the QPM NLO material. In other words, considering the overall area covered by the QPM NLO material, the fill factor of the QPM NLO material may be quite small, e.g. between 5 to 20%. For example, the spots could be circular and 0.3-0.5 mm diameter and distributed in a hexagonal close packed (HCP) grid with a grid spacing of 1-2 mm. The lower part of the figure shows detail in one portion 104 of a lens according to one implementation option for RGB image generation. Each spot is in fact a composite group of three spots 106R, 106G and 106B having different QPM structures so as to generate light in the red, green and blue respectively and thereby allow formation of an RGB image. Alternatively, RGB image formation can be achieved when the three QPM structures for red, green and blue are spatially overlaid, i.e. embedded at different depths, z, within the lens at the same xy-location. Another alternative for RGB image formation is to perform poling of the NLO material according to a single, more complex poling pattern that phase matches all three colours red, green and blue. There is an advantage in this approach of designing the lenses with a grid of spots where mixing can occur instead of a design with a continuous area of QPM NLO material over the part of the lens where the synthetic scene image is to be formed. Namely, nonlinear mixing, i.e. visible light generation for the synthetic scene image, can only occur at the specific locations where spots exist. This simplifies the beam management, e.g. beam routing and beam modulation, since beam crossing outside the spots will not generate any visible light so can be permitted.

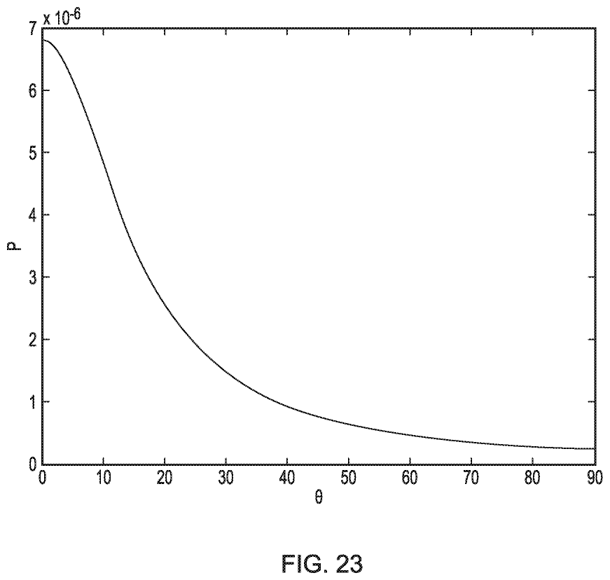

FIG. 23 is a graph plotting the dependency of QPM grating period, P, with angle, θ, the angle being 90 minus the half angle of the reflection from eye axis normal. This example is calculated for the nonlinear mixing of two 1064 nm beams to produce green light at 532 nm. It can be seen that if the traversal of the display panel by the input light beams is by shallow angle reflection (right end of graph) then the required period of the QPM grating becomes quite small which is likely to make fabrication more difficult and less accurate. For example, at 60 degrees (i.e. 30 degrees) the required periodicity is in the UV at about 400 nm and at 70 degrees is about 300 nm. At angles close to the critical angle for total internal reflection, i.e. about 40 degrees for a typical glass-air interface, the grating period is about 800 nm. If the lenses are provided with inner and outer infrared reflective material layers, then the input beams traverse the lenses by mirror reflection enabling larger angle reflections to be used. For example, at a 2 micrometre grating periodicity, the angle is about 22 degrees. On the other hand, each reflection is a cause of loss, e.g. by scattering, so the best range of angles to choose from is where there is a good compromise between ease (and accuracy) of fabrication and having a shallow enough reflection to keep the total number of reflections needed for the input beams of each beam pair to cross relatively small.

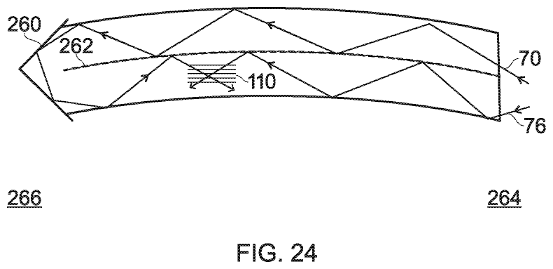

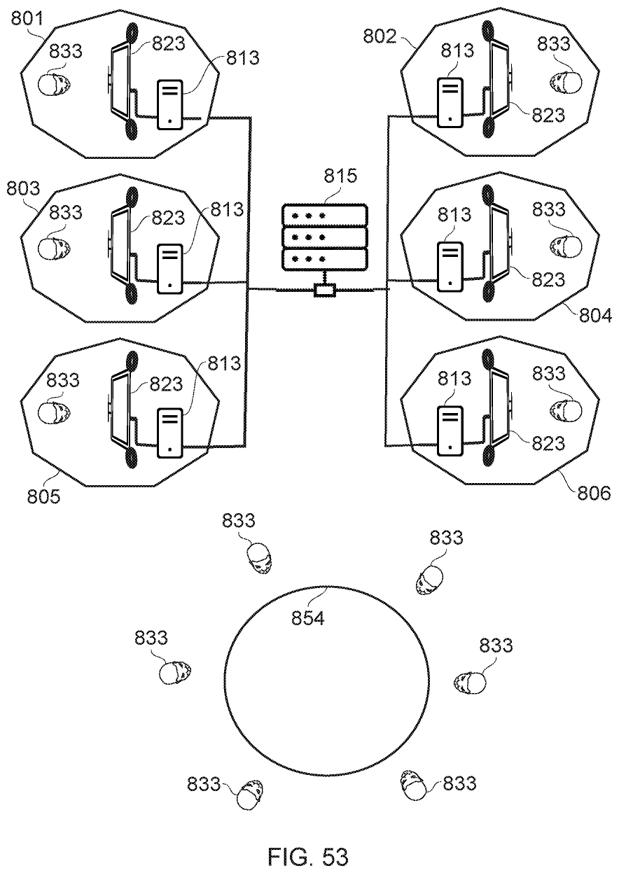

FIG. 24 is a schematic drawing of a structure for introducing the first and second input beams 70, 76 into a spectacle display lens. The first and second input beams 70, 76 are introduced in the spectacle arm or temple side 264 of the lens into respective distal and proximal lens layers in a dual layer lens structure. Each input beam 70, 76 traverses its lens layer. At the bridge side 266 of the lens, the first input beam 70 in the distal layer is reflected back by mirror surfaces 260 (two mirrors at 90 degrees to each other) into the proximal layer so that it counter-propagates with the second input beam 76 to arrive at the desired region 110 for the beams to overlap within a NLO material layer. There is an additional mirror layer 262 within the display element, which is reflective at the infrared wavelengths of the first and second input beams 70, 76. With this design, the first and second input beams 70, 76 are thus brought as desired to cross in the region 110 while being introduced into the same end of the lens, which may conveniently be the temple side as illustrated. It should be noted that other methods could be used to introduce the first and second input beams, including routing around the perimeter of the lens using a suitable light guide (see FIG. 54 below). Equally it is not necessary that two separate layers be used (as in the is figure, as it is also possible with a single layer to retroreflect the first input beam 70.

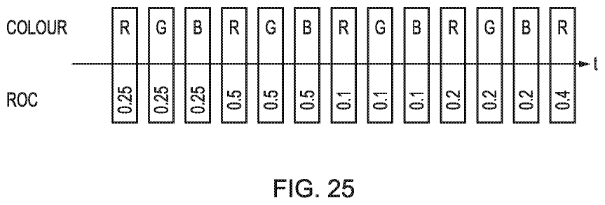

FIG. 25 shows a time-slicing sequence covering both RGB and ROC time multiplexing to generate a single example frame of a synthetic scene image. To form an image frame, a series of time slices are provided over time, t, each time slice being specific to one primary colour—e.g. red, green, blue (RGB)—and one radius of curvature (ROC)—e.g. 0.25 metres. A subframe of three time slices produces a synthetic colour image at one ROC. To generate a colour synthetic scene image containing objects at multiple distances in the scene, multiple such subframes are required, one for each ROC. In a full frame, synthetic subimages are formed at multiple different perceived depths in the synthetic scene. By sequentially displaying the relevant display fields, it is therefore possible to build up a convincing white light effect and render any colour, as in conventional displays such as projectors based on RGB. The example radii of curvature shown are 0.25 m, 0.5 m, 1.0 m, 2.0 m and 4.0 m. In this example they are shown in a monotonically increasing sequence which will then repeat. However, it will be understood that any given frame may use an arbitrary sequence of time slices. Indeed, sequences other than that shown may be more efficient to generate by the hardware and/or generate images that are perceived to have higher quality by human vision. The five example ROC values shown has the smallest ROC value at 0.25 metres, which is approximately equal to, or just below, the near point of normal vision. This value enables very near, and even slightly too near objects to be displayed in focus. The largest distance in this example is 4 metres, which is effectively the same as large distance (or infinity) for the normal eye in monocular vision. It will be understood that a smaller or greater number of distances may be chosen, and also that it is possible to adaptively control distance and frame. Moreover, the number of ROCs per frame may be varied according to the synthetic scene content, e.g. may be reduced or increased as certain objects leave or enter the synthetic scene. As previously discussed, the ROC value is set using the nonlinear mixing process and varying the crossing angles of the first and second input beams.

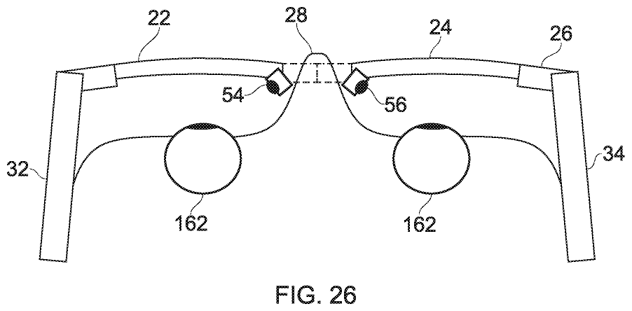

FIG. 26 shows a schematic cross-sectional view of a spectacle-format system comprising the standard components of a spectacle frame 26 accommodating left and right eye spectacle lenses 22, 24 separated by a nose bridge 28 and having left and right spectacle arms (temples) 32, 34. In this embodiment, left and right inwardly facing cameras 54, 56 are mounted on or adjacent the nose bridge 28 for capturing images of the left and right eyes 162, which are shown in cross-section through the eyeballs. The inwardly facing cameras 52, 54 are illustrated located at the nose side of each lens. However, it will be understood alternative placements could also be used, e.g. at the temple side of each lens. The function of the inwardly facing cameras 54, 56 is to track the direction of gaze of the person wearing the AR spectacles. The provision of inwardly facing cameras for eye tracking allows for a number of advantageous features and functionalities to be provided. Firstly, the position of the pupil (and hence the gaze) allows the system to illuminate the appropriate region of the display so that the viewer sees the image in the correct place. By means of the external facing camera and the information from LiDAR or other pre-determined scene information, plus location and orientation (from the compass, or accelerometers) the appropriate synthetic scene information can be displayed. Secondly, the eye position can be used to create a high-resolution image which will be received by the foveal region of the retina, which is the part of the eye with highest resolution. Thus, a limited number of spatial pixels on a modulator or emitter array can be used to create a high-resolution image, and then, when the eye gaze shifts, the input beams can be steered to a different region of the spectacle display lens, and in that new position generate a high-resolution image. It should be noted that in terms of creating a compelling synthetic scene it may also be helpful to display information (with lower resolution but the correct colours and intensity) into the more peripheral parts of the visual field (by appropriate beam steering into the other regions of the lens). A third feature of eye tracking is that it can be used to dim or extinguish the synthetic scene as the eye shifts gaze (over larger angles) so that unwanted ghost images are not perceived by the viewer. A fourth advantage of eye tracking by means of the inwardly facing cameras 54 and 56 is that they can ensure that all generated light is directed towards the pupil of the eye, both increasing electrical to visual efficiency for the display, but also to avoid visible light being directed onto other parts of the viewers eye (or elsewhere on their eye lids or surround skin) which can be perceived by another person looking at the wearer of the AR spectacle display system. A fifth advantage of eye tracking is that the system can adapt to compensate for different interpupillary spacing (separation between the eyes). As the eye spacing of different people can vary it is advantageous to be able to have system adapt to steer light towards the eye of the individual. This may be achieved by altering the input angles of the two beams into the NLO material so as to steer the wavefront direction of the emitted light.

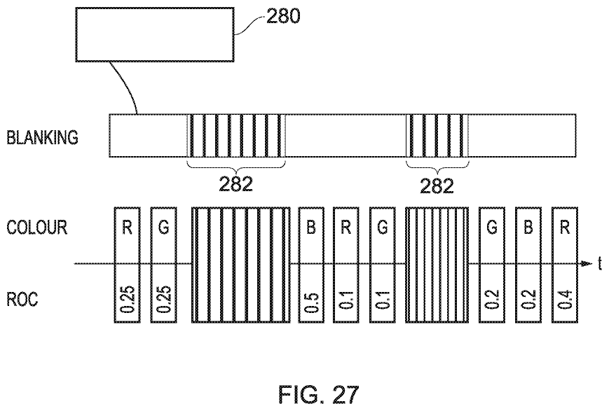

FIG. 27 shows a time-slicing sequence covering RGB and ROC time multiplexing to generate a single example frame of a synthetic scene image which additionally includes saccadic movement blanking periods 282. When the system is blanked, the illumination (either one or both of the input beams) are switched off or switched to low intensity so that during the blanking periods no synthetic scene image is formed. The decision on when to blank is made by a control system 280 which carries out signal processing based upon eye tracking information obtained from the inwardly facing cameras 54, 56. The purpose of the blanking is so that when the eye is swivelling no light is sent to the eye. This avoids unwanted ghost images and streaks on the visual field. This is particularly important in a pulsed system as the pulsing can cause transient images to be projected across the retina. Pulsing may be present either because one or both beam sources are pulsed, e.g. pulsed lasers, or because of a pulsing effect caused by the time slicing of the colour and radius of curvature RGB, ROC.

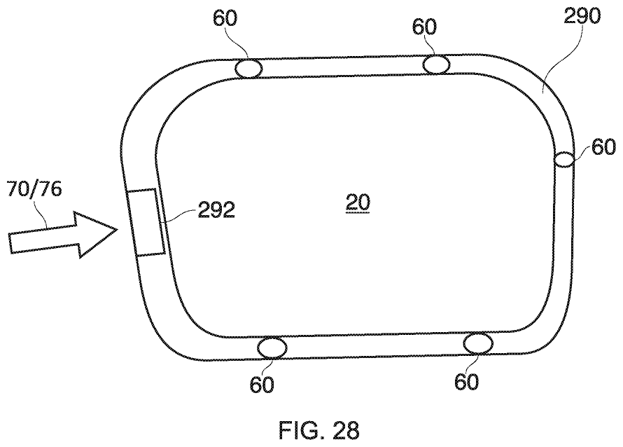

FIG. 28 shows an absorbing layer arranged in a peripheral region of a display element lens through the example of a spectacle lens 20. The spectacle lens 20 is surrounded by an absorbing material region 290 which is placed there to absorb input beams after they have crossed in the NLO material and reached the peripheral region, thereby stopping further propagation of the input beams by reflection from the lens edges after the input beams have served their purpose. The absorbing material may advantageously have a similar refractive index to the material of the lens (to avoid Fresnel reflection) while incorporating an absorbing function through molecular absorption, absorption by a dye, or absorption by black absorbing particles. The same design may be used for display panels of other format, e.g. large area displays for conferencing or a single panel for both eyes as may be used in a VR headset format. These designs have in common that there is a peripheral region containing a material that is absorbent to light at the first and second frequencies so that the first and second input beams are absorbed after the first and second paths have crossed each other in the NLO material when they reach the peripheral region. There are also photodiodes 60 arranged at the periphery of the lens 20, which, as previously described, can be used to check the integrity of the lens structure and provide a switch-off safety feature in the event of damage. The lens periphery also includes a non-absorbing region 292 through which the input beams 70/76 are injected into the lens 20, i.e. the absorbing material region does not extend fully around the periphery of the lens 20.

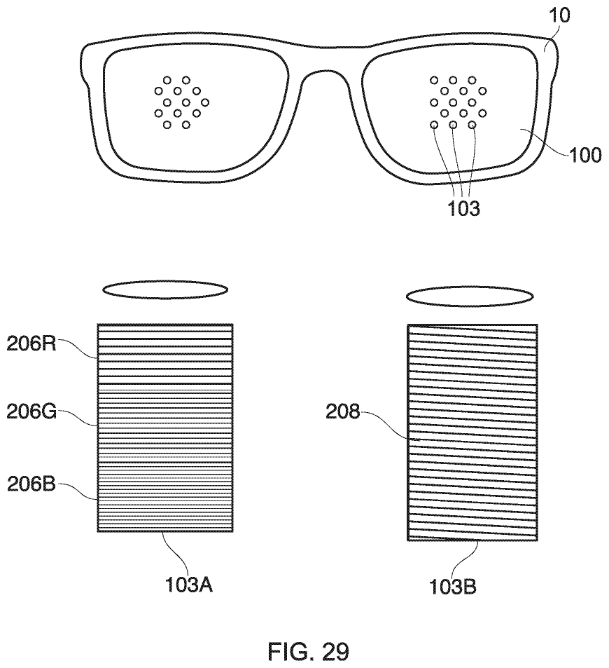

FIG. 29 (upper part) shows a schematic of a pair of AR spectacles 10 in which the NLO material in the lenses 100 is formed in discrete regions, i.e. spots 104, across the image area, the spots being embedded in areas of material which are either not the NLO material or which is the NLO material but are areas thereof that have not been periodically poled (or otherwise quasi-phase matched to the input beams). Visible light generation is therefore confined to the spots of QPM NLO material with the remaining area between the spots being inactive, i.e. not able to generate any significant flux of visible light by nonlinear mixing of the input beams. As the eye swivels in its socket, it is only necessary to ensure that a quite small amount of synthetic scene image light reaches the eye, and given that the iris can be 4-8 mm across, and the lens surface is only around 12 mm from the eye, the NLO material can be confined to quite small area spots without the image perception degrading compared with full area coverage by the QPM NLO material. In other words, considering the overall area covered by the QPM NLO material, the fill factor of the QPM NLO material may be quite small, e.g. between 5 to 20%. For example, the spots could be circular and 0.3-0.5 mm diameter and distributed in a hexagonal close packed (HCP) grid with a grid spacing of 1-2 mm. There is an advantage in this approach of designing the lenses with a grid of spots where mixing can occur instead of a design with a continuous area of QPM NLO material over the part of the lens where the synthetic scene image is to be formed. Namely, nonlinear mixing, i.e. visible light generation for the synthetic scene image, can only occur at the specific locations where spots exist. This simplifies the beam management, e.g. beam routing and beam modulation, since beam crossing outside the spots will not generate any visible light so can be permitted.

FIG. 29 (lower left part) shows a first way to realize each spot. Namely, a spot 103A is comprised of a stack of three different QPM periods, 206R, 206G and 206B respectively, designed to phase match the appropriate nonlinear mixing processes for generating three different wavelengths, e.g. red, green and blue light wavelengths respectively. In the illustration the layers are shown as being in contact (as could be achieved by electric field poling), but it will be understood that gaps of inactive material could be interspersed.

FIG. 29 (lower right part) shows a second way to realize each spot. Namely, a spot 103B is realized as a superstructure grating 208, which is designed so that it can simultaneously phase match for three colours, e.g. red, green and blue. This can be fabricated by poling of the NLO material according to a single, more complex poling pattern that phase matches all three colours red, green and blue. The superstructure grating is also illustrated with its layers being tilted slightly away from the plane of the NLO material layer. The grating for each spot may be tilted in a way that varies from spot to spot over the lens area so as to direct the phase matching output beam towards the pupil—as was described further above with reference to FIG. 17. The same local tilting approach may be used for the multi-stack spot 103A described above.

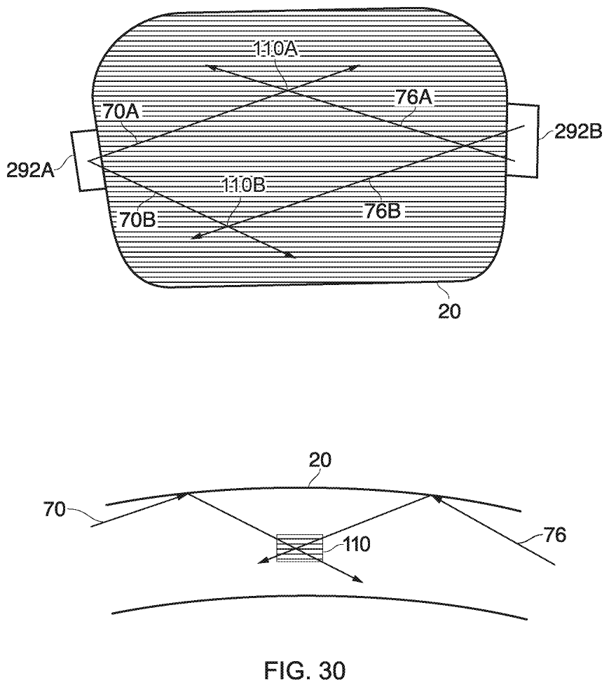

FIG. 30 shows two schematic views of a spectacle lens 20 for AR spectacles. The upper portion shows a front view of a lens 20, while the lower portion of the figure shows a top view, i.e., a view which is a section through the lens. In the front view, the first and second input beams 70A, 70B and 76A, 76B enter the lens 20 from left and right sides thereof respectively through entry regions 292A and 292B. The first and second input beams 70A, 70B and 76A, 76B cross at two different crossing positions 110A and 110B. As the eye behind the lens swivels, the gaze will be directed to many such places and it is necessary that synthetic scene information be created that will be received by the pupil of the eye. In this example, the crossing position 110A involves the gaze directed upward, and the crossing position 110B involves the gaze directed downward. Two different arbitrary first input beam directions 70A, 76A and two different second input beam directions 70B, 76B are shown by way of example. The lower portion (top view) is a slice through the lens showing the bouncing paths. It will be appreciated the respective crossing angles in the nonlinear overlap regions 110A and 110B need to be considered in three dimensions, as is clear from considering the front and top views in combination, where the input beam injection directions shown in the front view and the traversal of the lens by bouncing are relevant. From the diagram it will be appreciated that the vector directions crossing at a given point on the lens 20 depends on the position on the lens at which the gaze is directed. The resultant wavefronts need to be directed to the viewer's pupil, and so the phase matching diagram (which is now 3-dimensional vectorial) must be designed so that the light is appropriately directed. This can be achieved by setting the QPM direction in an appropriate orientation across the face of the lens so that phase matching in desired directions can be achieved.

It should be noted that, although the phase matching periods and QPM grating vector will be determined in manufacturing the lens, there are still degrees of freedom that can be controlled to ensure that the resulting light from the NLO process is directed to the eye. The first of these is that, at a given crossing position 110A or 110B, the bouncing angles θ (see FIG. 10) of the first and second input beams can be independently controlled. Secondly, the wavelengths of the first and/or second input beams can be altered somewhat to change the phase matching condition, although this would require that at least one of the beam sources be tuneable. As already discussed, by using the inwardly facing cameras it is possible to ensure that the light from the system is directed towards the pupil efficiently and to adapt to differing interpupillary distances. As illustrated, the spectacles can be configured so that the beams enter each lens at intermediate height positions 292A and 292B from opposing sides of each lens. The beams are then directed to cross at different positions 110A and 110B as required. As just discussed, to ensure light is directed efficiently from lens-to-pupil of the wearer it is required that the QPM grating vector be set locally at crossing positions 110A and 110B so as to ensure phase matched wavefronts (or nearly phase matched wavefronts) travel to the pupil, i.e. so that the wavefronts have appropriate wavevectors.

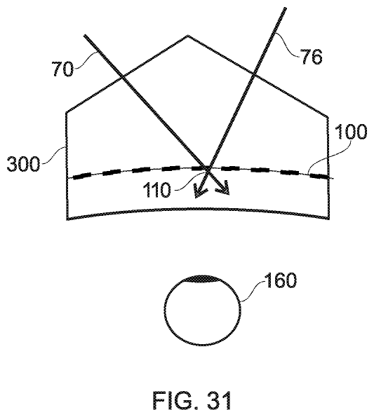

FIG. 31 shows an example lens 300 suitable for VR goggles. The lens 300 has embedded therein an NLO material layer 100. The first and second input beams 70 and 76 enter the lens 300 from the distal side, which is possible for VR where there is no natural scene to transmit onto the eye, and cross in the NLO material layer 100 at an intersection region 110.

The injection of the input beams from the distal side of the lens 300 is also facilitated by the fact that, in VR, the lens 300 can be made much thicker than is possible for AR. The thickness of the lens 300 may for example be 50 mm. The illustrated form of the lens 300 is a roof shape with first and second sloping facets whose surfaces form an approximate orthogonal angle with the first and second input beams 70, 76 at the points of injection. The other features of the system remain the same as previously discussed for end injection of the input beams with a bouncing traversal to arrive at the intersection region where the input beams cross.

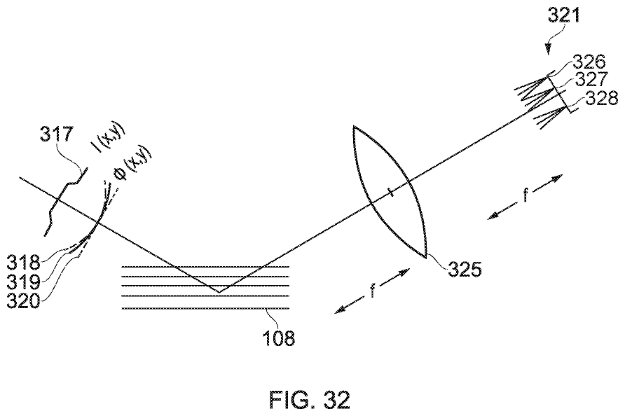

FIG. 32 schematically shows image generation in a NLO material layer having a nonlinear QPM grating 108 when the first input beam source is an incoherent emitter array 321 that emits multiple objects as incoherent infrared light (such as from a monochromatic microLED array), thereby acting as the first input beam. A lens 325 is arranged midway between the emitter array 320 and the QPM grating 108 one focal length, f, away from each. Three emitting regions are shown as pixels 326, 327 and 328. Each of these has the same radius of curvature. An input infrared laser wave 317 acting as the second input beam and having an intensity profile and a phase profile (corresponding to radius of curvature) is shown coming into the QPM grating 108 (from the left). The input laser wave 317 can be given three different radii of curvature 318, 319 and 320 at different times. By altering the ROC of the input laser beam from the left and by providing different intensity patterns from the microLED incoherent emitters, it is possible to create successive wavefronts that can be rapidly cycled in sequence so that the viewer perceives different objects to exist at different apparent focal positions in the visible nonlinear wave emitted from the QPM grating 108 as a result of the nonlinear mixing of the input beams.

### Summary of Options for Phase & Amplitude Modulation Between Beams

In the following, we summarize possible approaches for carrying out the amplitude and phase modulation functions, in particular in respect of whether both are applied to one of the input beams or one to each of the input beams as well as whether the beams are large area beams (or equivalent beam arrays as generated by an array emitter) or rastered pencil beams. While the following aims to provide a comprehensive overview of the options, it is not exhaustive and further variations will be readily understood, e.g. by combining elements from the following specific examples. It is also noted that the labelling of the two input beams as Beam 1 and Beam 2 is arbitrary.

TABLE A
Example approaches for amplitude modulation

| | | | Example of | |
|---|---|---|---|---|
| | | | modulation | |
| Description | Beam 1 | Beam 2 | approach | Comment |
| Ai) Raster | Amplitude | Phase | Laser current drive, | Modulation can be |
| scanned whole | modulated | modulated | or electro-optic | made in reflection |
| beam | across whole | (see Table | modulator, or | or transmission. |
| approach | beam | B) | uniform liquid | |
| | | | crystal modulator | |
| Aii) Laser like | Required | Phase | Requires a 2D | Note the amplitude |
| beam with | amplitude | modulated | modulator (e.g. | on the beam must |
| complex | pattern is | (see Table | LCOS in reflection, | be such as to |
| amplitude | imprinted onto | B) | or liquid crystal in | create a virtual |
| modulation | the whole input | | transmission, or | image for the eye. |
| across beam | laser beam | | DLP type MEMs | The amplitude |
| | | | array | modulator may |
| | | | | operate in either |
| | | | | reflection or |
| | | | | transmission |
| Aiii) Emitter | Beam 1 is a | Phase | Micro LED array or | The emitter array |
| array | 2D array of | modulated | OLED array, with | can be incoherent |
| | individual | (see Table | the amplitude set | (e.g. in an OLED |
| | beams created | B) | using drive current | or micro-LED |
| | by an emitter | | to individual pixels | display) or can be |
| | array in a 2D | | | coherent (such as |
| | modulated | | | an array of |
| | manner | | | VCSELs) but with |
| | | | | amplitude control |
| Aiv) | Beam 1 is a | Phase | Similar to the | |
| Composite | 2D array of | modulated | preceding but the | |
| modulator | individual | (see Table | emitter function | |
| array/emitter | beams created | B) | and the modulation | |
| hybrid | by a hybrid | | function are | |
| | modulator- | | created via a | |
| | and-emitter | | hybrid or | |
| | array in a 2D | | composite | |
| | modulated | | approach. For | |
| | manner | | example, by | |
| | | | placing a liquid | |
| | | | crystal modulator | |
| | | | directly onto an | |
| | | | LED array, or | |
| | | | similar | |
| Av) Combined | Beam 1 is both | Beam 2 is | See Table B for | The device might |
| phase and | amplitude and | an | examples of | comprise a hybrid |
| amplitude | phase | unmodified | approaches for | structure |
| | modulated and | laser beam | phase modulation | modulating phase |
| | delivered to | delivered to | | and amplitude |
| | the NLO | the NLO | | together in the |
| | interaction | interaction | | same modulator, |
| | region | region | | or phase and |
| | | | | amplitude |
| | | | | modulation may |
| | | | | be applied |
| | | | | successively by |
| | | | | dedicated |
| | | | | modulators to a |
| | | | | single one of the |
| | | | | input beams. |

TABLE B
Example approaches for phase modulation

| | | | Example of | |
|---|---|---|---|---|
| | | | modulation | |
| Description | Beam 1 | Beam 2 | approach | Comment |
| Bi) Spatial | Modulated as | Spatially | A Pockels cell type | This example is in |
| phase | per Table A | varying | device with a radially | transmission and |
| modulation | | phase | varying electric field | could use materials |
| across laser | | modulation to | to create a quadratic | such as KTP, BBO, |
| like beam | | create | phase across the | KDP, KTN, LiNbO3, |
| | | required | beam or a | or organic electro- |
| | | radius of | transmissive LC | optic materials |
| | | curvature | phase modulator | |
| Bii) Spatial | Modulated as | Spatially | An LCOS mirror | Such a device |
| phase | per Table A | varying | device comprising | would typically |
| modulation | | phase | an appropriate liquid | operate in |
| across laser | | modulation to | crystal layer with | reflection, e.g. with |
| like beam | | create | locally addressable | the liquid crystal |
| (II) | | required | electric field | placed on a |
| | | radius of | strengths | reflector and |
| | | curvature | | addressed per pixel. |
| | | | | A transmissive |
| | | | | device may |
| | | | | however be used |
| | | | | instead. |
| Biii) Spatial | Modulated as | Spatially | Examples would | Typically the device |
| phase | per Table A | varying | include MEMS | would operate in |
| modulation | | phase | based deformable | reflection. |
| across laser | | modulation to | mirror or locally | |
| like beam | | create | thermally deformed | |
| | | required | mirror | |
| | | radius of | | |
| | | curvature | | |
| Biv) | Modulated | Unmodified | As discussed in | The same as Aiv) |
| Combined | with both | laser beam | Table A, by creating | but with the roles of |
| amplitude | amplitude | delivered to | a hybrid/composite | the two beams |
| and phase | and phase | the NLO | element | swapped |
| | modulation | interaction | | |
| | across a | region | | |
| | beam | (steered in | | |
| | | location only) | | |
| Bv) | Modulated as | Altering the | An amplitude | Compensatory |
| Diffractive | per Table A | intensity | modulator is used to | changes to overall |
| control of | | across Beam | spatially control the | beam intensities will |
| ROC | | 2 and then | extent of a beam so | be needed if one |
| | | using | as to increase or | beam is apertured |
| | | diffraction | decrease the effect | in this way. |
| | | effects to | of diffraction. | The diffractive |
| | | alter the | Spatially varying | control may be |
| | | ROC | amplitude | done in |
| | | | modulators could be | transmission or |
| | | | used (e.g. LCOS or | reflection. |
| | | | DLP or a variable | |
| | | | diameter iris).¹ | |
| Bvi) | Modulated as | Altering the | Variable focal length | |
| Gaussian | per Table A | focal lengths/ | zoom lens type | |
| beam | | relay optics | elements, or liquid | |
| optical | | to alter the | filled lenses, or | |
| control of | | spot size and | quadratically shaped | |
| ROC | | input ROC | electro-optic or liquid | |
| | | | crystal elements with | |
| | | | electric field drive | |

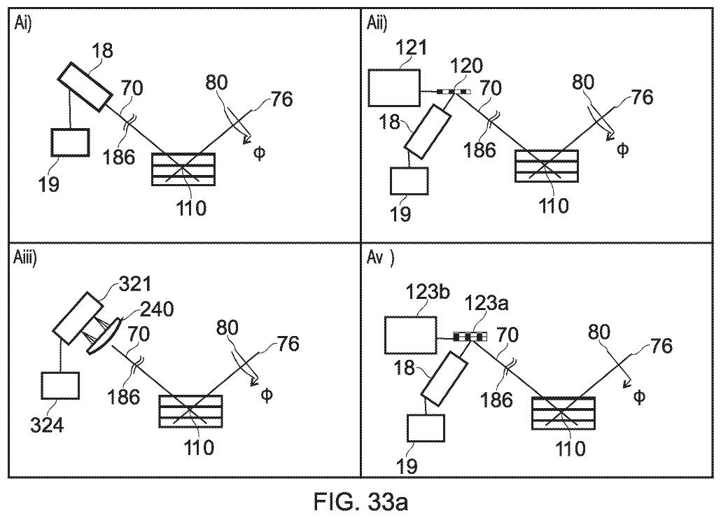

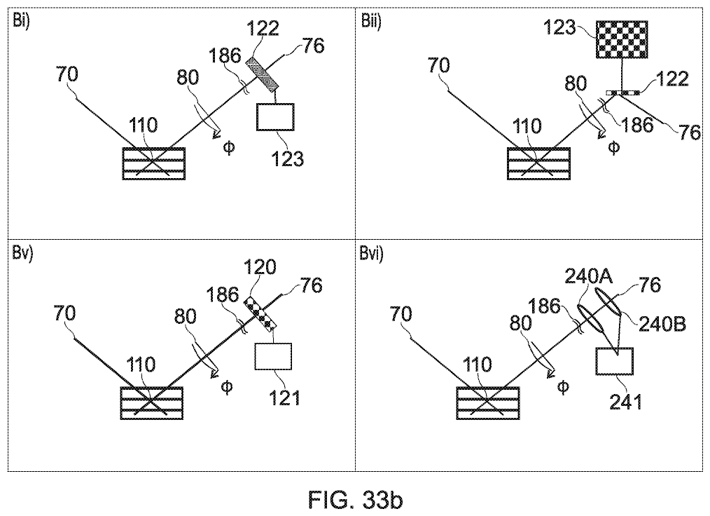

FIG. 33a shows a series of panels illustrating certain ones of the approaches summarized in Table A for controlling the amplitude and phase of the two input beams. The panels are labelled with references that are taken from the corresponding row of Table A. It will be understood in the following that the two beams here are labelled for convenience with 70 for the beam coming from the left to the interaction region 110, and labelled 76 for the beam coming from the right, but of course the directions of the beams may be swapped so long as the beams cross in the appropriate overlap region 110. It may also be convenient to design the system so that, for the right and left lens, the system is mirror symmetric, so as to maintain symmetry across the spectacles. For example, in both spectacle lenses one of the input beams (e.g. the first input beam carrying phase modulation) is injected from the bridge side whereas the other input beam (e.g. the second input beam carrying amplitude modulation) is injected from the temple (or arm) side.

FIG. 33a at Panel Ai) shows a scheme appropriate to a raster scanned and whole beam modulated approach. It shows two beams 70 and 76 that interact in a nonlinear region 110. The first beam is emitted from a laser 18, which is driven by a laser controller unit 19. The laser controller unit provides electrical power to the laser, and by varying the current the output power can be modulated as the beams are scanned in angle to build up an image. The figure shows a discontinuity 186 to indicate that there will be other optical elements placed in the optical path (for example to scan angle, etc). In this implementation the power of the laser beam 70 is controlled by the laser controller unit 19. The second beam 76 is shown with a phase profile 80 appropriate for controlling the radius of curvature of the resultant nonlinear beam (not shown). As discussed in Table A, the intensity of the whole 1 More complex approaches can make use of Fresnel zone plates with the advantage of being able to use an absorptive spatial modulator and exploiting the coherence of the laser like input beam beam 70 can also be controlled by placing a modulator in the beam path. The modulation element can be either transmissive or reflective.

FIG. 33a at Panel Aii) shows a beam created by a laser with a complex amplitude modulation imprinted across the beam. This differs from the previous example, where the intensity of the whole beam is modulated, because the intensity across the beam is varied using a spatial light modulator. The figure shows two beams 70 and 76. The first of these 70 is amplitude modulated by a spatially varying reflective amplitude modulator 120 (for example a reflective LC based spatial light modulator). The figure shows an amplitude modulator controller 121 which is connected electrically to the modulator 120. This example also shows the laser 18 and the laser controller 19. The laser controller can control the total amount of light in the beam, while the modulator controller 121 drives the modulator 120 to create a spatially varying intensity profile across the laser beam. As before, the discontinuity 186 indicates that other optical elements will be present in the beam path of 70. All of the controllers elements are controlled by a central controller which controls the image formation (not shown). The second beam 76 has a controlled phase profile 80.

FIG. 33a at Panel Aiii) shows a system in which the amplitude modulated light is created from a device with multiple separate emitters (such as a Micro-LED device). In this approach the first beam 70, is created from separate pixel emitter sources from the emitter array 321. The emitter array is driven and controlled by a separate controller 324 which sets the intensity of each emitting element. The light emitted from two pixel positions are shown. Note that in general the array will be a 2-dimensional array. In the diagram the light emitted from the emitter array 321 is shown to be diverging (as would be the case with a Micro-LED device) and a lens 240 is placed to collect the light and direct it into the first beam 70 direction. It will be appreciated that the first beam 70 is no longer like a laser beam, rather it is radiation emitted by the emitter pixels and directed by an optical system to the interaction region 110. The emitter array can be either incoherent between pixels such as would be the case with a Micro-LED array or could have coherence between pixels (such as would be the case if a single large laser spot were to have an amplitude modulator placed on its emitting surface). Alternatively, an array of emitting lasers (such as a VCSEL array) could be used, and again could either be coherent or incoherent between each emitter. (note that a VCSEL is a vertical cavity surface emitting laser.) Provision of a hybrid or composite emitter is described in Table A as example Aiv), which describes placing a modulator (such as a liquid crystal modulator) onto the emitting surface of a larger emitter (such as a laser or LED).

FIG. 33a at Panel Av) shows a combined phase and amplitude modulator. This example is a variant of the example shown in Panel Aii. A laser 18 and laser controller 19 are shown. The light from the laser is reflected off a combined amplitude and phase modulator 123a.

This is controlled by a controller 123b which imparts both amplitude and phase information onto the first beam 70. The combined amplitude and phase modulator 123a can either be a single device for example a modified LCOS device with a phase controlling layer, or it can be implemented using separate elements in proximity. Again, the device may operate in either transmission or reflection. The second beam 76 no longer has any controlled phase imparted across it because the function of altering the radius of curvature of the emitted light is now achieved by applying the phase information to the first beam 70. Thus, the phase 80 is now flat across the beam. However, this beam may still have some more complex phase function (e.g. it could be focused) but is not modulated as the image is produced to create the radius of curvature.

FIG. 33b shows approaches to controlling the phase across a beam according to Table B. It shows a series of panels illustrating different approaches. The panels are labelled with references that are taken from the corresponding row of Table B. The panel schematics concentrate on illustrating the role of the second beam (labelled 76 in the figures) but it will be understood that the labelling of the first and second beams as 70 and 76 is arbitrary. Similar to the description of FIG. 33a it will be recognized that it may be convenient to construct a system in which there has mirror symmetry in the left and right lens of a particular display apparatus (AR spectacles).

FIG. 33b at Panel Bi) shows a pair of beam 70 and 76 the interact within a nonlinear region 110. The first beam (that coming from the left) is labelled 70 and is the one that is amplitude modulated as per FIG. 33a and Table A. The second beam 76 is the beam that comes from the right-hand side. It is shown as passing through a transmissive spatial phase modulator 122 which imparts a desired spatial phase profile on the input beam 76. There is a discontinuity in scale 186 which indicates that other elements may be added to the optical path. The spatial phase modulator 122 is controlled by a phase modulator controller 123 which is used to create a phase pattern corresponding to a diverging beam so as to alter the radius of curvature of the emitted light from the NLO region 110, and thus create the appearance of differing focus to the viewer of the display device.

FIG. 33b at Panel Bii) is similar to Bi) except that the second beam 76 is reflected from a phase modulator 122, which is similarly controlled by the spatial phase modulator controller 123. The phase modulator 122 could, for example, be a deformable MEMs mirrors, could be a liquid crystal (LCOS) type device, or a thermal distorted mirror element. Note that the example Biii) from Table B is not shown in figures due to the similarity to the Bii) configuration.

FIG. 33b at Panel Biv) from Table B is not shown either because it involves combining amplitude and phase modulation into a single hybrid element and is the same as for example Av.

FIG. 33b at Panel Bv) illustrates a diffractive intensity modulation approach to altering the radius of curvature of beam 76. It looks superficially similar to Bi except that the modulator is now a spatially controlled intensity modulator 120. In this diagram it is shown in transmission but it will be understood that the same could be achieved in reflection. The intensity modulator 120 is controlled by an intensity modulator controller 121. In the simplest configurations the radius of curvature (equivalent to phase profile 80) of input beam 76 could simply be altered by transmission through an aperture (for example a pinhole) of controllable width. By reducing the size of the aperture, the beam divergence will increase due to diffraction. Equally, a transmission pixel-controlled aperture (e.g. a liquid crystal device) can create a transmissive pattern (e.g. a pinhole) that will also increase diffraction as required. A more elegant approach would be to use a Fresnel Zone plate pattern as this would be more light efficient.

FIG. 33b at Panel Bvi) shows a system based around altering the properties of the laser like beam 76 so as to control the phase 80 across the beam 76 (equivalent to radius of curvature) so as to create an output of the nonlinear interaction region 110 which creates a desired image depth for the display device. The figure shows a pair of lenses 240A and 240B which are used to create a beam expanding telescope. The two lenses are controllable (by a controller unit 241) which acts to modify the resulting optical power of the pair of lenses. This can be achieved in many different ways including a liquid lens, or by altering lens spacing by moving an element (such as in a zoom lens on a camera). It will be understood that different numbers of lenses could be used, and choice will be based on desired technical performance. Altering the size of the beam 76 (which will propagate over some distance (and other optical elements represented by 186) will result in diffractive spreading as is well known for Gaussian beam optics. Thus, the radius of curvature (phase) of the beam will be controlled.

### Example Control System Inputs, Outputs and Functions

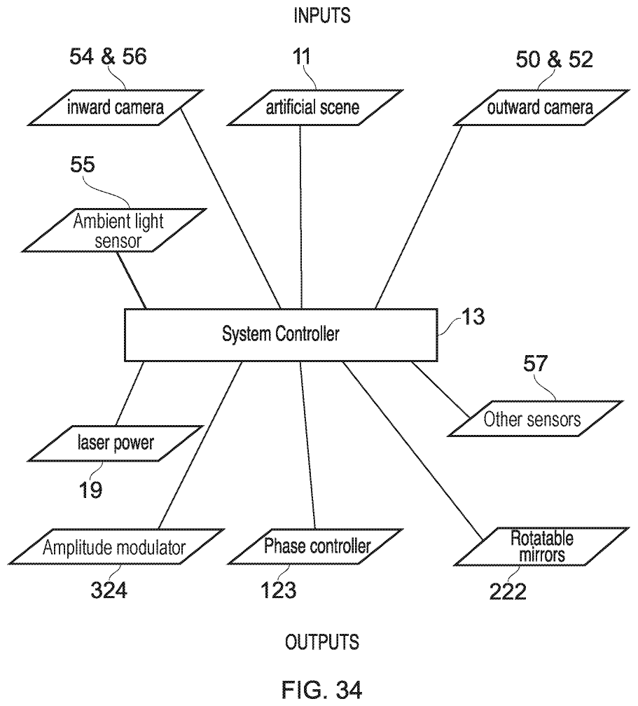

FIG. 34 shows a simplified schematic block diagram of a controller for a display system as described above. The controller 13 is shown having three prime inputs, namely image data of the desired synthetic scene information 11, eye monitoring data from the inward facing cameras 54 & 56 and image data of the natural scene from the outward facing cameras 50 & 52. The controller 13 takes information from the natural scene using the external cameras 50 & 52 to determine where the synthetic scene information should be located 11. The internal facing cameras 54 & 56 are used to determine where the eye gaze is directed which in turn is used to derive where on the display element the overlapping input beams should be directed to overlap in the NLO material. The ambient light sensor 55 is used to obtain a measurement of ambient luminance. The figure also shows the primary outputs of the controller 13 which are: the laser power 19 for the radius of curvature determining beam; the OLED controller 324 to create the intensity structured beam; the phase controller 123 (which sets radius of curvature/phase across the laser beam); and outputs to control input beam manipulating optical elements for steering and focusing the input beams, e.g. the rotatable mirrors 222. A further output is provided to control the dimming layer 140 according to the ambient luminance detected by the ambient light sensor 55. It will be appreciated that the system described is simplified and in more complex configurations other sources of information will be incorporated, such as additional sensors 57 to provide accelerometer data, magnetic compass data, LiDAR data, etc.

By way of example a display system as described herein may have any combination or selection of the following inputs, controller functions and outputs.

### Inputs:

Any of the following inputs and associated controller input interfaces may be provided.
WiFi or 4G/5G connection to internet
Bluetooth or equivalent (wired, wireless or optical)
Accelerometers and magnetometers
Outwardly facing cameras
Inwardly facing (eye tracking) cameras
Integrity sensors photodiodes
Information to determine synthetic scene including locally derived and that received from external network
Coordinates and geometry of local space (locally broadcast or from memory)
Lidar/3D mapping information
Calibration data from installation protocols
Light scatter from eye viewed by inward camera
Ambient light sensor to measure ambient luminance

### System Controller Functions:

Any of the following functions may be subsumed in the controller.
Determination of synthetic scene from external and internal sources
Determination of local geometry and feature identity
Memory and signal processing
Current eye gaze angle
Eye separation & other ocular properties, eye dominance, blinking, etc.
Calculation of overlap angles and phase control
Intensity modulation calculation
Determining display integrity
External light levels
Controlling brightness of displayed AR content according to ambient luminance
Calculation of need to block real-scene light block

### Outputs:

Any of the following outputs, which may be considered as control signals, and associated controller output interfaces may be provided.
Positional, rotational and acceleration data to external users
Camera outputs to external processing
Controller for first beam & controller for second beam
Amplitude modulation
Phase modulation for setting radius of curvature
Colour modulation
Steering optics to direct beams to desired spot
Control of photochromic real-scene light blocking by the dimming layer according to ambient luminance, e.g., through control of the dimming layer.

### Wavelength Combinations

For a colour display it will be necessary to provide red, green and blue light. Assuming the nonlinear process is three beam SFG, the frequencies of the two input beams must sum to the frequency of the desired colour of the product beam. There are a plethora of available laser and non-laser sources which provide almost limitless possible combinations of two frequencies that sum to red, green and blue.

One example combination is:

1064 nm + 1550 nm = 630 nm (red)
1064 nm + 1064 nm = 532 nm (green)
1064 nm + 780 nm = 450 nm (blue).

This example also shows a practical approach to reduce the number of source wavelengths that are needed. In this example, only three different wavelengths (frequencies) are used, i.e. fewer than two per colour.

A second example combination is:

1064 nm + 1560 nm = 632.5 nm (red)
1064 nm + 1064 nm = 532 nm (green)
1064 nm + 780 nm = 450 nm (blue).

This example shows a further approach to reduce the number of source wavelengths that are needed. In this example, only two laser sources are needed, as the 780 nm light can be created by second harmonic generation of the 1560 nm laser.

It will be appreciated that the choice of the number of lasers used will depend on the availability, efficiency, price, lifetime and physical volume of each technology. It should be noted that it is possible to use a single laser (for example at 3144 nm), which via frequency doubling would give 1572 nm and its third harmonic would give 1048 nm.

Thus, a third example combination using a single starting laser at 3144 nm is:

1048 nm + 1572 nm = 628.8 nm (red)
1048 nm + 1048 nm = 524 nm (green)
1048 nm + 786 nm = 449.1 nm (blue).

Another specific example would be:

950 nm + 1800 nm = 621 nm (red)
950 nm + 1210 nm = 532 nm (green)
950 nm + 880 nm = 456 nm (blue).

Where the 950 nm beam could be generated by an OLED array (or other infrared light emitting diode array) and the other three beams at 1800, 1210 and 880 nm by respective laser sources. In this example, there are four different wavelengths.

A general desirable feature of the present invention is apparent from the above examples. Namely, since the colours for the display are inherently in the visible range, the input beams will be in the infrared and hence invisible for most if not all practical combinations of two wavelengths. The scatter problem with conventional microprojector displays is therefore inherently solved, since any scattered light from the source beams will be in the infrared and so cannot be seen.

The conversion efficiency in a nonlinear process depends on the products of the input beam intensities. For this reason, although CW sources could be used, it is preferable that the sources are operated in pulsed mode to produce high peak power and thus greater conversion efficiencies. Laser sources for generating the input beams may be operated in any of the following modes: CW, long-pulsed, nanosecond pulsed, picosecond pulsed or femtosecond pulsed. The choice of which sources to use and in which modes of operation will depend on various factors including the nonlinearity of the NLO material, the damage thresholds of the NLO material, the required drive electrical power, form factor, weight, cost, lifetime, etc.

Moreover, it will be understood that any particular beam source that is used will generate a beam with a certain frequency response that is typically defined in terms of a single frequency (or wavelength)—the peak frequency—and a bandwidth—as a measure of the spread of the emission above and below the peak frequency. To the extent that it is relevant in this document, we define the bandwidth of a beam source to be the full width at half maximum (FWHM). When a laser is used as the beam source, the bandwidth will be very narrow, whereas when a non-laser source is used as the beam source the bandwidth may be appreciable. Considering the visible and near infrared wavelengths discussed in the examples above, typical bandwidths are as follows. In a single-mode edge-emitting LD, the bandwidth may be as high as a few nanometres reducing to sub-pm for distributed feedback (DFB) or distributed Bragg reflector (DBR) edge-emitting LDs. For non-laser sources, the bandwidths will generally be higher. For example, an OLED may have a bandwidth of a few tens of nanometres. In this document, we usually refer to ‘the frequency’ of a beam source-meaning the peak frequency- and do not mention the bandwidth unless relevant.

### Other Points and Variants

Although SFG by nonlinear wave mixing is typically associated with the need to use input beams with quite high power (e.g. mW to Watt level laser powers), such high power input beams will not generally be needed for embodiments of the present invention because of the human eye's high sensitivity. For the human eye, optical powers at the sub-microwatt level are quite bright, so the maximum output powers of the beam sources needed by close-to-eye embodiments of the invention, such as AR spectacles or VR headsets, will remain quite modest.

Many of the conventional approaches to the optical design known from existing AR and VR display apparatus can also be used in display apparatus embodying the present invention.

For example, it is well known to use a positive lens between a modulated light source (e.g. a micro-OLED emitter array) and the AR display panel to transfer the light to an emitting point on the display panel where it effectively becomes an angular spectrum. This concept is familiar in terms of Fourier optics, for example in a 4f imaging system, with a simple ‘positive’ lens placed one focal length from the emitting screen, and set such that the position the plane waves are reflected from is also one focal length away. In the simplest case, and assuming that the focal length of the positive lens matches the focal length of the eye lens (e.g. about 16 mm), a symmetric 4f imaging system is provided by the positive lens and the eye lens. The display panel is then located at the intermediate or Fourier plane between those two lenses and will thus contain the angular information. Modifications are possible in which the relay lens has a different focal length compared to the eye. Moreover, the positive lens may also be modified in a more sophisticated way, e.g. to compensate for undesired optical distortion, such as to correct chromatic and other aberrations, or to provide other effects, such as to provide different magnifications. In designing the relay lens, it should be noted that the non-collinear geometry causes the spatial distribution of image information in the product beam to be stretched compared with the corresponding image information in the first and optionally second input beams which needs to be taken account of. One simple approach is to use the Schleimpflug principle in which the lens is tilted so as to image to planes at an angle. More complex optical lenses and lens combinations can be deployed to correct for distortions and aberrations as are already commonplace in optical design theory. There are also effects due to the curvature of the display panel, and this can be corrected through a combination of determining the local angle of the QPM grating direction, and also through the selection of image information.

If an AR display apparatus is convincing, then a person wearing AR spectacles can have any image placed anywhere within their visual field. For example, if the wearer looks at their wrist to see a wristwatch, they don't actually need a watch face to be present. Rather, the watch face can be superimposed onto the watch face. Similarly, a mobile phone no longer requires a display, it can instead have an arbitrary display area on which the AR display superimposes what is on the display. The same approach can be taken for a television or personal computer, which no longer needs a screen, merely a designated area on the wall or the device for the wearer of the AR display to perceive the display to be. A keyboard can be projected too.

It will be realised that any of the approaches disclosed herein in the context of AR will also be applicable to VR (simply by blocking all natural scene light).

It is noted that when we refer to SFG of two input beams we include frequency doubling, i.e. second harmonic generation (SHG), SHG being a special case of SFG in which both input beams are of equal wavelength.

While certain features and advantages of the proposed design are specific to AR vision systems, the proposed design is also advantageous for VR vision systems, in particular VR goggles could be made with much smaller depth as a result of being able to engineer the wavefront curvature of the VR images. The ability to place different synthetic objects at different perceived depths is just as advantageous in the context of a virtual image formed in VR goggles as for AR spectacles in that it makes the VR image more convincing and also allows vergence-accommodation conflict to be avoided.

Moreover, the disclosure of this document can also be deployed to provide imaging solutions for other optically viewed systems where the eye is in close proximity to where image formation occurs, including but not limited to binoculars, monoculars, telescopes, camera viewfinders, cinema camera viewfinders, microscope eye pieces, medical imaging devices, endoscopes, magnifying elements, rifle scopes and military targeting systems.

### Low Signature

Conventional AR spectacles tend to emit significant amounts of stray visible light into the environment, which can be problematic, for example making the wearer visible.

In respect of stray light emission, the display panels according to the invention have several inherent advantages over conventional AR displays. Firstly, the product beam is highly directional and pointed towards the viewer's pupil. Secondly the input beams are not in the visible wavelength range, whereas in conventional AR spectacles of the projection type the input beam travels over a relatively large distance from the spectacle arms where the light source module is mounted into the spectacle frame and the light beams are directed along multiple projection paths in different directions, including the forward direction, via various lens and mirror combinations. According to the invention, the visible light of the product beam is generated in the display panel itself not beforehand. Thirdly, the display panel may be operated such that the AR scene information is only generated in image regions where the viewer is looking as detected by inwardly facing cameras tracking pupil position.

The total amount of visible light generated is therefore much lower than in a conventional AR display device and the visible light that is generated is generated close-to-eye and is highly directional pointed towards the pupil. The total amount of visible stray light that is emitted out of the front of the AR display panel can therefore be kept much lower than in a conventional AR display device.

Still further, the design of the present invention allows for stray light suppression. This is because the visible light of the product beam is produced by nonlinear frequency mixing and has a well-defined wavelength extending only over a narrow wavelength band. It is therefore possible to place filters that are spectrally narrow on the front layer of the AR display panel to filter out any stray visible light that would otherwise be emitted from the front of the AR display panel. The filters may be absorbers or reflectors. Specifically, in a colour system, it is possible to block at the specific RGB wavelengths with three narrowband filters. The provision of a stray visible light suppression layer to the front of the NLO material layer can significantly reduce the unwanted light signature of the AR display panel while retaining a substantially transparent lens for natural scene light across the visible spectrum. This is achievable because the bandwidth of the filter can be made much narrower than the bandwidth of any specific colour as perceived by human vision, so the viewer's perception of the natural scene will not be impaired.

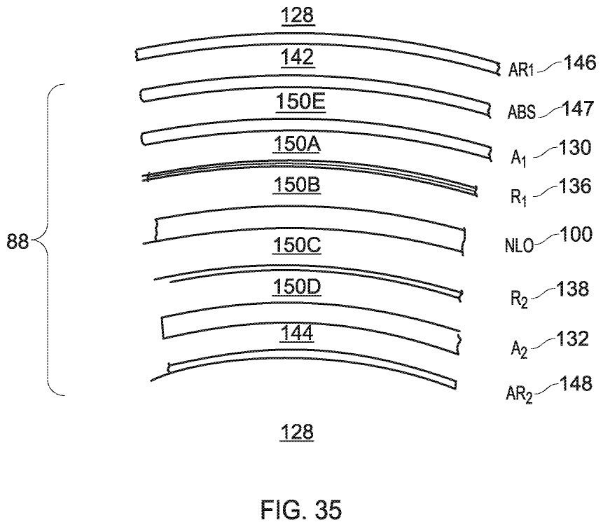

FIG. 35 shows an example layer structure for an AR display panel 88. The layer structure is the same as shown in FIG. 16 apart from the provision of an additional layer 147 serving the purpose of preventing light at the (or each) product beam frequency, i.e., the sum frequency, from being emitted in the distal direction out of the display panel. The common description of FIG. 16 is omitted for brevity. Layer 147 is to be incorporated between the display panel layer in which the input beams are routed and the distal surface of the display panel. Specifically, the layer 147 is shown arranged to the front of the layer 142 and separated from the layer 130 by a further spacer layer 150E.

The layer 147 thus constitutes a notch filter centred around the sum frequency which blocks stray light scattered from the product beam, e.g. product beam light reflected from the eye, while passing all other frequencies around it. The layer 147 can either operate by absorption or reflection. It will be understood that although the paired input beams (which are at non-visible wavelengths) combine to generate a product beam 82 (having a visible wavelength) that has a wavevector directed towards the viewer (proximal direction), i.e., directed out of the front of the display panel, there will inevitably be some unwanted scatter and reflection of the product beam leading to a relatively small number of photons at the product beam frequency travelling in a direction pointed towards the back of the display panel as stray visible light. To capture these stray photons, which would otherwise be emitted out of the back (distal) face of the display panel into the air 128, either an absorbing or one option for the layer 147 is for it to be a light absorbing layer with selective light absorbance in a narrow frequency band centred at the product beam frequency. To capture these stray visible photons, which would otherwise be emitted out of the back face of the display panel into the air 128, another option for the layer 147 is for it to be a reflective layer configured to reflect light in a narrow frequency band centred at the product beam frequency. The reflective layer may comprise a multilayer stack deposited as multiple coating layers that reflect based on thin film interference effects. In the case of a colour display panel, layer 147 may be a composite of three such light absorbing or reflective layers with respective selective absorbances or reflectivity in narrow frequency bands centred at the three frequencies of the different primary colour components, i.e., the three product beams. The narrow frequency band of the absorbance of layer(s) 147 ensures that light from the natural scene passes through the display panel to the viewer without the view perceiving any impairment of the natural scene, since only a small proportion of natural scene photons of each primary colour is absorbed by layer 147.

The stray light suppression layer 147 contributes to creating a low visible signature display. The back (distal) filter layer 130 contributes to creating a low infra-red signature display. In combination, the layers 130 and 147 thus provide a low signature display in which substantially no stray light from either the input beams (in the infrared) or the product beam(s) (in the visible) escapes out of the distal side of the display panel. This is important for military use where the detectability of the user of the display panel needs to be low, i.e., low signature. The display panel can therefore remain undetectable to a hostile party using infra-red imaging, visible imaging or simply natural human vision, The display panel may be part of a wearable headset, such as a helmet visor or AR spectacles, or embedded in a contact lens. Low visible signature may also be of benefit for policing applications using AR spectacles, since, when information is being displayed to the police officer wearing the AR spectacles, persons in close proximity to the wearer will not be aware of that. A potential source of tension is therefore eliminated. Stray visible light may just simply be annoying or distracting for someone who is interacting with the wearer of the AR spectacles. Other uses can be readily appreciated, e.g., hunting or wildlife photographers who wish to remain invisible to animals or people involved in surveillance.

To avoid impairment of the viewer's perception of the natural scene, the or each notch filter layer 147 should each have a bandwidth significantly smaller than the colour band that they lie in. The spectral bandwidth of the primary colours as perceived in human vision is as approximately as follows: 130 nm for red; 70 nm for green; and 45 nm for blue. If follows that the frequency band of the visible stray light suppression layer for any of these primary colours should be small relative to the red, green or blue bands, so that only a small proportion of natural scene photons of each primary colour is absorbed as they travel through the display panel into the wearer's eyes. For example, the ratio of the bandwidth of the notch filter to the colour band it lies in may be less than one of 1:3, 1:4, 1:5, 1:6, 1:7, 1:8, 1:9 or 1:10. The notch filter bandwidth may be defined using a 3 dB-bandwidth. In any case, for a colour display panel with multiple notch filters, the stop bands of each notch filter do not overlap.

Stray light suppression layer 147 can be combined with other features. For example, it could be combined with the anti-reflection coating 146. The placement of the stray light suppression layer 147 in the layer stack of the display panel may be different to that illustrated but of course needs to be placed on the distal side of the NLO material layer 100, i.e., between the NLO material layer 100 and the distal (back) surface of the display panel 88.

### High Brightness

The brightness of the AR image components can be dynamically adjusted to remain visible in all ambient light conditions without becoming too bright in low-light conditions. For example, the brightness of the ambient light can be detected with a suitable light sensor 55 integrated in the AR spectacles, and the brightness of the AR image components scaled linearly or according to some other function, to become brighter when the ambient light is brighter and darker when the ambient light is darker. For example, brightness may be controlled to maintain a certain ratio between measured ambient luminance and AR image luminance. The ambient light sensor 55 may be a photodetector arranged in a suitable position. For AR spectacles, the ambient light sensor 55 can be mounted in the spectacle frame 26, as illustrated in FIG. 20. The photodetector may be made of silicon or cadmium sulphide material, for example.

An inherent advantage of the display panel of the invention is that AR image components can be generated with extremely high brightness compared to conventional AR display panels based on visible light sources that are in essence isotropic emitters. Moreover, the brightness can be varied over multiple orders of magnitude. Still further, since the product beam is highly directional, the total energy of the light that needs to be generated to create an AR image feature is orders of magnitude lower compared with a conventional visible light emitter that radiates photons over a large solid angle.

As discussed further above, operation in bright ambient light is not readily achievable with current AR display technology for the following reasons. With AR devices based on light emitting diode (LED) sources, it is difficult to transfer light from the LED (which is inherently emitted over a wide range of angles) to the lens, and then to couple this light efficiently to the viewer. This is because of the limited numerical aperture and limited etendue of the optical system and also because transparent lenses must be ‘transparent’ and this transparency is difficult to reconcile with high efficiency transfer to the viewer's eye. One approach that has been considered to create brighter displays is to use laser sources instead of LEDs, since lasers are inherently much brighter than LEDs. By brightness in this context, we mean more photons per mode, with lasers being far brighter than any natural source of light, even the sun. However, with laser-based systems, the challenge still persists in how to make a transparent display.

The present invention solves these problems by providing an extremely high-brightness capability with a transparent display panel. Our approach uses pairs of input laser beams incident on a transparent NLO material layer where a directional product beam is created by frequency summation. The product beam can be made much brighter than conventional AR display using LED sources, the product beam of the present invention being both spectrally brighter but also brighter in terms of the light power emitted into a given solid angle. Through the use of suitable sensors, the brightness can be controlled so that the augmented reality scene information remains visible in the brightest conditions and is not overly bright in darker ambient light.

The present invention thus opens up new possibilities for using AR display panels outdoors in daylight, especially on sunny days.

A first high-brightness example applies to a pilot using a head-up-display while flying an aircraft such as a fixed-wing aircraft or a helicopter. The daytime sky above the clouds is extremely bright, especially if the pilot is looking towards the sun. Using the invention, the AR content of the head-up display is visible without the pilot needing to wear sunglasses.

A second high-brightness example would be in an automotive vehicle, e.g., a car, with a head-up display in the windscreen. AR content of the head-up display will remain visible even when driving towards the sun, especially when the sun is low in the sky at sunrise and sunset. A similar situation occurs when driving at night created by the headlights of oncoming vehicles.

Brightness control in bright ambient light conditions may be further controlled as described above through provision of a dimming layer made of photochromic or electrochromic material. The overall brightness of the natural scene light can be reduced, e.g. in bright ambient light conditions, so that the brightness of the synthetic scene light does not need to be increased as much as would otherwise be necessary in order that AR scene features blend into the natural scene appropriately.

### Selective Brightening and Dimming

Area-specific dimming in this way to attenuate bright spots in the natural scene has the effect of reducing the dynamic range in the overall image and therefore increases the quality of the image as viewed through the AR display panel.

Another way to reduce dynamic range is to increase the brightness of selected areas of the overall scene by reproducing parts of the natural scene in the synthetic scene. The same effect can be achieved by reproducing the whole of the natural scene in the synthetic scene and rendering selected areas in the synthetic scene with higher brightness. The synthetic scene is therefore used to increase the natural light level in selected areas of the scene. This approach can be used to enhance dark areas of the image to reduce the dynamic range within the image. The approach of brightening the natural scene may also be used uniformly across the whole image if desired and may for example be useful when the whole natural scene is dim.

Specifically, the controller can be configured to form the synthetic scene images to include a reproduction of the natural scene and to superpose the reproduction onto the natural scene thereby to increase perceived brightness of the natural scene as viewed through the display panel. This may also be done for only certain areas of the scene, so that the synthetic scene images reproduce one or more parts of the natural scene images and superpose them onto the natural scene thereby to enhance said at least part of the natural scene as viewed through the display panel.

Brightening the scene, either in certain areas or overall, will also tend to improve the quality of the image as perceived by the viewer for the following reasons. Brightening of the scene causes the viewer's pupil to reduce in diameter, which is a natural advantage, since aberrations of an optical lens, specifically here the eye lens, reduce with smaller diameter lenses. This is because of the reduced range of angles, which in turn reduces aberrations such as chromatic aberration, coma, sagittal and tangential distortion, etc. Furthermore, a smaller pupil has a greater depth of field (rather like a pin-hole camera) and this reduces other natural eye defects such as astigmatism, short sight, long sight, etc. Creating a brighter scene therefore contracts the pupil which reduces the lens diameter and thereby provides a better quality image on the retina.

This selective brightening approach has advantages of selective dimming in low light conditions or other situations where the natural scene is relatively dark in some significant areas. One example would be night driving when the headlights of an oncoming vehicle are extremely bright but the rest of the scene is dim. In such situations selective dimming alone will still leave road features quite difficult to perceive well, whereas selective brightening away from the headlights will improve the perception of these other road features.

It will be understood that the selective dimming and selective brightening may advantageously be used in combination.

As well as generally enhancing the natural scene, e.g., to provide whole scene image enhancement in low light conditions, this approach of providing an enhanced image of the natural scene may also be used to highlight certain parts of the natural scene.

The controller may be configured to process the natural scene images to identify at least one element in the natural scene, and to arrange the synthetic scene or an element thereof on the display panel having regard to the at least one natural scene element.

The enhancement may include one or more of positioning, sizing, alignment, brightness, or colouring of the synthetic scene element. An example of synthetic scene elements in this context could be text labels to label natural scene elements, e.g., parts of a machine, engine or other apparatus being worked on. Another example of synthetic scene elements in this context could be driving or flying aids for a vehicle driver or aircraft pilot, such as lane assist markers of a road for a driver or crosshairs for a combat pilot. For example, in the context of driving an automotive vehicle, this may be to highlight a hazard, e.g., to show a pedestrian or cyclist more brightly. Another example would be for a pedestrian wearing AR spectacles to enhance certain parts of the natural scene to make advertisements more prominent.

Artificial colouration of an element that has been identified in the natural scene may be useful in low light conditions when the eyes of the viewer are reliant on rods for image formation, so that the natural scene appears monochrome to the viewer. Artificial colouration may also be useful in any light conditions to highlight an identified element, e.g., red shading to indicate that the identified element is a hazard, such as to mark a pedestrian or cyclist to a vehicle driver. The enhancement could be outlining at or around the perimeter of the identified element.

Generating a copy of the natural scene to incorporate partially or wholly into the synthetic scene can be achieved as follows.

A synthetic scene can be generated from outwardly facing cameras. In the case of AR spectacles, these cameras may be incorporated in the spectacle frame. In the case of an automotive vehicle, the cameras incorporated in the vehicle may be used, optionally in combination with other imaging sensors built into the automotive vehicle such as LIDAR (Light Detecting and Ranging), thermal imaging cameras, or cameras external to the vehicle.

Computer processing can recognise bright features in the natural scene. For selective brightening, synthetic scene light is then generated in other areas. Optionally, the bright features can also be attenuated by selective dimming. For example, the sun can be dimmed (either in selective areas or across the whole display) while the areas of the scene away from the sun can be enhanced. Even if dimming is not used (e.g. in the example of automotive vehicle headlights at night) where it is not desirable to dim the overall AR display, the bright synthetic scene light (away from the dazzling headlight) can create the effect of increasing the visibility of the background scene thereby reducing the dazzling effect of the oncoming vehicle's headlights.

The creation of the synthetic scene light can make use of machine learning, artificial intelligence. The AI/ML can be trained to recognise and act on bright (or saturating) elements of the natural scene, or it can be trained to recognise specific features in the natural scene to suppress or enhance in the image by selective dimming and/or selective brightening respectively.

### Non-Close-to-Eye (NCTE) Displays

### NCTE Displays Introduction

Displays for televisions, personal computers and many other devices are designed to be viewed at a distance. Specifically with the display positioned at a greater distance from the viewer's eyes than the near point. The eye's near point is the closest distance which the eye can bring into focus, i.e., accommodate. The near point is often taken to be nominally 25 cm. However, a human eye's actual near point gradually increases with age from about 7 cm for a youth to over 50 cm for an old person. Specific examples of such displays would be laptop computer displays, televisions, mobile phone displays, smart watches, aircraft video screens, dashboard-mounted automotive displays, scientific instrument displays and medical instrument displays.

Common commercially available displays of this kind are liquid crystal displays (LCDs) and organic light emitting diode (OLED) displays, although other display types are known such as historically cathode ray tubes (CRTs), active LED modules, laser projectors, and digital micromirror devices (so-called Digital Light Processors, DLPs). In this document, such displays will be referred to as ‘non-close-to-eye’ (NCTE) displays in contradistinction to near-to-eye (NTE) displays such as augmented reality (AR) displays and virtual reality (VR) displays for headsets as well as smart contact lens displays.

One way to classify between NTE and NCTE displays is to consider whether the display distance is less than or greater than the near point distance (i.e., about 25 cm). For NCTE displays, taking the example of a television, the pixels on the LCD or OLED display panel are in effect point sources, so the wavefront radius of curvature at the viewer's eyes is equal to the distance between the viewer and the television display panel, which will typically be several meters. For NTE displays, taking the example of AR spectacles, a point source approach will not work and instead wavefronts must be created with a radius of curvature many times greater than the distance between the wearer's eyes to the transparent glass lenses of the AR spectacles, which will only be perhaps 10-30 mm.

NCTE displays generally operate using a light emitter. The light emission can be scatter from a matte screen or can be direct emission of light from an array of point sources (e.g. in an OLED display) or through an array of amplitude modulators operating in transmission to modulate transmission of backlit light (e.g. in a backlit LCD display). In general, a pixel of a conventional display emits a spherical wavefront of light centred at the pixel location into the half-space in front of the display. Since the radius of curvature of the wavefront emitted from the display matches the physical distance from the display, the viewer's eyes focus on the physical distance to the display element. The viewer's object plane, i.e. the plane in which the viewer perceives the object to be positioned, is thus coincident with the physical plane of the display panel. In other words, the viewer's individual eye focal distances (accommodation of monocular vision) and also their depth perception (vergence of binocular vision) are both congruent with the display position.

However, there are situations where it would be useful to have a display where the eye focus distance is different to the physical distance from the viewer to the display.

An example where it would be beneficial to provide an eye focus distance that is greater than the physical distance from the viewer to the display would be a dashboard-mounted automotive display for providing a driving aid, such as a speedometer or navigation image.

The driver will be looking at the road ahead, so their eye focus will be essentially at infinity, where infinity in human vision is often taken to be any distance greater than 4 metres. When the driver glances briefly to the display, their eyes must refocus to the shorter distance to the display panel, which might typically be between 50 cm to 150 cm. This refocusing takes time (typically 0.25 to 0.50 seconds) which is effectively dead time during which the driver is neither able to view the road nor the display.

An example where it would be beneficial to provide an eye focus distance that is shorter than the physical distance from the viewer to the display would be for very short-sighted individuals who are unable to focus on a display panel designed to be positioned at an eye-to-display distance of for example 50 cm or more. For example, a very short-sighted person may not be able to view the display of a wristwatch.

### NCTE Summary

This invention provides a display apparatus in which visible light for forming the display image is generated in an NLO material by sum frequency mixing (SFG) from a pair of infrared beams. The two infrared input beams are structured with amplitude and phase information to allow the visible light to be generated with any desired wavefront radius of curvature, thereby allowing an image to be presented to a viewer at any arbitrary object plane. The object plane may thus be chosen to be more distant, less distant or coincident with the physical plane of the display panel. In other words, the eye focus distance can be made different from the physical distance from the viewer to the display.

This invention also provides a display apparatus in which light can be generated in a non-linear optical material with any desired wavevector, i.e., directionality, by structuring the two infrared input beams with amplitude and phase information. This ability to control the wavevector of the visible light being generated allows different images to be presented to different viewing points through time slicing. Different images can be served to a viewer's left eye and right eye to provide stereoscopic viewing. In other words, the perceived vergence angle can be controlled. This also allows different images to be served to different viewers as well as different images to the same viewer as the viewer moves from one viewing position to another to provide the impression of perspective and changing perspective in a 3D scene.

The ability to control jointly the wavefront radius of curvature and the wavevector of light generated in the NLO material also allows for both vergence (stereoscopic or binocular vision) and accommodation (eye focus) to be controlled and, moreover, to be controlled independently of each other. This allows the left and right eyes of a viewer to be served image information in which vergence and accommodation match or at least are kept close enough to avoid unpleasant vergence-accommodation conflict effects for the viewer.

A general requirement of any NCTE display is to allow the viewer to gaze at a display panel located within their visual field and bring any features in the visual field into sharp focus. In this respect, it is noted that focusing of the human eye (for those with perfect eyesight) allows sharp images to be formed for distant objects (at infinity) through to a nearest distance (the near point) which is typically around 25 to 30 cm from the face for a young adult. Thus, ‘normal’ vision ranges from infinity to the near point. Some people (long-sighted—presbyopic) have eye lenses that are not sufficiently powerful to focus near objects onto their retinas (or eyes that are too short to allow focus), thus their near-point is at a longer distance. Other people are short-sighted or myopic and have lenses that are too strong (or eyeballs too long) and they are unable to focus light from infinity—although their near-points will be closer than 30 cm). Another effect is age-related loss of accommodation caused by the eye lens becoming stiffer and eye muscles weaker, making it more difficult for older people to focus on closer objects.

Because our approach allows wavefronts to be generated in the nonlinear optical material with a controlled radius of curvature and wavevector as well as amplitude, it is possible to create novel types of display element. In particular, the ability to control the wavefront radius of curvature makes it possible to manufacture a display that provides images in which the eye focus distance is different to the physical distance from the viewer to the display.

Some specific use cases are now described by way of example only.

NCTE display panels for devices for older people that are designed to be positioned at an eye-to-display distance which may be shorter than the eye's near point for an older person who suffers from loss of accommodation with age (presbyopia). For example, a display panel for a smart phone can be provided which will emit light with a radius of curvature that corresponds to 100 cm or 150 cm even though the smart phone will be held at a much shorter distance of perhaps 50 cm. To create an appropriate display, it is also beneficial to deal with stereoscopic vision to avoid vergence-accommodation conflict, a ubiquitous effect known to cause nausea, headaches and other unpleasant effects when viewing images where the vergence angle and focal distance are not matched. Example devices which could benefit from this approach are laptop computers (e.g. 10 to 14 inch display diagonal), tablets, smart phones and smart watches as well as other displays in a variety of commercial and industrial settings, as well as in automotive and transport. Specific examples include automotive vehicle displays for instrumentation and navigation (which can be hard to read for older drivers), and airplane seat-back screens for passenger entertainment that may be uncomfortably close for older passengers. These are all examples where there is a benefit to having a display panel that presents an object plane at a greater distance than the physical plane of the display panel.

NCTE display panels for devices for people suffering from extreme short-sightedness. Here the ability to control wavefront curvature can be used to present an object plane at a shorter distance than the physical plane of the display panel. This provides a viewable image to people who are very short sighted and unable to focus on a display panel designed to be positioned at an eye-to-display distance which is too far away. For example, if the display to eye distance is 50 cm then the display could present an object plane that is 20 cm in front of the physical display panel, thereby to provide a reduced image to eye distance of 30 cm. The same examples may apply as above, i.e., handheld devices such as tablets and mobile phones, displays of smart watches, and laptop computer displays.

NCTE display panels for dashboard-mounted automotive displays, as used to supply instrumentation and navigation images to the driver. The driver will be looking at the road ahead, so their eye focus will be essentially at infinity, where infinity in human vision is often taken to be any distance greater than 4 metres. With a conventional automotive instrument or navigation display, when the driver glances to the display, their eyes must refocus to the shorter distance to the display panel, which might typically be 50 cm. This refocusing takes time (typically 0.25 to 0.50 seconds) which is effectively dead time during which the driver is neither able to view the road ahead nor the display. The approach of the invention allows a dashboard-mounted automotive display to be provided in which the object plane presented to the viewer is also at infinity, so the driver can glance at the display without needing to refocus their eyes. Thus, the display allows the viewer to see with an eye focus and preferably also vergence angle corresponding to a greater physical distance than the eye-to-display distance. Another similar automotive example is that there is a trend to replace physical side mirrors (wing mirrors) and rear-view mirrors with displays fed with a camera feed. However, while physical mirrors preserve a far distant object plane, the effect of replacing physical mirrors with a conventional display panel provided with a camera feed is to bring the object plane into the near distance causing the same problems as described above in relation to instrument and navigation displays. This can be avoided by using a display according to the invention.

NCTE display panels can be provided that ensure privacy. The wavevector control available with displays according to the invention allows light to be directed specifically to a viewer, more especially each of the eyes of a viewer. This compares with a conventional display where a point source radiates light into essentially the whole half-space in front of the display panel and is viewable by anyone who is able to see the front of the display panel. For example, the authorized user of a smart phone or laptop computer can be recognized by facial recognition with a forward-facing camera and images can be served only to the eyes of the authorized user, so remain invisible to persons who are located at other viewing angles, who therefore are unable to snoop.

NCTE display panels can be provided that have much lower power consumption than conventional NCTE display panels with associated benefits for battery life and reduced energy usage. This advantage follows from the wavevector control being able to improve the ratio between the number of photons generated in the display panel to the number of photons entering the eyes compared to a conventional display based on an array of isotropically emitting point sources.

NCTE display panels can be provided that provide stereoscopic vision and depth of focus effects while avoiding the vergence-accommodation conflict opening up applications where 3D imaging is important. One such application is as a replacement for stereo-microscopes, e.g., for support of surgeons carrying out operations. Other applications of interest are in computer gaming to provide more realistic 3D experience and inspection and servicing of spatially complex apparatus such as engines or watch mechanisms.

NCTE display panels that remain viewable in bright background light, such as in daylight on a sunny day. This is a particular problem for aircraft cockpit displays, since aircraft are flown above the cloud base and sometimes towards the sun. The wavevector control available with displays according to the invention allows light to be directed specifically to a viewer, more especially each of the eyes of a viewer. This compares with a conventional display where a point source radiates light into essentially the whole half-space in front of the display panel. In a conventional display, the proportion of photons generated in the display that end up entering a viewer's eyes is therefore tiny and decreases rapidly with viewing distance. With the invention, the display can be driven to direct light only in the direction of the viewer (or viewers). For example, cameras can be integrated in the display apparatus and used to locate viewer(s) by facial recognition and then image generation on the display can be controlled to direct light only to each viewer's eyes. As a consequence, display apparatus according to the invention can provide images that are orders of magnitude brighter than conventional NCTE displays. Thus, displays according to the invention are suitable for use in daylight, sunlight, etc, and can be deployed for entertainment, advertising, providing safety and warning information, etc.

Generally, a NCTE display panel need not be transparent, since the viewer does not look through it like in an AR display panel, which needs to be transparent. In an NCTE display according to the invention, the display panel merely needs to be sufficiently transmissive to visible light between where the NLO material and the front of the display panel to allow the visible product beam light to travel from the intersection volume where it is generated to the front of the display panel without too much attenuation taking account of not only display brightness but also heating effects in the display panel. Since the NLO material for an NCTE display according to the invention need not be transparent, i.e., can either be transparent or translucent, there is a greater choice of NLO materials available. The same is true for the materials choice of other layers and coatings that lie between the NLO material layer and the front of the display panel. An additional consideration is also transparency to the wavelengths of the input beams, which will be in the infrared for generating a visible product beam. If the input beams are conveyed through the NLO material layer 100 to the intersection volumes via multiple total internal reflections then the optical paths of the input beams will of course need to have a high degree of transparency at the wavelengths of the input beams.

This also opens the route to other nonlinearities that create forward going light by wave mixing (e.g., through third harmonic generation, through chi-3 nonlinearities. Also surface based nonlinear generation could be used.

For larger NCTE display panels, organic QPM nonlinear materials are attractive to provide the NLO material. Moreover, it will be attractive to use short pulse lasers to increase the efficiency of the frequency mixing in the NLO material, e.g., nanosecond, picosecond or femtosecond laser pulse durations.

It is also noted that there is no requirement to use a single laser to generate each input beam. In particular, for an NCTE display panel, it may be attractive to use arrays of lasers to generate the input beams. For example, the array could be such that at each node of the array there is a plurality of lasers as required to generate the number of input beams that are needed, e.g. two, three, four, five or six per array node. In the case of an NCTE display panel, the spatial requirements are relaxed compared with a transparent AR display panel, since the whole back side of the NCTE display panel can be used to accommodate devices and components including laser arrays. For example, infra-red vertical cavity surface emitting lasers (VCSELs) could be used as laser sources for the laser arrays.

It may also be desirable to overlap multiple incoherent beams in given regions of the NLO material 108 to improve image uniformity and reduce laser speckle effects caused by transverse coherence.

Given the large size of the NLO material layer needed for NCTE displays embodying the invention, it will be attractive to use high peak power pulsed lasers as the excitation sources for creating one or both of the input beams of each input beam pair.

Two specific forms of NCTE display panel according to the invention are now summarized.

A first specific form of NCTE display panel according to the invention generates complete images in the NLO material according to the invention. Pixel-by-pixel amplitude control is provided by the input beam mixing, i.e., amplitude and phase modulation of the input beams. Pixel-by-pixel wavevector control is also provided by the input beam mixing, i.e., amplitude and phase modulation of the input beams. Further, the focus of the viewer is directed at the plane of the display as in a conventional display panel, so there is no vergence-accommodation conflict. Specifically, the input beam mixing sets the wavefront radius of curvature to the same value for all pixels in order to match the image plane closely to the physical plane of the display panel. The NLO material is used to create an image frame which only has a single wavefront radius of curvature, i.e., apparent depth of origin, across the display panel and which uses wavevector control, i.e., product beam directionality to direct separate image frames to each participant associated with that display panel and optionally separate image frames to the left and right eyes of each participant associated with that display. For this mode of operation, the amplitude modulation of the light field is generated within the NLO material. In this mode of operation, the phase modulation of one or both of the input beams is used to set the product beam's wavefront radius of curvature to the same value for all pixels whereas the product beam's amplitude and wavevector are set to different values on a pixel-by-pixel basis. A variant of this uses the same hardware as the first form of display panel but additionally the input beams are generated to provide pixel-by-pixel control of the product beam's wavefront radius of curvature to provide the illusion of different depths for different parts of the scene, such as a more distant background and nearer participants. The degree of complexity of the processing and the drive signals is therefore increased compared to the first form of display panel. This variant drives the NLO material in a similar way as for a near-to-eye display panel as used for augmented reality glasses or smart contact lenses.

A second specific form of NCTE display panel according to the invention forms images through combined use of an NLO material and an overlaid transmissive SLM. NLO material is arranged in one plane and combined with a transmissive electrically addressed spatial light modulator, such as a pixelated LCD layer arranged in front of the plane of the NLO material to provide amplitude (i.e., intensity) modulation. The transmissive spatial light modulator may also optionally provide colour filtering, which could be relevant if the display apparatus is configured to generate all three primary colours simultaneously. The colour filters would then selectively block two of the three primary colours or selectively attenuate all three to provide the desired colour mix. Otherwise, colour images can be produced by generating the three primary colours in the NLO material by separate mixing combinations of three pairs of input beams as described in detail elsewhere in this document. The focus of the viewer is directed at the plane of the display as in a conventional display panel.

Specifically, the wavefront radius of curvature is set to the same value for all pixels in order to match the image plane closely to the physical plane of the display panel. In this form of display panel, amplitude and phase modulation of the input beams is used to set the product beam's amplitude and wavefront radius of curvature to the same value for all pixels and the product beam's wavevector to different values on a pixel-by-pixel basis. The NLO material is deployed such that the two input beams or any given pair jointly provide directional illumination on a pixel-by-pixel basis through wavevector control. The directional illumination generated in the NLO material is then amplitude modulated and optionally also colour filtered with a transmissive spatial light modulator such as a conventional pixelated LCD display layer arranged in front of the NLO material layer. This may be considered to be a kind of modified conventional display panel as familiar from television displays in which the conventional backlight is replaced with a directional backlight formed by the NLO material layer which is drivable through adjustment of the input beam pairs to provide pixel-by-pixel directional control of the light generated in the backlight. This compares to a conventional LCD display panel, in which the visible light that is modulated by the liquid crystal is generally produced from a phosphor which has been excited with UV LEDs, this light generation part of the panel being referred to as the backlight.

The NCTE display panel adopting this hybrid NLO/SLM design may subsume full amplitude modulation to the SLM in which the NLO is driven so as to vary only wavevector and wavefront radius of curvature of the product beam on a frame-by-frame basis. Alternatively, amplitude modulation may be performed jointly by the NLO and SLM, in which case the NLO is driven to vary each of amplitude, wavevector and wavefront radius of curvature of the product beam on a frame-by-frame basis.

The NCTE display panel adopting this hybrid NLO/SLM design can be driven such that same scene may be served to both eyes of a viewer. Alternatively, different scenes may be served to the left eye and right eye of a viewer to create the illusion of 3D view, rather akin to a lenticular 3D display using the nonlinear material to create directed illumination. This hybrid NLO/SLM display panel is also capable of directing different scenes to different viewers by time slicing through an increased refresh rate of the SLM compared with a conventional display. A variant of this approach would be to subdivide the amplitude modulation between the NLO material and the SLM, e.g., so that an LCD modulator is responsible for amplitude modulation of active scene elements, e.g., participants in a video conference, and the NLO material is responsible for amplitude modulation of scene elements representing background, e.g., conference room features in a video conference.

### NCTE Embodiments

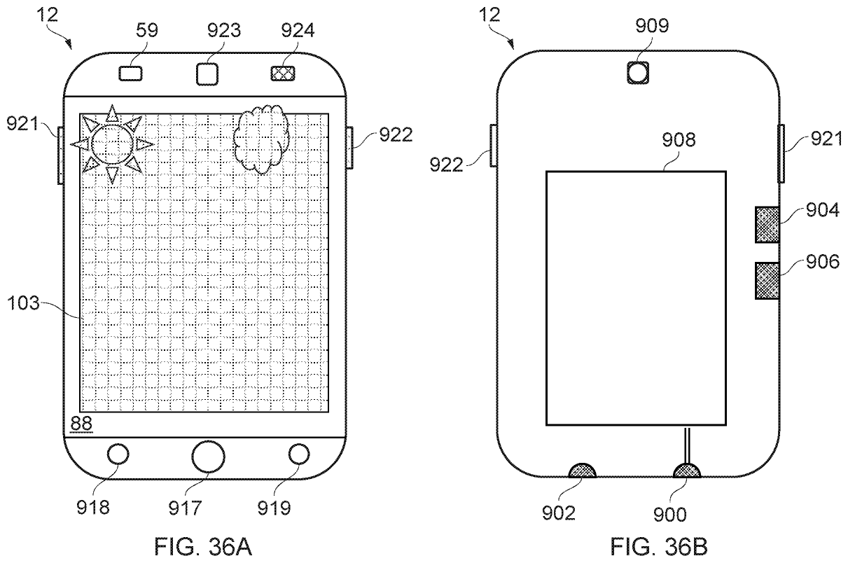

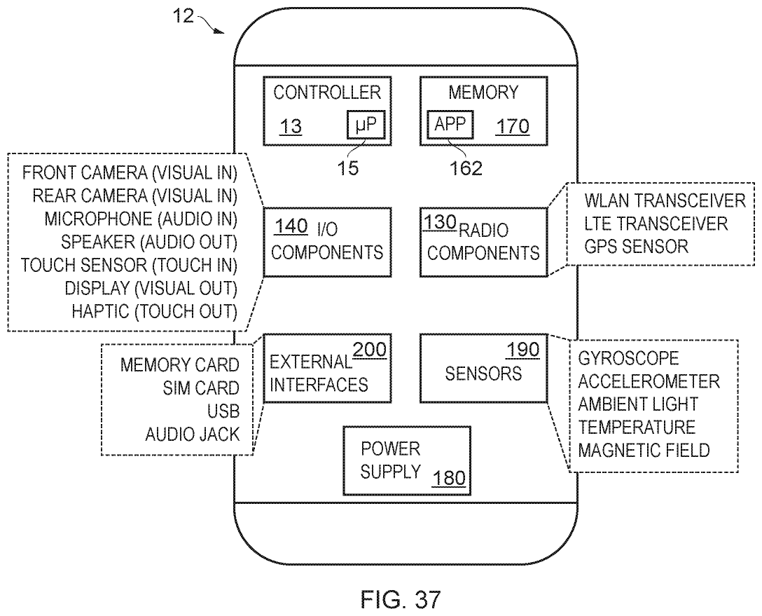

FIG. 36A and FIG. 36B are schematic perspective views from the front and behind of a hand-held display apparatus 12, such as a smartphone or tablet, incorporating a display panel 88.

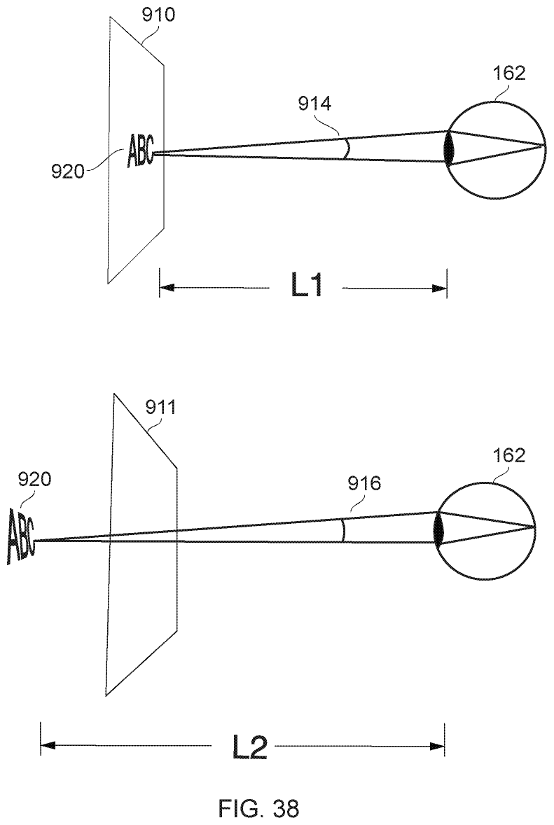

FIG. 37 is a block diagram of the functional components of the computing device of FIG. 36A and FIG. 36B.

Referring to FIG. 36A, the display apparatus 12 is shown incorporated in a hand-held device, such as a smartphone or tablet. More generally, a NCTE display apparatus according to the invention may be incorporated in any of the following devices. A mobile phone (smartphone), phablet, tablet including specialist drawing tablet, laptop computer, personal computer, smart television, media player, satellite navigation device, automotive display console, games console, kiosk computer, or point-of-sale device. Further, the device may be a user equipment as defined by one or more telecommunications standards. Still further, the device may be portable, e.g. a handheld display apparatus, or fixed. The display apparatus according to the invention may also form part of a household appliance or other appliance.

The illustrated hand-held display apparatus 12 is arranged in a housing with a front face (facing outwards from FIG. 36A), a rear face and a bezel forming the edges of a substantially rectilinear object. The front face is mostly taken up with a touch screen display which combines a display panel 88 (shown displaying a scene with house, smoke and sun) with a touch sensitive area 912 (shown with the hatching). The front face also accommodates a mechanical key (or button) 917 and two touch sensor keys (or buttons) 918, 919, one either side of the mechanical key 917. The edges of the housing accommodate a mechanical rocker switch 921 for volume control and an on/off switch 922.

An inwardly facing camera 923 for capturing stills or video images is arranged on the front face near the top of the housing facing forwards and has adjacent to it a range finder 59 for measuring the distance to the face or eyes of someone holding the device and gazing at the display panel 88. A microphone 924 is arranged on the front face. A speaker (not shown) is arranged on the edge of the housing.

Referring to FIG. 36B, the rear view, an outwardly facing camera 909 for capturing stills or video images is arranged near the top of the housing facing backwards. A battery 908 is accommodated within the housing and constitutes a power supply (shown with dashed lines). The power supply further includes an external power supply input socket 900 which may be used for powering the device as well as charging the battery. Alongside the power input socket 900 at the bottom of the device there is another external connector in the form of an audio jack 902 for audio output. Further external interfaces may be provided including various ports, holders and sockets for physical connections. With dotted lines we show two internal holders 904, 906 which may be for a SIM card and a memory card or further SIM card. The memory card is a kind of data storage device.

Referring to FIG. 37, this shows selected functional components of the display apparatus 12 of FIGS. 36A and 36B. The display apparatus 12 has radio components 43, input/output (I/O) components 61, one or more controllers 13 associated with one or more processors 15 and one or more memories 48, a power supply 41, sensor components 39 and external interfaces 45. The memory 48 is operable to store computer applications (‘apps’) 47 which comprise software code portions that are loadable into and executable by the processor 15. The controller(s) 13 may include a touch sensor controller and a display controller, or a combined touch and display controller.

The processor(s) may comprise separate processing units for specialist tasks such as touch sensing, display drive, video processing, speech/audio analysis and/or speech/audio synthesis. The controller(s) and associated processor(s) and memory(ies) have the task of controlling the display apparatus and executing computer programs stored in the memory(ies). The memory(ies) may store computer applications for running on the display apparatus as well as collecting data from the various I/O devices. The controller(s) typically functions to control overall operation of the display apparatus, in addition to the operations associated with the application programs. The controller(s) processes signals, data, information and the like input or output through the above-mentioned components and/or runs application programs saved in the memory, thereby processing or providing a user with appropriate information and/or functions.

The radio components 43 include a WLAN transceiver, an LTE transceiver, and a GPS module. The I/O components 61 include a display capable of displaying content and also acting as part of a graphical user interface, wherein the display may be based on a suitable technology such as liquid crystal or organic light emitting diodes, as well as a position-sensitive touch sensor area overlaid on, or formed as an integral part of, the display to serve as part of a graphical user interface in conjunction with the display with optionally other touch sensor areas or buttons (e.g. on the reverse side or edge (bezel) of the device housing. Further I/O components, as previously mentioned, are front and rear facing cameras for capturing stills or video images, a microphone for capturing audio, a speaker for outputting audio and a haptic output embedded in the touch screen to provide tactile feedback. The sensing components include a gyroscope, an accelerometer, an ambient light sensor and a temperature sensor, for example. The external interfaces may include various ports and sockets for physical connections, such as a SIM card, wired LAN connectors, memory cards, audio jack socket, USB ports and so forth.

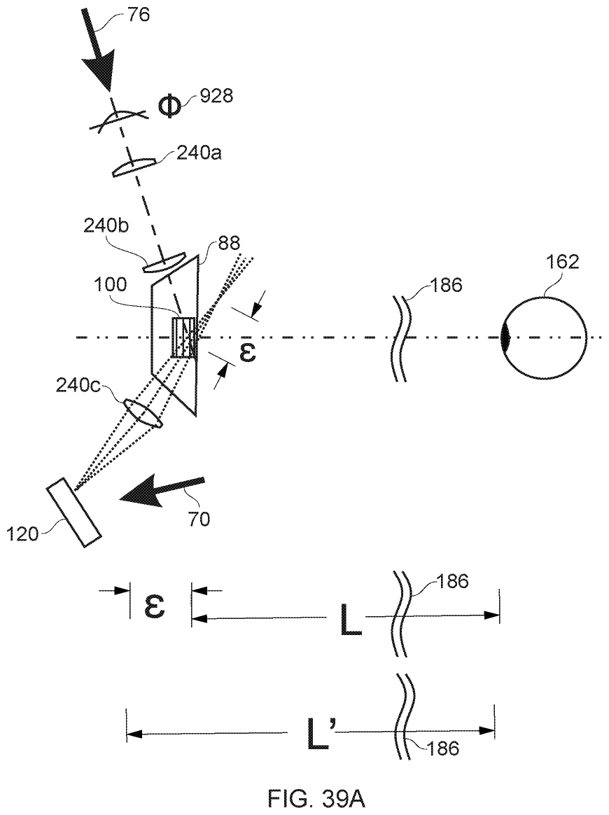

FIG. 38 shows the differing principles of operation of a conventional NCTE display panel 910 (upper drawing) and an example NCTE display panel 911 embodying the invention (lower drawing). In the conventional NCTE display 910, the radius of curvature 914 of the emitted light representing an object 920 (shown as text ABC) comes from the pixels and enters the eye 162, so the eye focus 162 must match the position of the emitting pixel, i.e. the plane of the display panel. This corresponds to a physical distance marked as L1 and the object is a real object. In the example NCTE display 911 according to the invention, the display emits a wavefront of light with a radius of curvature 916 to show the object 920 at an apparent distance L2 (926) that is different from the physical distance L1. The viewer then perceives the object to be at the apparent depth L2, i.e., the viewer's eye will focus at the apparent distance L2, and the object is a virtual object. (In the illustration, L2>L1 but it is also possible for L2<L1.) Although the viewer sees a 1:1 mapping of points between the virtual object and their retina, the display 911 emits the wavefront that represents any given point in the virtual object over a spatially extended region of the display. In other words, multiple pixels in the display 911 are involved in forming the wavefront representing any given point of the image as formed on the retina. This differs from the conventional display where each pixel, i.e., each point in the real object, emits light which is imaged to the retina as a single point of a real image. It is noted that the angles 914, 916 and also the pupil are shown enlarged for greater conceptual clarity and the object closer than is realistic. In the ‘real world’, the angles 914, 816 are limited by the small pupil diameter of the human eye.

### Input Beam Delivery

We now discuss in more detail input beam delivery considerations.

The basic idea of our approach is to have two beams intersect in a non-collinear configuration in a nonlinear material, and to control amplitude and phase to create a desired output that forms the image. Various combinations for amplitude and phase modulation are shown further above in Table A and Table B respectively. An important factor for image formation is whether the display panel is positioned NTE (inside the near point of the human eye—as would occur with AR spectacles) or NCTE (beyond the near point of the human eye—as for a personal computer display or television. It is important to consider how best to deliver the input beams to the NLO material with appropriately controlled amplitude and phase for image formation.

For NTE display panels, our preferred approach is to use an optical design that places the NLO material at a Fourier Plane. An example is shown in FIG. 15 where the emitter array lies in the focal plane of lens 242. Another example is the 4f imaging system described further above with the display panel located at the Fourier plane. The optical field in the Fourier plane is essentially mapping spatial frequencies of the object (e.g. the light scattered from the DLP or other spatial light modulator) into spatial positions. This light of the first input beam is used to create the visible light in the display panel by sum-frequency mixing of the first input beam with the second input beam in a non-collinear geometry.

With the NLO material located at this Fourier plane and the amplitude modulation being impressed on the first input beam, if the second input beam is a plane wave, then the image is created at infinity.

As we have discussed elsewhere in this document, the wavefront curvature of the second input beam can be used to alter the wavefront curvature of the eye's visible image, and this creates the effect of focal depth. If one thinks mathematically about the creation of a nearer-than-infinity image, it is equivalent to the formation of a Fresnel transform (akin to a near-field diffraction pattern), and our approach of mixing allows us to create this Fresnel transform automatically using the laws of images and optics. The ability of our system to perform Fresnel transforms through the optical design is important, since Fresnel transforms are computationally intensive to perform numerically. In particular, Fast Fourier transform algorithms cannot be used to perform Fresnel transforms. The computational intensity of performing Fresnel transforms numerically is what makes it difficult to realise real-time holographic imaging using phase modulators and visible light (see Shi, L., Li, B., Kim, C. et al. Towards real-time photorealistic 3D holography with deep neural networks. Nature 591, 234-239 (2021). https://doi.org/10.1038/s41586-020-03152-0).

A particularly practical implementation of the invention from a cost and miniaturisation perspective that uses solely commercially available optical components is as follows. A first one of an input beam pair is amplitude modulated with a suitable spatial light modulator which may be a DLP (operating in reflection) or an LCOS (operating in reflection or transmission). The second one of the input beam pair provides whole-beam phase modulation with a variable focal length lens (often referred to as a varifocal lens). Varifocal lenses are, for example, available from Corning, Inc. under the registered trade mark ‘Varioptic’ and are based on modifying the interface between two liquids with an electric field with a response time of around 10 milliseconds which for real-time imaging corresponds to 100 frames per second (fps). A response time of 33 milliseconds corresponds to a frame rate of 30 fps, which is the slowest usual frame rate for video. The response time for the variable focal length lens is therefore preferably less than or equal to one of: 40, 35, 30, 25, 20, 15 and 10 milliseconds. The variable focus lens is used to set or vary the wavefront radius of curvature of the second input beam. For the avoidance of doubt, this is relevant for both NTE and NCTE display panels. Alternatively, if the amount of phase modulation needs to be controllable across the second input beam, then an LCOS operating in reflection or transmission can be placed in the path of the second input beam, which may be instead of or in addition to a variable focal length lens. We now discuss how input beam delivery can be suitably configured to control apparent size of the synthetic scene.

When the human eye looks at a scene, what is perceived as the size of an object, referred to as its apparent size, is essentially defined by the angular subtense of light from that object. In a NTE display, such as AR spectacles or contact lenses, the actual area on the display that light representing a certain scene element is emitted from has little bearing on the apparent size. Rather, apparent size follows from the range of angles of light emitted from the display that represent that scene element.

In a display apparatus according to the invention in the case where one of the input beams of each pair carries all the phase information as a plane wave, the apparent size of an object will be determined by the range of angles of the input beams of each pair that are coupled into the NLO material (e.g. see FIG. 10).

Consider a simple configuration with the first input beam performing the amplitude modulation, the amplitude modulator or emitter array is located one focal length (1f) from a single focusing lens, which is itself located one focal length (1f) from the NLO material. An example of this setup is shown in FIG. 15. Here the range of angles that can be created is set by the size of the amplitude modulator and the focal length of the lens. Having a short focal length lens increases the range of angles involved, and therefore increases the apparent size of the object, i.e., the synthetic scene. Setting the focal length with which the amplitude-modulated input beam is focused on the NLO material is therefore an important design decision. Since the focal length of the eye is around 16 mm, this sets the overall size of the image that will be formed on the retina.

The apparent size of the synthetic scene will depend on the range of angles with which the light from the amplitude modulator converges on the NLO material. Since the NLO material is located at a Fourier plane, the size of the input beam intersection region 110 in the NLO material sets the resolution of the display. The requirement for reasonably efficient sum frequency or second harmonic generation also sets a limit to the range of angles. However, using a thinner QPM structure can reduce this limitation.

The apparent size of the synthetic scene as a whole, or synthetic scene elements within it, will therefore depend on the optical design choices and in particular on the specification of the lens or lens combination which relays the input light beam from the spatial light modulator used for amplitude modulation onto the NLO material.

The pixel size, p, of the spatial light modulator used for amplitude modulation will impose a minimum size on the relay lens. For example, for a DLP or LCOS, a typical pixel size may be 5×5 micrometres. The diffraction angle (sin theta) will be around N/d (1.064 micrometre/5 micrometre) which corresponds to approximately 12 degrees at a wavelength of 1064 nm, so if a focal length of 16 mm is chosen and a simple 1f:1f configuration is used, then the relay lens will need a minimum diameter of around 6 mm. The size requirements on the imaging lens are thus quite modest and relatively small lenses can be used in most cases.

The phase modulation is used to define a small solid angle over which the product beam light is emitted. This directionality towards the viewer also provides an inherently very bright display. The high brightness combined with the high directionality means that the optical components used for manipulation the input beams, i.e., lenses, mirrors, filters and the like, can all be small. This is a significant advantage for miniaturisation compared with known display apparatus using DLPs or LCOS devices to amplitude modulate light from a white-light phosphor LED or OLED array, where large optical components must be used to maintain brightness.

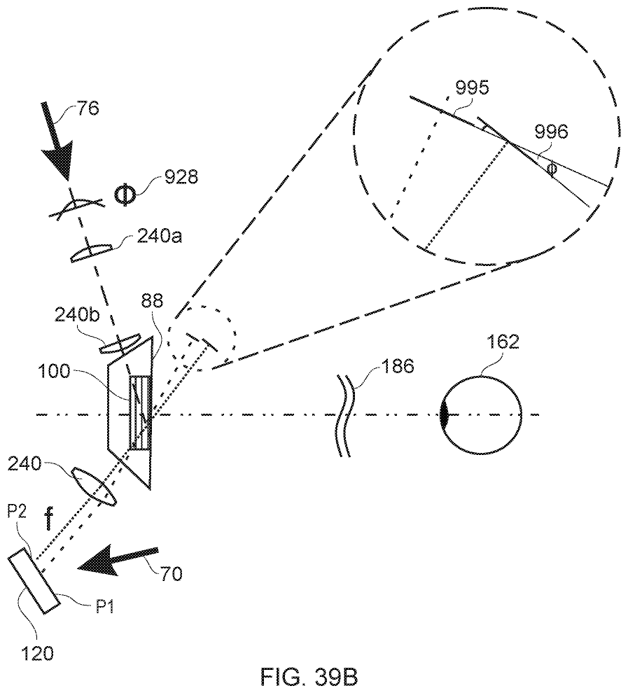

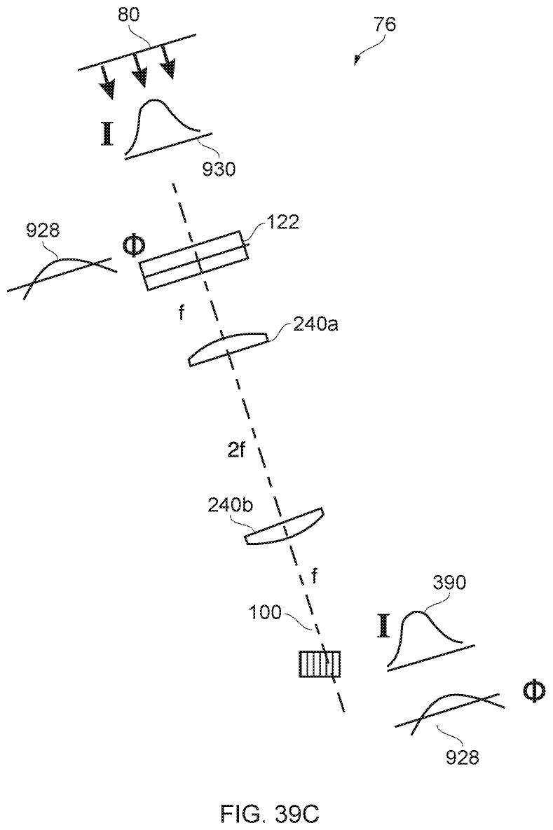

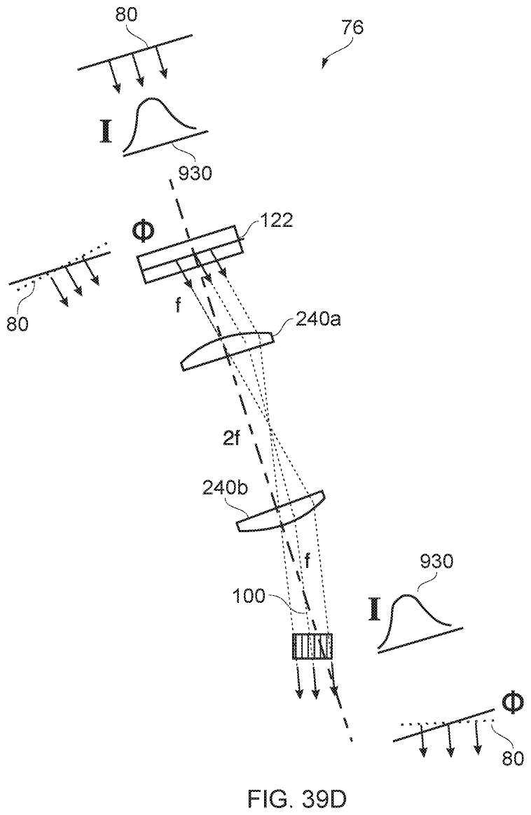

FIG. 39A shows an example optical design according to the above with the first input beam 70 being impressed with amplitude modulation with a DLP 120 operating in reflection and the second input beam 76 providing whole-beam phase modulation with a variable focal length lens 928. The first and second input beams are directed to cross in an intersection region within a phase-matched grating of the NLO material layer 100, which in turn is a part of the display panel 88. For the second input beam 76, a 4f imaging system is used with a suitable lens pair with the same focal length, f. The lens pair is a collector lens 240a on the object side and a detector lens 240b on the image side. In a 4f imaging system, the distances between object, collector lens, detector lens, and image are in the ratio f:2f:f. A discontinuity of scale 186 is shown to convey the fact that there will be a greater distance to the eyeball of the viewer 162. A pair of input light beams 70, 76 is combined by sum frequency mixing (or SHG if both input beams 70, 76 are at the same wavelength) in the NLO material 100.

Input beam 70 is spatially modulated with the desired image as a pixel pattern using a spatial modulator 120 of the type that operates in reflection, such as a DLP or LCOS device, as schematically illustrated. The light reflected from the spatial modulator 120 (or passing through it in cases where the spatial modulator is of the type that operates in transmission, such as a spatial light modulator, SLM) is collected by a lens 240c and an image of the pixels is formed (as shown in the figure). The object plane is chosen to be formed not in the NLO material region 100 but rather at an additional distance away having an offset value ε as shown also by the scale bars at the bottom of the drawing. The apparent depth to the eye L′ is equal to the sum or difference between the physical distance between the eye and the display, L, and the additional offset distance, ε, i.e., L′=L±ε, where the illustration is with this being the sum but in other configurations the difference could be used. When L′=L±ε as illustrated, the spatial modulator 120 is imaged beyond the front of the physical display, so the viewer needs to gaze ‘deeper’ than the physical display 88. Alternatively, when L′=L−ε, the spatial modulator 120 is imaged before the physical display, so the viewer needs to focus ‘in front’ of the physical display 88. In either case, the viewer needs to focus their eye at the L′ distance to see a sharp image of the desired scene as set by the pixels on the spatial modulator 120. The spatial modulator 120 is driven with an appropriate video feed, such as a video feed according to the HDMI protocol. The DLP or other spatial modulator can simply be driven as conventionally with standard pixel encoding. No additional calculations are required to supply the image information to the display compared with a conventional display. This allows the display to be operated with standard computing hardware and avoids the need to calculate complex transfer functions such as Fresnel transforms which are computationally involved.

Input beam 76 is shown as having a controllable phase front 928. This phase front can be created by using various different elements as discussed elsewhere in this document. One convenient approach is to use a dynamically variable focal length lens. Variable focal length lenses are, for example, available from Corning, Inc. under the registered trade mark ‘Varioptic’ and are based on modifying the interface between two liquids with an electric field with a response time of around 10 milliseconds which for real-time imaging corresponds to 100 frames per second. In this diagram two lens are shown 240a and 240b which can be chosen so as to image the phase element 928 into the nonlinear material 100. In this way the intensity of the beam is unaffected as the phase is altered. Although the phase is illustrated schematically as a curved spatial feature, it could be a plane wavefront. A plane wavefront results in an image being formed with output curvature dependent on the imaging parameters of the beam 70 (as described elsewhere in this document). However, by controlling the phase element 928 further refinement and optical adjustment can be made.

In the diagram, the elements that transfer the radius of curvature of the input beam 76 are included (specifically 928, 240a and 240b). This option provides another way of modifying the radius of curvature of the output wavefronts of the visible product beams that form the image. In particular, manipulating the input beam 76 may be an attractive option for adding (or removing) additional wavefront curvature to allow for sight correction of the viewer, such as correction of astigmatism and other refractive errors of the viewer's sight. Therefore, input beam 76 is used for vision correction while input beam 70 is used to carry the wavefront curvature data needed for digital image information. The input beam 76 can be manipulated to match an individual optical prescription of the viewer (for each of the left eye and right eye) to make a personalized wavefront to correct for vision defects. The individual optical prescription could for example be looked up after the viewer is recognized with facial recognition. The system may also be able to create its own optical prescription of each individual viewer based on guiding the viewer through an eye test process. Finally, it is noted that the imaging condition has aspects of tilt, which can be compensated for using the Schleimpflug approach.

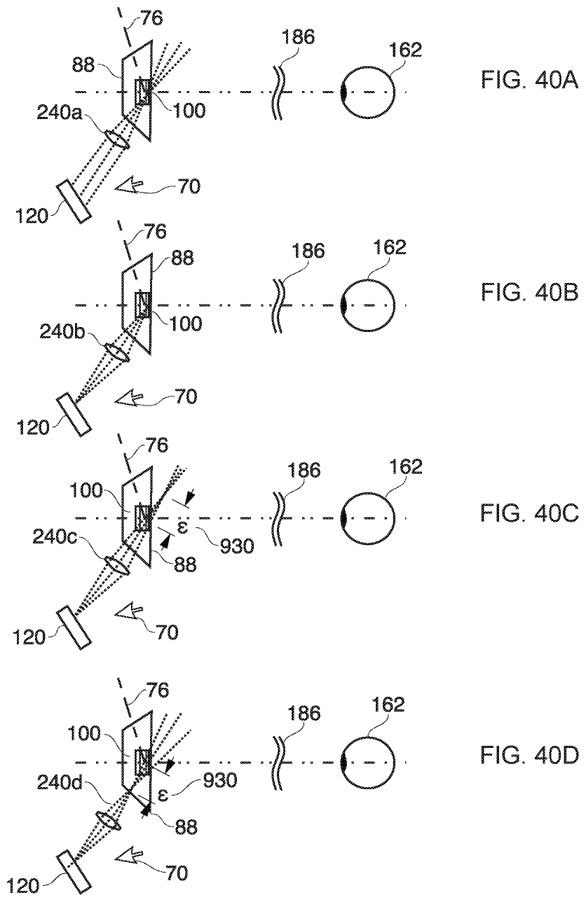

FIG. 39B shows how the magnification of the system, i.e., the apparent size of synthetic scene objects, can be controlled. The optical set-up is the same as shown in FIG. 39A and the apparent depth is set to coincide with the NLO material layer as shown in FIG. 40A. In other words, the Fourier plane is located to lie in the NLO material layer. The relay lens 240 is in a 1f:1f arrangement with the DLP 120 and the NLO material layer 100. (It is noted that the choice of focal length for the first input beam is made independently from that of the second input beam.) Ray traces from each of two arbitrary points on the amplitude modulator are shown, i.e. two example pixels on the DLP chip. These are labelled P1 and P2. Light of the first input beam 70 as reflected from each of the different DLP pixels is collected by the relay lens 240 and sent into the NLO material 100, where light from each DLP pixel will mix with light from the second input beam 76 to create a sum frequency visible light beam, the product beam, that goes to the eye 162 to form the synthetic scene image. The diagram is not to scale and, moreover, a discontinuity in the distance scale is labelled 186.

An inset shows the wavefronts of the input beam light from the two example pixels P1 and P2. It is apparent how the light from the different pixels P1 and P2 will travel through the NLO material in different directions. The light rays of the first input beam are reflected at all pixels of the DLP so as to emerge from the DLP parallel to each other. This is because the first input beam as incident on the DLP is essentially a plane wave and the DLP pixels all orient at the same angle. However, since the rays from the different pixels are incident on the relay lens at different radial distances from its optical axis, they are focused onto the NLO material layer at a range of angles, i.e., with a range of incoming directions, with the angle mapping to positions in the Fourier plane. This means that light of the first input beam from all the DLP pixels travels to the same point in the NLO material. However, as will be seen in the diagram, the corresponding wavefronts (which are labelled in the enlarged section as 995 and 996 have different directions. Specifically, there is a difference in the crossing angles φ which depends upon the focal length of the relay lens 240.

If the separation between pixels P1 and P2 is t, then the equation for the angle φ becomes f·φ=t, so φ=t/f. Assuming the eye is focused at infinity, the viewer will then see the light from the two pixels as having an angular separation of t/f.

It will be clear that choosing a small value for the focal length of the relay lens 240 leads to a larger angular separation φ between any two points on the spatial light modulator, leading to the apparent size of the object becoming larger. Choosing a larger size DLP chip has the same effect. However, for miniaturisation, it will usually be more preferable to choose a smaller DLP chip and set the apparent size of the synthetic scene by an appropriate specification of the relay lens.

The same considerations as discussed above by way of example with reference to a DLP also applies to other types of spatial light modulator. Furthermore, in practice, the single relay lens 240 may well be exchanged for a suitable lens combination, as for example may be desirable for cancelling out chromatic aberrations.

FIG. 39C shows, in more detail than in FIG. 39A and FIG. 39B, a 4f imaging system to transfer a desired phase pattern into the NLO material. This scheme is attractive for transferring the desired radius of curvature phase structure into the NLO material. In the figure an input laser beam 76 with wavefront 80 which has a given intensity profile 930 is imaged into the NLO material 100 to yield an identically sized intensity profile 930. It is noted that the profile is inverted (but as this is illustrated by way of example as a Gaussian profile it appears the same before and after the imaging system). By placing the phase modulating element 122 (which may be a phase modulator acting in transmission or reflection, or a varifocal lens) at a conjugate image point in the 4f imaging system from the NLO material, the image of the light at the varifocal lens will be imaged across regardless of the phase added by the lens. Strictly, of course, this is only approximately true for finite thickness lenses, and only true for small angles, but in our approach the numerical aperture (NA) can be limited to small angles, and thus thin lenses can be used. The phase (in this case a radially varying phase is indicated as 928) is imparted on the beam 76 (which is initially shown to have an approximately plane wave wavefront 80). The phase is imaged across to the NLO material 100 and will retain the curvature. Thus, the use of the 4f imaging system allows us to transfer the intensity unaltered as the phase is altered, allowing us to achieve our desired optical function of altering the radius of curvature of the generated wave in the NLO material (as extensively discussed elsewhere in this document).

FIG. 39D illustrates the same 4f imaging system as FIG. 39C but with a linear phase and showing ray tracing to show how a linear phase 80 is transferred through the imaging system. The ray directions are also indicated on the inset phase representations. FIG. 39D shows how rays of light associated with the linear phase are refracted by the two paired lenses 240a, 240b in the f:2f:f design. The output is still a linear phase but now reversed across the optical axis. Again, placing the phase modulator (in this case a transmissive phase modulator) as the object in the imaging system preserves the intensity profile 930 of the beam.

It is noted that the sizes of the spot formed in the NLO material (which determines the size of the intersection region together with its paired input beam) can be altered by altering the imaging lens focal lengths while maintaining the imaging formation condition. However, it is advantageous to use a two-lens imaging system as in the 4f design, since that maintains plane waves at the output, whereas a single lens in a 2f:2f design would not have this desirable property.

While simple singlet lenses are illustrated, it will be understood that more complex lenses can be used to correct for aberrations, particularly chromatic aberrations amongst others. Moreover, the same optical design approach can also be implemented with focusing mirrors instead of lenses. Still further, the phase modulator need not be transmissive as illustrated but may instead be reflective (e.g. LCOS).

FIG. 40A, FIG. 40B, FIG. 40C and FIG. 40D are schematic drawings of different object placements for the synthetic scene to vary the apparent depth in relation to the physical position of the display panel. It is noted that the set-up of FIG. 39 can be used to switch between these different object placements through adjustment of the variable focal length lens.

FIG. 40A shows a virtual object formed at infinity, as may be applicable for a dashboard-mounted automotive NCTE display example or synthetic rear-view or side-view mirror example discussed further above. Input light beam 70 carries the digital image information and input beam 76 is a plane wave. The two input beams 70, 76 mix in the NLO material of the display to create product beams that collectively form a virtual object at infinity. The dotted lines of input beam 70 indicate that light specularly reflected from the spatial light modulator are focused into the plane of the display, i.e., the plane of the NLO material layer. The lens 240a is chosen so that it is placed one focal length from the NLO material 100 so that the NLO material 100 is placed at a Fourier plane of the lens (e.g., 1f:1f set up), which in turn maps input angles to positions in the light from beam 70. When mixed with input beam 76 (assuming input beam 76 is plane wave) product beams will generate an image that the eye perceives to be localised at infinity, so the viewer will need to focus at infinity.

FIG. 40B shows an object formed in the plane of the display panel, as may be suitable for a video conferencing or television display example where it is acceptable for the eye focus distance and the physical distance from the viewer to the display to be the same. As discussed above, one condition for this to be acceptable is that the display will be positioned at a greater distance than the viewer's (or any potential viewer's) near point, e.g. greater than 1.5 metres. This is referred to as localised display. With localised display, the intensity modulator is focused into the NLO material, so as to create the impression for the viewer that the image is being generated in the plane of the display panel, as in a conventional display panel. The emission pattern created by the product beams collectively is controllable by the second input beam 76 (to set additional radius of curvature values; setting the output direction of the product beams) and setting the effective brightness (numerical aperture) of the product beams. The pixels from the spatial modulator 120 are imaged directly into the NLO material 100 by lens 240c. The optical system is shown to be 2f:2f in terms of distances, which corresponds to the classical imaging condition (1/f=1/u+1/v) where u and v are the object and image distance respectively, and f is the focal length of a simple lens. Specifically, distance u is the distance from the spatial modulator 120 to the lens 240c and distance v is the distance from the lens 240c to the NLO material. The dotted lines shown emerging from a single pixel of the spatial light modulator are to show imaging to points in the plane of the NLO material. When the input beam 70 is mixed with light from input beam 76 in the NLO material 100 to create the product beams this will generate pixels localised in the NLO material 100. Thus, the viewer will need to focus on the display itself to see a sharp image.

FIG. 40C and FIG. 40D shows a virtual object formed at a finite offset distance ε from the plane of the display panel. We refer to the set-up option of FIG. 40C with a positive value of the offset ε as a virtual depth display and of FIG. 40D with a negative value of the offset ε as a closer display. The positive offset set-up option is applicable to NCTE display panels for devices for older people suffering from age-related loss of accommodation (using a positive value of offset ε) and the negative offset set-up option is applicable to people suffering from extreme short-sightedness (using a negative value of offset ε). The virtual depth display approach places the image plane at some intermediate plane which corresponds to ‘virtual’ pixels that appear to emerge from this virtual image plane. If mixed with a plane wave input beam 76, the output waveform formed by the product beams will appear to have a different radius of curvature than the real physical pixels of the spatial modulator. When the input beam 70 is mixed with the light of input beam 76 in the NLO material 100, the viewer must now look beyond (or in front of) the display element to see a sharp image. The image equation now makes the image distance, v, the sum of the physical distance from lens 240c (or 240d) to the NLO material 100 plus (or minus) the desired magnitude of the offset.

To simplify the above-described representations, details of the delivery optics for input beam 76 are not shown. However, it is noted the set-up shown in FIG. 39A can be used for any of the options shown in FIG. 40A, FIG. 40B, FIG. 40C and FIG. 40D.

Importantly, the differences between the different options shown in each of FIG. 40A, FIG. 40B, FIG. 40C and FIG. 40D for selecting the apparent depth in these examples follow solely from optics of the input beam 70.

It is further noted that optical elements in the path of the input beam 70 may also provide dynamically variable focusing (e.g., using a vario-optic lens for lenses 240a, 240b, 240c, 240d or by adding a phase modulator). By providing dynamically variable focusing elements in the path of the input beam 70, dynamic adjustment of the apparent offset depth is possible, e.g., to move dynamically between the different options described above. For example, the display may be operated by default in localised display and then only adjusted to virtual depth display with positive offset when it is detected that the viewer suffers from age-related accommodation loss with a near-point greater than the display-to-eye distance.

The adjustment is then preferably only by the minimum amount needed based on the optical prescription of the viewer, i.e. so that L+ε is equal to the viewer's near-point. This is desirable since it is easier for a viewer to adjust their vision to smaller offsets than larger ones. These adjustments may of course also be made responsive to changes in the display-to-eye distance as relative movement between the display and the viewer takes place, as may occur with a hand-held device or when a viewer moves their chair when sitting in front of a desk-mounted display of a personal computer or when a viewer moves within a conference room while watching a wall-mounted display panel.

Provision of dynamically variable focusing elements in the path of the input beam 70 also allows 3D effects to be incorporated in the image, for example by varying the wavefront radius of curvature within each image to create the illusion of depth using the techniques described elsewhere in this document for AR displays and other NTE displays.

In addition, the display apparatus may incorporate or be in data communication with cameras, LIDAR and other image information acquisition devices that allow the distance from the viewer's face (or eyes) to the display to be tracked, so that the image presented to the viewer can be dynamically and automatically adjusted for maximum viewing comfort and visual acuity. Furthermore, by tracking the viewer's pupil the system may adjust its operation to maximise the viewing comfort and visual acuity, for example to make personalized adjustments based on the viewer's optical prescription.

While single element lenses are shown it will be understood that more complex lens systems can be deployed to reduce unwanted artifacts from aberrations such as spherical aberration, chromatic aberration, coma, field curvature, distortion, astigmatism. Creating compound lens elements made from materials with different refractive indices and dispersion are all approaches widely used in lens design and can be applied to this situation. Additional features of the lens system can include automatic adjustment of focus according to position within the display, active alignment of components, additional filters and absorbers to reduce stray light, the addition of antireflective coatings on lenses, etc such are already well-known within optical systems such as single-lens reflex cameras, binoculars, telescopes, microscopes and so forth.

Hybrid Display Panel with Spatial Light Modulator

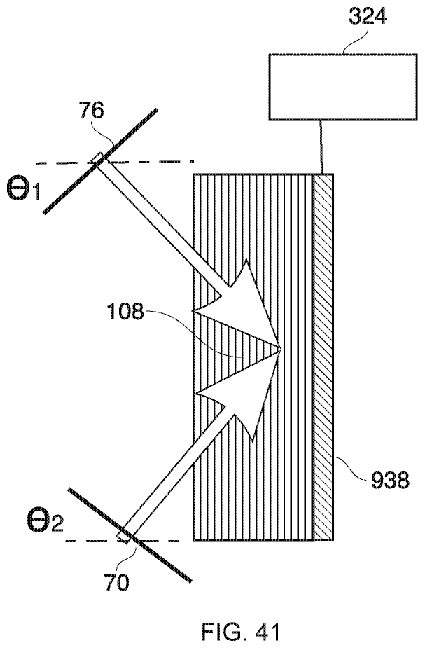

FIG. 41 is a schematic drawing of a display panel according to an embodiment of the invention comprising an NLO material layer with QPM grating 108 for visible light generation (i.e., the product beams generated with defined wavevector to define their direction) and an overlaid transmissive SLM 938 for image formation through amplitude modulation of the visible light generated in the NLO material 100. The SLM 938 is pixelated and electrically addressable, so it can be driven using a conventional drive signal delivered by a suitable controller 324. Since the hybrid NLO/SLM display panel still permits full directional control of the product beams through control of the angles θ1, θ2 of the input beams 76, 70, it is possible to provide 3D effects to a viewer, which may be without stereoscopic imaging by showing perspective or with stereoscopic imaging by serving different images to the left and right eye of the viewer.

The NLO layer thus provides a directional backlight that is modulated by the SLM, which can be a conventional liquid crystal overlay, to create a pixel display but with directionally controlled light emission. In the hybrid NLO/SLM display panel, the visible light is generated by NLO mixing between pairs of non-collinear infrared input beams, which generates the visible light only in defined directions (wavevector control). It is thus possible to generate visible light not only in terms of beams with a desired optical axis but also with control of a beam's numerical aperture and brightness. As described elsewhere in this document, wavevector control allows images to be served directly to specific viewers and separately to the left and right eyes of any given viewer. Among other things this increases the optical efficiency of the display panel by several orders of magnitude compared with conventional display panels that emit light isotropically over essentially the whole half-space in front of the display panel. To serve images directed to a viewer, suitable forward-facing cameras are need to track viewer position. A simpler approach for display panels embodying the invention, which still provides improved optical efficiency compared with a conventional display panel, is to use the wavevector control to emit light only over a controlled solid angle, i.e. with a specific numerical aperture, so that the images are only viewable to viewers located in some range of angles in front of the display panel. For example, for a television at home, viewers will generally always be seated on a sofa or chairs in front of the display within a limited solid angle, so a limited emission angle is acceptable, especially if the emission angle, i.e., the numerical aperture, is adjustable by the user.

The hybrid NLO/SLM display panel provides an extra option for generating colour images. The NLO/SLM display panel can still use the same approach as described elsewhere when there is no SLM overlay, namely providing three pairs of input beams with three different sum frequencies to provide the three primary colours. However, optionally the NLO/SLM display panel can use the SLM also to provide colour filtering as described further above.

It is further noted that some of the amplitude modulation may be performed in the NLO material. For example, for deep black pixels, it may be beneficial to reduce the brightness of the light generated in the NLO material. Similarly, for very bright pixels, the NLO material can generate with increased brightness. Images can thus be generated that have a larger dynamic range than is possible from using the SLM alone for amplitude modulation.

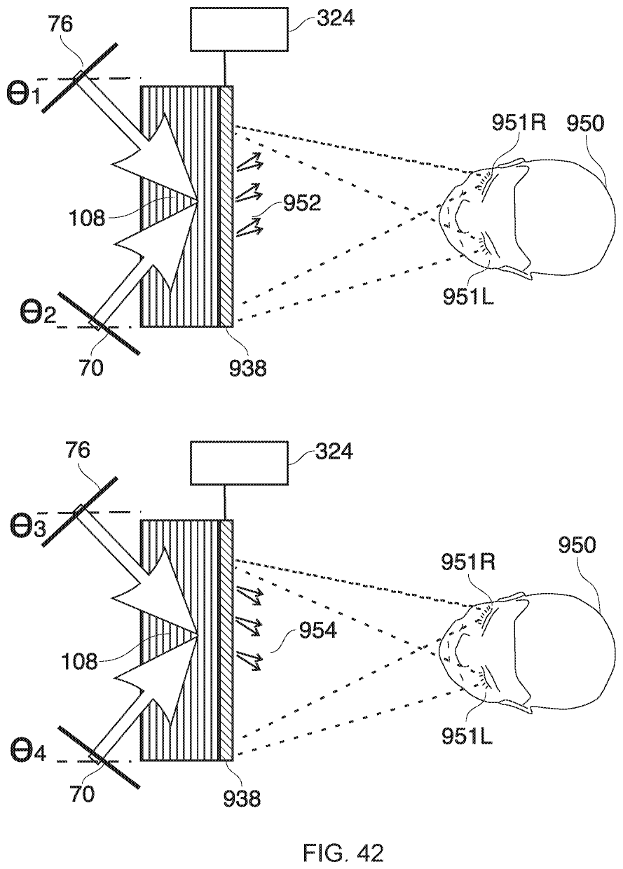

FIG. 42 illustrates use of a hybrid NLO/SLM display panel as shown in FIG. 41 operated to serve different display images to the left and right eye 951L, 951R of a viewer 950 and thereby create a 3D effect. The lower and upper parts of the drawing show product beam light being directed respectively solely to the left eye and the right eye of the viewer as beam 954 to the left eye 951L and beam 952 to the right eye 951R. The product beam directions 952 and 954 are determined by the angles, spatial phase and amplitude of the input beams 70 and 76. The angles (or equivalently phase functions) of the input beams are indicated as θ1, θ2, θ3, θ4. By alternating left and right images in rapid succession (e.g. using at least 60 Hz to provide 30 fps to each eye, preferably at least 100 Hz), the viewer will be able to see a stereoscopic effect. Increasing the display brightness can also be exploited to cause the viewer's irises to contract and thereby increase the depth of field. The locations of the left and eyes can be determined by forward-facing cameras embedded in the display panel bezel, for example. The hybrid NLO/SLM display panel can also be operated to direct the emitted light so that images are only viewable to a targeted viewer to ensure privacy and avoid snooping.

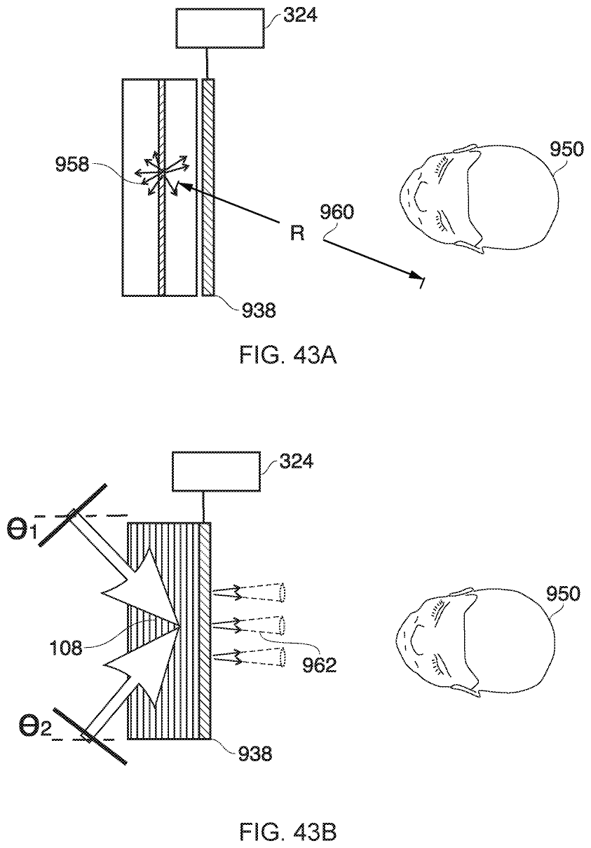

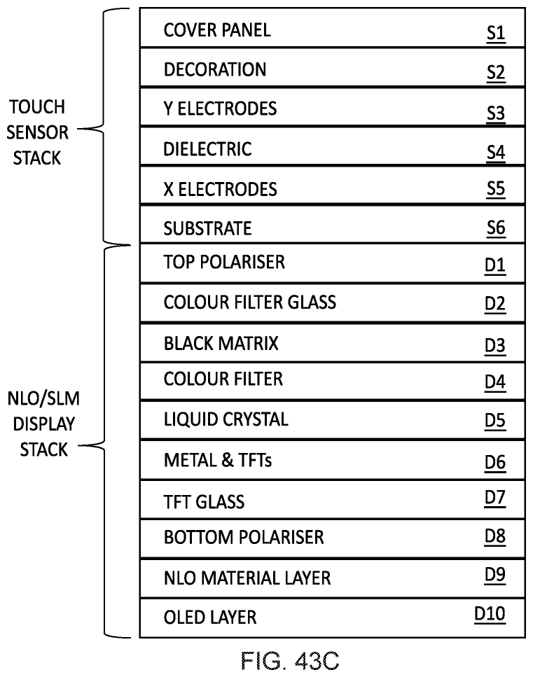

FIGS. 43A and 43B illustrate how the hybrid NLO/SLM display panel as shown in FIG. 41 provides higher brightness compared to a conventional display panel. The lower drawing, FIG. 43B, shows the hybrid NLO/SLM display panel of FIG. 41. The upper drawing, FIG. 43A, shows a conventional LCD display panel comprising an LCD modulator layer 108 and a phosphorescent backlight layer 958. The control unit 324 determines the transmission of pixels in the LCD layer so as to create the desired pixel display pattern. As schematically shown in FIG. 43A, in the conventional LCD display panel, the backlight emitting phosphor 958 emits light in all directions (over 4 Pi steradians) and nearly all of this light is wasted in the sense that only a tiny proportion of the backlight photons ultimately enter the eyes of the viewer. (Some commercial LCD displays have a reflective back layer behind the phosphor layer 958 to recover some of the backlight that is emitted backwards and direct it back to pass through the LCD layer.) The viewer 950 is shown located a distance R (960) away from the display. FIG. 43B shows a display in which the backlight function is replaced by our nonlinear approach 108 with directional input beam pairs 70, 76 which are—jointly or separately—modulated in amplitude and phase. Here the product beams 962 forming the image are highly directional with a small solid angle, so that a much higher proportion of the visible photons generated in the NLO material ultimately enter the eyes of the viewer compared with the conventional case. This is what makes the hybrid NLO/SLM display panel able to provide higher brightness compared to a conventional display. Considering the optical efficiency of a conventional backlit LCD television, take the example of a viewer watching the television screen at a distance of 3 metres. The eye pupil has an area of perhaps 7.1 mm\hat{ }2 (π·r\hat{ }2 where r=1.5 mm) whereas the light from the television screen is essentially emitted isotropically, i.e., over 4π steradians, over a sphere of area 4π·r\hat{ }2. A sphere of three metres radius has a surface area of about 113 square metres. The ratio between these two areas sets the effective photon collection efficiency between photons generated in the backlight phosphor of the LED and the coupling to the human eye. The ratio in this example is 16 million to 1, i.e., only about 1 photon in 16 million arrives at the eye. This ratio explains why conventional television screens based on phosphorescent backlights are inefficient in using optical power. In contrast, in display panels according to the invention, essentially all the product beam photons can be directed towards the viewer over a narrow angle, yielding improvements in photon coupling efficiency of many orders or magnitude compared to the conventional case, which offers the opportunity to improve display brightness, reduce power consumption (increase battery life), and increase display lifetime.

While this difference to a conventional display is illustrated by comparison with a hybrid NLO/SLM display panel according to the invention, the same is true of other NLO display panels according to the invention, i.e., ones that have no overlaid SLM.

FIG. 43C shows an example display stack of a an NLO/SLM display panel using an LCD as the SLM. The display stack comprises an NLO material layer 100 according to the invention. Below the NLO material layer 100 there is an optional OLED layer, similar to what is provided in conventional displays, to provide backlighting of a selected brightness and colour. Above the NLO material layer 100 there are bottom polariser and a glass layer to act as a substrate for the thin film transistors (TFTs). The TFTs together with their addressing and other electrodes, referred to as metal, are arranged in top of the TFT glass. It will be understood that reference to metal includes any suitable metallically conductive material, it often being the case that ITO is used (i.e. a non-metal), since it is transparent and therefore suitable for display applications. The next layer is the liquid crystal layer acting as the spatial light modulator followed by a colour filter layer. It will be appreciated that suitable spacers will be provided to maintain a design thickness for the liquid crystal layer. Next there is a black matrix layer for contrast enhancement, colour filter glass, and finally a top polariser. It will be appreciated that additional layers, such as adhesive, coatings and so forth may also be included as desired. Moreover, some of the recited layers could be omitted, for example the black matrix. A simpler structure would also result if the display was monochrome. A touch sensor layer stack may optionally also be arranged on top of the display stack. The touch sensor layers commence with a substrate, made of a material such as a glass material (e.g. an alkali aluminosilicate glass) or a plastics material (e.g. PET) for example, on which X electrodes are deposited. The X electrodes may be embedded in a dielectric matrix, such as an adhesive layer. On top of the X electrodes there is a dielectric and then Y electrodes. There then follows an optional decoration layer followed by a cover panel. The cover panel may be a glass or a plastics material. Moreover, the cover panel may be coated, e.g. with an anti-scratch material for increased hardness and/or wear resistance. It will be appreciated that one or more adhesive layers (e.g., OCA) may be used to bind layers of the display and touch sensor stack together, but these are not illustrated.

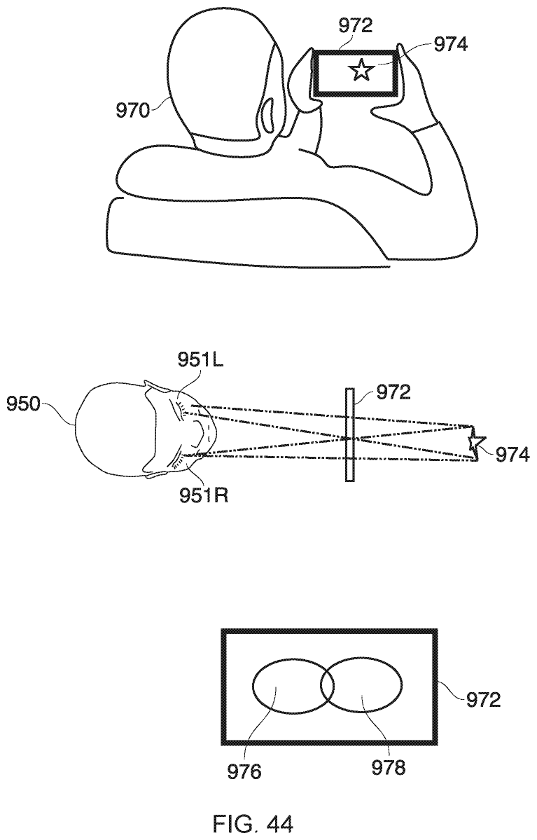

FIG. 44 is three schematic illustrations relating to a person 970 holding and viewing a hand-held device 972 with a display, such as a tablet or smart phone, on which a five-pointed star 974 is being shown. The display is being operated in a virtual depth display mode as shown in FIG. 40C in which the apparent depth of the display (i.e. the virtual object distance) is different to the real eye-to-display distance with a positive value of offset ε. The star 974 is an example of a virtual object. As shown in the diagram, the virtual depth display mode creates a diplopia (or double vision) challenge. In effect the viewer needs to gaze beyond the plane of the display panel in order to see the virtual object in focus.

The viewer 950 has left and right eyes 951L and 951R. The viewer 950 is looking beyond the display at the virtual object 974 (the star). The light paths from the display panel that generate one image for the left eye and another image for the right eye are necessarily different and must emanate from different regions 976 and 978 of the display panel, because of the stereoscopic nature of vision. In other words, display region 976 is responsible for image formation for the left eye, and display region 978 is responsible for image formation for the left eye. Moreover, the two regions 976, 978 may have some overlap as illustrated.

The viewer needs their eye convergence and eye accommodation to be formed on the virtual object 974 at its apparent distance. While FIG. 44 illustrates a positive offset ε, the same discussion applies to operating in a virtual depth display mode with negative offset ε when the apparent depth is brought closer to the eye of the viewer than the physical location of the display panel.

### Adjusting Vision to Apparent Distance

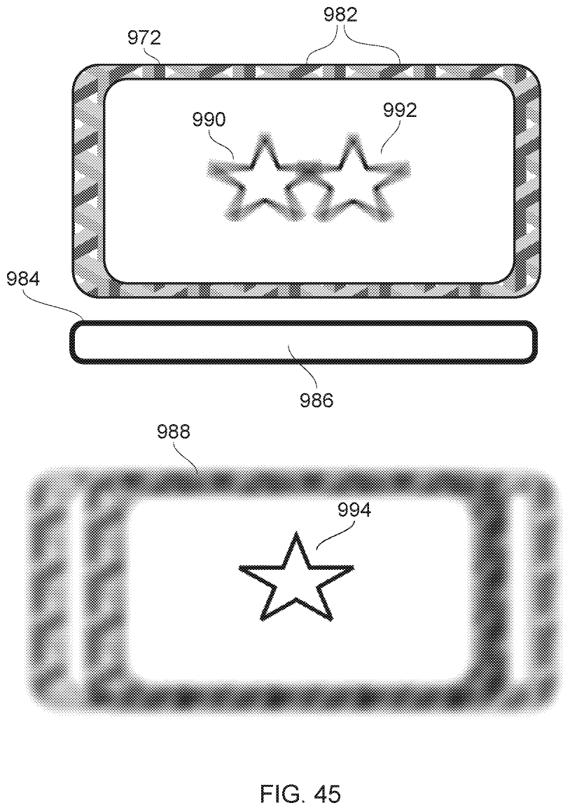

FIG. 45 illustrates further design considerations for operating a display panel according to the invention in a virtual depth display mode by further developing the example of FIG. 44 of a star virtual object with positive offset. The upper illustration shows what the display will look like when the viewer is looking at the display itself, i.e., when their eye focus is set on the display and their stereo eye vergence is overlapped onto the physical display (VIEW CASE 1). The lower illustration shows what the display will look like when the viewer allows their eyes to refocus, and allows their stereo vergence to be appropriate to the apparent distance of the virtual depth object, which is beyond the physical display in this example (VIEW CASE 2). The upper illustration labels the display as 972 (VIEW CASE 1) and the lower illustration labels the display as 988 (VIEW CASE 2). The object is the star pattern which is labelled 990 and 992 in VIEW CASE 1, and is labelled 994 in VIEW CASE 2. In VIEW CASE 1, the physical display as represented by a patterned display bezel is in sharp focus while the virtual object is blurred, with the virtual object represented by the star appearing double and blurred. In VIEW CASE 2, the virtual object represented by the star is in sharp focus while the physical display as represented by the patterned display bezel appears double and blurred.

Measures can be taken to make it easier for the viewer to set their vergence angle and focus to the distance of the virtual object, i.e., at the apparent distance, so they are gazing at the distance of the image to be viewed rather than at the distance of the physical device.

One aid is to make the edges of the physical device chamfered or angled or rounded to avoid sharp lines and specular reflections. The middle side view of FIG. 45 is an illustration of this, where the display 986 has chamfered edges 984. The purpose of rounding the edges is to confuse the visual cues of the edge of the display to allow the viewer to refocus beyond (or in front of) the display panel more easily. In the case that the display panel has a bezel, choosing a bezel design where the edges of the display are matt finish and in darker colours may further help the device to blend into its surroundings. FIG. 45 also illustrates a bezel area 982 that is patterned. The pattern may be printed or otherwise permanently present on a physical bezel or in the case of a bezel-free device the pattern may be a kind of virtual bezel shown around the edges of the display. The bezel pattern is periodic with a period chosen to match a specific value of stereo-vergence correction making it easier for the viewer to refocus and change their eye vergence.

In the case of a virtual patterned bezel created by the display, the pattern period could be set to the apparent distance. Moreover, this could be dynamically varied to track changes in the apparent distance.

The edge of the display can also be made to appear invisible or less visible by matching its colour to the colour of what the viewer sees directly adjacent the display edge, similar to camouflaging by an octopus. This could be done using backward-facing cameras.

Another approach is to exploit the phenomena of double vision (diplopia) by encouraging the viewer to locate their stereo-convergence at the apparent depth of the display, i.e. the virtual object distance, rather than at the actual depth of the physical display panel.

Forward-facing cameras, e.g. bezel mounted cameras, can be used to assess the viewer's vergence angle to determine whether the viewer's binocular vision is matched to the apparent distance of the virtual object (as needed for viewing) or the physical display distance (which will cause blurry double vision).

When a display is switched on for the first time, or when the image being displayed changes from a localized display to a virtual depth display, the forward-facing cameras can track the vergence angle of the viewer and specifically whether the stereo gaze distance changes from the physical display distance to the virtual object distance.

Vergence angle can be determined from changes in pupil separation and compared with the vergence angle associated with the physical display distance, which may be determined by appropriate sensing, e.g. forward-facing cameras or LIDAR mounted on the device. It is therefore possible to sense if the viewer is focusing on the display panel or on the in-focus image plane. Every individual person will have a different functional mapping of pupil separation distance to vergence angle. The functional mapping will, for example, be a function of interpupillary distance which is the distance between left and right pupils when the eyes are focused at infinity. The functional mapping could also be learnt by the display apparatus. Learning could be done by a calibration or test routine in which the viewer changes focus between the display panel and different offset distances from the display panel and provides feedback to the display apparatus. Learning could also be done adaptively by the display apparatus by the inwardly facing cameras observing a viewer's face over time and determining their left and right gaze direction as they comfortably operate the display at different offset distances-positive, zero and possibly also negative.

Through the above measures, the display apparatus will be able to determine when a vergence-accommodation conflict exists and can provide a prompt or active assistance to the viewer to change their vergence to match accommodation (which will automatically take account of a positive or negative offset). One way to assist the viewer to match their vergence to a non-zero offset is to display a pattern (like the illustrated star pattern) and then alter the pattern so as to encourage the viewer's eyes to seek the correct virtual depth (perhaps using eye tracking and feedback during the process). Another way to assist the viewer to match their vergence to a non-zero offset is to use a peripheral region of the display area (like an active bezel) to display a sliding pattern (again perhaps with feedback) to encourage their stereo vergence to move from being localised on the display to the offset distance (positive or negative).

### Video Conferencing

### Video Conferencing Introduction

Video conferencing is an important application for NCTE display apparatus embodying the invention. Video conferencing has become even more commonplace since the Covid Pandemic, with the widespread use of video conferencing software such as Teams, Zoom, etc. In video conferencing, a software application enables people at different physical locations to communicate with each other via suitable computing hardware located at each location. In other words, a communication node is provided at each location. A typical communication node includes: a computer apparatus, a data communication link, a display (video out), a camera (video in), a microphone (audio in) and a loudspeaker (audio out). The camera, microphone and loudspeaker are often ancillary devices to the computer apparatus.

The microphone and loudspeaker are commonly combined in a single headset device to provide both audio in and out. Any of the display, camera, microphone and loudspeaker may be in wireless or wired communication with the computer apparatus. In the case of a receiver-only communication node, the video out and audio out channels may be omitted. The camera and display are for respectively transmitting and receiving a video image feed comprising successive image frames. The microphone and loudspeaker are for respectively transmitting and receiving an audio feed. The video conferencing software application presents a graphical user interface on the display to provide user controls and other features as well as the video feed. Data communication between the communication nodes is used to transfer the video and audio data between the communication nodes as well as other data. Such other data may be a share of the graphical user interface of a third-party computer application being run on the computer apparatus of one of the conference participants (e.g. a window of a presentation program, word processor program, video program etc.). Such other data may be a share of the whole screen of the computer apparatus of one of the conference participants (so-called screen share).

One of the major challenges with video conferencing is to create a more realistic experience. The aim should be to replicate as many of the features of an in-person meeting as possible and hence give a better impression of actually sitting in a meeting room with the other participants.

When only a single participant is present at a communication node, there is no sharing of a display between multiple participants at one location, the subjective experience is reasonable. However, when multiple participants share a display, then the fact that a conventional display lacks any 3D depth perception leads to a larger perceived difference between the quality of experience of an in-person meeting and a video conference. In particular, the perceived quality of experience is poor when a conference involves multiple participants sitting together at a conference table in a conference room at one location and viewing a single large display to communicate with remote participants. This poor experience is worsened further if this situation is replicated at another location, for example when the conference involves two groups of people in two conference rooms at different locations.

It is noted that, in video conferencing, the display will typically be positioned at a greater distance from the eye than the near point. The eye's near point is the closest distance which the eye can bring into focus, i.e., accommodate. The near point is often taken to be nominally 25 cm. However, a human eye's actual near point gradually increases with age from about 7 cm for a youth to over 50 cm for an old person.

For one person who is video conferencing on their personal computer, the eye-to-display distance may be a small multiple of the near point, e.g. 25 to 75 cm, i.e., 1 to 3 times the near point distance. In a conference room for video conferencing which a group of participants using a single shared display, the eye-to-display distance may be much larger, e.g., in the range 2-10 meters for the different individuals sitting at different positions around a conference table. To be viable for such large viewing distances, a video-conferencing display therefore needs to be relatively large. For example, for a maximum viewing distance of 6 metres, a 90 inch (230 cm) display (diagonal) is the approximate minimum requirement.

### Video Conferencing Display Panels

There are several specific ways to incorporate NLO display features according to the invention into a display panel suitable for video conferencing. The display panel will include NLO material arranged to receive pairs of input beams which have appropriate amplitude and phase profiles to create a product beam of the required amplitude, wavevector and wavefront radius of curvature.

### Video Conferencing Systems

A video conferencing system according to different embodiments of the invention have a set of common features. There will be a minimum of two physical locations with a minimum of one participant per location.

At least one display apparatus is provided at each location that comprises a display panel with NLO material according to the invention to display images of participant(s) at remote location(s) on the display panel at the local location.

At least one image capture device is provided at each location. The image capture device will typically be a camera operating in the visible, to capture video image data of the participant(s) at that location for transmission to participant(s) at remote location(s) after suitable image processing (see below). Preferably multiple image capture devices are provided at each location. Multiple image capture devices will assist construction of 3D models of the participants and the environment of the participants. Additional data capture devices may be provided for capturing other kinds of scene data that can be combined with the image data to build up more complete, accurate and/or reliable 3D models of the participants and/or their background scene. These additional data capture devices may include any of: range finders, LIDAR systems and thermal (infrared) cameras. These additional data capture devices may contribute further to the image information provided by, for example, identifying the position of the participant(s) in the room, and assisting in creation of an appropriate background scene 3D model, if required. Having multiple cameras and other additional data capture devices in the room will be helpful to determine the participant positions more accurately and will also assist creating a more accurate and complete 3D model of the location of the video conference participants in the room. The image capture device(s) may be integrated structurally in the display panel, e.g. mounted in corners or vertex mid-points of a display bezel, and/or independently mounted, e.g. desk-mounted or wall-mounted elsewhere in the room.

A data transmitter and receiver (data transceiver) is required at each location to send and receive video and audio data to and from the other participants via appropriate data communication links.

Appropriate computer processing resource is provided for image processing the video image data and optional additional data collected respectively by the image capture device(s) and additional data capture devices. One important task of the image and additional data processing is to determine the position(s) of the participant(s) relative to the display panel they are associated with (participant position). These positions are needed so that the display panel directs output light (product beam light), and thus images, in a targeted way to each participant. Optionally, this may include directing different images to the left eye and to the right eye of each participant. Another important task of the image and additional data processing is to generate a 3D model of the participant(s), most especially their head (3D participant model) so that perspective can be included in the images sent to the remote locations. The participant 3D model may be head-only or head-and-shoulders only, for example. A further task of the image and additional data processing is to generate a 3D model of the location to provide a backdrop (3D real local environment model), such as of a conference room or one side or other part thereof. The 3D real environment model will not include the participants. A 3D model of the locations' real environments will not be needed if the conference is fully virtualized, by which is meant that all the participants are placed in a fully virtual conference room that is defined by a fully virtual 3D environment model. In general, a video conference will involve an arbitrary number of locations. It will thus be necessary to create an overall 3D environment model for the conference (3D conference environment model) so that participants can be allocated a place from which perspective can be calculated. Assuming the conference is not fully virtual, then the 3D environment model will need to merge one or more 3D real local environment models into the overall 3D conference environment model. A simple scenario would be a conference involving two locations with respective groups of participants, each group seated on the same side of an elongate conference table. The 3D conference environment model would then simply merge the two 3D real local environment models as two halves of one virtual conference room.

The 3D conference environment model and the placement of the 3D participant models within it enables participant-specific viewpoints (or pairs of viewpoints in case left and right eyes are to be served different images) for rendering images on the display panel at each location which have a participant-specific perspective. In other words, the images of remote participants that are formed on the display panel for each (local) participant are given a perspective that has been determined from the placement of the local participant (to whom the images are being served by the display panel) in relation to how each of the remote participants are placed in the 3D environment model. In the case that the remote participants are set in a 3D real local environment model, they will appear as if in their remote location as viewed from the perspective of the position in which the viewing participant is placed in the 3D environment model. In the case that the conference is fully virtualized, the perception of perspective will follow entirely from how the participants are placed in the fully virtual 3D environment model.

For ease of representation and discussion the following examples omit inclusion of the audio channel and include only the video channel. However, it will be appreciated that suitable audio equipment is included, namely microphones and loudspeakers for respectively transmitting and receiving an audio feed.

It will be understood that the data communication links, such as network connections, between and within video conferencing locations may comprise any of: copper transmission cables, optical fibres, wireless transmission, satellite communication, routers, firewalls, switches, gateway computers and/or edge servers. Moreover, the computers and their resources discussed in the following may be physical or virtual machines.

It will also be understood that while the following description concentrates on the video representation on the display panel, a commercial video conferencing system incorporating display panels according to the invention and associated video processing of scene image information will most probably include further ancillary hardware and software features as familiar from existing video conferencing systems. These may include: surround sound, multiple microphones, privacy filtering of backgrounds, provision of artificial backgrounds, various modes for scheduling calls, noise cancelling, the ability to remove certain people from the synthetic scene, blanking of the display for certain participants and so forth.

The image processing for the video conferencing system should take account of one or more of the following points.

The video image frames served to each viewing participant (viewer) are specific to that viewer taking account of the viewer's position in relation to the display panel and/or the position of remote participants in the 3D conference environment model. In this respect, if a remote participant is placed in a 3D location model, then that remote participant will appear to the viewer as being in their real environment. The viewer's position at their location may change during the conference. The position of remote participants may also change during the conference. Both classes of positional change result in the video image frames served to that viewer changing to take account of one or both such classes of positional change. Optionally, the image frames served to the left and right eyes of a viewer will be different in which case the viewer's position shall include separate positions for the left and right eyes.

Optionally, the viewer's viewing direction may additionally be taken account of when forming the image frames for that viewer on the display panel. Head orientation may be taken as an approximate proxy of eye gaze direction of the viewer. Alternatively, eye tracking may be used to gain more precise information on eye gaze direction of the viewer. The synthetic scene served to that viewer is then adapted to take account of gaze direction, e.g. if the active speaker in a video conference changes from one remote participant to another remote participant, the viewer may change gaze direction to follow the active speaker, in which case the image served to the viewer could shift, e.g., to the right or left, accordingly—for example by a gradual panning movement from the previous gaze direction to the new gaze direction.

The imaging processing software will need calculate the scene that each viewer will see on the display panel at their location based upon the image data acquired at each of the remote locations. In general, the scene that is displayed on the display panel to a viewer will have to be synthesized, since the viewpoints of the cameras at each location that acquire the image data will not coincide the viewpoints of the scene required to be displayed to a viewer. The image processing software will therefore calculate an artificial 3D scene and then use appropriate rendering based on the desired viewpoint of each viewer (or pairs of viewpoints in the case of separate images being served to the left and right eyes of each viewer). The image element representing a remote participant or at least their head may either aim to look like a faithful representation of the participant (photo-realistic) even though they are actually synthesized. Alternatively, the image element representing a remote participant may be generated to look like an artificial avatar of the person (cartoon characters, animations, etc). For example, an active speaker or a moving participant may be represented photo-realistically whereas a silent or non-moving participant may be represented as an avatar.

The most sophisticated and realistic 3D effects during video conferencing will be created if the system uses all of: full pixel-by-pixel control of wavefront radius of curvature of the product beam as well as wavevector and amplitude; viewer eye tracking of each viewer; provision of different depth of field views for different elements in the scene being displayed (e.g. for each participant and the background); separate image frames served to left and right eyes of each viewer; full colour rendering; and photo-realistic rendering of participants and background. However, in most practical systems, the specification will be reduced to select those features which make the largest contributions to perceived quality of participant experience. In particular, driving the display panel to provide only a single depth of field (single image plane), which may be matched to be coincident with the physical plane of the display panel, may be acceptable, even though an accommodative focusing effect is not provided. Similarly, not catering for left and right eyes may be acceptable, so that the same image is delivered to both eyes of any individual viewer, which will still provide some amount of 3D effect through changes in perspective, e.g., when a remote participant moves in their room the scene will change, although a full stereoscopic effect is not provided.

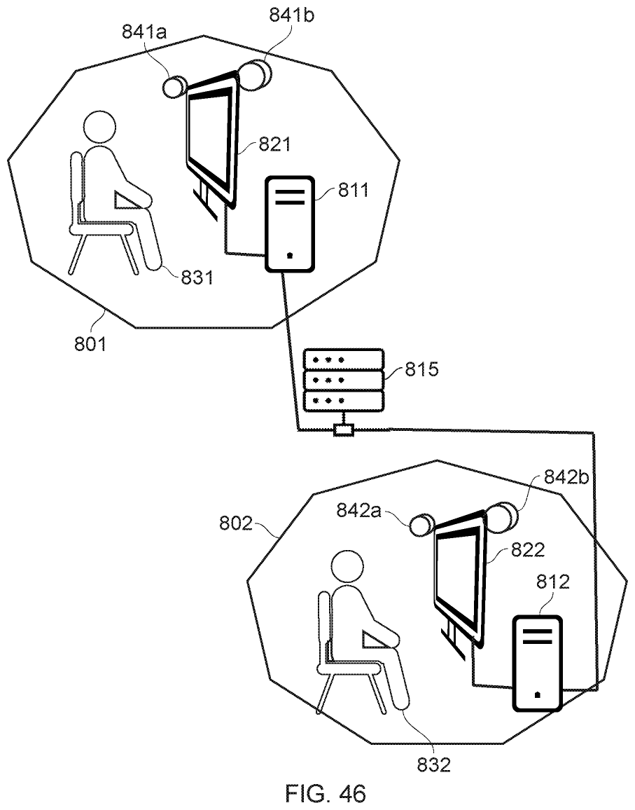

FIG. 46 and FIG. 47 are schematic drawings in perspective and plan view respectively of a first example video conferencing configuration. This is the simplest possible configuration for video conferencing, namely two people 831, 832 at two locations 801 and 802 respectively. The location may be a conference room for example. At each location a communication node is formed around respective computers 811 and 812. The computers are connected to each other by data connections to a central server 815 which may be a physical or virtual resource. Alternatively, the function of the central server 815 may be distributed to one or each of the local computers 811 and 812, which will be referred to as a peer-to-peer or point-to-point configuration. However, in this example a central server is used. An advantage of the central server is if in more than two locations are used. It is also possible to locate a central server function at either of locations 801 or 802 as desired.

The communication nodes 801, 802 have respective display panels 821, 822. The participants in the video conferencing system 831 and 832, each have left and right eyes 831R, 831L, 832R and 832L.

It will be understood that multiple displays could be deployed at each of the two remote locations and with appropriate software calculation they can be made to appear as separate display elements allowing the viewing of a larger total scene.

The system has cameras capable of locating each of the participants 831 and 832. In this example, each node has a plurality of cameras mounted at different locations. Two cameras 841a, 841b are illustrated at location 801 and two cameras 842a, 842b are illustrated at location 802. The cameras may be provided integral with the display panel, i.e., in a common housing, in which case the distance between the cameras is known. Alternatively, the cameras may be structurally independent of the display panel and independently mounted, in which case the distance between the cameras can be determined through image processing of images captured by the respective cameras to calculate the local geometry of the two locations.

The images provided by the cameras serve to determine the location of the participant, more specifically the location of the participant's head, still more specifically the location of the participant's left and right eyes.

Cameras are not the only element that can be used for determining the location of a participant. For example, a LIDAR system or a laser scanner can be used either instead of or in combination with cameras.

The video conferencing system operates by creating a synthesised view on the display panel that is appropriate for the locations of the left and right eyes of the participant. The synthesised view combines:
camera information of the local scene,
information of the location of the remote viewer, and
local geometry in the video conference room.

As an example, participant 832 is viewing 831 and 831's location 801. The two cameras attached to the display at 831's location (display element 821 and cameras 841a and 841b) must create a synthesised synthetic scene. This is accomplished by using standard machine vision approaches to identify participant 831, and their orientation, plus their position within the room at 801. This synthetic scene needs to take into account the furniture at 801, the lighting of participant 831 and then render an appropriate synthetic scene to transmit to the display element 822 located at 802. Furthermore, the cameras at 802 need to locate the position of participant 832 (and their orientation, head position, eye positions, etc) so as to allow the system to send the correct synthetic scene to the left and right eyes of participant 832. Thus, the system needs to calculate the synthetic scene based on both the position of participant 832 relative to their screen 822, and the position of participant 831 at their location 801. In this way the participant 832 can be served an appropriate scene that places participant 831 in their correct position within conference room 801, for example, showing participant 831 situated in front of a pot plant and behind a table. The scene showing participant 831 in room 801 is thus constructed for and served to the remote viewer 832 based on the actual scene information at room 801 as viewed by the cameras 841a, 841b as well as based on where the viewer 832 is located in relation to display panel 822 as determined by cameras 842a, 842b, more specifically where the head of the viewer is located, still more specifically where the left and right eyes of the viewer are located.

It will be understood that light generated at any given point on a display panel according to the invention can be directed as desired (wavevector control and optionally also wavefront radius of curvature control). This ability is exploited here to allow the scene to be served to the viewer in a targeted way. The least precise implementation is to direct the scene image to the head of the viewer so that the same scene image is served to the left eye and the right eye. This can be done by wavevector control and optionally also wavefront radius of curvature control, with the same values for each eye. A more precise implementation is to serve separate scene images to the viewer's left eye and right eye to provide a stereoscopic overall image and thus provide a better 3D experience to the viewer. This can be done with wavevector control and optionally also wavefront radius of curvature control, with different values for each eye.

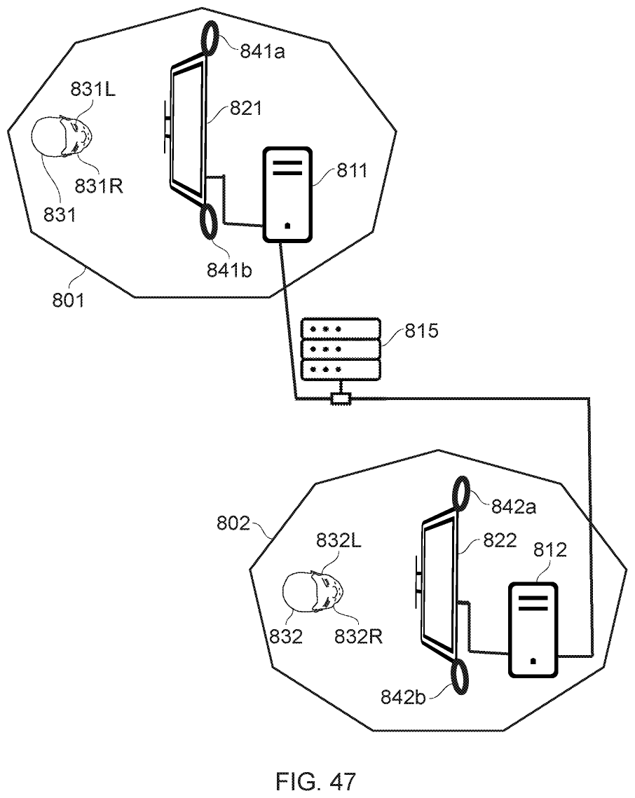

FIG. 48 is a schematic plan view of a second example video conferencing configuration. The video conferencing apparatus is the same as in the first example but this time there are two participants at each location. At location 801, there are participants 831(1) and 831(II) sharing the same display panel 821 and the same cameras 841a, 841b. At location 802, there are participants 832(I) and 832(II) sharing the same display panel 822 and the same cameras 842a, 842b.

In this situation with multiple participants viewing the same display panel, the display panel is driven to serve different scene images to the different participants.

The different scene images provide different perspective views of the remote scene.

The display panel according to the invention has the ability to serve different images to different viewers, which is most simply achieved through time slicing, i.e. time division multiplexing, at a refresh rate that is fast enough not to degrade the perceived image quality for each viewer. In other words, the display frame rate is no longer the same as the viewer frame rate, since each viewer is receiving their own video feed. Rather the display frame rate needs to be an integer multiple of the viewer frame rate where the integer depends on the number of viewers and also whether each viewer is receiving the same video feed into both eyes or a different video feed into each eye. Namely, if each viewer is to be served at a certain frame rate, f such as 60 Hz, then the display panel needs to be driven at a frame rate ‘n’ times ‘f’ to serve ‘n’ images to ‘n’ viewers in the case of both eyes receiving the same image, or ‘2n’ times ‘f’ in the case of the left and right eyes of each viewer being served different images. With the illustrated example of two viewers per display panel, then the display frame rate needs to be either double or quadruple the viewer's frame rate.

The positions of the cameras 841a and 841b, i.e., their viewpoints and hence their views of participants 831(I) and 831(II), will in general be different from the viewpoints needed by the remote participants 832(I) and 832(II) for a realistic video conference experience and in any case will not be able to take account of movement of participants 831(I) and 831(II).

Consequently, the system will synthesise a synthetic scene which interpolates the views taken from the cameras (which may be more than the two shown) and any other devices that provide relevant data for image formation, such as LIDAR or acoustic sensors. Such technology is readily available from computer gaming systems and graphics processing cards which is able to create a 3D model of the scene which can be viewed from any desired perspective.

A general system can have multiple locations (two or more) and at each location one or more participants. With two locations and multiple participants at each location the participants may occlude each other, may be blocked from view by furniture etc. It may then become necessary to reconcile conflicts, i.e., incompatibilities, between different viewpoints, which the view generating software will need to resolve. One route to resolve such inconsistencies will be to place the scene information in a virtual room with locations and relative positions of the participants that are not representative of the true geometry of their individual locations, e.g. to place all participants around a virtual circular table sized to seat the number of participants or the number of invitees to the video conference.

It will be noted that more cameras can be deployed at each location, and that scene information can be learnt over time by the video conferencing system, so as to minimise the processing required. Furthermore, the amount of data requiring transmission will be reduced if a standard model of the 3D geometry of the conference room at each location is built up in software and the participant synthetic figures (avatars) are the only part transmitted in real time because the background information constituted by the conference room will not change either from one conference to the next or during a conference if participants move.

### Video Conferencing Embodiments

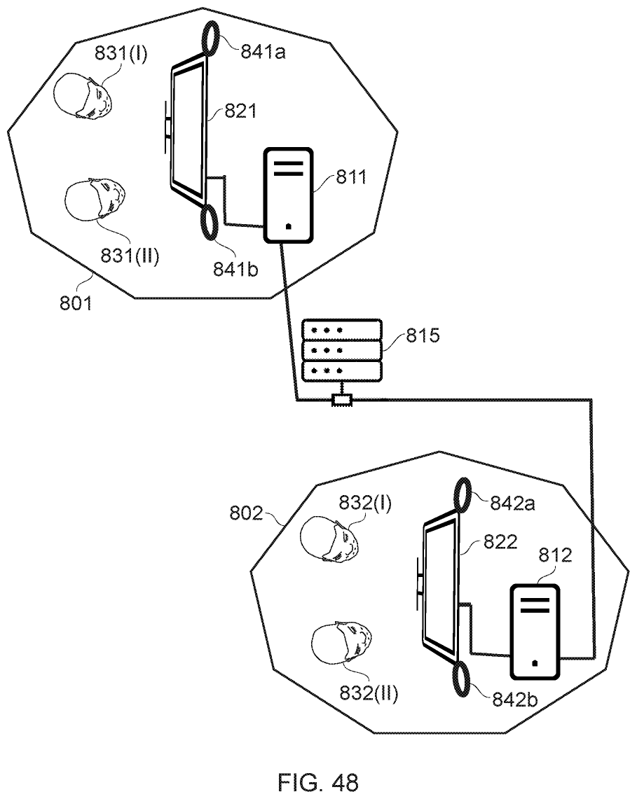

FIG. 49 is a schematic plan view of a third example video conferencing configuration. The number of locations is four, labelled 801, 802, 803, 804. There are two participants 833 at each location and in this example each participant has their own display panel 823. Each display panel 823 has two cameras (illustrated but not labelled). A local computer 813 is provided at each location and the computers 813 at the different locations are interconnected via a central server 815. In this case, all of the information from all of the local cameras and optional additional sensors are sent to the central server, and this information is sent back to the screen as appropriate. The role of the central server 815 is to take the camera image data (and any other image data collected by additional sensors) from each of the four locations and create appropriate 3D synthesised images for display on each of the screens 823.

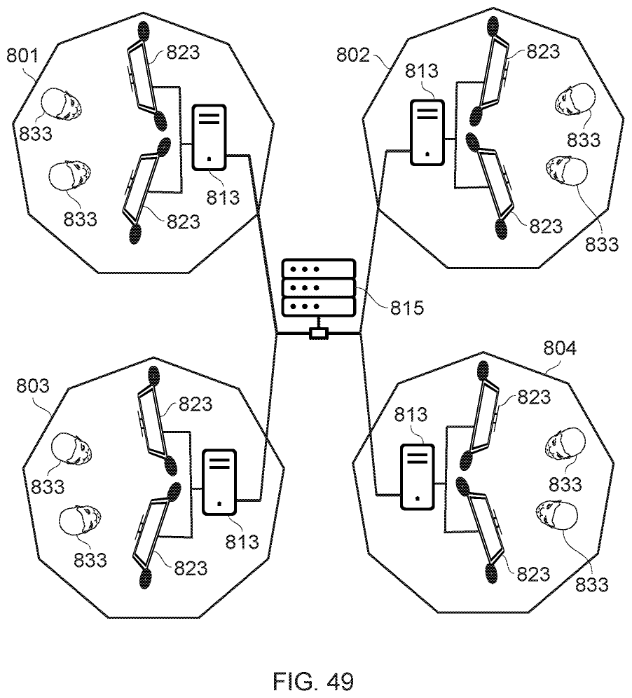

FIG. 50 is a schematic plan view of a fourth example video conferencing configuration. The number of locations is three, labelled 801, 802, 803. There are two participants 833 at each location and each participant has their own display panel 823. Each display panel 823 has two cameras (illustrated but not labelled). A local computer 813 is provided at each location and the computers 813 at the different locations are interconnected to exchange video and audio data directly in a peer-to-peer configuration without the intermediary of a central server. In this case, each location receives camera and location information from the other video conference locations. The processing to create synthetic scenes is distributed between the relevant computers 813.

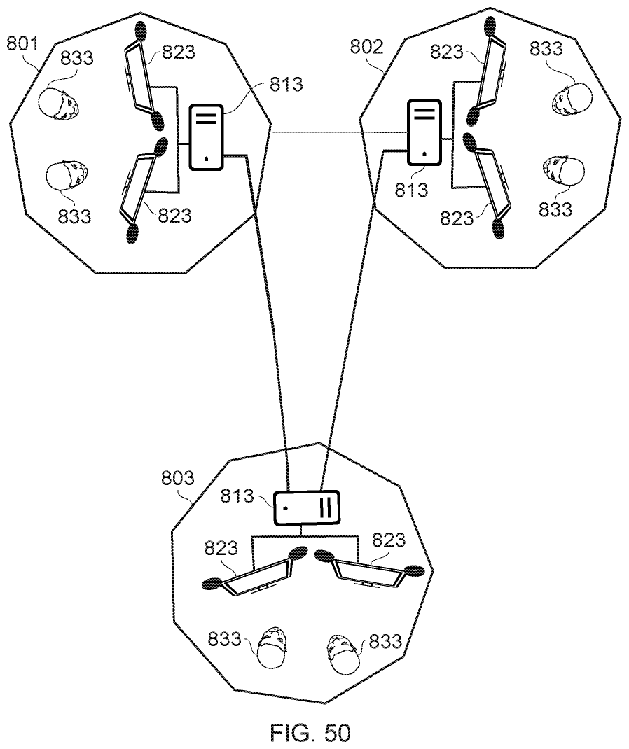

FIG. 51 shows a video conference configuration where the 3D synthesised view creates a virtual conference configuration in which the participants directly face each other either side of an elongate rectangular virtual table.

In the real-world configuration (upper drawing) there are two locations 801 and 802. In each location there are two participants labelled as 833. Each location has one screen 823 per participant, i.e., two in this case, and a computer 813. Each screen 823 has two (or more) cameras, so that each participant is filmed from two (or more) different viewpoints. The interconnection between locations is illustrated as being peer-to-peer but could be via a central server.

In the virtual conference configuration (lower drawing), the participants 833 from the two locations appear to be located as if they are sitting opposite each other, as if at either side of an elongate meeting table. A virtual division 852, which we refer to as a table divide, is created, which defines how the participants view each other. The screens 823 are fed respective views consistent with this virtual conference configuration. The allocation of the participants to a side of the virtual table based on location is only one option. Another option is to allocate participants to a side of the virtual table based on affiliation. For example, with an arbitrary larger number of participants from two organisations located at an arbitrary larger number of locations, the participants from one organisation can be placed on one side of the table and those from the other organisation on the other side of the table.

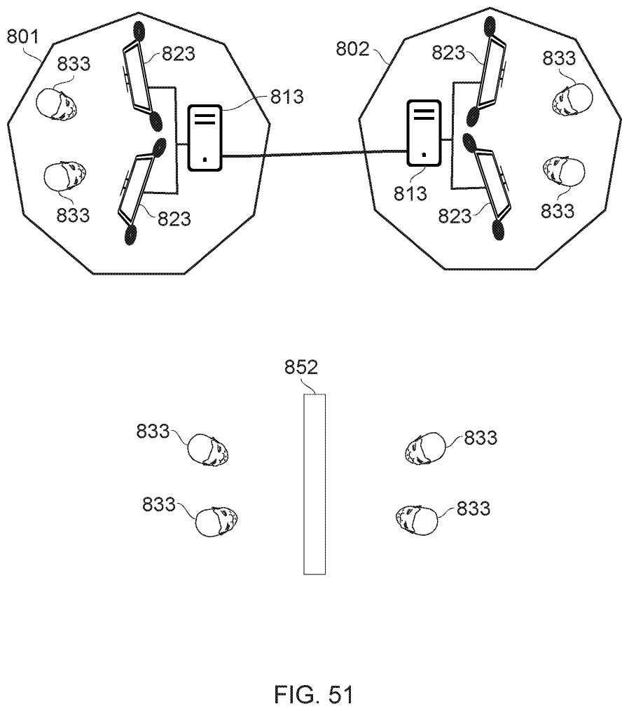

FIG. 52 shows a video conference configuration where the 3D synthesised view creates a virtual conference configuration in which three groups of participants sit across an equilateral triangular virtual table.

In the real-world configuration (upper drawing) there are three locations 801, 802, 803. In each location there are two participants labelled as 833. Each location has one screen 823 per participant, i.e., two in this case, and a computer 813. Each screen 823 has two (or more) cameras, so that each participant is filmed from two (or more) different viewpoints. The interconnection between locations is illustrated as being via a central server 815 but could be peer-to-peer.

In the virtual conference configuration (lower drawing), the participants 833 from the three locations appear to be located as if they are sitting on different sides of a triangular table 853. The system creates a synthetic scene which places the participants as if at a three-way table.

The viewing angles of the participants (in this example as positioned around a virtual triangular table) will be different from the viewing angles of the cameras and screens in the real world. Thus, the system will need to synthesise virtual views (in effect avatars of the participants). This can be done in real time and/or can use earlier scanned information about the participants and their appearances. Similarly, the background room scene can also be rendered artificially to create a realistic looking virtual scene. Equally, other avatars could be used (cartoon figures, etc).

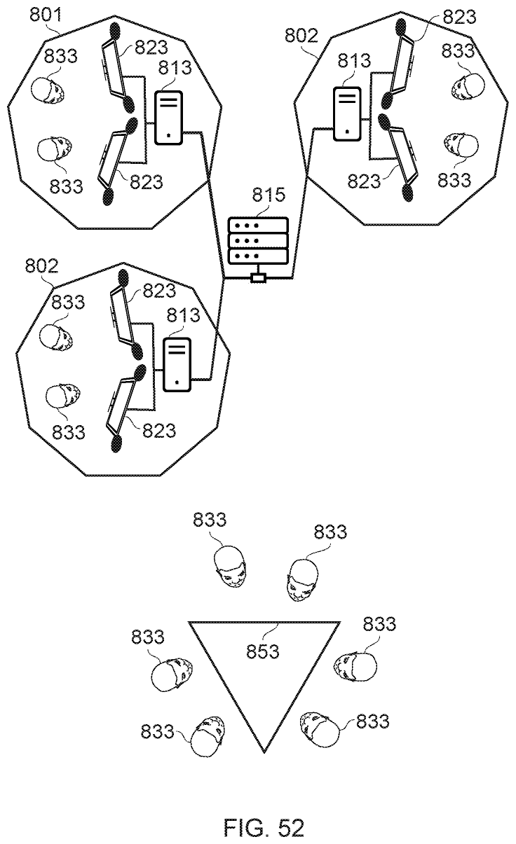

FIG. 53 shows a video conference configuration where the 3D synthesised view creates a virtual conference configuration in which the participants face each other seated around a circular or round virtual table.

In the real-world configuration (upper drawing) there are six locations 801, 802, 803, 804, 805, 806. In each location there is one participant 833. Each location has one screen 823 and one computer 813. Each screen 823 has two (or more) cameras, so that each participant is filmed from two (or more) different viewpoints. The interconnection between locations is illustrated as being via a central server 815 but could be peer-to-peer. In a peer-to-peer configuration it may be advantageous to have one computer as a master controller with the other computers subservient to the control from the master computer.

Thus, in this example, while in the real world each participant is sitting directly in front of a display panel at their own location, in the virtual world a synthesised view is provided of the participants as if they are all seated around a circular table. The system creates a circular conference table in a virtual geometry. Again, the virtual scene will need to create angled viewpoints of the different participants and the illusion of an appropriate virtual room background.

### Input Beam Delivery for Near-to-Eye Displays

A significant design aspect for beam delivery is how best to route the input beams through the AR spectacles or other display elements and into the lenses or other components in which the NLO material layer is situated.

The most straightforward approach is to inject both input beams in opposing directions from opposite sides of the lens or other display panel, as for example shown in FIG. 9.

Another approach is shown in FIG. 24 where both input beams of a pair are introduced into the same side of a lens (or other format of display panel) and one of the beams is returned by a mirror arrangement 260 so that it meets the other beam in the phase matched region with an appropriate combination of wavevectors for generating a product beam normal or near normal to the plane of the lens.

A further approach, as briefly mentioned further above, is to route the input beams around the perimeter of the lens using a suitable light guide such as a waveguiding structure.

FIG. 54 shows such an approach using the example of AR spectacles. Input beam light for one of the input beams of a pair is routed from the temple side of the lens rim to the nose or bridge side of the lens rim through a light guide, in particular a graded index (GRIN) light guide or stepped index light guide. The right side of a pair of AR spectacles 10 is shown with frame 26, right temple 34, right lens rim 38 and right lens 24 which incorporates an NLO display panel according to the invention. (The left side of the AR spectacles 10 corresponds.) The right temple 34 accommodates the input beam source(s). Input beams from the input beam sources are coupled into the lens rim via coupling optics shown schematically with dashed lines. The beam sources are accommodated in a suitable source module (sometimes referred to as a light engine) that is embedded in the temple 34 and contains all of the required laser sources, modulators (amplitude and phase), drive electronics, batteries, focusing optics and so forth. The input beam 70 is coupled into the lens 24 at the temple side via and input beam port 66 whereas its paired input beam 76 is coupled into the lens 24 at the nose or bridge side via an input beam port 68 by virtue of being guided through the lens rim 38 which has embedded therein (or thereon) a suitable light guide 39, such as a graded index (GRIN) light guide. According to the illustration the light guide 39 extends around the top of the lens rim 38. In other embodiments, it could extend around the bottom of the lens rim 38. Multiple input beams may be routed in the same light guide or multiple light guides may be provided to route individual input beams in the case that there are multiple input beam pairs and/or input beam pair wavelengths to route to the nose or bridge side of the lens 24. The light guide may be an optical waveguide such as a GRIN or stepped index optical fibre or a GRIN or stepped index rod lens. A GRIN light guide can map input and output fields directly. On the other hand, a stepped index light guide will create additional spots of light. In some situations, the multiple spot effect of a stepped index light guide could be desirable to create multiple illuminated spots, such as to map onto groups of spatially separated phase matched regions for different colours as shown in FIG. 22. In other situations, the multiple spot effect will not be wanted in which case a GRIN light guide would be preferred.

Placement of a Piece of NLO Material within a Host Material

Certain embodiments of the invention for near-to-eye displays, such as VR goggles, AR spectacles and contact lenses, may incorporate the display panel according to the invention only over a selected small area of a larger optical element such as a transparent lens.

This may be an attractive option where the role of the synthetic scene elements is to provide information to the user rather than to assist or enhance vision of the natural scene. Here it may be ideal to form the display panel over a limited area of the wearer's vision angles, specifically so that the user will not have the display panel in their line of sight when looking forward but only when purposedly looking up or down (or probably less likely left or right).

The synthetic scene information could then for example be alphanumerically represented text information or graphically represented information such as to show a representation of an analogue dial or gauge. This leaves the user's normal view unimpeded and requires the user to purposely look up or down to access what is represented on the display panel.

An example of where this would be useful is as a driving aid where the driver wears AR spectacles. The basic head position of the driver is forwards-looking through the windscreen- and dashboard-type information is shown on a display panel, e.g., of elongate rectangular shape, arranged embedded in the AR spectacle lenses below where the driver is normally looking through the lenses to view the road ahead. The driver then has to make a deliberate eye movement downwards to see the information displayed on the display panel.

The display apparatus may also be configured to bring information deemed to be more important to the attention of the wearer. This may be done by increasing brightness, changing colour, flashing, or moving the displayed information in position on the display so it is closer to the wearer's current line of sight (or the line of sight for normal forward vision). For example, if a vital sign has a value that worsens by passing through a life-threatening threshold (e.g., heart rate to high or low, blood pressure too low), this may prompt such a display change.

Non-visual aids, such as aural or haptic aids, may also be incorporated in the AR spectacles to prompt the wearer to look at the display panel, such as a light (which may flash) or a vibration or a sound, for example when there is important information to be viewed on the display panel.

The inwardly facing cameras for eye tracking may also be used so that the display panel is only activated to display when the eyes are detected as having their optical axes directed to the display panel area. The eye tracking may also be used to deactivate the display panel after the wearer's gaze has left the display panel area, for example after a certain number of seconds. In the case of text information, the eye tracking may also be used to detect when the wearer has read the information, which may be a prompt to display new text information, e.g. the next line.

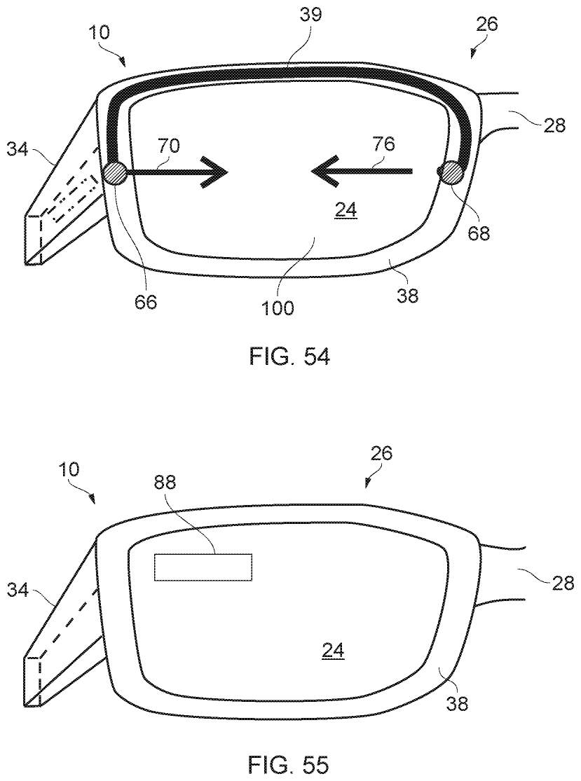

FIG. 55 shows the right half of an AR spectacles showing the right temple 34, right lens rim 38 and right lens 24. The spectacle lens 24 is a conventional lens but has a display panel 88 according to the invention arranged in a position above and offset to the right of the wearer's line of sight for normal forward vision, thereby forming a composite structure. The display panel 88 is shown as having an elongate rectangular shape by way of example only. The display panel 88 is set into the conventional lens for example in a cut-out area of the lens or by embedding the display panel in the lens. The temple 32 houses the optics and electronics as previously described.

A specific example might involve creating the composite lens from a known optical plastics compound (e.g. acrylics such as PMMA, or polycarbonates, Polyethylene Terephthalate, Polyether Ether Ketone, CR-39 Allyl Diglycol Carbonate, polydimethyl siloxane, polystyrenes, etc.) and the display panel having as its NLO material a suitable NLO compound such as PPLN, PPKTP or an organic NLO material.

The composite lens structure will most likely result in the display panel part having a refractive index different from the conventional part. The refractive index difference may be quite large, since conventional lens materials have refractive indices in the range 1.4 to 1.6 whereas many NLO materials have refractive indices in the range 1.8 to 2.3. Especially for such larger refractive index differences, unwanted reflection, scatter and other visual artefacts are likely to be quite apparent without appropriate countermeasures being taken.

To suppress these unwanted visual features, the refractive indices at either side of each interface, the plane of these interfaces, the angles at which the different beams are incident on these interfaces, and the wavelengths of those beams are factors that need to be taken into account.

Unwanted reflections are one type of visual artefact to be suppressed. Unwanted reflections from the infrared input beams inside the spectacle lens will largely come from reflections at the interfaces between the inset NLO display panel and the lens material it is set in, either at near normal angles or at glancing angles at the left and right interfaces or top and bottom interfaces between the inset display panel and the lens. Unwanted reflections from the product beam or natural scene light, i.e., at visible wavelengths, will be normal or near normal to the front and back surfaces of the inset NLO display panel (which may be interfaces to air or interfaces to the lens material depending on whether the NLO display panel is fully embedded in the lens or only embedded around the sides (left, right, top, bottom). Anti-reflection coatings are provided at these interfaces to suppress these unwanted IR and visible reflections. The ARC coatings will need to be designed with the optical materials of the lens and embedded NLO display panel taken into account. For example, if the NLO display panel is made of an inorganic material (such as PPLN) and it is placed in a settable resin transparent plastics compound lens material, then the NLO display panel material can be coated with appropriate anti-reflection layers before it is embedded in the resin of the lens. Similarly, if the NLO display panel is to be glued into a suitable hole within a lens by adhesive bonding, then the difference in the refractive indices of the lens material and the NLO display material needs to be taken into account.

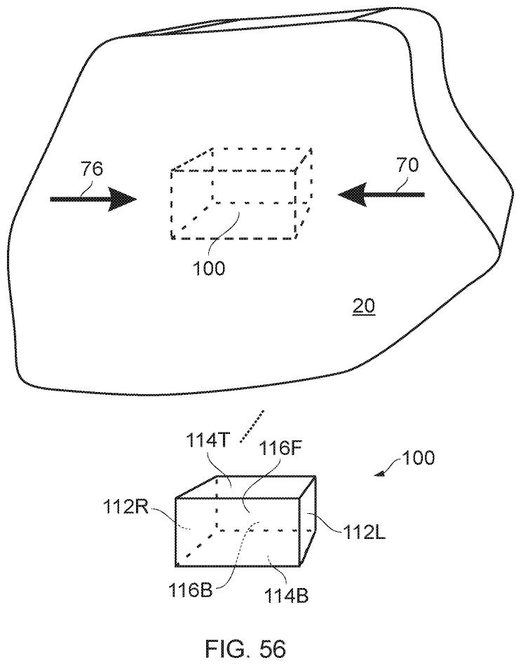

FIG. 56 is a schematic perspective view of a section of a lens 20 with a piece 100 of an NLO material embedded or set therein which forms the NLO display panel 88. The piece 100 has an approximately cuboid shape in the sense that it is bounded by left & right surfaces 112L, 112R, top & bottom surfaces 114T, 114B and front & back surfaces 116F, 116B. The surfaces 112, 114, 116 may be curved or at non-normal angles as dictated by factors such as overall lens curvature for the front & back surfaces (see e.g. FIG. 9) and input beam coupling for the left & right surfaces (see e.g. FIG. 13). The directions of the two input beams 70, 76 of any given pair within the lens 20 are shown with arrows. The lower diagram shows the NLO material piece 100 with its surfaces labelled. An example NLO material for the piece is PPLN. An example lens material for embedding the NLO material piece is PMMA.

Different considerations apply to each pair of surfaces: left & right 112, top & bottom 114 and front & back 116, since their roles in the display panel are different.

The role of the left & right surfaces 112 in the display panel is to couple in the infrared input beams 70, 76. It is therefore advantageous to arrange anti-reflection coatings on the left & right surfaces 112 which are optimized for: (i) the specific wavelength(s) of the input beam(s) or the range of near infrared wavelengths spanned by the input beams collectively; (ii) for the coupling-in angles between the input beams and the left & right surfaces 112 (which may be much less than the 90 degrees schematically shown); and (iii) for the refractive indices involved at the interfaces at which the surfaces 112 are formed, for example PPLN-to-PMMA. (Alternatively, in some embodiments an end portion of the front surface 116F is used to couple in the input beams as shown in FIG. 10 in which case the comments above apply to that surface portion instead.)

The role of the front & back surfaces 116 is to let the visible product beam light created within the NLO material travel to the eye. It is therefore advantageous to arrange anti-reflection coatings on the proximal (front) surface 116F that faces towards the eye which are optimized for: (i) the specific wavelength(s) of the produce beam(s) or just for the whole visible wavelength range; (ii) near normal incidence, since this is the angle of incidence of the product beams on the proximal (front) surface 116F as they pass towards the eye; and (iii) the refractive indices involved in the distal back surface interface 116B which may be a PPLN-to-air interface or a PPLN-to-PMMA interface, if the piece 100 is fully embedded in the lens 20. It may also be advantageous to arrange an absorbing coating, for the product beam wavelength on the distal (back) surface 116B to absorb scatter and reflections of product beam light.

The top & bottom surfaces 114 on the other hand have no active role in the optics of the display panel in that they are not designed to transit either input beams or product beams.

Any NIR or visible light incident on the top & bottom surface facets 114 is likely to be at a small (glancing) angle, whether it be stray NIR input beam light or visible natural scene light that is travelling to the viewer. At glancing incidence angles, it is very hard to stop reflections using anti-reflection coatings, because the sensitivity to refractive index difference becomes very high. Here the approaches of surface roughening and use of a light absorbing layer may be used to suppress these glancing angle reflections.

The interfaces which will receive input beam light at a glancing angle, in particular the top and bottom surfaces 114, may be deliberately roughened rather than be polished or cut to be smooth. This is since a smooth flat surface will tend to lead to a significant amount of reflection unless the two materials at the interface are very well matched in refractive index. Roughening these surfaces will cause scatter but will reduce specular reflection and can lead to a net reduction in perceived artefacts.

The interfaces which will receive input beam light at a glancing angle, in particular the top and bottom surfaces of the NLO display material, may be coated with a light absorbing layer. The light absorbing layer may be provided by an optical glue or cement that is used to attach the NLO display panel into the lens. The light absorption of the light absorbing layer may be selective to absorb at the input beam wavelength(s), at the product beam wavelength(s) or across a wide range of wavelengths spanning the visible and near infra-red of the input beams. The approach of using a light absorbing layer is particularly attractive for a near-to-eye display (e.g. AR spectacles), since the presence of absorbing layer is imperceptible, because of its closeness to the eye, i.e., at a small fraction of the near point (e.g. 16 to 20 mm for AR spectacles). For example, a black light absorbing adhesive will not be resolvable by the wearer's vision.

### Suppression of Double Refraction Artefacts

Many NLO materials are birefringent, either uniaxial or biaxial, and therefore double refraction effects will occur whereby when light from a natural scene passes through a transparent piece of birefringent material two copies of the natural scene appear which are displaced relative to one another. A well-known example is when looking through calcite to observe the classic effect of doubling of the object. For example, PPLN is uniaxially birefringent with a largest nonlinear coefficient when all beams area polarised along the z-axis of the crystal.

Since certain embodiments of the present invention, notably AR spectacles and contact lens implementations, involve looking through the NLO material to view the natural scene, it may be important to undertake measures to minimize the amount of double refraction when the NLO material is birefringent.

Different measures for reducing double refraction are now discussed.

A simple measure to reduce double refraction is to select the thickness of the NLO material layer to be small, which is often desirable anyway for AR spectacles or contact lenses.

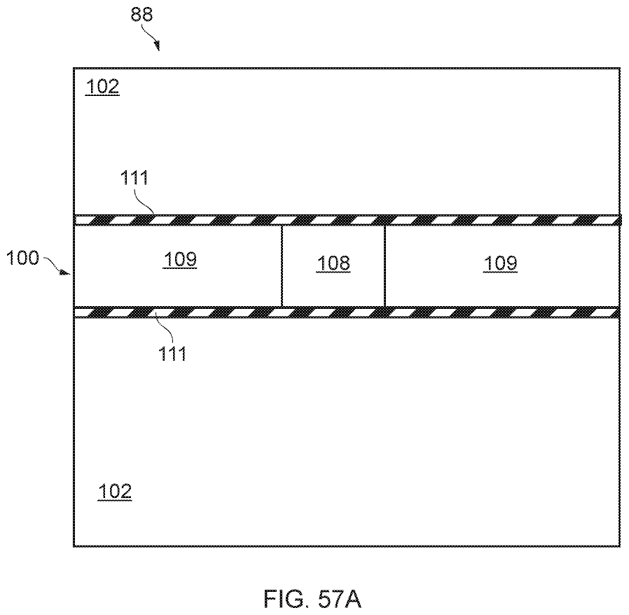

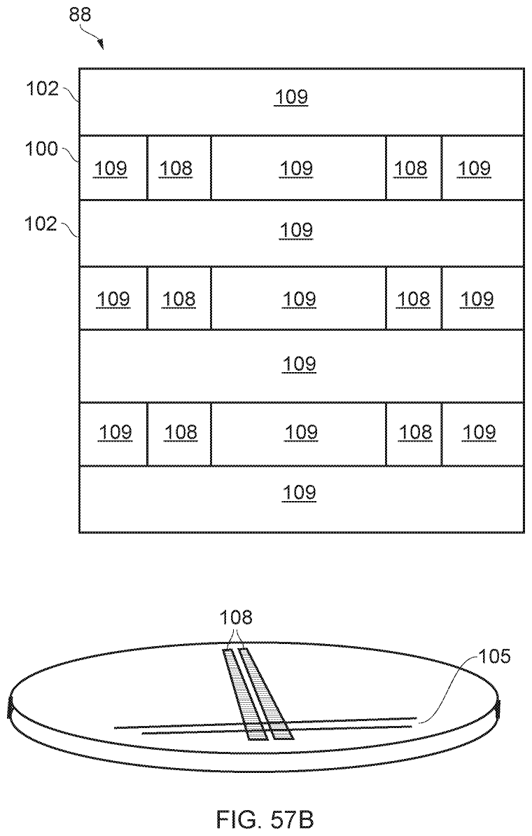

A measure to reduce double refraction in the NLO material is to include a compensating sheet or piece of single domain, i.e. not phase matched, uniaxial (or biaxial) NLO material with its axis (or both its axes) rotated 90 degrees to the phase matched NLO material sheet or piece in order to compensate for the birefringence. The compensating sheet or piece can most conveniently be made of the same material as the phase matched NLO material sheet or piece and having the same thickness. The compensating sheet or piece could also be provided as two such sheets arranged above and below the NLO material sheet or piece in a sandwich construction, the two sheets or pieces have an aggregate thickness that cancels out the birefringence from the phase matched NLO material sheet or piece. This approach could be applied as an add-on to the display panel of FIG. 57A, described further below, by placing an extra sheet (or pair of sheets) in front of and/or behind the display panel shown in FIG. 57A.

### Composite Display Panel

FIG. 57A shows a display panel 88 as suitable for an AR spectacle lens, for example. The plane of the drawing is the plane of the display panel, e.g., an AR spectacle lens. The panel 88 contains a region 108 of NLO material that is periodically poled or otherwise has a phase-matched grating formed therein. The panel 88 is a sandwich assembly of top and bottom pieces 102 of material either side of a middle piece 109 of NLO material in which the grating region 108 is formed. The top and bottom pieces 102 may be made of the same material as the middle piece or a different material. An advantage of using the same material is that this will automatically provide optical and also physical and chemical matching to the middle piece. If a different material is used, it is selected to be matched to the middle piece optically and also physically and chemically. The maximum possible thickness of the piece 109 may be dictated by the periodic poling process which is based on lithography under application of electric fields. By thickness we refer to the direction normal to the plane of the drawing. The periodic poling process performs best with thinner samples (e.g. 2 mm, 1 mm or 500 micrometre thickness) and the achievable thickness reduces for shorter grating periods, i.e. smaller distance between domain inversions. For example, the middle piece 109 may have a thickness of 2.0 mm, 1.5 mm, 1.0 mm, 500 micrometres or less while the top and bottom pieces 102 may each be 5 to 10 mm thick. The lens area, i.e., lateral dimensions, of the region 108 may also be limited by the periodic poling process. For PPLN, a convenient-to-manufacture square grating area might be 1 mm×1 mm, for example. Larger lateral dimensions can be more difficult to make owing to domain merger and lack of uniformity in the NLO material itself. One example would be for all the pieces to be made from LiNbO3, in particular MgO-doped LiNbO3. The grating region 108 would then be PPLN with the remainder of the middle piece 109 being single domain lithium niobate, and the top and bottom pieces 102 would also be single domain lithium niobate.

The pieces 102 and 108/109 can be adhesively bonded with a suitable bonding agent to form respective bonding layers 111. The bonding agent may be an optical cement or optical glue. The bonding layers 111 may advantageously be made absorbent to at least one of the input beam and product beam wavelengths, for example by adding some appropriate absorbing dye to the bonding agent. The bonded surfaces that abut to form the interface between the middle pieces 108, 109 and the top and bottom pieces 102 may also be roughened to suppress narrow-angle specular reflection. The bonding layers 111 should be kept as thin as possible to keep the display element looking aesthetically attractive and to avoid unwanted light loss.

The display panel 88 may have a large area spanning the whole display area, which would likely be the case for liquid crystal or organic NLO material that was readily manufacturable in large areas as needed for smartphone displays, laptop computer screens and televisions. Alternatively, the display panel 88 may be relatively small in area as used for AR spectacle lenses or contact lenses. Moreover, the display panel 88 may be sized to occupy only a portion of a larger lens area and be embedded in a composite lens structure as described with reference to FIG. 55 and FIG. 56.

It will be readily appreciated how the structure of FIG. 57A can be adapted to provide the grating stack 103A of FIG. 29. Namely, the different colour regions 206R, 206G and 206B of FIG. 29 can be assembled from three separate middle pieces 109 stacked in the plane perpendicular to the plane of FIG. 57A.

FIG. 57B (upper drawing) shows a further example display panel 88 according to the invention as suitable for an AR spectacle lens, for example. The plane of the drawing is the plane of the display panel, e.g., an AR spectacle lens. The panel 88 may be considered to be a ‘thicker’ sandwich compared with FIG. 57A with multiple repeats. NLO material layers 100 with phase-matched regions 108 that are periodically poled, or otherwise have a phase-matched grating formed therein, are separated by unpoled layers 102, typically made of the same NLO material as the poled layers. Lithium niobate is a suitable material with the phase-matched regions 108 being PPLN.

FIG. 57B (lower drawing) shows an example NLO material wafer that has been periodically poled, from which pieces to form the poled layers 100 can be cut or sliced (along lines 105) and stacked with unpoled layers 102, which may be cut from a virgin wafer or from unpoled regions of the periodically poled wafer, to form the structure shown in the upper drawing (or FIG. 57A).

For example, the poling process for PPLN is typically carried out on 3 inch diameter wafers of MgO-doped lithium niobate by first using photolithography, and then applying pulsed electric fields to selectively reverse the domain orientation where openings exist in a photoresist structure. Further details of this process can be found in U.S. Pat. No. 8,054,536B2.

To create the illustrated sandwich structure and form a lens or lens inset piece, the wafer can be sliced into sections and these can be stacked. On the wafer, there are two poled domain regions 108 (of the correct poling period for the non-collinear phase matching). Typically, a wafer might be 1 mm in thickness and have a 3 inch diameter. By way of example, two cut lines 105 are shown which might, for example, be 1 mm apart. After cutting sections out of the wafer, the resulting pieces will have the wafer thickness of 1 mm and a depth dimension defined by the cut line separation, e.g., also 1 mm to match the thickness dimension, and a width that is much greater, the width dimension being along the cut direction. A number of elongate square (or rectangular) section rods is therefore produced. These rod pieces are then stacked along their long dimension as shown in the diagram to form the lens or lens inset piece in the case of a composite lens as shown in FIG. 56.

It is noted that there is considerable design freedom on what shape and dimension the pieces cut from the wafer should have and also on how to stack them. For example, the pieces may be cut and stacked to create a lenticular type display. Moreover, in some situations, it may be attractive to have only a single layer containing poled material (FIG. 57A), while in others a stack with many repeats may be attractive, e.g., simply to increase the display area (FIG. 57B). The different layers 100, 102 may have different thicknesses individually or collectively. Moreover, the unpoled layers may be omitted entirely so that all the layers of the stack contain phase-matched regions, for example the phase-matched regions may be staggered between adjacent layers in the direction left-to-right in the drawing.

### Stabilisation Control of Images

When a human looks at a scene their eye naturally roves around the image. This is partly to allow a wider field of view, partly to scan their foveal region over the natural scene (the part of the retina with the highest density of cone receptors and thus highest visual acuity) and partly to avoid saturation. The human brain synthesizes all of the resulting visual information into our representation of the visual scene. If the person is in a moving environment—e.g. in a car, the eyes also move to counter vibration and changes of direction. Effectively utilising eye movement as an image stabilisation mechanism.

When a person wears AR reality spectacles, synthetic scene elements are superimposed on the natural scene, so there is the issue of how to position the synthetic scene elements in a way that is consistent with the wearer's view of the natural scene.

A first option is to keep the synthetic scene element at the same position on the display, which is appropriate if the viewer's brain perceives the synthetic scene element as being shown on the display. An example might be text information that the wearer of AR spectacles perceives as being shown on the display such as a person reading their text messages while moving.

A second option is to move the synthetic scene element around the display in a way that its position appears static relative to the natural scene, which is appropriate if the viewer's brain perceives or should perceive the synthetic scene element as being part of or associated with the natural scene.

Within either of these options, fine motion stabilisation may be added so that there is compensation against vibration and other rapid movements.

Adding fine motion stabilisation to the first option would involve move a synthetic scene element on the display in respect of one or more types of fine motion, e.g. vibration, but not against one or more types of gross motion, e.g., wearer head rotation. An example might be a vehicle driver wearing AR spectacles that are used for displaying text information. The wearer perceives the text information as being shown on the display so the text information is not moved in response to drive head movement, but the display position of the text information is nevertheless moved around to counteract vibration of the vehicle which would otherwise simply cause blur and shake of the text information.

The two options in practice can therefore be summarized as:
Option A—synthetic scene element fixed to the display (with or without fine image stabilisation)
Option B—synthetic scene element fixed to the natural scene (with or without fine image stabilisation).

The same stabilisation may be applied to the whole synthetic scene or independently to different elements of the synthetic scene. For example, for a combat pilot, target crosshairs would follow the natural scene (Option A), whereas flight data would be locked to the display (Option B).

Image stabilisation may make use of data collected from one or more types of sensors. Sensor types useful for image stabilisation include: an outwardly facing camera, an inwardly facing camera, LiDAR, accelerometer, magnetometer, tilt sensor, MEMs sensor, ECG sensor, microphone. The sensors may be mounted on the display apparatus (e.g. AR spectacles), on the body of the viewer (heart rate monitor), somewhere external to the display apparatus (e.g. cameras viewing the natural scene including the viewer as known for gaming or video conferencing).

The stabilisation can be achieved either in software (e.g. altering the synthetic scene to take account of the position of AR spectacles) or it can be achieved optically (e.g. by gimballing, tilting, altering the angle of components, moving DLP chips, etc.) so as to direct optical beams in different directions or altering positions of components responsive to the motion being compensated for. In practise, it may be especially attractive to include a combination of software stabilisation and optical stabilisation. Software stabilisation lends itself in particular for macroscopic and slow movements (such as turning the head). Optical stabilisation may be preferred for cancelling vibration and other rapid motion changes.

It may also be desirable for the viewers optical comfort and convenience to include saccadic blanking within the stabilisation system (dimming the display when the viewer's eye moves far) and also damping the movement-so that, for example, as the viewer moves their head (and the glasses move) the synthetic scene moves with some lag and so appears to make a smooth and slow movement to its new position.

Moreover, the brightness of the synthetic scene elements can be controlled such that they retain sufficient contrast relative to the natural scene, e.g., with a luminance of at least three times that of the natural scene, while not becoming too bright and becoming distracting, e.g., being capped to having a luminance of no more than one of 10, 20, 30, 40, 50 or 100 times that of the natural scene.

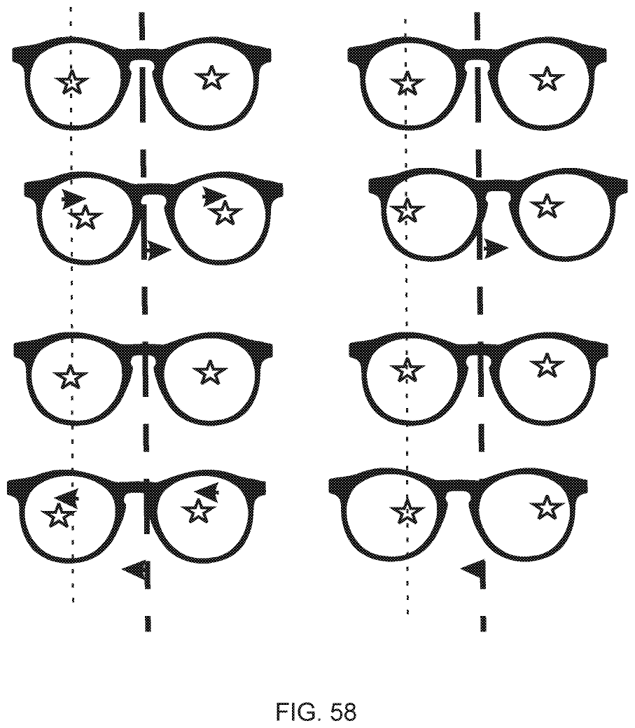

FIG. 58 is a collection of schematic diagrams of an AR spectacle frame 26 with a synthetic scene element shown as a five-pointed star. The star is shown for both the right and left eye. The left-hand column images portray Option A with the synthetic scene element fixed to the display. The right-hand column images portray Option B with the synthetic scene element fixed to the natural scene. The images of each column from top to bottom indicate wearer head swivel motion with horizontal arrows. The perspective of the drawing is as seen by the wearer of the AR spectacles, i.e., looking outwards.

The thick dotted vertical lines show the centre of the spectacles frame at the start of the motion, i.e. top row of each column.

The thin dotted vertical lines show the centre of the star at the start of the motion, i.e. top row of each column.

The sequence from top to bottom shows head swivel to the right (column 2), back to the centre (column 3), and to the left (column 4).

Following the left-hand column images from top-to-bottom, showing Option A with the synthetic scene element fixed to the display, it is clear that the star simply remains fixed in position relative to the spectacle frames, i.e. moves in absolute space with the movement of the AR spectacles.

Following the right-hand column images from top-to-bottom, showing Option B with the synthetic scene element fixed to the natural scene, it is clear that the star stays fixed relative to the natural scene whose vertical registry can be followed by the thin dotted vertical line through the left-eye lens.

Note that other features of the display can be used to improve these two situations respectively.

In Option A, with the synthetic scene element fixed to the display, the display apparatus may use other features to enhance the viewer experience. Namely, if inwardly facing cameras track the eyes as being directed to the synthetic scene element, then the synthetic scene element may be brightened in an absolute sense and/or in a relative sense compared to the natural scene brightness. For example, a person walking down the street and reading text messages in their AR spectacles would benefit from the display being driven to increase the synthetic scene element's brightness relative to the natural scene to make the text message easier to read while optionally also dimming light from the natural scene as it passes through the AR spectacles. Furthermore, the object distance of the synthetic scene element can be brought forward, through increasing wavefront curvature, so that if the wearer is focused on the synthetic scene element the natural scene goes out of focus, since it is beyond the depth of field (or depth of focus). Changing the object distance of the text information or other synthetic scene element can be done adaptively, e.g., based on eye tracking or responsive to a user command by voice or other user input.

In Option B, with the synthetic scene element fixed to the natural scene, the display apparatus may use other features to enhance the viewer experience. Firstly, the object distance of the synthetic scene element should be set so that both the natural scene and the synthetic scene element are within the viewer's depth of field. The object distance may be set to a fixed distance selected according to the context, e.g. set to the range of headlights for night driving. The object distance could also be set to infinity in some contexts, e.g., for an aircraft pilot. The brightness and optionally also colour of the synthetic scene element should also be chosen to be appropriate so it does not saturate out or distract from perception of natural scene elements while at the same time remaining easily visible in the fused natural and synthetic scene. Fine image stabilisation of the synthetic scene element may play a significant role here to avoid the synthetic scene element becoming an annoying distraction by appearing to jiggle around in the natural scene.

### Representation of Peripheral Vision Features in a Synthetic Scene

Human vision has a remarkably small angle of high acuity, corresponding to the foveal region, and when a person looks at a scene their eye roves around and builds up the illusion of a high-resolution object, while in reality this high-resolution region (instantaneously) corresponds to an area about the size of the thumb nail at arm's extent. Thus, the eye essentially only ‘looks’ at a small area close to the line of sight (eye optical axis). This means that in the context of a near-to-eye display apparatus according to the invention, such as AR spectacles or VR goggles, the incremental advantage for perceived image quality of rendering synthetic scene elements diminishes with increasing angular divergence away from the line of sight. Certainly, for angles outside the central vision angles, i.e. at peripheral vision angles, there is little marginal benefit in rendering synthetic scene elements. The same is true to a lesser extent for central vision angles well away from the line of sight. This aspect of vision perception can be exploited with near-to-eye display apparatus according to the invention to lower the specification both of the display panel and the computational intensity involved in scene rendering during use. A small rendering area may be imposed by the limited physical extent of the NLO display, when the display apparatus only incorporates a relatively small area of the NLO material. A small rendering area may also be an advantageous operational choice to only expose a part of the available NLO material area to reduce the computational intensity of image formation and also to reduce power consumption.

While it is that case that the eye will only look at a small part of the total angular area lying within the visual field at any one time, it would be desirable to replicate the perception away from the line of sight and in particular at peripheral vision angles. A route to achieve this is to provide illumination that creates the sensation of peripheral vision. This can be achieved in AR spectacles by providing a plurality of visible light sources distributed around the inner perimeter of the left and right rims of the spectacle frame. A similar placement of light sources can be provided in a VR goggles format. The light sources are arranged so that the emitted light is incident on the pupil at a glancing angle and can therefore be accepted into the eye. Moreover, preferably the light sources are arranged recessed in a mounting to shroud the light sources from direct view by others, i.e., from the distal side of the headset. The light sources could, for example be individually recessed or collectively arranged in a recessed channel.

Because the eye has no particularly high resolution from these angles, a perception of peripheral vision, or vision at smaller angles that are nevertheless far away from the line of sight (eye optical axis), is provided simply by generating light of an appropriate brightness and colour from the corresponding angle to ‘fool’ the eye into merging information from the narrow angular range of high acuity into information at larger angles that is provided with the peripheral vision light sources to form a perception of a full optical field. Placing the peripheral illumination inside the frame of the display and close to the eye allows sufficient light to enter into the pupil to give the illusion of display permanence. The degree to which this approach is beneficial will depend on the brightness of the natural light scene. With a bright natural light scene, the provision of this peripheral light will be relatively unimportant, whereas in a dark natural light scene (e.g. at night), it will be more beneficial to add peripheral lighting.

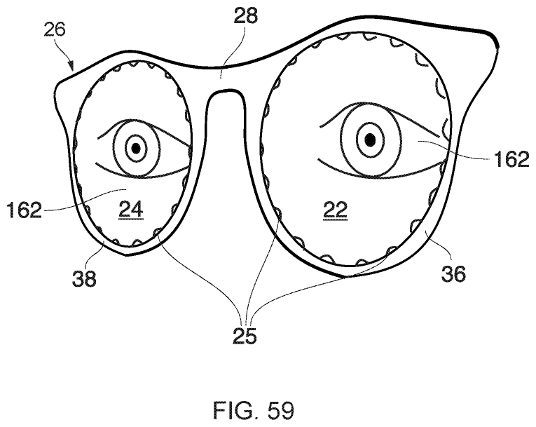

FIG. 59 is a schematic perspective drawing showing the front part of a pair of spectacles, namely the spectacle frame 26 comprising left and right lens rims 36, 38 which accommodate left and right eye spectacle lenses 22, 24 separated by a nose bridge 28. The spectacle arms are not shown. The eyes of a wearer are also shown schematically with eyeballs 162. A plurality of light sources 25, such as a strip of LEDs are arranged distributed around each of the left and right lens rims 36, 38 to radiate light inwardly to each eye, so that the light is perceived in the peripheral vision of the spectacles wearer. The light sources can be controlled individually and each light source can be controlled in brightness and colour.

The light sources 25 are thus able to mimic some aspects of what a wearer would perceive in their peripheral vision of a natural scene. This may be when viewing a wholly synthetic scene (i.e. virtual reality scenario or NCTE display scenario) or when viewing synthetic scene elements overlaid on a natural scene (i.e. augmented reality scenario). In an example VR scenario, the light sources 25 can be used to simulate light sources in the peripheral vision of a person seated in a room, to mimic light entering the room from windows or light emitted from a ceiling light. In an example AR scenario, the light sources 25 may be used to indicate the presence of bright or coloured synthetic scene elements in the peripheral vision which are then rendered in the AR spectacles only when the wearer changes their viewing direction so that the synthetic scene element falls within their central vision (or a narrower portion thereof more closely encompassing high acuity vision on the fovea). The light sources 25 may be recessed or otherwise arranged and configured so that they only emit light inwardly towards each eye of a wearer and specifically are not directly visible to other people in the vicinity of the wearer.

### Contact Lens Near-to-Eye AR Display

The above-specified display apparatus may be incorporated into a contact lens format as a “smart” contact lens (see e.g. US2016091737A1) in which AR content is presented in the contact lens using a display panel according to the invention embedded in the contact lens. We note that in this context, the smart contact lens need not be associated with any vision impairment correction, i.e., need not be a lens. A contact lens is a thin deformable sheet of transparent material configured to be placed directly in contact with the eye surface over the pupil area.

The nature of the visible beam generation according to the invention enables a contact lens to be provided without electronic power, electronic processing capability and low-power wireless transceivers. This is important, since current technology of smart contact lenses that incorporate electronics is very challenging and certainly not able to embed laser sources and image processing capabilities into a contact lens format.

Specifically, to realize a display apparatus according to the invention with contact lenses, the contact lens incorporates the display panel, whose components are all passive. The principal display panel components are the NLO material and suitable optical coupling ports to allow the input beam pairs to enter into the display panel, which need not be conceptually different from those used in an AR spectacles format. In addition, the input beams need to be provided and directed into the display panel, which is now a contact lens. This input beam delivery may be via spectacle frames. The spectacle frames accommodate the input beam sources and also incorporate inwardly facing cameras to locate and track the optical coupling ports, which could be located at or near the rim of each contact lens. (The inwardly facing cameras may be the same ones as already discussed in relation to eye tracking.)

In the AR embodiments discussed elsewhere in this document the optical coupling of the input beams into the display panel has been illustrated as being through the front face (FIG. 10) or through the end face of the display panel (FIG. 13), either directly or via a diffraction grating. For a contact lens format display panel, the optical coupling of the input beams into the display panel will either be through the back face or the end face. The coupling in could be direct or via a diffraction grating as described for the AR embodiments. Moreover, the design approach as described with reference to FIG. 24 could be advantageously applied in a contact lens format display panel so that only one input beam coupling-in location would be needed.

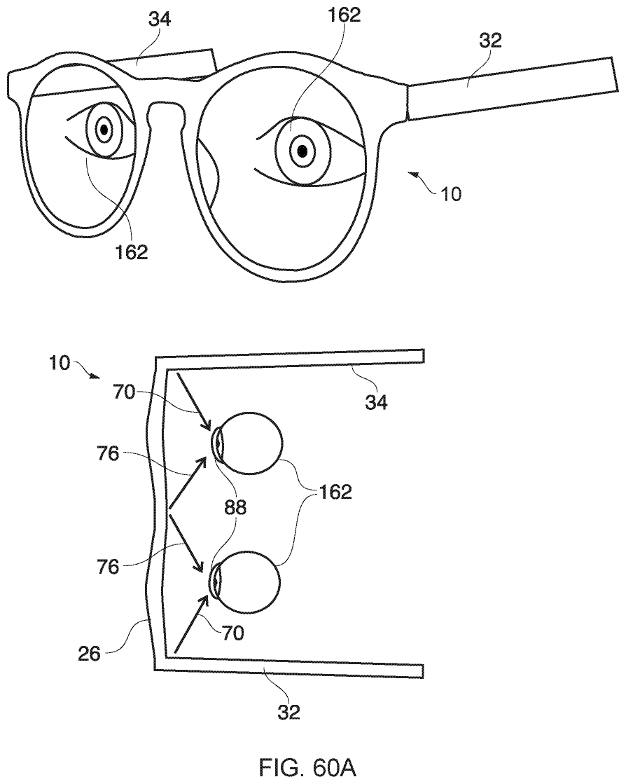

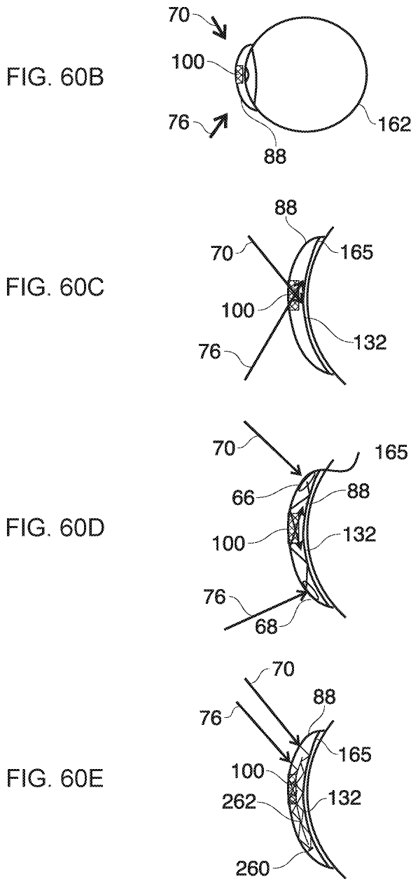

FIG. 60A shows a display apparatus according to an embodiment of the invention comprising contact lens format display panels 88 placed directly onto the eyeballs 162 of the user in combination with a spectacles frame 26 incorporating the remaining components of the display apparatus. These are principally the first and second beam source 16, 18 for providing the first and second input beams 70, 76 and inwardly facing cameras 54, 56 (not shown but same as FIG. 26). The spectacle frames may or may not incorporate lenses, since lenses are not part of the display apparatus other than, if present, allowing the wearer to view the natural scene. Rather, the role of the spectacles frame in this embodiment is to accommodate the input beam delivery optics. The contact lens format of the display panel does not change the main aspects of the layer design compared with AR spectacles, so for example the discussion around FIG. 16 will apply. In this respect, we specifically refer to the IR absorbing layer 132 for preventing stray input beam light entering the eyes of the wearer. The input beams 70, 76 are shown with arrows coming from the frame, more specifically from the edges of the frame where the temples meet the frame).

One application area of interest for a contact lens format display panel and associated apparatus components according to the invention is for eye testing, e.g., by an ophthalmologist. An ophthalmologist would be able to observe a patient's eye while light is being sent into the eye via the contact lens. Moreover, light could be sent into the eye by the display panel and then another diagnostic apparatus (not shown) used to collect light that emerges from the eye which has been scattered, reflected, diffracted, Raman shifted, fluoresced etc. from the light injected into the eye by the display panel.

FIGS. 60B to 60E show further details of contact lens embodiments.

FIG. 60B shows the contact lens 88 in position on the eyeball 162 with one pair of input beams 70 and 76 shown as entering the contact lens on opposed sides of the distal surface.

The contact lens 88 is illustrated to shows the centrally located NLO material 100 which includes a phase-matched region (not separately shown).

FIG. 60C shows a magnified version of FIG. 60B with the contact lens 88 seated on the corneal surface 165 of the eye. The input beams 70 and 76 are shown as entering the NLO material 100 and crossing without any internal reflections within the contact lens 88.

FIG. 60C shows a front filter layer 132 which is an additional optical layer between the NLO material layer and the proximal surface of the contact lens 88 that sits on the corneal surface. The filter layer 132 is absorbing at the wavelengths of the input beams (typically infra-red wavelengths) and thereby prevents input beam light from entering the eye.

FIG. 60D is similar to FIG. 60C but uses a different optical configuration for coupling-in the input beams 70, 76. The input beams 70, 76 are coupled into the contact lens 88 at respective input beam ports 66, 68. The ports are implemented as diffractive coupling regions, i.e., for example transmission diffraction gratings formed on or in the contact lens 88 to redirect the input beams at an appropriate angle so they are delivered to the correct location in the phase-matched region of the NLO material layer 100. Internal reflections may be used as described elsewhere in this document with reference to a spectacle type lens.

FIG. 60E is similar to FIG. 60C and FIG. 60D but uses a different optical configuration for coupling-in the input beams 70, 76. The input beams 70, 76 are coupled into the contact lens 88 in a single input beam port 66 and then pass with a succession of total internal reflections to their crossing point in the phase-matched region of the NLO material layer 100.

They do this in the manner of FIG. 24 in which one of the two beams passes beyond the phase-matched region and is then returned by a mirror arrangement 260. Namely, input beam 70 passes through a proximal region of the contact lens 88 to mirror arrangement 260 via multiple internal reflections from the proximal side of a mirror layer 262 extending in the plane of the contact lens 88 and a proximal mirror layer (not separately shown). Input beam 76 on the other hand passes through a distal region of the contact lens 88 to the crossing point via multiple internal reflections from the distal side of the mirror layer 262 and a proximal mirror layer (not separately shown) or simply the air-contact lens surface. This configuration allows both input light beams of a pair to be delivered into closely adjacent locations on the same side of the contact lens, which may be particularly advantageous in a contact lens format. In the configuration of FIG. 60E diffractive coupling as described with reference to FIG. 60D may also be used for one or both of the input beams 70, 76.

For a contact lens, it is important that the lens regions in contact with the eye are compatible with the corneal surface and the inner surfaces of the eyelids. Thus, the contact lens surfaces must be smooth and biologically and chemically compatible with the eye. The contact lens can contain other materials provided that they are encased within the biologically and chemically compatible material. As a contact lens implementation of the invention will only require a small phase-matched region of NLO material-likely no more than 2 mm in diameter-many choices of material are possible including inorganic QPM materials such as PPLN or PPKTP, and also organic NLO materials. For the above configurations that employ reflective layers, these mirror surfaces can be designed with thin-film coating approaches and, since they are only required to be reflective for the input beams, which are at infrared wavelengths, it is possible to ensure that the mirror surfaces remain transparent in the visible.

### Window Panel Display

The above-specified display panel may be integrated with a transparent window panel of another structure as an AR display panel. The window panel may be flat (i.e. planar) or curved or some other shape and the display panel is shaped to match. The window panel may be of rectangular or square shape or some other shape. The window panel may have a minimum width and/or height dimension of one of: 30 cm, 40 cm, 50 cm, 60 cm, 70 cm, 80 cm, 90 cm or 100 cm or larger. The input beams would be routed into the window and then the display panel with suitable input beam routing components as described elsewhere in this document.

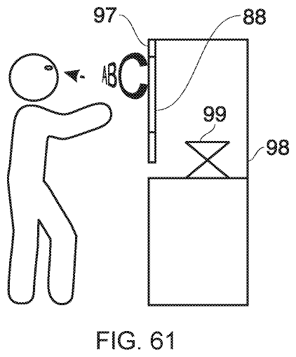

FIG. 61 shows a window AR configuration according to this invention using the example of a fume cupboard or glove box as used in a laboratory or cleanroom setting. A display panel 88 according to the invention is integrated with a front window 97 of the casing 98 of the fume cupboard. The display panel 88 may be an extra layer fixed over the exterior surface of the window or integrated with the window as described with reference to FIG. 55 and FIG. 56. The window could be set in a wide variety of other casings. The window panel has a proximal surface facing towards an intended viewing region and a distal surface facing away from the viewing position. In the example of a fume cupboard, the proximal surface would correspond to the outside surface and the distal surface to the inside surface of the window panel and display panel. The operator standing or seated in front of the window panel will have a fixation point, i.e., be concentrating their view, on a sample space positioned approximately centrally on the fume cupboard countertop, e.g., at a sample arranged on a sample holder 99, which will be at a distance of perhaps 50 cm to 150 cm from the eyes. The window panel will be at a closer distance of perhaps 10 cm to 30 cm from the eyes for a person standing in front of the window or perhaps more, e.g., up to 60 or 70 cm, for a person seated in front of the window.

The ability of the display panel according to the invention to control the wavefront radius of curvature in the synthetic scene allows the image plane of the synthetic image to be set to a larger distance than the image generation plane, i.e., the plane of the display panel. For example, the synthetic scene image can be formed so it appears to the operator of a fume cupboard as if it were at the same or similar distance to the sample space, or perhaps behind the sample space, e.g., at the distance of the back panel or back wall of the fume cupboard.

For interfaces formed between the display panel and the window panel in which it is set various measures can be undertaken as described with reference to FIGS. 55 and 56. In particular, suitable anti-reflection coatings may be provided optimised for efficient coupling of the input beams from the window panel into the display panel. Moreover, surface roughening may be provided over some area portions of the interfaces to cause visible light scatter and thereby inhibit glancing angle specular reflection. Further, light absorbing material to absorb visible light may be provide over some area portions of the interfaces to absorb light that would otherwise refract or reflect from the interfaces.

### Correcting Eyesight Deficiencies

Many people have less than perfect eyesight. Common vision defects are long-sightedness, short-sightedness and age-related accommodation loss (effectively spherical power vision defects) and astigmatism (effectively a cylindrical power vision defect). An eyesight or spectacles prescription, as issued by an optometrist, will define the correction parameters needed to be incorporated into spectacles lenses (or contact lenses) in terms of spherical power and cylindrical power, which for older people will often be different for near vision and far vision owing to age-related accommodation loss.

These common vision defects can be addressed with according to the invention by providing a display apparatus, which may be NTE (e.g. AR spectacles) or NCTE (e.g. a smartphone or laptop display), that corrects for spherical power and cylindrical power in a personalized way. This may be according to foreknowledge of the viewer's eyesight prescription, i.e., the display apparatus can look up the viewer's prescription from memory. This may also be from active ophthalmic diagnostics by the display apparatus of the viewer, e.g., using forward-facing cameras. The viewer who would ordinarily wear corrective spectacles can thus view the display without those spectacles, since images are formed on the display in a way that incorporates the viewer's eyesight prescription. Moreover, the display can apply different corrections to near vision and far vision according to the viewer's prescription.

The user can be identified with suitable software, such as standard authentication software, for example by fingerprint scanning, voice recognition or face recognition. Once the user has been identified, the eyesight prescription associated with that individual can be loaded via a data communication link and stored in local memory of the display apparatus. Multiple users of the same device, whether that be augmented reality spectacles, virtual reality goggles, a smartphone, a tablet computer, a laptop computer, a computer monitor or a television, can thus have their individual eyesight prescriptions corrected for by suitable phase modulation. An alternative approach is for the headset or other format device to be configured to perform an eye test on the wearer to generate an eyesight prescription with said correction values and store it in said memory. The individual would be served different test images, like in any conventional eye test, and be asked to comment on which images are brighter, legible etc.

Returning to the issue of how the viewer can make use of our new technology—the first involves the addition of optical correction within the spectacles. For example, by placing an optical prescription derived element within the glasses. As an example, the wearer of the glasses might be short-sighted—with an eyesight challenge that is usually solved with a negative lens. One approach therefore is to place a negative lens within (or closely adjacent to the display element).

A corrective approach suitable for astigmatism and also for mild degrees of short-sight or long-sight is to use the optical image forming attributes of display apparatus according to the invention to generate synthetic scene light with a pre-distorted wavefront so that the synthetic scene image is corrected for the vision defect of the viewer and hence clear.

As a specific example, for a viewer with no spherical power, a more complex phase structure on the phase controlling beam can be used to give different powers with a cylindrical component with a defined axis. This will mean that the viewer will be able to see the synthetic scene image without astigmatic distortion. The display apparatus feeds the viewer's prescription data (e.g. power of astigmatism and its axis) into the phase modulator during operation of the display apparatus, so that it is corrected for. If there is a spherical power defect, this can also be corrected for to present the synthetic scene at a single object distance, or a range of object distances (for a 3D image), that the viewer is able to bring into focus. Furthermore, if the AR spectacles are progressive lenses (also called varifocal lenses), then an inwardly facing eye tracking camera can be used to compensate for the effect of eye direction and view position through the lens to create the most realistic image for the viewer.

### Organic NLO Materials

### Introduction—Organic Materials

Displays for different purposes vary in size from a few millimetres mm up to 10 metres or more. Example smaller displays are for smart watches or AR spectacles or VR goggles. Displays for smart phones and tablet are somewhat larger. Computer monitors and television screens are larger still, perhaps 10 inch to 90 inch diagonal length (25 cm to 225 cm). Even larger displays are found in cinemas, advertising hoardings and arenas, such as indoor and outdoor sport stadiums. Many different display technologies are used depending on the required brightness, the cost, the colour gamut, etc. These include liquid crystals, organic LED, and DLPs. Historical technologies include plasma TV, cathode ray tubes and laser back-projection.

For the new class of display panel described in this document, where the light for forming the display image is generated using non-colinear mixing of infrared beams in an NLO material, a suitable NLO material needs to be selected. The NLO material needs to be transparent at visible wavelengths and also manufacturable into gratings of appropriate period for quasi-phase matching at visible wavelengths means typically in the range 500 nm to 2 micrometres for sum frequency mixing of the two infrared beams, which points towards using crystalline oxide materials such as LiNbO3 and KTP (KTiOPO4). If higher order mixing is used, e.g., double the frequency of one of the input beams mixed with the frequency of the other input beam then the range of suitable grating periods will be higher.

While crystalline oxide materials can be used to provide panels for smaller displays of wristwatch or spectacle lens size, current technology does not allow for production of metre scale sheets of LiNbO3 and KTP as would be needed for computer or television size displays or larger, although such larger areas could be assembled from arrays of smaller single pieces of LiNbO3, KTP or other NLO crystals.

We propose fabricating a transparent display panel with embedded phase matched gratings of arbitrary size based on the use of organic NLO materials. By arbitrary size, we mean panels appropriately sized for any display size ranging from small displays as required for wristwatches up to very large displays for cinemas, advertising hoardings and arenas.

We propose a display panel containing nonlinear optical, NLO, material capable of generating a visible beam for image formation by mixing a pair of near-infrared beams by crossing them in the NLO material in a non-colinear configuration. The display panel comprises a succession of alternating first and second NLO material layers to form a grating having a period selected to phase match to a selected combination of the frequencies of the near-infrared beams and the frequency of the visible beam. The NLO material layers are formed of a non-centrosymmetric organic material that is transparent at the wavelengths of the visible beam and the infrared beams.

Historically, there has been research on organic NLO materials. A good summary can be found in the 2001 textbook:
Organic Nonlinear Optical Materials—Bossard, Sutter, Pretre, Hulliger, Florsheimer, Kaatz and Gunter. ISBN 2-88449-007-8 Gordon and Breach Publishers, 2001

However, interest in organic NLO materials has been limited, because their properties are inferior to inorganic NLO materials such as LiNbO3 and KTP. Specifically, organic NLO materials discovered to date, when compared to popular NLO inorganic crystal materials, tend to have lower power handling capabilities and lower melting points. They are often also mechanically soft and consequently not well suited for optical polishing. These attributes of organic NLO materials are significant disadvantages for high power laser applications, and therefore stand at the forefront of current perception that inorganic crystalline NLO materials are superior. However, these properties of organic NLO materials are not significant disadvantages for low power applications. In particular, the new class of display technologies mentioned above based on non-colinear sum frequency generation of infrared beams can be viewed as a low power application, since the amount of visible light that needs to be generated in the display panel is small, with optical power levels in the milli-Watt to micro-Watt level being sufficient in many cases.

### Detailed Description—Organic Materials

It is proposed to use an organic material for the nonlinear optical material used to create the gratings needed for quasi-phase matching. The gratings are provided by a layer stack of the nonlinear optical material in which the domain orientation in the nonlinear optical material reverses from layer to layer so that the polarity (i.e. sign) of the nonlinear coefficient changes from layer to layer. A layered structure of this kind is often referred to as poled. The layers may be layers of an appropriately non-centrosymmetric organic material. The poling process most often takes place during manufacture by application of electric fields of opposite polarity to each of the layers as they are formed, this being referred to as electric field poling. Other processes exist for performing the poling on the material after its manufacture, e.g., by using light fringes.

The following considerations are relevant for the selection of an appropriate NLO material for the new class of display technologies mentioned above.
1) The NLO material needs to have appropriate nonlinear coefficients to operate when illuminated with the two input laser beams. This requires a non-centrosymmetric material (e.g. a polar or ferroelectric material) and a material in which the optical nonlinearity is large enough to generate a sum frequency light beam of sufficient brightness without excessive power needed in the input beams.
2) The NLO material needs to have a second order nonlinearity in which sufficient phase matching can be achieved to create sum-frequency light either by quasi-phase matching or intrinsic birefringence. For an NLO material that relies on quasi-phase matching, it needs to be possible to create a periodic or near-periodic structure in the non-centrosymmetric material that provides for coherent addition of the sum frequency light over a sufficient length to yield a useful level of optical output. For an NLO material that relies on true phase matching, the material needs to have sufficient intrinsic birefringence. The consequent double-refraction effect may limit the use of such materials to non-transparent displays. Here it is noted that the second order nonlinearity may be generated by electrical biasing of a third or higher order nonlinear material, so the NLO material can in principle be either a second or third order nonlinear material.
3) The NLO material needs to be sufficiently transparent or translucent for operation in the intended class of display. Here a distinction needs to be made between near-to-eye augmented reality displays where a high degree of transparency in the visible is a requirement in order that the natural scene is visible through the display and non-close-to-eye displays such as for smart phones, personal computers and televisions where the display must allow the image forming light to emerge, but full transparency is not required. Nevertheless, even when the display device is not transparent, the NLO material should not be too strongly absorbing of the light which is generated in the material by the sum frequency mixing, so a certain degree of translucency in the visible range is needed. Generally, the NLO material needs to be transmissive enough in the visible to allow for NLO operation without excessive optical heating or too much absorption that might cause optical damage or loss of electrical efficiency. This requirement will not be too stringent, since the thickness of the NLO material layer will in most cases be quite small, perhaps 1 mm or less. Transparency is also required for the input beam wavelengths that mix to generate the visible light.
4) The NLO material and the process for manufacturing a layer of it must be suitable for creating an area the same size or larger than the intended display area. While for some displays areas of 1 mm by 1 mm might suffice (e.g., when embedded in a simple one sector of visible field display), the ability to make large areas is attractive for larger display panels increasing in size from regular spectacles lenses, through smart phones, tablets, laptop computers, desktop monitors, televisions etc.
5) The NLO material should be manufacturable in large volumes at reasonable cost.
6) The NLO material should be manufacturable in layers of different shape, e.g. flat layers, layers curved in one axis, layers curved in two axes.

The 2001 textbook Organic Nonlinear Optical Materials by Bossard et al ibid, the full contents of which are incorporated herein by reference, identifies several primary routes for manufacturing NLO materials. Specifically:
1) Solution growth—where an appropriate solvent is slowly evaporated to grow bulk crystals
2) Melt growth—where the material of interest is melted and then crystalised.
3) Vapour growth—where a vapour of the material is deposited onto a substrate (at lower temperature) and the vapour can be created by thermal heating, laser heating or laser deposition, from e-beam excitation/heating, or by introducing pre-cursor gases with appropriate activation (e.g. RF plasma excitation).

While the above manufacturing methods are known for making inorganic NLO crystals they can also be used for making organic NLO materials. The temperatures used in these manufacturing processes are usually lower for organic materials than for inorganic materials, not least because the nature of organics is often that they will degrade in structure at higher temperatures (the carbon backbone or carbon rings will break apart). In general, such techniques will often lead to non-crystalline or amorphous deposition, and so it is often useful to apply an electric field during growth to create a polar material capable of exhibiting second order nonlinearity. In addition to the above techniques, the scientific literature also describes use of the following further manufacturing methods suitable for organic materials:
4) Langmuir Blodgett Growth—in which a substrate is dipped into a trough or container with a liquid (e.g., water) which has a thin-film of molecules which have hydrophilic and hydrophobic ends, so as to form controlled layers.
5) Use of liquid crystals which can feature appropriate order (at the few hundred nanometres to few micrometres scale).

The organic NLO material will need to be phase matched with a relatively short period grating (i.e. a relatively large grating k-vector). Organic NLO materials also tend to have higher natural dispersion than inorganic NLO materials, which will also tend to reduce the grating period that is needed. The grating period may typically be around 1 micrometre or less. Indeed, as the two input beams approach 180 degrees in angle the phase matching period will asymptotically tend towards λ/2n. A change from second order phase matching to a higher order can be used to increase the grating period in any particular organic NLO material and increase the limit of input beam angle that is usable, e.g., higher-order phase matching (3^{rd} order, 5^{th} order, etc).

The short grating period that is needed provides some limitations but also opportunities for creating appropriate NLO materials for the new class of display. Materials can be considered that either self-organise or can be controlled to organise (such as a liquid crystal) or materials that are produced in layers where we can apply electric fields as the layers are produced to create the desired phase matched grating structure. In some approaches we can also look at mechanical approaches (such as complex structured Langmuir Blodgett manufacturing methods) to create the layered grating structure that is required.

The following table presents candidate NLO materials with parameter values for the absorption edge and nonlinearity.

The parameter λ_eg is the wavelength of the transition between the ground state and excited state, the e-to-g transition, which is representative of the absorption edge of the material, more specifically the wavelength below which (or the photon energy above which) the material absorbs light. For colour display applications, the material should be transparent across the visible spectrum or at least over a reasonable range of blue, green and red colour bands. An absorption edge at or below approximately 450 nm, and ideally below 400 nm, is needed to allow the material to operate efficiently at blue wavelengths as well as green and red wavelengths. For non-full-colour applications (e.g. red-only coloured display), larger values of λ_eg may be acceptable.

The nonlinearity parameter indicates the strength of the nonlinearity possessed by the material. Materials with larger nonlinearity coefficients are of course more attractive, since then the material will generate more visible photons per unit power of the infrared beams that are being mixed in the nonlinear process.

| | | Non- | |
|---|---|---|---|
| | | linearity | |
| Compound | λ_{eg} | (pm/V) | Reference |
| DCANP | 375 nm | ~7 pm/V | https://doi.org/10.1063/1.102560 |
| APDA | 384 nm | 50 pm/V | https://doi.org/10.1063/1.110634 |
| DMNP | 450 nm | 90 pm/V | https://doi.org/10.1063/1.106274 |
| MBANP | 450 nm | 63 pm/V | https://doi.org/10.1143/JJAP.28.1622 |

The full chemical names of these materials are as follows:

| Short Name | Full Name |
|---|---|
| DCANP | 2-docosylamino-5-nitropyridine |
| APDA | 8-(4′-acetylphenyl)-1,4-dioxa-8-azaspiro[4.5]decane |
| DMNP | organic 3,5-dimethyl-1-(4-nitrophenyl)pyrazole |
| MBANP | (−)2-(α-methylbenzylamino)-5-nitropyridine |

More generally, suitable candidate organic materials with nonlinear optical properties are ring molecules (e.g. pyridine, aniline, benzene) to which donor and acceptor molecules are attached at opposite sides of the ring. Namely, suitable candidates for NLO organic materials are based on:
nitro-aniline (C6H5NH2 containing a nitro group NO2 to form C6H6N2O2),
nitro-pyridine (C5H5N containing a nitro group NO2 to form C5H4N2O2), or
nitro-benzene (C5H6 containing a nitro group NO2 to form C6H5NO2)
   with acceptor and/or donor molecules arranged on opposite sides of the ring molecule. The donor and acceptor molecules respectively donate or accept electrons onto the ring molecule. It is the asymmetry created by the donors and acceptors that creates the nonlinear response to the optical field. The length of the molecule also affects the magnitude of the nonlinearity, with a longer molecule having a higher nonlinearity, and also the twist between different organic moieties. Specifically, substituting acceptors such as NO, NO2, CHO, CN or donors such as N(CH3)2, NH2, OCH3, OH will increase nonlinear polarizability. The acceptors and donors listed above are in order of decreasing nonlinear polarizability, i.e. the first mentioned acceptors and donors are the best candidates.

Transparency of the NLO organic material is not only required in the visible range but also for the input beam wavelengths that mix by sum frequency generation to generate the visible light. In a colour display, there will be three input beam pairs, which requires between 3 to 6 different wavelengths to be used. When selecting suitable input beam wavelengths, the infrared cut-off of the NLO organic material needs to be considered. Specifically, the transmission window of many organic materials closes at around 1300 nm due to the onset of absorption by C—H, C—C, and N—H bonds. The input beam pair wavelengths, in particular for the red, therefore can be chosen to be within the transmission window of the NLO organic material being used.

Specifically, if one of the input beams for each of red, green and blue is generated with an optically pumped Nd:YAG laser operating at 1064 nm, then the other input beams of each input beam pair will need to be at around 1550 nm, 1064 nm and 780 nm respectively to generate red, green and blue light from sum frequency mixing. The input beam for the red at 1550 nm would therefore be problematic for use with an NLO organic material with an absorption edge at around 1300 nm.

One solution to provide sufficient transparency for the input beams is to more closely match the wavelengths of at least the two red-producing input beams so that the longer wavelength one of those input beams is at or below 1300 nm. For example, for equal wavelengths, red light can be produced with 1260 nm+1260 nm input beams which sum to 630 nm. Another example is that, if one of the input beams is at 1300 nm, then the other input beam would need to be at 1225 nm to produce red light at 630 nm. Semiconductor diode lasers would be appropriate sources for such wavelengths, either edge emitting or vertical cavity surface emitting. For example, distributed feedback lasers (DFBs) based on the semiconductor alloy systems InGaAsP or InGaAsN can access appropriate wavelengths in the desired range 1260±40 nm for generating red light. Raman lasers would be another appropriate source for such wavelengths. A Raman laser uses a nonlinear optical material as its gain medium with gain being based on stimulated Raman scattering instead of stimulated emission for a conventional laser. With a Raman laser there is freedom to select a desired lasing wavelength from the pump wavelength provided that the NLO gain medium is sufficiently transparent and has a sufficiently strong nonlinearity at both the pump and lasing wavelengths. Moreover, Raman lasers can be cascaded to further shift the lasing wavelength away from the pump wavelength by nesting cavities. Specifically, a laser based on a single Raman shift is known from R. Bannerman, D. Smith, A. Gray, J. Gates, N. Broderick, C. Gawith, and P. Smith, “Short single-frequency self-pulsing Brillouin-Raman distributed feedback fibre laser,” Opt. Express 30, 12427-12439 (2022) https://doi.org/10.1364/OE.445876 which lases at 1119 nm from a 1064 nm pump laser (i.e. Nd:YAG). This design could be modified by adding a second Raman shift in addition to the first Raman shift to produce a laser lasing at 1260 nm which could then be used for both input beams of a pair for generating red light at 630 nm.

An example wavelength combination for a colour display using semiconductor diode lasers is 1064 nm (e.g. AlGaAs/InGaAsP), 780 nm (e.g. AlGaAs/InGaAsP) and 1269 nm (e.g. GaInNAs or InGaAs) is:

1269 nm + 1269 nm = 635 nm (red)
1064 nm + 1064 nm = 532 nm (green)
1064 nm + 780 nm = 450 nm (blue).

An example wavelength combination for a colour display using a 2-step cascaded Raman laser with a 1064 nm pump is:

1260 nm + 1260 nm = 630 nm (red)
1064 nm + 1064 nm = 532 nm (green)
1064 nm + 780 nm = 450 nm (blue).

An alternative solution to provide sufficient transparency for the input beams, especially the longer wavelength one of the red input beams, is to use deuterated analogues of a known NLO organic material to push out its absorption edge further into the infrared. Specifically deuterated analogues of the above-mentioned DCANP, APDA, DMNP and MBANP could be used. In a deuterated compound, deuterium is substituted for hydrogen. The absorption peaks linked to fundamental and higher harmonic vibrations of C—H bonds and N—H bonds in the organic material are thus shifted to longer wavelengths by replacing H by D. The deuteration approach is well known in optical waveguides using organic materials. Perhaps surprisingly, deuteration is not associated with too much additional expense, since D2O (deuterium oxide) is readily available and relatively inexpensive. A conceptually similar approach is to use fluorinated analogues of the NLO organic material, in which H is replaced with F. Specifically fluorinated analogues of the above-mentioned DCANP, APDA, DMNP and MBANP could be used. With deuterated or fluorinated NLO organic material, the wavelength combinations discussed elsewhere in this document could then be used, for example:

1064 nm + 1550 nm = 630 nm (red)
1064 nm + 1064 nm = 532 nm (green)
1064 nm + 780 nm = 450 nm (blue).

The NLO organic material accommodating the phase matched gratings required for the display may be mechanically integrated with other suitable organic materials to provide structural rigidity and optionally also lensing. Known optical organic materials include the plastics compounds such as polycarbonates and polyurethanes, more specifically poly (allyl diglycol carbonate) (PADC) and polymethyl methacrylate PMMA). The monomer of PADC is particularly well known, namely allyl diglycol carbonate (ADC), most commonly referred to as CR-39. These plastics compounds can be produced from organic precursors with polymerisation and then subject to mechanical formation by processes including: casting, pressing, extrusion, and melting. Such materials soften at temperatures of around 150 to 200 Centigrade and can readily be made into lenses, flat sheets or curved sheets. More widely, liquid crystal displays also make use of organic materials such as the classic 5CB (4-Cyano-4′-pentylbiphenyl), and other more recent compounds. The plastic compound material can be combined with the NLO organic material, for example to sandwich the NLO organic material, i.e., arranged on both sides of an NLO organic material layer, or to provide one-sided backing to form a substrate.

Various manufacturing methods are now discussed.

### Example 1). Vapour Phase Deposition

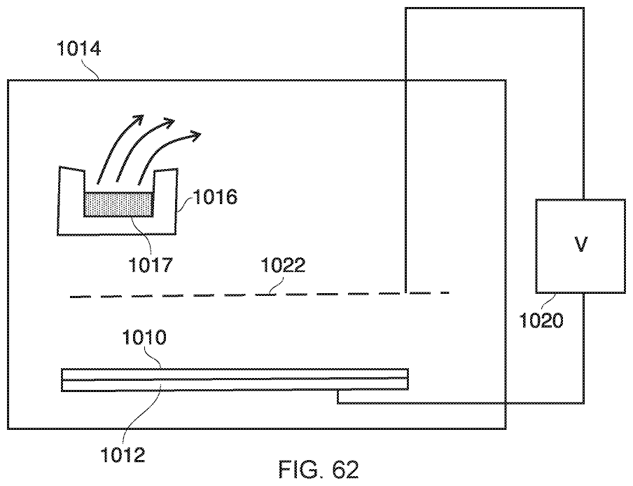

FIG. 62 shows a vapour phase deposition apparatus in which the deposition components are arranged in a vacuum chamber 1014. A substrate 1010 is placed on a conductive base 1012. The substrate may be transparent, translucent or opaque as desired for the display panel being manufactured. One or more chemical sources 1016 are provided, such as heatable boats or other vessels containing one or more chemicals 1017 needed for forming the organic NLO material layer according to the deposition process being implemented. The chemicals may be the organic NLO material itself, atomic constituents thereof, chemical pre-cursors etc. Multiple sources 1016 may be used for the different chemicals and these may be activated by heating at the same time as each other or in some appropriate time sequence.

A voltage source 1020, shown arranged outside the vacuum chamber 1014 is connected on one side to the conductive base 1012 and on the other side to an upper electrode 1022 arranged to extend as a plate above the conductive base 1012. The conductive base 1012 thus forms a lower electrode paired with the upper electrode. The voltage source 1020 is controllable to apply a desired voltage between the conductive base and the upper electrode. A series of alternating voltages with different polarity may be applied and/or different voltages of the same polarity to vary the magnitude and/or direction of the electric field between the conductive base 1012 and the upper electrode 1022.

Deposition of layers of the organic material is performed by heating the precursor materials in the source 1016 and creating a vapour which deposits material onto the substrate. The deposition can be configured to orient the polarity of successively deposited layers of the organic NLO material to create a grating of the desired period for quasi-phase matching. Adjusting how the sources are heated can be used to control the composition of the deposited material. Shutters (not shown) may be provided to permit or block the path of vapour from individual ones of the sources 1016, or all of the sources, to the substrate 1010.

There are several different heating routes that can be applied for creating the vapour, for example, ion beam heating, electron beam heating, resistive heating, laser heating, etc. The base can be heated or cooled as another deposition parameter to vary how deposition proceeds.

In the illustrated configuration, the electric field is applied normal to the plane of the layers of deposited material so the electrodes are parallel to the plane of the layers of deposited material. This would be a suitable configuration for poling in the plane of the NLO material layer(s). It is also possible to apply the electric field in a direction that is in the plane of the layers. This would be a suitable configuration for poling perpendicular to the NLO material layer(s), in which case the electrodes would then be arranged vertically (as viewed in FIG. 62 at either end of the substrate. More generally, the electric field can be applied in an arbitrary direction as desired by appropriate positioning and alignment of the electrodes, which would be the arrangement for poling at some angle between in plane and perpendicular to the planes of the NLO material layers, i.e., an acute angle between 0 and 90 degrees.

### Example 2). Creation of a Multilayer Hybrid with NLO Materials and Transparent Conductive Layers for Poling—e.g. Rolling Extrusion

The NLO material requires a grating for quasi-phase matching with a period defined by the input beam wavelengths and angles of incidence according to the non-colinear mixing used by display panels according to the invention. The grating period (often called coherence length) that is needed will typically be in the range 500 nm to 2 micrometres.

One route to creating such a NLO material layer with embedded grating is by creating a composite of multiple layers which alternate between a layer of the NLO organic material, which is an electrical insulator, and another organic material which is chosen because it is an electrical conductor. In this context, the conductive organic material does not need to be a particularly good conductor in an absolute sense, rather only relatively more conductive than the NLO organic material, for example by at least one, two, three, four or more orders of magnitude. However, since polymers have in general extremely high resistivity, in practice it will usually be possible for the NLO organic material to be three, four or more orders of magnitude more resistive than the conductive organic material.

Odd and even numbered ones of the conductive organic layers can be electrically addressed by opposite poles of a voltage source 1020 to create alternating polarity electric fields across odd and even numbered ones of the insulating NLO organic layers in the polar direction (or ferroelectric direction) of the organic NLO material, thereby to induce the desired periodic alternation of the domain orientation as need for periodic poling. Since very little current will flow between the layers of NLO organic material, very little electrical power will be consumed.

The electrical actuation may be a one-off operation, for example to apply a high voltage after manufacture to set up a ferroelectric NLO organic material so that the electric field induced directions are opposed in odd and even numbered layers of the NLO organic material. The electrical actuation may be applied during a cooling from a higher temperature to lower temperature process, for example during a thermal cross-linking. The electrical actuation may be applied during a process in which other excitation is used to allow re-orientation of the nonlinearity (e.g. UV exposure and applied voltage). The electrical applied voltage may be kept switched on during poling, noting that as the NLO organic material of both the even and odd numbered layers are good insulators there will be little current flow and thus little power consumption. The applied voltage in this case could be either DC or AC. AC would be preferable if the NLO organic material is a liquid crystal or when it is helpful to avoid charge migration effects.

The even and odd numbered NLO organic material layers may be of the same material or different materials. For example, the even and odd numbered NLO organic material layers may differ in composition. When different materials are used for the even and odd numbered NLO organic material layers care should be taken that their refractive indices are well matched to avoid excessive reflection loss. It is also possible that only one of the odd and even numbered layers has a second order nonlinearity that can be induced with electrical poling whereas the other of the odd and even numbered layers is not capable of being electrically poled.

It is also noted that the nonlinearity in the NLO organic material could be a third order nonlinearity in which case during operation of the display panel it would be necessary to apply a voltage using the same electrical addressing scheme as illustrated here for manufacture in order that a second order nonlinearity is created in the third order nonlinear material, where the applied voltage biases the third order nonlinearity to create a second order nonlinearity. The electrical actuation will create one electric field and the two input beams will create two further electric fields as optical frequency fields, these three electric fields combining for the sum-frequency generation. With this approach, the electric field applied during operation allows the strength of the second order nonlinearity to be controlled, which can be exploited to alter the brightness of the display. This may be an overall brightness control of the whole display, or a per pixel brightness control depending on the electrode addressing scheme implemented in the display panel.

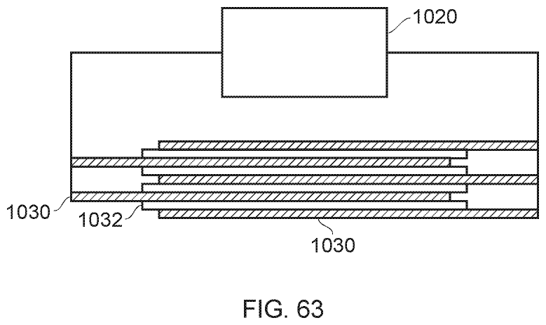

FIG. 63 shows a NLO material as described above comprising layers of a more electrically conductive organic material (e.g. a conductive polymer) 1030 and layers of a less electrically conductive NLO organic material 1032 (e.g. one of those listed above).

An electrical supply such as a voltage source 1020 is driven to alternate in polarity during deposition of the NLO organic material layers so that even and odd numbered ones of those layers are oppositely poled.

For example, as illustrated, even and odd numbered ones of the conductive organic material layers, which are effectively acting as electrodes, allow alternating polarity voltages to be applied from the left and right sides of the layer stack respectively. It would also be possible to make these connections at 90 degrees to each other, e.g., with one of the even and odd numbered electrode layers connected from either the left or right as illustrated while the other of the even and odd numbered electrode layers is connected either from the front or back in the plane of the drawing.

The layer types may be of equal or approximately equal thickness as illustrated. However, the electrode forming conductive organic material layers can be quite thin, so the NLO organic material layers 1032 can be much thicker than the conductive organic material layers (1030).

It will be convenient for deposition that the electrode forming material is an organic material with similar optical chemical and physical properties. Regarding optical properties, it is specifically important that the refractive index of the electrode forming material is well matched to that of the NLO organic material to avoid excessive reflection loss. Regarding chemical and physical properties, it is important that the interface between the different material types can be formed with good quality and that the two materials can be deposited under similar or at least compatible conditions, such as temperature and ambient atmosphere. In principle, this opens up the choice of the electrode forming material to inorganic materials, provided that their deposition is compatible with that of the NLO organic material.

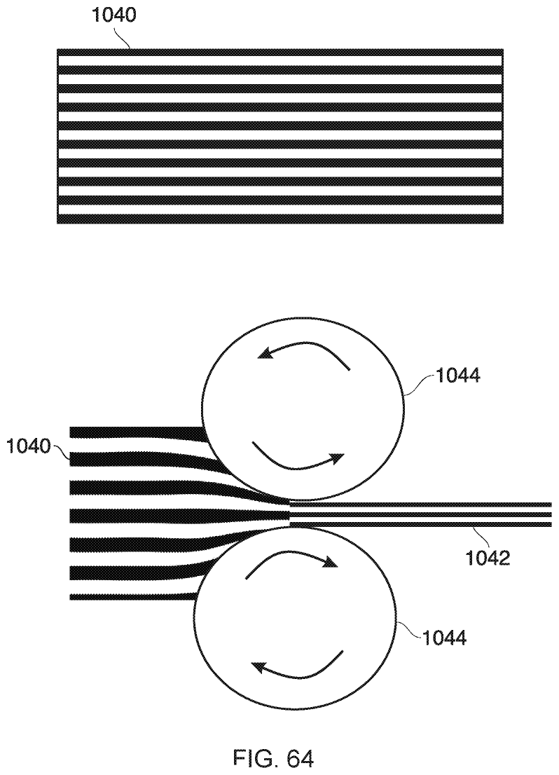

FIG. 64 shows a layer stack as described (upper diagram) and this layer stack during a process of rolling it to reduce the stack thickness (lower diagram) using a pair of counter-rotating rollers, which may be heated (heated rollers) or not heated (cold rollers). This allows the stack to be formed initially with a greater overall thickness than ultimately desired and then be rolled to the desired stack thickness. The rolling also has the effect of increasing the area of the stack in the manner of pastry or pasta rolling. The as-deposited layer stack therefore has a layered starting material with alternating polarity but with a period larger than required for forming the grating in the display, shown as period 1040. The as-deposited layer stack is forced between the heated counter-rotating roller pair 1044 to produce a thinner stack 1042 with correspondingly smaller period. It is possible to apply the rolling process more than once to successively reduce the stack thickness. For example, rolling may be performed twice in orthogonal directions so that the area of the layer stack is increased in each of the two orthogonal directions to maintain the aspect ratio of the layer stack before and after rolling, or to produce a particular final aspect ratio, as desired for the display being manufactured, e.g., 4:3, 16:9, 21:9 etc. The resultant layer stack may then be bonded onto other display panel layers, e.g. onto a substrate, such as other display panel layers made of glass, transparent optical plastics material, crystalline material etc.

It is possible to carry out the electrical alignment poling step before, during or after rolling. For example, the electrical fields may be applied to the even and/or odd numbered layers of NLO organic material in the feed of the stack that emerges at elevated temperature from the pinch roller pair, so that as the stack cools, the NLO organic material layers—even and odd—adopt their preferred poling directions-directed left and right. Rolling while an electric field is applied would be particularly suitable for the example above in which only one of the two NLO organic material types can be poled with an electric field whereas the other type is not suitable for poling.

### Example 3) Spin-Coating

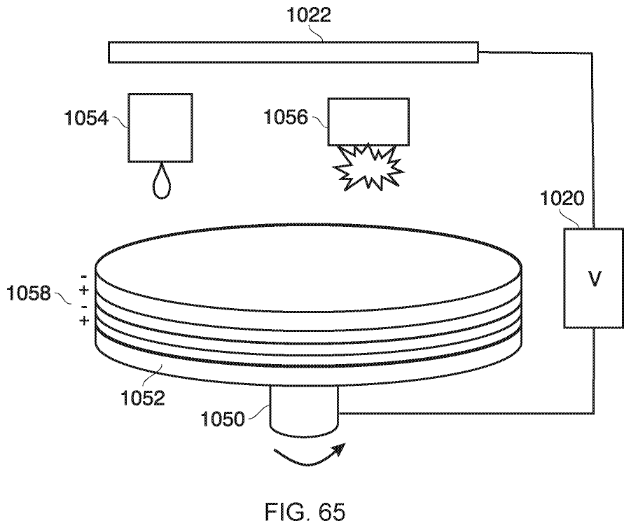

FIG. 65 shows a spin-coating apparatus for forming a stack of NLO organic material layers for a phase matched grating. Spin-coating is well known generally from the semiconductor industry for forming photoresist layers, these being thin layers of organic material formed on the semiconductor wafer which are then selectively exposed through a mask. Spin-coating may be used for any organic material formed of cross-linked polymers. A spray or drop of organic material in liquid form, for example suspended in a volatile solvent, is applied onto the surface of a substrate, which is then spun to spreads the liquid organic material over the surface by centrifugal force to form a thin coating which then solidifies, e.g., following evaporation of the solvent, into a layer of organic material. A baking process may be used to drive off the solvent. The NLO organic material is cross-linked (for example with UV exposure) while an electric field is being applied to pole the material. After each cross-linking (and poling) another layer of NLO organic material is applied with the polarity of the poling field being reversed between the formation of each layer so the next layer is oppositely poled to the previous one, thereby to build up the desired alternating orientation NLO organic material.

In the illustrated configuration, the electric field is applied normal to the plane of the layers of deposited material so the electrodes are parallel to the plane of the layers of deposited material. This would be a suitable configuration for poling in the plane of the NLO material layer(s). It is also possible to apply the electric field in a direction that is in the plane of the layers. This would be a suitable configuration for poling perpendicular to the NLO material layer(s), in which case the electrodes would then be arranged vertically (as viewed in FIG. 62 at either end of the substrate. More generally, the electric field can be applied in an arbitrary direction as desired by appropriate positioning and alignment of the electrodes, which would be the arrangement for poling at some angle between in plane and perpendicular to the planes of the NLO material layers, i.e., an acute angle between 0 and 90 degrees.

The spin-coating apparatus comprises a rotatable chuck 1050 holding a carrier plate. A substrate wafer 1052 is arranged on the carrier plate. The substrate 1052 may be of a transparent material for forming part of a transparent display panel. A liquid dispenser 1054 is arranged above the carrier plate. The liquid dispenser contains a reservoir of liquid in which the NLO organic material is held, e.g. in suspension in a solvent. The liquid dispenser 1054 is controllable to emit the liquid from a nozzle thereof in desired amounts. The emission may be as a spray of droplets or macroscopic drops. The liquid is dispensed from the nozzle onto the upper surface of a wafer that is mounted on the carrier plate. The wafer is then spun to spread the liquid containing the NLO organic material evenly over the wafer to form a layer of uniform thickness. A cross-linker 1056 is arranged above the carrier plate to induce cross-linking in the NLO organic material to fix the same. The cross-linking may be induced by ultraviolet light to induce UV cross-linking, radiative heating to induce thermal cross-linking or some other cross-linking process. The cross-linker 1056 would be a UV light emitter, such as a lamp, LED, SLD or laser for UV-cross-linking. The cross-linker 1056 would be an emitter of radiative thermal energy, such as a resistive heater element for thermal cross-linking. An alternative for thermal fixing, or just to drive solvent evaporation, would be to integrate a heating element in the carrier plate. Energy emitted from the cross-linker as light or heat may also assist evaporation of the carrier solvent. A variation would be to provide two liquid dispensers to deposit two respective liquids containing complementary pre-cursors of the NLO organic material containing respective first and second polymers that are to be cross-linked, such as a two-part epoxy. The first and second polymers then first come into physical and chemical interaction with each other during the spin coating and then are reacted to cross-link. A voltage source 1020 is provided which is connected to apply an electric field to induce poling in either direction between the carrier plate, which forms a base electrode, and an electrode plate 1022 that is arranged suspended above the carrier plate and extending parallel thereto.

The spin-coating process steps for producing layers of opposite poling direction are:
i) Dispense an amount of liquid containing the NLO organic material onto the substrate surface.
ii) Spin the substrate to create a uniform layer of the NLO organic material on the substrate.
iii) Fix the NLO organic material layer under an applied electric field so that the cross-linking takes place in a way that fixes the NLO organic material with the desired poling alignment direction.
iv) Switch the polarity of the applied electric field after fixation and solvent evaporation of the NLO organic material layer is complete.
v) Deposit the next layer by returning to step i).

This process allows a stack of multiple layers of oppositely poled NLO organic material to be built up as illustrated. The alternating polarity of the poling in the adjacent layers is illustrated by plus and minus symbols.

The resulting layer stack of NLO organic material layers may meet the final specification for the display panel or may constitute an intermediate product for the display panel that needs to be subjected to further working. For example, the stack as manufactured by the spin-coating process may be subject to the rolling process as described above, either hot rolling or cold rolling. Another example is that the layer stack may be pressed to deform the layer stack into a particular shape, such as required for a non-planar lens, with the pressing taking place under heat (hot pressing) or not (cold pressing) as required for the particular materials and the nature of the processing being carried out.

### Example 4) Langmuir Blodgett Film Deposition

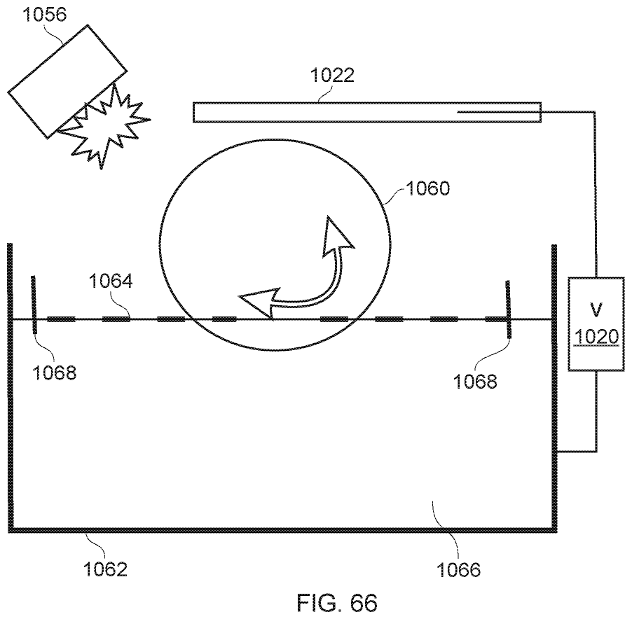

FIG. 66 shows an apparatus for forming multiple layers for NLO organic material for a phase matched grating with Langmuir Blodgett (LB) films.

A LB film is formed on a cylindrical roller 1060 which allows for very large-scale films to be grown (many metres in each dimension). The roller 1060 is partly immersed in a tank 1062, sometimes referred to as a trough. The tank is filled with water 1066 or another carrier liquid on whose surface floats a monolayer of a polar molecule 1064 that is both amphiphilic for forming the monolayer on water and has non-linear optical properties as required for forming the NLO organic material. A pair of barriers 1068 positioned parallel to each other and separated by a variable distance may be provided in the tank, whose separation distance controls the density of the surface layer and its surface tension through lateral pressure changes. A voltage source 1020 is provided which is connected to apply an electric field to induce poling in either direction between an electrode positioned adjacent a surface of the roller that lies above the water surface and the tank, which forms a base electrode.

Before starting deposition, the roller has a substrate-forming sheet placed on its surface. The roller is then partly immersed into the water. The roller is then rotated in one direction to pick up a monolayer of the polar molecule layer from the water surface and deposit it on the sheet. Continuous rotation of the roller in the same direction through multiple full rotations will build up successive monolayers on top of the sheet. This will in general be necessary, since the grating period (coherence length) will typically be in the range 500 nm to 2 micrometres, whereas a single monolayer thickness of the LB film will typically be around 1 to 3 nm. A change in the rotation direction of the roller will also continue to deposit more monolayers on top of the sheet but after a change in poling orientation. The desired change in poling direction could alternatively be achieved by applying an electric field between the roller and the tank, where the electric field defines the orientation with which the polar molecules are deposited. Moreover, electric field and roller rotation direction changes could be used in combination to achieve the desired change in poling direction. It is noted that an electric field induces orientation switch for changing the poling direction may be by altering the polarity of the electric field but could also be by altering the magnitude of the electric field with the same polarity of electric field. In other words, there are multiple options including: only alternating the roller direction, alternating only the applied voltage (magnitude and/or polarity), alternating both voltage and roller rotation direction. The switching of rotation direction and of applied voltage need not occur with the same frequency. For example, twenty monolayers could be built up by alternating the rotation direction twenty times, and then the voltage switched, and then another twenty monolayers could be built by alternating the rotation direction another twenty times. Another technique which may be applied is to have two different polar molecules arranged either side of the roller. In this technique the roller is partly immersed and then first and second molecule types are added to one side of the roller and the other. The two types are selected to have opposite dipole moments in relation to how the molecule stands up on the water surface, so that continuous rotation of the roller deposited alternate monolayers of the two types of molecule on the roller.

A cross-linker 1056 is arranged to expose a radial portion of the surface of the roller to induce cross-linking in the NLO organic material to fix the same. The cross-linking may be induced by ultraviolet light to induce UV cross-linking, radiative heating to induce thermal cross-linking or some other cross-linking process. The cross-linker 1056 would be a UV light emitter, such as a filament lamp, LED (light emitting diode), SLD (superluminescent light emitting diode) or laser for UV-cross-linking. The cross-linker 1056 would be an emitter of radiative thermal energy, such as a resistive heater element for thermal cross-linking.

The system can be further configured to have a heating zone (above the water trough) or a UV curing system, so as to allow for cross-linking (either thermal or UV) or evaporation of solvent. The system can also be configured to introduce chemical vapours into a controlled region above the roller to allow for cross-linking, or to control of pH, or other properties.

The system can also make use of thickness monitors, e.g., capacitive, optical, etc., to monitor the film deposition and control the film growth and to achieve the desired poling period.

### Example 5) Liquid Crystals Cells

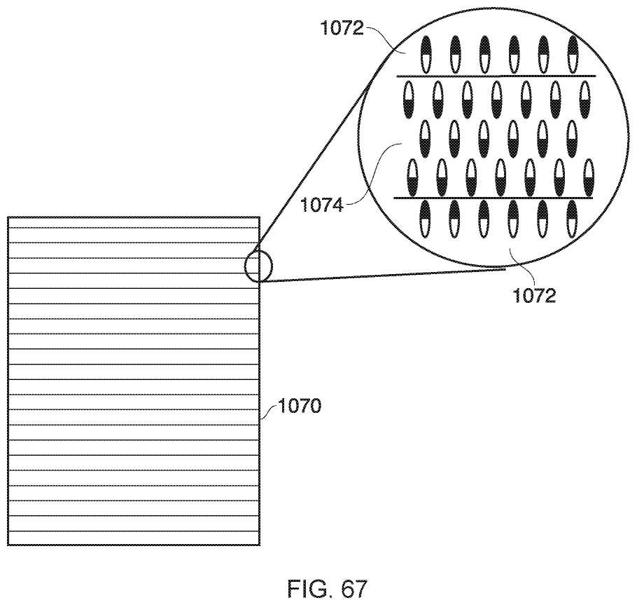

FIG. 67 shows a liquid-crystal based structure for creating the fine period NLO material 1070. The figure shows individual regions 1072 and 1074 of liquid crystal molecules with alignment that alternates between different polarities. The alignment of the layers can be created by appropriate surface chemistry of the interfaces or by electric field alignment prior to a cross-linking process.

### Poling Configurations for Phase Matched Regions

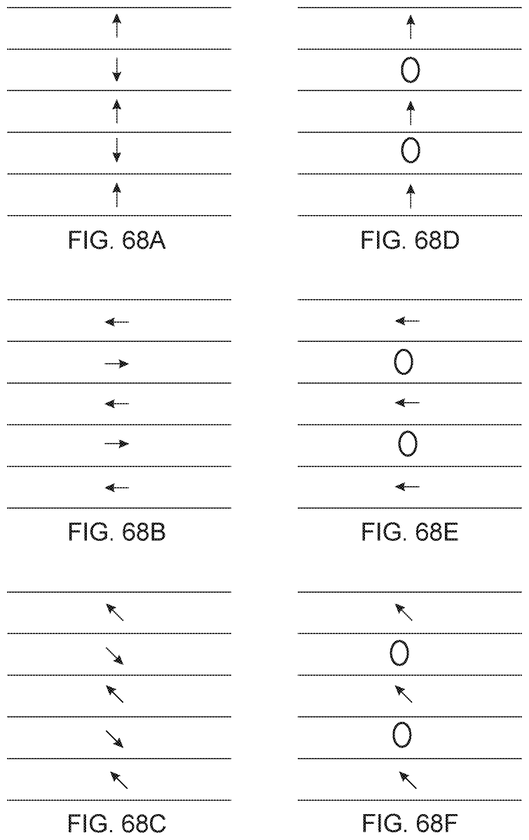

FIGS. 68A to 68F show different possible poling arrangements for NLO materials according to the invention, including both inorganic and organic NLO materials. In general, to exhibit a chi: 2 nonlinearity a material must be polar (must not have inversion symmetry). To achieve a phase matched or QPM structure, it requires different regions with different polar directions. These may be ferroelectric- or simply polar. In the case of an inorganic NLO material, this generally means a crystalline unit cell that is non-centrosymmetric, while in polymers or plastics which have amorphous structure, it represents aligning polar molecules. All of these cases are suitable for creating phase matched regions in NLO material for a display panel according to the invention.

FIG. 68A shows a case where the polar element (e.g. ferroelectric inorganic, a polar organic, a polar liquid crystal, etc.) are aligned vertically with each period being made up for up and down orientations.

FIG. 68B shows the polar directions oriented in the plane of the layers.

FIG. 68C shows the polar directions at an angle to the plane of the layers.

FIGS. 68A, 68B and 68C all show cases with alternating layers which are oppositely poled.

FIGS. 68D, 68E and 68F show poling configurations which, compared with FIGS. 68A, 68B and 68C respectively, have the alternating layers replaced by layers which are unpoled, for example made of nonpolar or amorphous material. Such structures still allow for product light generation by mixing of a pair of input beams.

It is noted that in all of these diagrams the product beam light generated by the input beam pair mixing will be directed vertically in the figure, while the input beams will be directed at an angle into the poled NLO material. The efficiency of the NLO interaction depends on the magnitude of the nonlinearity. Noting that the nonlinear response is a tensor property, it will be understood that, while the configuration of FIG. 68A might give a first impression that there will be no nonlinearity, this may not be the case owing to the tensorial nature of the interacting fields of the input beams.

### Medical Applications

### Medical—Introduction

Existing AR technology is generally limited in brightness, has challenges in providing consistency between stereo vision vergence and eye accommodation, and this limits the usability. In many situations it is critical that a display tech be fully transparent- and does not limit peripheral vision, does not add glare, scatter, etc.

These factors are important for aspects of medical deployment of display technology.

Issues to do with depth of field, accommodation, focus, and virtual scene information are particularly important. The display technology described in this document incorporated into an AR spectacles format lends itself for use in various medical applications for diagnostic, treatment and corrective purposes as well as to assist medical professionals performing diagnosis and treatment.

### Relevant Apparatus Features for Medical Applications

The following capabilities of a display apparatus according to the invention as described elsewhere in this document are of particular relevance for various medical applications.

The ability to control wavefront curvature to test eyesight at different apparent distances, for example for far vision and near vision and over a continuous range of distances.

The ability to control wavefront curvature to correct for long-sightedness, short-sightedness and age-related accommodation loss (all effectively spherical power vision defects) and astigmatism (effectively a cylindrical power vision defect).

The ability to create a synthetic scene that is a replica of the natural scene or parts thereof through use of image data acquired from an outwardly facing camera, wherein the ability to control wavefront curvature allows the synthetic scene to be given a wavefront curvature matched to the wavefront curvature of the natural scene or natural scene element that it corresponds to.

The ability to perform eye tracking with inwardly facing cameras for the left and right eyes.

Eye tracking combined with image content delivery via display of synthetic scene elements enables various diagnostic and treatment options.

Eye tracking combined with wavefront curvature control allows synthetic scene elements that are provided to impart information content to the wearer to be displayed with an apparent depth matched to what the wearer is looking at, i.e., the wearer's line of sight, so that the information can be acquired by the wearer without having to refocus from the object distance being looked at in the natural scene to the display and back again.

### Medical—Testing (Diagnostic) Applications

Eye tracking combined with content delivery via synthetic scene elements enables various diagnostic and treatment options not possible conventionally. The display is used to generate synthetic scene elements that are mapped onto elements of the natural light scene and then an inwardly facing camera is used to observe the eye response.

For eye testing, as conventionally performed by an ophthalmologist, the display apparatus can display synthetic scene elements at different locations in the patient's field of view and at the same time track the patient's eye motion automatically. Alternatively, more traditionally, the patient can be asked to provide feedback instead of automatic eye tracking, e.g., by the patient pressing a button when they see something. For example, a field-of-view test is used to assess glaucoma. Glaucoma is a condition caused by the optic nerve being damaged and results in the patient suffering from loss of vision in some angular ranges of the field of view. Conventionally, a field-of-view test is performed by the ophthalmologist using a visual field analyser, which is a bulky and costly piece of laboratory equipment.

A display apparatus according to the invention in an AR spectacles format allows a field-of-view test to be performed. The portable nature of AR spectacles means that the field-of-view test can be performed in any setting, e.g., outdoors during the day, outdoors at night, indoors etc. to account for all normal lighting conditions. For example, the patient may have their field of view tested while walking outdoors under different light conditions day and night. Further, if the display panel is provided with a controllable dimming layer as described elsewhere in this document, the dimming layer can be used to vary the lighting levels by attenuation, so that testing in different lighting conditions can be carried out rapidly, for example in a clinical setting. The lighting levels may also be varied by varying the brightness of the synthetic scene image, for example by changing background image brightness over the full field of view. The synthetic scene comprises a combination of a background image of a certain brightness and the test features. Moreover, the ability to control wavefront curvature enables the field-of-view test to be performed at different object distances (eye focal lengths) to make separate assessments for far vision and near vision.

To test for a variety of sight-related medical conditions, a display apparatus according to the invention in AR spectacles format may be operated to create synthetic scene information and use eye tracking to monitor how the patient responds.

One example is to test speed of response to a visual cue. Speed of response is an important medical parameter which can be used to assess loss of mental alertness caused by an underlying medical impairment, such as tiredness, influence of alcohol or drugs, psychotic episodes, other mental health issues, or effects of an illness which might be infection, sepsis, seizure, epilepsy, meningitis, etc. Speed of response measurement may also be correlated with other medical indicators to improve diagnosis. One specific use example where speed of response measurements could be employed is for triage as performed in an accident and emergency (A&E) department.

Another example is to test for oculomotor dysfunction, which can also be measured by presenting synthetic scene elements and monitoring the response by eye tracking. All three main optical traits of oculomotor dysfunction can be detected in this way. These are: convergence testing, which is to check that the vergence angle changes correctly in stereoscopic vision as the object distance changes between near and far; saccades testing, which tests the ability to jump focused gaze between objects at different locations in the field of view; and smooth pursuits testing, which tests the ability to track a continuously moving object with a steady gaze in the field of view.

### Medical—Eye Testing Applications

Colour blindness is traditionally assessed by an ophthalmologist showing an image to a patient in which image information is encoded by two or three colour differences, for example letters or numbers. The patient is asked to say what they see. A common example of a set of test images is the Ishihara plates which test for a red-green colour vision defect and a red-green colour vision deficiency,

A display apparatus according to the invention, for example in AR or VR format, or a NCTE display, can display images that contain colour coded information that are conceptually similar to the traditional ones. For example, the Ishihara plates may be used as synthetic scene elements. The display can be operated to move colour coded image information around a larger image within the patient's field of view such that the larger image appears static save for the changing colour coded image information. For example, the synthetic scene can display a sequence of Ishihara plates in the same area of the display, so the only change in the synthetic scene is a colour change. A patient lacking colour sensitivity in a particular colour owing to an absence of, or reduced function in, cone cells of the relevant type will therefore see a static image or at least find it difficult to perceive image changes. It is noted that cone cells are of three types: short(S), medium (M), and long (L) cone types. These correspond very approximately to blue, green and red wavelength ranges but human colour perception is more complex than that.

Whether the patient can decode the colour coded information can be determined automatically by eye tracking of the patient's line of sight. Whether or not the patient's line of sight moves to be directed towards the newly shown colour coded feature in the larger image can be taken as an indicator of whether or not the patient has noticed it. Alternatively, more traditionally, the patient can be asked to provide feedback instead of automatic eye tracking, e.g., by the patient being asked to say what they see.

The colour blindness eye test can be done with the colour coded image features displayed at different depths of field. This extends the test to include any accommodation dependence.

Furthermore, the same approach can be looked for evidence of night blindness (nyctalopia) where the test would be carried out in low light conditions as well as bright blindness (hemeralopia) where the test would be carried out in bright-light conditions.

Using a display according to the invention for these purposes, when combined with eye tracking, lends itself to use with small children or people unable to respond to prompts about what they see. For example, in very young children, diagnostics can be run for any of the above eye conditions even though the child is too young to be able to talk or read. The same advantages can be used for testing vision of animals, which might be for research purposes or for diagnosis.

### Medical—Treatment Applications

There are a number of eye conditions where the condition can be treated using behavioural treatments—sometimes known as behavioural optometry, or by using additional eyesight correction.

A good example is for treatment of young children who are long-sighted. It is common for young children who are long-sighted to develop esotropia (a type of strabismus) in which the eye vergence becomes misaligned. In small children, if they are long sighted and struggle to focus on close-up objects, they will become esotropic. In estropia, one eye will move towards the centre so that the images from the left and right eyes do not overlap and thus do not create confusion. The person has one eye which effectively is looking away from the object. Over time, the vergence-accommodation association for close-up vision will become habitual, where focusing the eye muscles for close-up vision is naturally linked to the eyes being crossed.

This habituation can be prevented from developing in young children if they wear corrective spectacles (corrected for their long sight) so that they can focus on close-up objects normally and do not develop esotropia. The challenge is that a young child, e.g., a 2 year old, will object to wearing the spectacles, will try to pull them off, will complain, etc.

Using a display incorporated in an AR spectacles format, the ability to superimpose synthetic scene images will allow the child to remain more entertained (e.g. playing a fun cartoon) as they wear the AR spectacles. The AR spectacles can also be provided with inwardly facing cameras for eye tracking to collect data that can be analysed in real time to detect when strabismus occurs. This can be used as a trigger to display synthetic scene objects on the display which are configured to induce the child to bring the eyes back into normal alignment. Furthermore, the ability of the display to create synthetic scenes or scene elements at different apparent distances can be used to provide training sequences. A training sequence may commence with display of a distant appearing synthetic scene element and then progressively bring the object distance forward. For a young child, this may be done as a fun cartoon character sequence). The training sequence can be used to encourage the child's vision to stay correctly aligned as the synthetic scene artefact is brought closer and closer, i.e. maintaining correct vergence and accommodation for both eyes. The training sequence can be triggered to start when strabismus is detected.

Other behavioural eye treatments are for eye movement desensitization and reprocessing. These treatments are used, for example, for treating PTSD (post-traumatic stress disorder). In this type of therapy, a smooth pursuit exercise is carried out. Namely, the patient's gaze is directed by a therapist to follow an item (e.g. the therapist's finger) which is moved in patterns. Using the display technology of the invention, smooth pursuits therapy can be implemented directly in a suitable display, for example in an AR or VR spectacles format.

Treatment software is configured to create and move synthetic scene elements for the patient's gaze to follow. The synthetic scene element to be followed can be displayed at varying apparent distances and, in the case of a transparent display, such as in AR, superimposed on a natural scene.

### Medical—Corrective Application to Colour Blindness

The display technology of the invention lends itself to correction of vision defects, in particular when the display is incorporated in an AR spectacles format or contact lens format.

A person suffering from colour blindness will have a reduced sensitivity to specific wavelengths, e.g., an inability to perceive red and/or blue light. However, commonly it is the case that a so-called colour-blind person is not in fact completely unable to see the affected colour. Rather, it is often the case that the colour ‘blindness’ is a reduced sensitivity to that colour rather than a complete absence of sensitivity. It is well known that it is possible to restore a more natural colour vision for a colour-blind person by using colour filters which absorb a proportion of the light of colours the person sees well while passing the low-sensitivity colour unattenuated. This effectively distorts the spectrum of the light entering the eye. However, with this approach the total light level drops. A reduced light level causes eyesight acuity to reduce, for example since the pupil will dilate. A reduced light level may be unacceptable in low light levels, for example when driving at night it would be dangerous.

A display according to the invention can be incorporated in an AR spectacles format or contact lens format for correction of colour blindness. The person with colour blindness can wear the transparent AR spectacles or contact lenses. The AR spectacles are provided with outwardly facing cameras to allow a representation of the natural scene to be reconstructed.

The synthetic scene is then used to provide a colour enhanced replica of the natural scene. A colour-filtered reproduction of the natural scene or selected areas therein are superposed on the natural scene being viewed through the transparent display panel, thereby improving the perceived colour balance of the natural scene as viewed through the display panel. Software processing of full-colour images collected by the cameras may be used to generate the colour compensating synthetic scene. Alternatively, the camera may simply have a colour filter placed in front of it to attenuates colours that the wearer has high sensitivity to so the images as acquired already have the distorted colour balance that is needed for the synthetic scene. Boosting the brightness of colours the person does not see well, provides a more natural colour balance without reducing the persons visual acuity. Critically, the ability of a display apparatus according to the invention to create synthetic scenes and scene elements at any apparent distance through control of wavefront curvature allows the colour-boosting light being generated in the display panel to have a wavefront curvature matched to the wavefront curvature of the natural scene or natural scene element that it is enhancing. The synthetic scene colour rebalancing light thus appears to come from the correct point and apparent distance as the natural scene light it is rebalancing.

### Medical—Corrective Application for Low Light Conditions

In night blindness (nyctalopia) and age-related macular degeneration, vision is poor in low light conditions.

The display technology of the invention incorporated in an AR spectacles format or contact lens format can be used to boost natural scene brightness. This may be considered to be a simplified version of what is described above for colour blindness to boost the brightness of specific colours in the natural scene. Namely, the synthetic scene provides a replica of the natural scene to boost brightness. A reproduction of the natural scene or selected areas therein are superposed on the natural scene that is being viewed through the transparent display panel, thereby increasing the perceived brightness of the natural scene as viewed through the display panel.

Increasing image brightness also improves vision in other ways. Brightening an image causes the pupil to contract, which reduces eye lens aberrations and thus improves focus. Reducing pupil diameter (increasing f-number) also increases depth of field. This is why, when a person is reading text, it is a common experience that it is easier to read in bright light.

### Medical—Corrective Application for Nystagmus

In nystagmus, the eye moves more rapidly than required to stabilise the image.

Using a display apparatus according to the invention in an AR spectacles format, contact lens format or other transparent format, like the previous examples, the ability to overlay a synthetic scene replica of the natural scene can be exploited. In an AR spectacles format, inwardly facing cameras can be used to detect onset of rapid eye motion, i.e., when nystagmus starts, and to track the eyes during periods when it is occurring. The display panel can then respond by replacing the natural scene or a portion of its brightness with a synthetic scene replica of the natural scene that is stabilised in the sense of being moved to track in synchronization with the rapid eye movement. The synthetic scene replica of the natural scene is obtained from outwardly facing cameras as discussed elsewhere. The natural scene can be dimmed by use of an electronically controlled dimmable layer as described with reference to FIG. 21. The synthetic scene replica of the natural scene is thus moved in synchronicity with the eye movement of the viewer. Thus, while the natural light scene will still be moving in an undesirable way, the synthetic scene will be steadier in appearance to the viewer.

### Medical—Use by Medical Professionals

Using a display apparatus according to the invention in an AR spectacles format has utility to medical professionals, such as a surgeon in an operating theatre or an emergency paramedic attending a road traffic accident.

A medical professional carrying out a time-critical task will often need to monitor vital signs of a patient. This is traditionally done by looking at screens and displays of different pieces of medical equipment. Looking at these screens or displays while carrying out an operation or giving emergency treatment can be a significant distraction for a surgeon or emergency paramedic. A display panel according to the invention incorporated in AR spectacles allows the medical professional to quickly view information on the patient status without turning their ahead away from the patient. The vital signs information may be arranged away from the medical professional's direct line of sight, so as not to interfere with normal forward vision, but the wearer can access that information whenever needed by looking up or down for example to where the information is displayed. In this respect, the AR spectacles may either have the display panel covering only a limited area of the spectacles lenses away from the normal forward vision or the display panel may extend over the whole lens area, or at least also the normal forward vision area.

A further advantage of the invention comes into play for such applications, since the object distance of the vital signs' information can be matched to the object distance of the wearer of the AR spectacles, e.g. the operation site being looked at by the surgeon, so no refocusing of the wearer's eyes is needed. The object distance may be a fixed distance estimated for the situation at hand, e.g., the operation site, e.g. about arms' length or 1 metre, or the actual distance as measured by a range finder (e.g. LiDAR device) mounted in the AR spectacles. This is a significant advantage, since refocusing time for human eyes is about 0.25 to 0.50 seconds. As discussed elsewhere in this document, the display apparatus may also be configured to bring information deemed to be more important to the attention of the wearer with visual, aural or haptic aids.

Of course, any information of use can be displayed on the display panel. In the context of a medical professional, telemedicine opportunities can be envisaged. For example, a surgeon performing an operation can be provided with advice from colleagues who are watching a livestream of the operation either from separate video feeds or through transmission of a video feed from an outwardly facing camera integrated in the surgeon's AR spectacles.

A further useful addition to this scenario would be an outwardly facing thermal imaging camera which acquires a natural scene image in the infrared. The infrared natural scene image data acquired by the thermal imaging camera is used to create a synthetic scene using false colouring that is a replica of the natural scene in the infrared. The synthetic scene is then superposed, i.e., overlaid, on the natural scene (in the visible) as observed by the wearer through the transparent display panel. For example, in the paramedic situation, the synthetic scene would provide a thermal map of a patient to show their skin temperature. Skin temperature is a useful indicator for an emergency medic, as it can indicate blood-loss, onset of sepsis, etc.

A further feature that will be useful in medical scenarios is the addition of heated elements to the display to keep it warm enough so that condensation doesn't form when the medic wears a mask—and their breathed-out air can cause fogging. As the system already contains electronics and optics there is already capacity to provide electrical power (or could use waste heat) to ensure that the lens of the AR glasses does not fog up.

### Input Beam Routing Optics

### Introduction—Input Beam Routing Optics

An advantage of a display apparatus according to our invention when operating as a close to eye display is that it can direct light to the eye of the viewer specifically to their foveal region. Moreover, as the viewer's eye swivels around, by using an eye tracking camera, the display apparatus can create its output localised to a region of the display panel through which the viewer is looking. The following section deals with design considerations for routing the input beam light to the correct sub-area of the display panel. Specifically, it is important to ensure that the focusing conditions for the input beams are met across the display panel taking account of the fact that the distance travelled by each input beam will vary depending on where on the display panel the beam pair intersection is to take place.

For example, placement of the Fourier plane of the lens or lens combination which has the task of focusing input beam light from a DLP chip or other amplitude modulator onto the correct position in the NLO material where it is intended to cross with the other input beam with which it is paired. Similar considerations apply to the phase-modulated input beam. One way of achieving correct focus of the input beams across the display panel area is to use variable focus lenses or moving elements—as in photographic zoom lenses—as discussed elsewhere in this document. Here the optics system for each input beam is configured and arranged to be parfocal, meaning that the image stays in the same place as the focal length of the lens is changed.

### Detailed Description—Input Beam Routing Optics

In the following, we describe another way of achieving correct focus of the input beams across the display panel area.

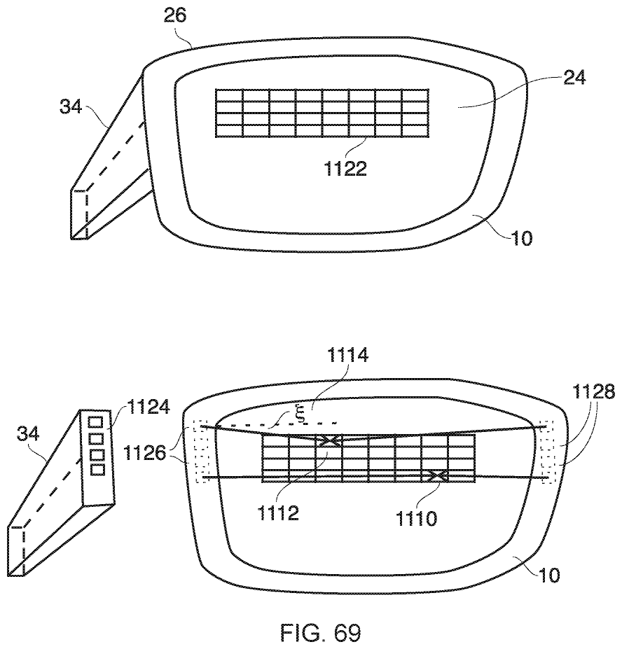

FIG. 69 (upper drawing) shows one half of a pair of spectacles showing the right-hand frame 26, the right-hand lens 24 and the right-hand arm (temple) 34. The lens of the glasses is shown with a rectangular grid 1122. This grid can either represent a set of positions on the lens from which the display needs to emit light (i.e. illuminated NLO regions in a larger NLO lens—or alternatively may be regions of a segmented (lenticular) lens such as shown in FIG. 22. Note here they are shown in a rectangular pattern—and that there is no physical marking on the lens like this grid—it is purely to explain the following.

FIG. 69 (lower drawing) shows the same components as FIG. 69 (upper drawing) but with the spectacles temple 34 removed to show a surface with a plurality of light ports for respective light channels 1124 which abut corresponding light ports 1126 in the frame 26. There are also a corresponding set of light ports 1128 on the bridge side for introducing the other beam of the input beam pair into the lens 24 in an opposed direction. The function of these ports is to allow light to be routed from a light engine containing lasers held in the temple of the glasses to the display.

FIG. 69 (lower drawing) shows, by way of example, ray traces for two pairs of input beams which cross at points 1110 and 1112 (i.e. the intersection regions of a crossing input beam pair). Areas of the display panel can be addressed in a grid-like manner by column and row. The illustration by way of example is with 4 rows and 8 columns. Intersection 1110 is in row 1, column 3 and intersection 1112 is in row 4, column 4.

A key requirement is that the input beams delivered to the phase-matched regions of the NLO material arrive with the correct amplitude and phase modulation. For example, in certain embodiments for a localised-at-infinity mode of operation, a DLP acting as an amplitude modulator needs to be configured so that the crossing point in the NLO material of the amplitude modulated input beam lies in a Fourier plane. Similarly, the phase controlling input beam needs to be placed correctly (as discussed elsewhere in this document).

Referring to FIG. 69 (lower drawing), it is also noted that the ray trace corresponding to the input beam directed to crossing point 1110 is shown as being directed partly downwards as indicated by an angle marked as ξ relative to a horizontal shown with dashed lines. By directing the input beams in a somewhat downward direction for the top of the display panel, the resulting phase matching will send the product light downwards towards the pupil of the viewer (which will be tilted upwards). Another measure which can route the product beam appropriately into the eye is to vary the axis of the phase-matched grating from row-to-row by different amounts away from normal to the lens 24, so that the output (product) beam direction is directed appropriately into the eye, in which case a downward angle may not be needed, or may be reduced.

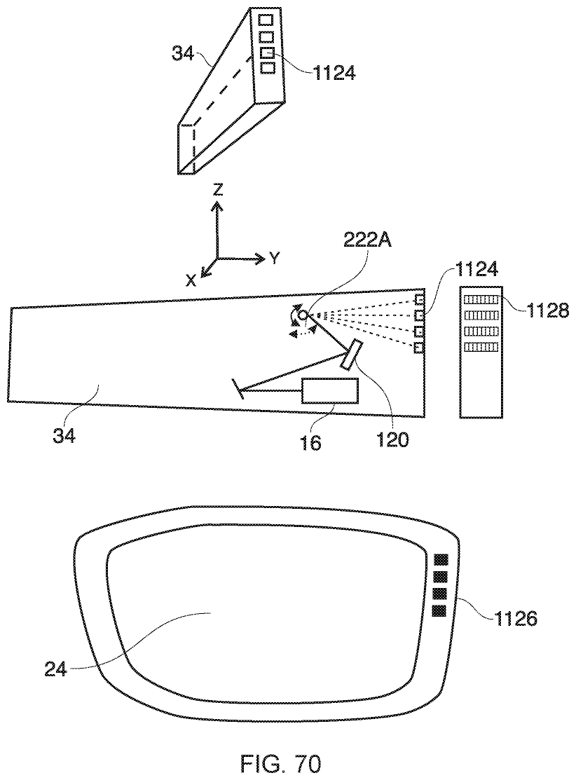

FIG. 70 (upper drawing) shows the same view of the temple as in FIG. 69 to give context to FIG. 70 (middle drawing) which is a schematic side view showing some of the miniaturised optical elements contained within the temple as well as an end-on view of the temple showing the surface that mates with the frame. FIG. 70 (lower drawing) shows the lens 24 from the opposite view direction compared with FIG. 69, i.e., as it is viewed from the eye.

The side view of FIG. 70 (middle drawing) shows an input beam laser source 16 which is directed via a mirror to an amplitude (intensity) modulator 120 such as a DLP chip and then reflected (having been spatially intensity modulated with a desired image frame) onto a tiltable scan mirror 222A. The mirror shown here can scan in two orthogonal directions. The x,y,z axes are indicated. The mirror 222A can scan in the yz plane—allowing light to be directed to any one of the four output paths 1124. A single MEMS type scan mirror is readily available that has two scan axes. Alternatively, a pair of single axis tiltable mirrors may be used instead. Other routing solutions are possible, for example using optical switches. The MEMs scan mirror can also scan in the XY plane—and that creates a scan in the orthogonal direction. In the end-on view, it can be seen that eight separate regions are provided, which may either be separate physical apertures or can just be notional channel spaces in a single larger physical aperture. In either case, the light paths through the eight regions are directed differently.

It will be appreciated that additional components that are not shown in FIG. 70 (middle drawing) will be included as needed, e.g., batteries, microprocessors, memory, wireless transceivers, accelerometers, etc.

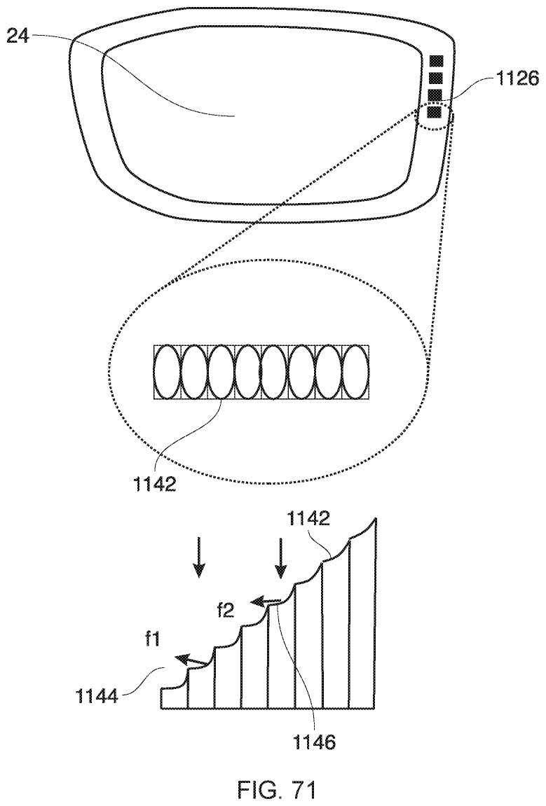

FIG. 71 (upper drawing) is a drawing of the lens 24 from the perspective of the eye of a wearer (i.e. in the distal direction) showing the beam receiving region 1126 that is set in the frame 1126.

FIG. 71 (middle drawing) shows an enlarged view of one port of the receiving region 1126 which comprises a multi-channel focusing structure 1142 having a plurality of mirrors. By way of example, an eight-mirror structure is shown. The mirrors 1142 route input beam light from the temple into the lens 24. The mirrors 1142 each have a focusing capability and therefore have rounded mirror surfaces (like the inside of a spoon). The different mirrors 1142 have different radii of curvature. The mirrors 1142 can be formed by imprinting into a plastic material and adding reflective coating, by stamping a reflecting metal sheet, by physical machining, etc. The mirrors 1142 each have essentially equivalent focusing power in for both sagittal and meridional axis, and are also configured for reflection at around 45 degrees so as to route input light received from the temple structure into the lens 24 as desired.

FIG. 71 (lower drawing) is a side section view of the mirror structure 1142. The different radii of curvature of the individual mirror elements are shown schematically. The radii of curvature are different from mirror to mirror, most conveniently varying in increments from one side of the mirror structure to the other as illustrated. The different radii of curvature are selected to allow input light to be reach a focus in the NLO material at different distances into the display panel to allow as many different focus distances to be provided for as there are individual mirror elements. Referring to FIG. 69, two example input beam paths for a pair of input beams are shown with the crossing points labelled as 1110 and 1112. The mirrors are arranged in the mirror structure 1142 in a sloped arrangement so that successive mirrors do not block each other. FIG. 71 (lower drawing) also shows how rays from input beams reflected from different ones of the mirrors—rays 1144 and 1146—have different output angles.

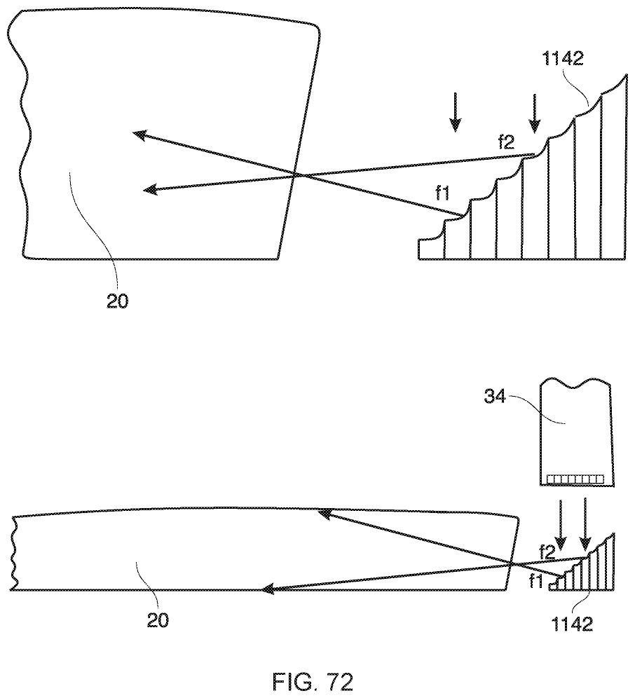

FIG. 72 shows light being reflected from the mirror structure 1142 and entering the lens 20 of the AR spectacle (which contains the NLO material—not shown). The upper drawing is in close-up while the lower drawing is at a larger scale to show the temple 34. part shows a larger view, including more of the lens 20 and also the temple 34 which accommodates the input beam sources and their channel routing optics.

It should now be clear that this method allows light from the temple to be sent to the AR lens, and for the focal distance to be controlled by choosing the position of the MEMs tilt mirror 1134. By selecting one of the four (row selecting) positions in the YZ plane and one of the eight (column selecting) positions in the XY plane, an input beam can be sent to a selected subarea coordinate in the NLO material. The configuration as a whole therefore provides an addressing scheme for the input light beams. Image data supplied by the eye facing cameras can be processed to determine eye position (gaze direction) and in response the controller can drive the MEMs mirrors to cause the input beams to cross in the subarea of the display panel where the eyes are looking.

While the above figures all relate to an input beam which is amplitude modulated a corresponding tiltable mirror design can be used to route and focus the phase modulated beam, where again it can be desirable to image the varifocal lens into the nonlinear material.

One aspect of the design will be clear from the discussion of system magnification. The apparent image size of the synthetic scene will alter depending on the focal length of the path, so therefore without some other compensation the image would appear to be a different size at different row and column addresses, for example 1110 and 1112. A simple solution is to compensate for this in software, by scaling the displayed image on the DLP to compensate for the focal length. Other solutions are possible, including adding additional zoom lens components or a variable focal length lens to alter the magnification.

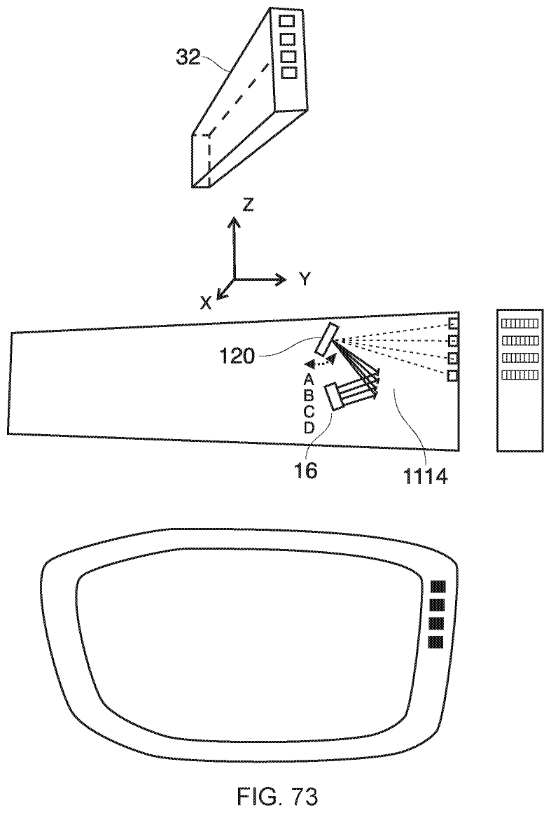

FIG. 73 shows an alternative optical arrangement for creating the input beam illumination from the temple. In this case an array of lasers 16 is used—labelled A,B,C,D in the figure. The lasers may be independent lasers-mounted separately—or maybe VCSEL structures from the same semiconductor chip. Each of the laser beams is directed from an appropriately angled mirror 1114, these mirrors being arranged to route the laser beams onto a DLP chip 120—whose individual pixel mirrors are themselves independently tiltable. A separate single axis tilt mirror may be provided instead. The required tilt is in the xy plane and allows for routing into the different channels for column selection (8 in number in our example), while switching on only one of the lasers of the laser arrays (4 in number in our example) allows for different paths in the YZ plane to be selected for row selection.

### Outward Going Beam Generation

### Outward Going Beam Generation—Introduction

Beyond display technology there are many applications where the use of our technology can be applied to provide useful functionality.

Previously, display embodiments are described in which pairs of input beams are combined in a non-collinear configuration to create a product beam directed to the eye, with the product beam carrying synthetic scene information for displaying an image to the wearer.

### Outward Going Beam Generation—Summary of Invention

Using the same physical principles of non-collinear combination of pairs of input beams, a headset can be provided which generates the product beam travelling in the opposite direction, i.e., away from the eye. In a spectacles format, this can be done with minor modification of the display implementations by routing the paired input beams so that the product beam wavevector (see FIG. 8, k_g) is directed outwards instead of inwards.

Such an outwardly going (distal direction) product beam is then emitted into the external world or, if desired, into another optical device such as a microscope.

Eye tracking, as described for display implementations, can then be used to direct the emitted product beam in the direction of the wearer's gaze through wavevector control. Eye tracking through vergence angle determination can also be used to define a focus distance for the outwardly going product beam.

The outwardly going product beam can be controlled using the same control measures as described for display implementations, wherein all of amplitude, wavevector and wavefront radius of curvature are controllable. For example, the outwardly going product beam can benefit from the ability to create complex patterns with controlled depth of focus through a transparent panel.

Creating the outwardly going product beam in a transparent material, e.g., a transparent lens, visor etc., is beneficial, since then the wearer can see where the product beam is directed and so has visual feedback to adjust gaze direction and thereby adjust vergence and accommodation.

Myriad use examples can be envisages including by way of example: providing alignment marks for another laser to provide material processing directed by the users gaze; providing a laser pointer function to deliver a spot in the external scene for educational purposes; providing a targeting mark for military guidance or hunting; providing a bright illumination to dazzle a hostile person (for example for policing); providing a grid to illuminate or align items (e.g. hanging wallpaper); etc. It may simply be for general illumination of an area in the field of view of the wearer. Both the direction and angular spread of the beam is controllable. For example, a directional flashlight or torch function can be provided to illuminate a feature according to feature size (visible area), for example, as determined from image data of the natural scene captured by an outwardly facing camera.

The images captured by the inwardly facing cameras used for eye tracking can also be analysed to recognise blink commands, e.g. a double blink may provide similar command functionality as a double mouse click. This may be used to ‘fire’ the outwardly going product beam, for example. Multiple blink commands can be envisaged and programmed into the headset control software using similar principles to mouse commands or touch screen gesture commands. Instead of or as well as blink commands conventional user interface devices may also be used to control the outwardly going product beam, such as a mouse, trackpad, joystick or touch panel. Voice commands may also be used.

Medical use examples include: photocoagulation, treatment of birthmarks, tattoo removal, and eye surgery. There are some situations, e.g., in eye surgery, where once the laser is fired it creates debris—literally burnt tissue and blood—so a single shot is good. The surgeon can use the tracking to mark up—e.g. along a blood vessel, and then can deploy another laser (or the same laser) in a complex beam profile. So e.g. look and click at points in an artificial overlayed image—perhaps with laser illumination to confirm, and then the surgeons clicks at all the points along a path, and then the higher energy laser provides the pulse that carries out the medical procedure.

A headset can be provided which combines the ability to generate an outwardly going product beam with an inwardly going product beam for image formation according to the previously described display implementations. It is thus possible to direct synthetic scene light to the eye of a wearer of the headset and independently send a complex light field into the external scene.

It will be understood that certain embodiments of a headset for generating an outward going product beam need not exploit the ability to vary wavefront radius of curvature of the product beam, either across the beam profile at any given moment in time (phase front control with a spatial phase modulator such as an LCOS) or as a function of time (e.g. focus control with a variable focal length lens in one of the input beams). Nevertheless, phase modulation will be required for the wavevector control that provides the beam steering function. Similarly, the ability to perform amplitude control across the profile of the beam may not be exploited in certain embodiments, rather merely whole-beam amplitude (i.e. intensity) control.

### Outward Going Beam Generation—Detailed Description

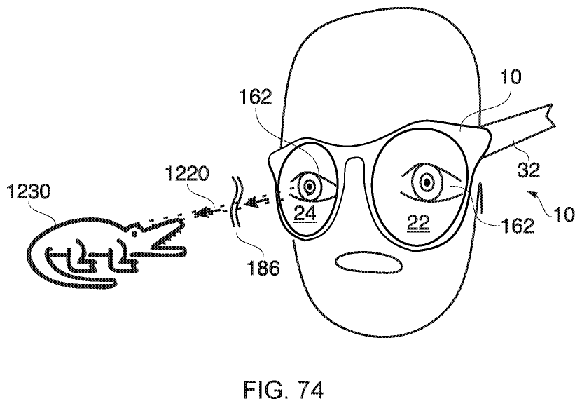

FIG. 74 is a schematic drawing of person wearing a pair of spectacles 10 with left and right eye lenses 22, 24. The spectacles 10 are capable of emitting a product beam out from the spectacle lenses into the natural scene. The spectacles may or may not have an AR capability as described elsewhere in this document. In this example the spectacles wearer causes a visible product beam 1220 to be generated in and transmitted from the spectacles 10 towards a target 1230 in the natural scene that the wearer has their gaze directed to. By directing light onto the target 1230, the wearer can perform some function, e.g., dazzling. The schematic diagram also shows a discontinuity of scale 186, and the eyes of the viewer 162. In this example, if the spectacles incorporate a display panel (to generate product beam light into the eyes of the wearer), the wearer may also be served a synthetic scene element, which may be a graphic element such as target crosshairs. Target crosshairs could be fixed to an element of the natural scene that has been identified by outwardly facing cameras or be centred on the outward going product beam. The synthetic scene element may be text information content relevant to the situation, e.g., to provide information regarding the identified natural scene element.

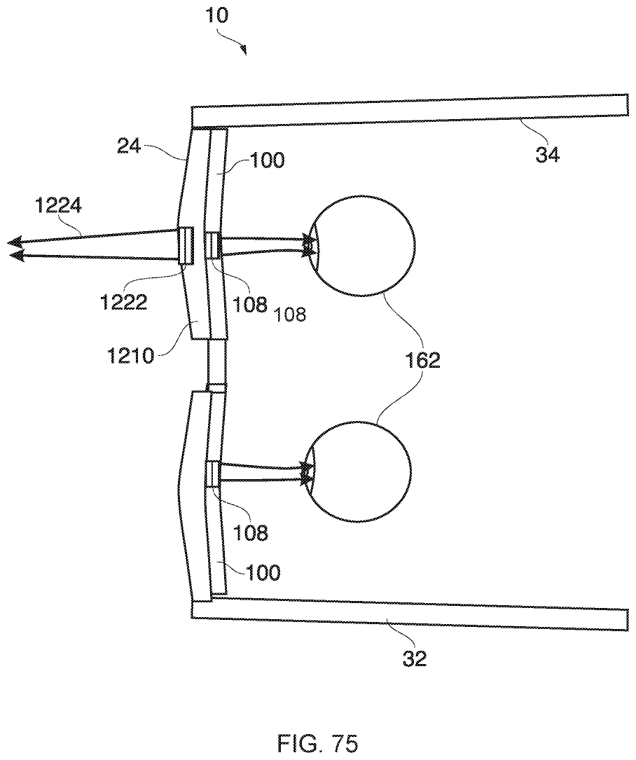

FIG. 75 is a schematic plan view of the spectacles 10 of FIG. 74 with temple pieces 32, 34, and left and right eye lenses 22, 24 mounted in a frame 26. The wearer's eyes 162 are also depicted. The right eye spectacle lens 24 has two different phase-matched regions 1222, 108 for generation respectively of the desired outward and inward going product beams by non-collinear combination of a pair of input beams. The phase-matched region 1222 generates the outgoing product beam 1224, for example by SFG or SHG. Namely, one phase-matched region 108 functions to create a synthetic scene image visible by the viewer (the inward going product beam), and the other phase matched region 1222 functions to create an outward going product beam. The phase-matched regions 108, 1222 for the inward and outward going beams are shown as being accommodated in two different layers of NLO material 100, 1210 but could both be accommodated in a single layer of NLO material. Moreover, the NLO material layer for the outward going beam is shown on the distal side and that for the inward going beam on the proximal side of the lens. However, this order could be reversed. The left eye spectacle lens 22 has a phase-matched region 108 for generating an inward going product beam but no phase-matched region for generating an outward going product beam. In another embodiment, the left eye spectacle lens could be similar to the right eye spectacle lens and also be able to generate an outgoing product beam. The ability to create left and right eye product beams may be beneficial for some applications. For example, in a medical context, it may be useful for the outward going beams to track vergence where the wearer can use this as a training aid to detect onset of strabismus. For simplicity, the input beams are not shown but similar considerations apply as described elsewhere for display implementations.

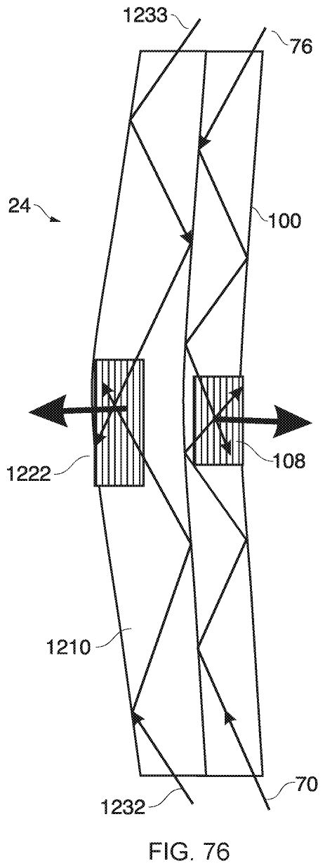

FIG. 76 shows an enlarged version of the right eye lens plan view of FIG. 75 to show an example input beam routing configuration. For generating the inward going product beam, the configuration is as described in previous display implementations, with the first and second input beams 70, 76 being introduced into opposite sides of the lens 24 and then passing to a crossing point in the phase-matched region 108 via multiple total internal reflections. All of the earlier design features can be incorporated into this display, so for example one of the input beams of a pair can be amplitude modulated with a suitable amplitude modulator and the other input beam of the pair can be phase modulated to impart a desired wavefront curvature, so the resulting product beam can have all of the flexibility already discussed. The input beams for outward beam generation and the input beams for inward beam generation may share wavelengths and optionally also light sources, or different wavelengths and/or light sources may be used.

Using eye tracking, the crossing point of the input beams where the outgoing beam is generated may be moved across the display area to follow where the optical axis of the wearer's eye intersects the lens (gaze direction). The outward going beam axis then moves to remain intersected with the pupil, thereby giving a “laser eye” impression to the wearer for improved intuitive control of the direction of the outward going beam.

As an alternative to using eye tracking or beam steering, the outgoing beam could be steered under control of a user interface device being controlled by the wearer of the headset which is in data communication with the headset directly or indirectly via a third device. The user interface device may be, for example, a joystick, mouse, trackpad or touch panel. Another alternative for beam steering is for the beam to be directed towards a feature in the natural scene. The natural scene feature could be one identified by data input from a camera, LiDAR, directional microphone etc. or could be identified by a directional motion sensor. The camera or other sensor may be one integrated on the headset or a separate unit.

It will be appreciated that lenses can be constructed solely to generate synthetic scene towards the eye, solely to send light outwards or both functions. If the headset is capable of performing both functions, the headset can operate in any of: a passive mode (no outputs), only eye-directed (display active), only outward beam generation (external beam active), and both display and external beam active.

To ensure that the outward and inward beam generating optics do not interfere, appropriate, reflective and absorbing layers can be provided in a similar manner to those described in connection with display-only implementations.

There are myriad applications of this type of artificial glasses structure, a good example being the aforementioned photocoagulation of blood vessels in the human eye. In this example a surgeon would wear the spectacles and be presented with synthetic scene information. For example, a surgeon could identify a series of points on a blood vessel where they wish laser radiation to be delivered, and then when they are happy with the situation, they can ‘fire’ the outward laser—which could be a higher energy or pulsed system which would act to cauterize/coagulate the blood of the patient. As the system can create complex intensity and phase patterns, the system could create complex optical fields which would distribute optical power (with focus control). The outward going light beam could be used directly to treat tissue, or it could be used to direct another secondary laser source to where the surgeon wishes the secondary laser to be delivered. This ‘target designation’ function could also extend to delivery of other treatment modalities—such as radiotherapy for tumour treatment, laser tattoo removal, laser treatment of skin conditions such as birthmarks, laser treatment of scar tissue, etc. All of the above optical features can also translate into other known laser applications such as: laser welding, laser cutting, laser ablation, laser material processing, laser sintering, laser peening, laser marking and so on. The target designation function can be used in other modes of use in which designated target is subject to other outcomes, such as in a military situation for guiding a munition to the target. Other application examples could include education settings, or indeed any situations where laser pointers might be used. The light sent into the natural scene can be viewed by other observers and, because complex light fields can be produced, this can be applied to many other applications. For example, a grid pattern could be projected onto a non-planar surface to provide the headset wearer with an intuitive understanding of the surface morphology.

### Beam Forming

### Beam Forming—Introduction

Beyond display technology there are many applications where the use of our technology can be applied to provide useful functionality.

### Beam Forming—Summary of Invention

The approach of non-collinear beam combining in a phase-matched region of NLO material can be used more generally for a whole raft of different applications involving light and optics. While it is already known that NLO materials can be used to combine laser beams, and this has been demonstrated in materials such as Beta Barium Borate (BBO) including at high powers of hundreds of Watts, our approach to beam combining allows a more sophisticated and nuanced set of optical operations to be performed through in particular the ability to control not only amplitude but also wavevector and wavefront radius of curvature across the generated profile of the product beam.

Optical operations that can be envisaged include: combination of laser beams to create a structured output, combination of laser beams with poor beam quality to give a better beam quality, combination of multiple beams to increase brightness, power and pulse energy, and creation of beams with controlled phase and amplitude distributions, which are optimised at the point of beam generation for material processing, laser marking, compensation of atmospheric beam distortion, creation of bespoke laser beams, etc. The beam formation with non-collinear combination of a pair (or multiple pairs) of input beams therefore substitutes for conventional approaches for laser beam quality improvement which place lenses, mirrors, filters in the beam path of the beam.

Unlike the purely display opportunity-(where the beams are produced for visible viewing (through sum frequency generation or second harmonic generation)

For generating the outward going beam, the selected combination of frequencies of the input beams may be different than for display implementations. Whereas for display implementations, the product beam needs to be in the visible range, and materials considerations lead to a choice of sum frequency generation (including SHG) between pairs of input beams of near infrared wavelengths, these limitations do not apply to all applications of beam combination per se. In particular, difference frequency generation may be suitable for some use examples. Difference frequency generation is appealing because this allows for wavelength tuneable output and also creation of product beam light in the infrared region, which is suitable for many use examples, including: materials processing, medical, atmospheric sensing. The non-collinear beam combining disclosed herein can therefore be extended to include difference frequency generation as well as the previous sum frequency generation.

It will also be realised that it is advantageous to use adaptive control within a system with feedback. An example is to take two laser beams of non-ideal quality, for example as measured by beam propagation ratio, M2, and then combine the two laser beams non-collinearly by SFG. The two beams with a less than ideal Gaussian profile are then combined by SFG into a new beam with a closer to ideal Gaussian profile, i.e., better M2 value.

More generally, the ability of our non-collinear beam combination approach to create near arbitrary amplitude and phase (as exploited in the display implementations) can be exploited to create more complex beams. It is well known that a laser beam output from any given laser is not completely stable. The output can alter slowly over time due to aging effects. The output may be affected by thermal lensing within the laser. Our non-collinear beam combination approach can be used to provide a stable combined output beam by provision of an appropriate feedback control loop, in particular to adjust the phase modulating component(s) in response to measurements of the combined output beam from which a relevant characteristic can be determined, so as to maintain the combined output beam with a desired characteristic, i.e., a desired output optical field. Furthermore, by using intensity and phase control we can control intensity profile, total power and optical phase of a resulting combined output beam. A significant benefit of this approach is the ability to create light at a new wavelength as defined by sum or difference frequency combinations of the input beams of any given pair.

Our non-collinear beam combination approach can also be used in multiple stages, for example in two stages, by a series arrangement of two or more of the beam combiners as previously described. For example, two input beams of 1064 nm (e.g., from a Nd:YAG laser) may be non-collinearly combined to generate a product beam at 532 nm and then two input beams of 532 nm may be non-collinearly combined to generate a product beam at 266 nm, thereby generating light deep in the ultraviolet region from a 1064 nm laser source.

Another two-stage combination is: 1560 nm+1560 nm→780 nm (by SFG) then difference frequency generation (DFG) of 1560 nm with the new 780 nm combined beam to yield a structured (or improved) beam back at 1560 nm.

Another two-stage combination is: 1560 nm+1560 nm→780 nm (by SFG) then combining 1560 nm with 780 nm to generate a second-stage output beam at 520 nm. As the SFG or DFG can be used with different wavelengths the resulting light fields from multiple lasers can either be coherently or incoherently combined.

The ability to perform the non-collinear beam combining in a phase-matched region of a NLO material that is transparent is advantageous for these multi-stage combinations, since a simple transmission configuration is possible as will be evident from the embodiments described below.

### Beam Forming—Detailed Description

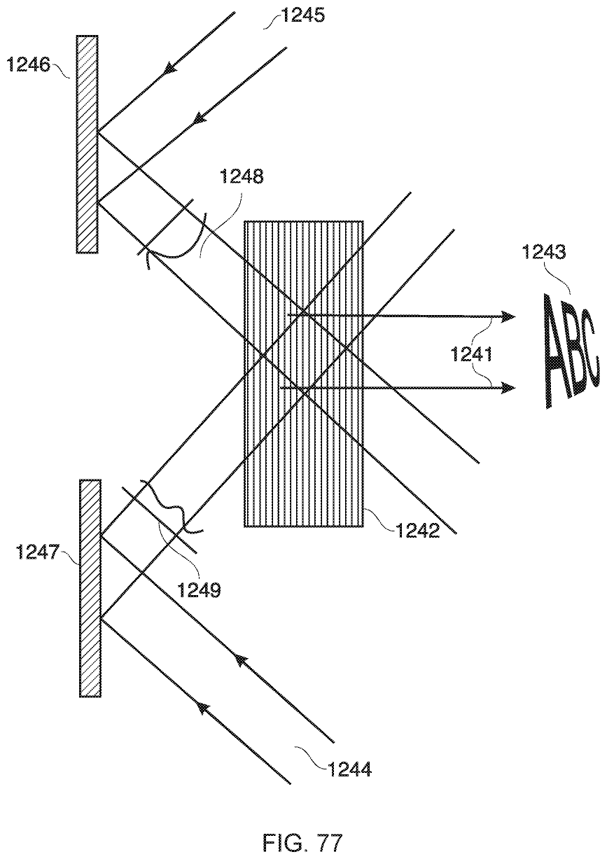

FIG. 77 show an optical arrangement for beam forming by non-collinear sum frequency mixing (or SHG) in a phase-matched region of material, e.g., QPM, to create a product beam from two input beams. By way of example, the drawing shows the product beam being created to carry a pattern (the letters ABC) which can be used for laser marking.

A QPM nonlinear material designed for non-collinear phase matching 1242 is illuminated by two input laser beams 1244 and 1245. These beams are reflected from phase modulators 1246 and 1247 which impart phase structure across the beams 1248 and 1249. The beams pass on into the NLO material 1242 where the create an output light field 1241 which in this case creates the pattern ABC 1243 at some desired position in space.

An example for this would be laser marking of a material with visible light-so for example, the two input beams could be at 1064 nm (either from the same laser or different lasers). The non-collinear mixing creates a SFG visible pattern at 532 nm which could be used to laser process visibly responding materials, such as photoresists, copper metal, plastics, human tissue, plant matter, etc. The desired pattern is created by the non-collinear SFG process in the nonlinear material.

In a variant, one of the phase modulators can be removed, e.g., replaced with a simple mirror if the exact same optical configuration as illustrated is to be retained. In other words, a desired patterning of the output beam can be imprinted in only one of the input beams.

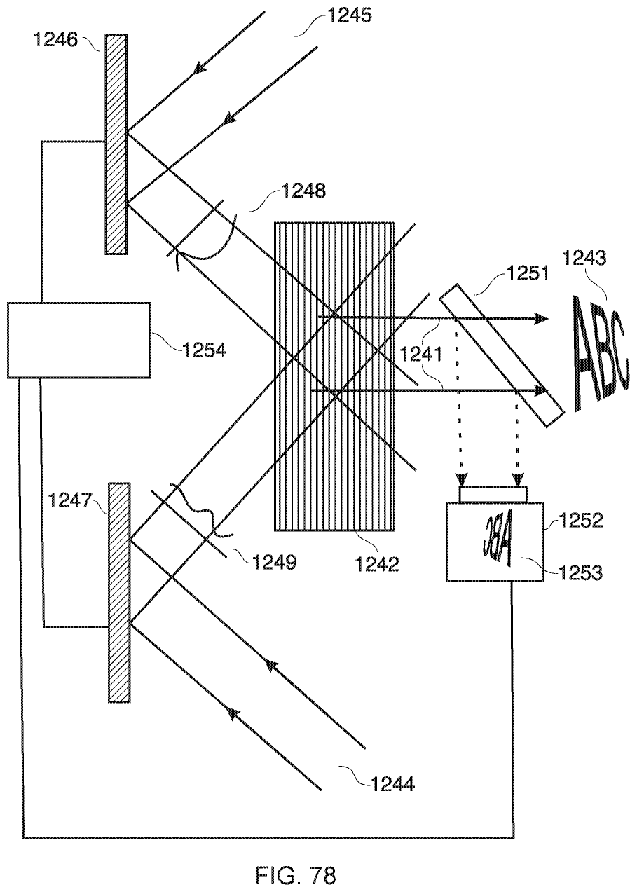

FIG. 78 shows the same optical configuration as in FIG. 77 but with the addition of a beam splitter 1251 arranged in the output beam path which takes a fraction of the light to a camera 1252. The camera 1252 can then be used to measure the output beam pattern 1253 (in this case ‘ABC’). Other arrangements are possible, for example a camera viewing scatter from a target area where the output beam is incident which is placed to the side of the target. The product beam pattern may also be viewed by a camera through the transparent display itself, i.e., from the left side of the drawing. Moreover, other sensors for measuring the output beam can provided as well as or instead of a camera-including wavefront sensors, shear plates, spatial filters and power meters etc. The image from the camera 1252 is routed to a controller 1254 which reviews the pattern and compares it to the desired pattern. The controller 1254 can then control phase modulation as performed in this example by the two phase modulators 1246, 1247 to cause the generated pattern to conform more closely to the desired pattern thus providing a feedback control loop. This can be achieved computationally—for example by using diffractive optics calculations—or can be achieved using machine learning, genetic algorithms, artificial intelligence etc. It will be appreciated that with additional sensors (e.g. wavefront sensors such as a Shack-Hartmann sensor or shear plate and an additional camera), it is possible to control both for the intensity of the desired pattern and its phase profile. If a sufficiently rapid feedback loop is implemented, the system will be able to adapt for changes in the input beam quality, i.e., the quality of input beams 1244 and 1245, and will be able to create near arbitrary patterns in a highly stable manner.

It is noted that even without the above-described feedback control, a controller will be needed to control the phase modulator(s) and optionally also the input beam sources.

There are a number of additional advantages to this approach, the first is, that the NLO material 1242 can be fully optically transparent. This means that the output beam can be viewed through the NLO material, so, in this case there is the option of a camera system can be placed viewing the target pattern 1243 through 1242, and the phase modulators can be controlled to produce the desired output. This control may either be algorithmic by defining a phase (and also amplitude if desired) pattern on each input beam and calculating the output, which given the well understood diffractive optics is straightforward. Another control option is to use machine learning or artificial intelligence to define the required phase front for each modulator.

It will be realised that it may not always be necessary to have two phase modulators in the system, one may suffice, and that other optical elements can be added as required (e.g. lenses to collect the light from the phase modulators and to deliver the light into the non-collinear phase-matched regions in the NLO material.

The output pattern can be controlled in amplitude and phase, which opens up a range of application areas. Firstly, it is possible to take two lasers beams of less than perfect Gaussian beam properties, e.g., as defined by the M2 parameter, and to task the control system to generate a product beam with a pattern that is a good quality Gaussian beam-better than either of the input beams, with a high-quality optical phase. The M2 value of the output beam can therefore be ‘better’ than that of the input beams, effectively increasing the beam quality. The output beam can be made to have other shapes than Gaussian—in fact arbitrary functional shape of the profile is possible. In the illustrated example, the output beam is impressed with text information (‘ABC’) but any arbitrary pattern can be produced, so for example a pair of Gaussians with some separation, a top-hat, Bessel beams, etc.

As well as creating beams with improved beam quality, the system can also be used to combine the two input beams to create an output beam with higher optical power than either input beams provided that magnitude of the nonlinearity in the NLO material is sufficient and sufficient input power is available. For example, if two input beams were directed into the system with 100 W each at 1064 nm from two separate lasers then an output beam of up to 200 W would in theory be possible although in practice outputs above 100 W at 532 nm from SFG would be useful as they would represent a power increase and, if the beam quality is also improved, also an increase in brightness.

If pulsed lasers are used for generating the input beams, it will be easier to obtain higher conversion efficiencies in the NLO material and so obtain a higher net energy gain (per pulse) while also improving spatial beam parameters.

The above examples relate to the output beam having the sum frequency of the input beams by SFG (or SHG if identical beams are combined).

In some situations, it would be useful to use DFG. For example, this would allow an output beam to be generated at longer wavelengths in the infrared region.

The system as described also lends itself to use of adaptive optics. For example, adaptive optics could be used to create output beams that can be controlled for atmospheric aberrations—so would be useful for laser guide stars—for directed laser weapons, etc.

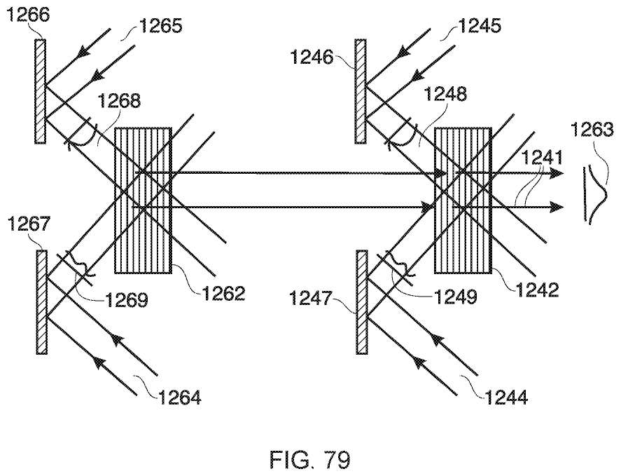

FIG. 79 shows a concatenated pair of the previously described configurations, i.e., a two-stage beam combiner comprising a series arrangement of multiple stages as previously described.

The figure shows a target light field 1263 (illustrated by way of example as having a Gaussian profile) which is produced by a pair of non-collinear beam combiners as described above.

NLO material 1242 combines light from two input lasers 1244 and 1245 using two phase modulators 1246 and 1247. As the nonlinear material 1242 is optically transparent it can also transmit light from the other nonlinear material 1262 which has two other lasers 1264 and 1265, and another two phase modulators 1266 and 1267.

The four laser beams can all be from separate lasers—in which case the pairs of sum frequencies generated will be different- and also move randomly in phase, and so the output gaussian field 1263 will be the incoherent sum from the two combiners. However, if the beams are highly coherent-then it will be necessary to lock the phases of the SFG from the first mixing with the second mixing process. In this case it will be necessary to also consider carefully the phase fronts and amplitudes to avoid creating unwanted structure. However, as a major advantage of the scheme the ability to scale laser power by beam combining the case of independent lasers will be most likely deployed.

The same approach can be used to design a three-stage, four-stage or higher stage beam combiner configuration.

An advantage of the beam combining scheme is that the NLO materials are not absorbing (if chosen correctly) and are transparent, so there will be little heating or loss. Furthermore, the NLO materials can operate with large cross-section input laser beams which helps with accommodating higher CW or peak laser powers and laser energies.

The transparency of the NLO material at the input and product beam frequencies allows multiple stages to be combined in series in a straightforward manner. It is therefore necessary when concatenating different stages that the NLO material of the or each subsequent stage is transparent to the product beam frequency of the or each preceding stage.

Successive pairs of beams from stage to stage are converted by SFG (or DFG or SHG) to further increase power. If the generated beams are coherent, then it is important to control the phase in successive combiners, while if they are from separate lasers (even if all almost identical), then because the frequencies of the resulting (SFG or DFG) pairs are not identical the beams will add incoherently, allowing for a simple way of combining laser beams to create higher power, higher energy and better beam quality laser outputs.

The same approach can also be used to create higher harmonics. For example, starting with lasers at 1064 nm, we can create 532 nm SFG which could then be combined in an appropriate NLO material (again non-collinear) to create 266 nm light deep in the ultraviolet region.

Other options include mixing other standard lasers, e.g. two 1560 nm lasers, to create a higher power (than either of the 1560 nm lasers) 760 nm laser and then using difference frequency with a third 1560 nm laser to create an output from the transparent NLO material which has power from all three lasers but back at 1560 nm by DFG and with improved beam quality or patterned with any desired amplitude and phase laser field.

These designs can be applied beneficially to many known applications of lasers including: launching light into optical fibres, material processing, photolithography with complex patterns, laser marking, optical switching for telecoms, etc.

To provide sufficient optical efficiency for any given application depends on factors including: availability of suitable NLO materials that can also be processed to form a suitable phase-matched region by QPM or otherwise; availability of lasers that can deliver sufficient power at the frequencies needed; availability of low-loss phase modulators at the relevant frequency. Luckily many lasers exist suitable for a wide variety of implementations of embodiments of the invention. Moreover, phase modulators based on LCOS are readily available and can be used for many applications.

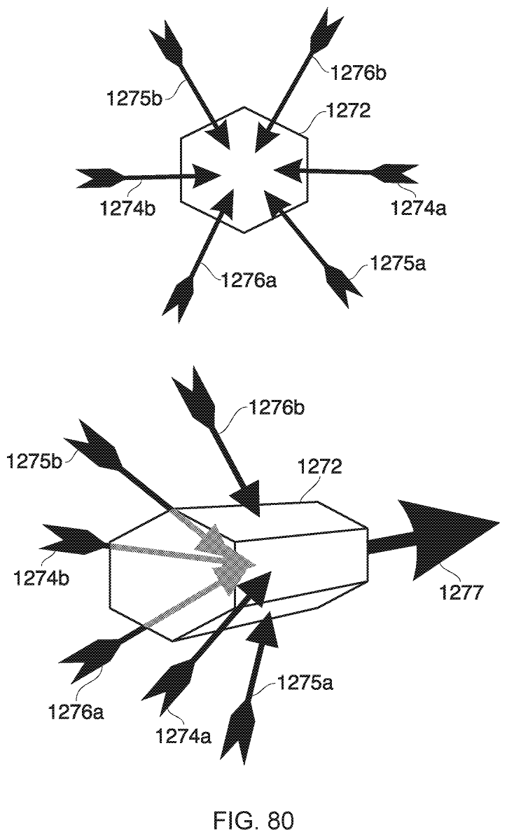

FIG. 80 shows a hexagonal cross-section NLO material being used to combine 3 pairs of input beams in order to show an example of how our approach to beam combining can also be extended to combine multiple pairs of input beams so as to generate multiple output beams that are coaxial. The upper drawing is an end-on view and the lower drawing a perspective view.

The NLO material is in the form of a hexagonal rod 1272 and has been processed to contain appropriate phase matching (birefringent or QPM) along the rod axis to meet the non-collinear beam combination criterion discussed throughout this document.

The three input beam pairs are labelled as follows: first pair 1274a & 1274b, second pair 1275a and 1275b, and third pair 1276a and 1276b.

These input beams can be derived either from the same laser—from six different lasers, or some intermediate number of lasers. Each of these lasers will have a controlled phase front from a phase modulator as shown in the previous figures. There may be one or two phase modulators per input beam pair as previously mentioned. If independent laser sources are used for each beam of any given beam pair the combined output beam for that pair will be incoherent (unless the two lasers are exceptionally narrow linewidth and locked in frequency).

As evident in the lower perspective drawing, the phase matching is created along the rod axis so as to generate a new combined laser field 1277 which combines all three output beams, since they are generated in the common central axis of the rod. As before, this new laser field can be structured in amplitude and phase, and can be controlled using sensors (e.g. cameras and wavefront sensors). The resulting combined field 1277 can have higher power, higher beam quality, higher energy, etc.

While we have described a hexagonal section rod, the same approach can be used with any regular polygonal section with an even number of sides, e.g., two beam pairs in a square section rod, or four beam pairs in an octagonal section rod etc.

It will also be understood that a multi-stage beam combiner, for example two stage or three stage, may be based on concatenating a beam combiner of the type just described. Through phase modulation it is also possible bring the input beams of any given pair into focus where they cross in the NLO material to increase intensities, or to defocus or expand the input beams to avoid catastrophic optical damage or accelerated degradation of the NLO material itself or phase-matching properties.

It will be realised that with more than one pair of beams it becomes a more challenging issue to determine the phase modulator patterns for each of the pairs of beams. A number of solutions however can be applied, with the simplest being to switch on each pair separately, optimise the phase modulator structures for each pair independently, then switch all of the input lasers on. Another option is to briefly reduce the power of a given single beam (or of a pair), and then measure the change in the overall output field (e.g. with camera, wavefront sensor, etc), and then apply algorithmic (or machine learning/AI) optimisation to the modulators affecting the beams that were reduced in power.

### Computing Resources and System Data Communication Features

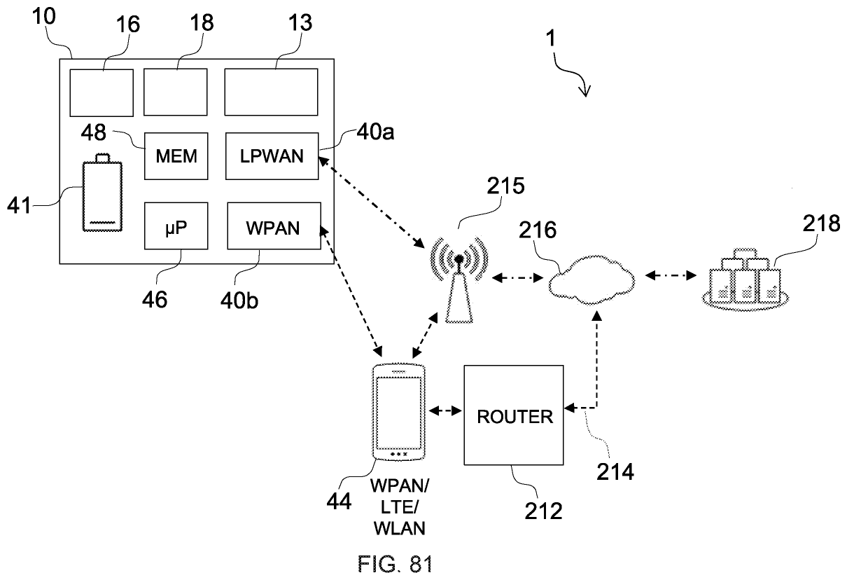

FIG. 81 is a schematic diagram of a communication system 1 including a headset or other device 10 according to the invention. The headset 10 includes a controller 13, input beam sources 16, 18, one or more wireless transceivers 40a and 40b, power supply 41, such as a battery, processor 46 and memory 48. Battery 41 may be rechargeable for example wirelessly by placing on a mains-powered charging pad. The first wireless transceiver 40a may be configured to operate according to a low-powered WAN (LPWAN) communications protocol to transmit and receive data using a first data communication path (illustrated with dot-dashed lines). The second wireless transceiver 40b is configured to operate according to a WPAN communications protocol to transmit and receive data using a second data communication path (illustrated with dot-dashed lines) to an external control device 44 for the headset 10, such as a smartphone, tablet or personal computer. A distributed network that forms cloud services 216 may act as a repository for storage of image and other data and may also contribute to data processing tasks. A remotely located data centre 218, referred to as a backend, may act as a repository for storage of image and other data and may also contribute to data processing tasks. The device 10 therefore has access to appropriate computing resource in terms of processing power, memory etc. as needed in particular for image processing tasks through a combination of on-device hardware, local hardware (e.g. a smartphone, tablet or personal computer located directly adjacent to the device and in wired or wireless communication therewith) and further remotely located hardware in the cloud or a remote data centre. A cellular network base station 215, referred to as a cellular tower, serves as a communication node between the headset 10, smartphone or tablet 44 acting as an external control device for the headset 10, and the cloud services 216 and backend 218. Data may be locally stored in the memory 48 prior to onward transmission to the backend 60. The memory 48 also stores a computer program, i.e. computer readable instructions, which when executed on the processor 46 controls the controller 13 to perform headset functions. The system provides first and second data communication paths between the headset 10 and the cloud services 216 and the backend 60 as illustrated respectively with dot-dashed and dashed lines. The first data communication path involves direct communication between the headset 10 and a cellular network base station 215 using the LPWAN transceiver 40a. The second data communication path involves the low-power WPAN transceiver 40b communicating with the WPAN-capable external control device 44 such as a smartphone. The external control device 44 has a software application (‘app’) installed for performing storage and processing functions relevant for the headset 10 as well as providing a user interface, comprising a graphical user interface, for the headset 10.

The external control device smartphone 44 has wireless transceivers respectively for WPAN, cellular and WLAN communication. For the second data communication path, the smartphone 44 communicates with the cloud services 216 and the backend 218 in one of two ways. One option for the second data communication path is to use the smartphone's WLAN capability to transmit the signal to a router 212, and the router 212 transmits the image data onward via a telephone network 214 to the backend 218 or distributed network forming cloud services 216. Another option for the second data communication path is to use the external control device's cellular capability as a user equipment (UE), e.g. using LTE, 4G (4^{th} generation) or 5G (5^{th} generation) protocols, for data communication via the cellular tower 215 to the backend 218 and/or cloud services 216.

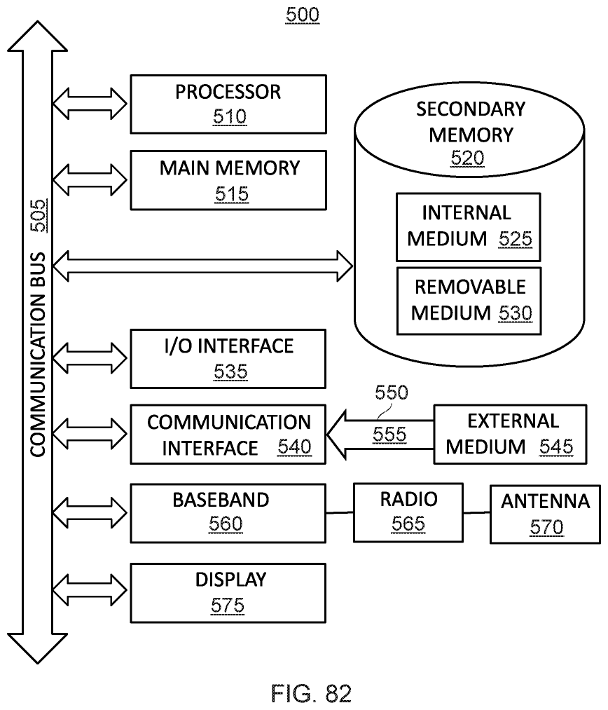

FIG. 82 is a block diagram illustrating an example computing apparatus 500 that may be used in connection with various embodiments described herein. For example, computing apparatus 500 may be used as a computing resource in any of: a headset or other device incorporating a display apparatus according to the invention, an external control device for providing local computing resource for the display apparatus, or remote computing resource such as located in physical or virtualized computing nodes.

Computing apparatus 500 can be a server or any conventional personal computer, or any other processor-enabled device that is capable of wired or wireless data communication. Other computing apparatus, systems and/or architectures may be also used, including devices that are not capable of wired or wireless data communication, as will be clear to those skilled in the art.

Computing apparatus 500 preferably includes one or more processors, such as processor 510. The processor 510 may be for example a CPU, GPU, TPU or arrays or combinations thereof such as CPU and TPU combinations or CPU and GPU combinations. Additional processors may be provided, such as an auxiliary processor to manage input/output, an auxiliary processor to perform floating point mathematical operations (e.g. a TPU), a special-purpose microprocessor having an architecture suitable for fast execution of signal processing algorithms (e.g., digital signal processor, image processor), a slave processor subordinate to the main processing system (e.g., back-end processor), an additional microprocessor or controller for dual or multiple processor systems, or a coprocessor. Such auxiliary processors may be discrete processors or may be integrated with the processor 510.

Processor 510 is connected to a communication bus 505. Communication bus 505 may include a data channel for facilitating information transfer between storage and other peripheral components of computing apparatus 500. Communication bus 505 further may provide a set of signals used for communication with processor 510, including a data bus, address bus, and control bus (not shown). Communication bus 505 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

Computing apparatus 500 preferably includes a main memory 515 and may also include a secondary memory 520. Main memory 515 provides storage of instructions and data for programs executing on processor 510, such as one or more of the functions and/or modules discussed above. It should be understood that computer readable program instructions stored in the memory and executed by processor 510 may be assembler instructions, instruction-set-architecture (ISA) instructions, machine instructions, machine dependent instructions, microcode, firmware instructions, state-setting data, configuration data for integrated circuitry, or either source code or object code written in and/or compiled from any combination of one or more programming languages, including without limitation Smalltalk, C/C++, Java, JavaScript, Perl, Visual Basic, .NET, and the like. Main memory 515 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Secondary memory 520 may optionally include an internal memory 525 and/or a removable medium 530. Removable medium 530 is read from and/or written to in any well-known manner. Removable storage medium 530 may be, for example, a magnetic tape drive, a compact disc (CD) drive, a digital versatile disc (DVD) drive, other optical drive, a flash memory drive, etc.

Removable storage medium 530 is a non-transitory computer-readable medium having stored thereon computer-executable code (i.e., software) and/or data. The computer software or data stored on removable storage medium 530 is read into computing apparatus 500 for execution by processor 510.

The secondary memory 520 may include other similar elements for allowing computer programs or other data or instructions to be loaded into computing apparatus 500. Such means may include, for example, an external storage medium 545 and a communication interface 540, which allows software and data to be transferred from external storage medium 545 to computing apparatus 500. Examples of external storage medium 545 may include an external hard disk drive, an external optical drive, an external magneto-optical drive, etc. Other examples of secondary memory 520 may include semiconductor-based memory such as programmable read-only memory (PROM), erasable programmable read-only memory (EPROM), electrically erasable read-only memory (EEPROM), or flash memory (block-oriented memory similar to EEPROM).

As mentioned above, computing apparatus 500 may include a communication interface 540. Communication interface 540 allows software and data to be transferred between computing apparatus 500 and external devices (e.g. printers), networks, or other information sources. For example, computer software or executable code may be transferred to computing apparatus 500 from a network server via communication interface 540. Examples of communication interface 540 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 550 with a network or another computing device. Communication interface 540 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 540 are generally in the form of electrical communication signals 555. These signals 555 may be provided to communication interface 540 via a communication channel 550. In an embodiment, communication channel 550 may be a wired or wireless network, or any variety of other communication links. Communication channel 550 carries signals 555 and can be implemented using a variety of wired or wireless communication means including wire or cable, fibre optics, conventional phone line, cellular phone link, wireless data communication link, radio frequency (“RF”) link, or infrared link, just to name a few.

Computer-executable code (i.e., computer programs or software) is stored in main memory 515 and/or the secondary memory 520. Computer programs can also be received via communication interface 540 and stored in main memory 515 and/or secondary memory 520. Such computer programs, when executed, enable computing apparatus 500 to perform the various functions of the disclosed embodiments as described elsewhere herein.

In this document, the term “computer-readable medium” is used to refer to any non-transitory computer-readable storage media used to provide computer-executable code (e.g., software and computer programs) to computing apparatus 500. Examples of such media include main memory 515, secondary memory 520 (including internal memory 525, removable medium 530, and external storage medium 545), and any peripheral device communicatively coupled with communication interface 540 (including a network information server or other network device). These non-transitory computer-readable media are means for providing executable code, programming instructions, and software to computing apparatus 500. In an embodiment that is implemented using software, the software may be stored on a computer-readable medium and loaded into computing apparatus 500 by way of removable medium 530, I/O interface 535, or communication interface 540. In such an embodiment, the software is loaded into computing apparatus 500 in the form of electrical communication signals 555. The software, when executed by processor 510, preferably causes processor 510 to perform the features and functions described elsewhere herein.

I/O interface 535 provides an interface between one or more components of computing apparatus 500 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

Computing apparatus 500 also includes optional wireless communication components that facilitate wireless communication over a voice network and/or a data network. The wireless communication components comprise an antenna system 570, a radio system 565, and a baseband system 560. In computing apparatus 500, radio frequency (RF) signals are transmitted and received over the air by antenna system 570 under the management of radio system 565.

Antenna system 570 may comprise one or more antennae and one or more multiplexors (not shown) that perform a switching function to provide antenna system 570 with transmit and receive signal paths. In the receive path, received RF signals can be coupled from a multiplexor to a low noise amplifier (not shown) that amplifies the received RF signal and sends the amplified signal to radio system 565.

Radio system 565 may comprise one or more radios that are configured to communicate over various frequencies. In an embodiment, radio system 565 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 565 to baseband system 560.

If the received signal contains audio information, then baseband system 560 decodes the signal and converts it to an analogue signal. Then the signal is amplified and sent to a speaker. Baseband system 560 also receives analogue audio signals from a microphone. These analogue audio signals are converted to digital signals and encoded by baseband system 560. Baseband system 560 also codes the digital signals for transmission and generates a baseband transmit audio signal that is routed to the modulator portion of radio system 565. The modulator mixes the baseband transmit audio signal with an RF carrier signal generating an RF transmit signal that is routed to antenna system 570 and may pass through a power amplifier (not shown). The power amplifier amplifies the RF transmit signal and routes it to antenna system 570 where the signal is switched to the antenna port for transmission.

Baseband system 560 is also communicatively coupled with processor 510, which may be a central processing unit (CPU). Processor 510 has access to data storage areas 515 and 520. Processor 510 is preferably configured to execute instructions (i.e., computer programs or software) that can be stored in main memory 515 or secondary memory 520. Computer programs can also be received from baseband processor 560 and stored in main memory 510 or in secondary memory 520 or executed upon receipt. Such computer programs, when executed, enable computing apparatus 500 to perform the various functions of the disclosed embodiments. For example, data storage areas 515 or 520 may include various software modules.

The computing apparatus further comprises a display 575 directly attached to the communication bus 505 which may be provided instead of or addition to any display connected to the I/O interface 535 referred to above.

Various embodiments may also be implemented primarily in hardware using, for example, components such as application specific integrated circuits (ASICs), programmable logic arrays (PLA), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above-described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit, or step is for ease of description. Specific functions or steps can be moved from one module, block, or circuit to another without departing from the invention.

Moreover, the various illustrative logical blocks, modules, functions, and methods described in connection with the embodiments disclosed herein can be implemented or performed with a general-purpose processor, a digital signal processor (DSP), an ASIC, FPGA, or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such that the processor can read information from, and write information to, the storage medium. In the alternative, the storage medium can be integral to the processor. The processor and the storage medium can also reside in an ASIC.

A computer readable storage medium, as referred to herein, is not to be construed as being transitory signals per se, such as radio waves or other freely propagating electromagnetic waves, electromagnetic waves propagating through a waveguide or other transmission media (e.g., light pulses passing through a fibre-optic cable), or electrical signals transmitted through a wire.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

Embodiments of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

Apparatus and methods embodying the invention are capable of being hosted in and delivered by a cloud-computing environment. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

### REFERENCE NUMERALS

1 communication system
10 headset (e.g. AR spectacles)
11 information defining synthetic scene
12 display apparatus
13 controller
14 beam source
15 microprocessor
16 beam source, e.g. emitter array
18 beam source, e.g. laser
19 laser control unit
20 spectacle lens
22 spectacle lens, left eye
24 spectacle lens, right eye
25 spectacle lens rim light sources
26 spectacle frame
28 spectacle frame, bridge
30 spectacle frame, nose pad
32 spectacle arm, left (temple)
34 spectacle arm, right (temple)
36 spectacle lens rim, left
38 spectacle lens rim, right
39 light guide integrated in spectacles frame
39 sensor components
40 radio or wireless transmitter and/or receiver
41 power supply
42 communication path to external control device
43 radio or wireless transmitter and/or receiver components
44 external control device
45 external interfaces
46 processor
47 software application
48 memory
49 comms interface to external networks (WiFi, Bluetooth, etc).
50 outwardly facing camera, left-side (for natural scene acquisition)
52 outwardly facing camera, right-side (for natural scene acquisition)
54 inwardly facing camera, left-side (for eye tracking)
55 ambient light sensor (light meter)
56 inwardly facing camera, right-side (for eye tracking)
57 other sensors
58 range finder for natural scene objects (e.g. LiDAR device)
59 range finder for measuring distance to eyes
60 photodetectors (for detecting input light leakage)
61 I/O components
62 compass, frame or arm mounted
64 accelerometers, frame or arm mounted
66 input beam port, first input beam
68 input beam port, second input beam
70 first input beam/beam path (of a pair)
71 angle scanning of first beam
72 first input beam wavevector
74 first input beam wavefront
75 amplitude and phase modulation function on beam
76 second input beam/beam path (of a pair)
77 angle scanning of second beam
78 second input beam wavevector
80 second input beam wavefront
81 Gaussian beam profile
82 product beam (from one pair of input beams)
84 product beam wavefront
86 product beam wavevector
88 display panel
90 display panel, front face (proximal)
92 display panel, back face (distal)
94 display panel, left end face
96 display panel, right end face
97 window
98 casing
99 sample holder
100 NLO material piece or layer
102 top and bottom pieces or layers to sandwich NLO material piece or layer
103 NLO material superstructure spot
104 NLO material spot cluster
105 cut lines for PP NLO material wafer
106 NLO material cluster spots R, G & B (106R, 106G and 106B respectively)
108 phase matched or QPM region or grating in the NLO material piece or layer
109 NLO material piece or layer regions that are not phase matched or QPM
110 intersection region of beams within the NLO material layer
111 bonding layers
112 left & right surfaces of embedded piece of NLO material
114 top & bottom surfaces of embedded piece of NLO material
116 front & back surfaces of embedded piece of NLO material
120 amplitude modulator
121 amplitude modulator controller
122 phase modulator
123 phase modulator controller
123a combined amplitude and phase modulator
124b controller for combined amplitude and phase modulator
124 input beam routing components
125 rotatable mirror elements
128 air surrounding an element
130 distal (back) filter layer
132 proximal (front) filter layer
134 light blocking layer
136 mirror layer, distal (back)
138 mirror layer, proximal (front)
139 electrical control element for electrochromic layer
140 photochromic/electrochromic layer (for dimming in bright light)
141 electrical connection
142 vision correction lens layer, distal (back)
144 vision correction lens layer, proximal (front)
146 antireflection coating (ARC) layer, distal (back)
147 notch filter layer for visible light suppression, distal (back)
148 antireflection coating (ARC) layer, proximal (front)
150 spacing layers
154 dimming layer (e.g. photochromic, electrochromic)
156 dimming layer, electrical connection line
160 eye
162 eyeball
164 cornea
165 corneal surface
166 eye lens
168 retina
170 pupil
172 iris
174 optic nerve
180 object in natural scene (stick man)
181 wavefront from the natural scene
182 light scattered from object
184 rays of light
186 discontinuity of scale
188 scattered wavefront
190 inset of scattered wavefront
192 distance
188A wavefront from point A
188B wavefront from point B
190 focal point
190A focal point for light from point A
190B focal point for light from point B
200 a QPM structure in a NLO material
202 ‘up’ domain in a NLO material
204 ‘down’ domain in a NLO material
206x QPM period (206R for red, 206G for green, 206B for blue)
208 A superstructured QPM period
212 router
214 telephone network connection
215 cellular network base station, cellular tower
216 distributed network, cloud services (e.g. virtualised computing resource)
218 remotely located data center, backend
220 input single beam
222x mirror (222A is first mirror, 222B is second mirror, 222C is third mirror)
224x output beam path (224A is first output beam path, 224B is second output beam path,
224C is third output beam path)
240x lens (240A is first lens, 240B is second lens)
241 controller for a lens or lenses
242 lens
260 reflective structure
262 internal mirror layer within display
264 spectacle arm/temple side of display element
266 nose/bridge side of the display element
280 control system for eye tracking
282 blanking period
290 region on outside of lens containing absorber
292 entry region for optical beams
300 lens for VR
317 input laser wave
318, 319, 320 example radii of curvature of input laser wave
321 incoherent emitter array (e.g. microLED array)
324 controller for amplitude modulator (incoherent emitter array, LCOS, DLP etc.)
325 lens
326, 327, 328 example pixels of incoherent emitter array
500 computing apparatus
505 communication bus
510 processor
515 main memory
520 secondary memory
525 internal memory
530 removable medium
535 I/O interface
540 communication interface
545 storage medium
550 communication channel
555 signals
560 baseband system
565 radio system
570 antenna system
575 display
801 First location of video conferencing system, e.g., conference room
802 Second location of video conferencing system, e.g., conference room
803 Third location of video conferencing system, e.g., conference room
804 Fourth location of video conferencing system, e.g., conference room
811 Computer at location 801
812 Computer at location 802
813 Computer at arbitrary video conferencing location
815 Central computer server for connecting the video conferencing system.
821 Display panel for video conferencing located at 801
822 Display panel for video conferencing located at 802
823 Display panel at arbitrary video conferencing location
831 Participant in video conferencing located at 801
832 Participant in video conferencing located at 802
833 Participant in video conference at arbitrary location
831(I) and 832(II) first and second participants at location 801.
831R, 831L right and left eyes of participant 831
832R, 832L right and left eyes of participant 832
841a, 841b cameras located on display element 821
842a, 842b cameras located on display element 822.
852 Face-to-face virtual meeting room geometry
853 Triangular virtual meeting room geometry
854 Round table virtual meeting room geometry
900 external power supply input socket
902 audio jack
904 SIM card holder
906 SIM/memory card holder
908 battery
909 outwardly facing camera
910 conventional display screen
911 non-close-to-eye display screen according to the invention
912 touch sensitive area
914 radius of curvature of light emitted from a conventional display
916 radius of curvature of light emitted from apparent depth display
917 mechanical key (or button)
918 touch sensor key (or button)
919 touch sensor key (or button)
920 displayed feature
921 rocker switch for volume control
922 on/off switch
923 inwardly facing camera
924 microphone
926 equivalent distance from virtual object and corresponding to radius of curvature of light from NCTE display
928 phase of input beam
930 intensity of input beam
938 Pixelated light modulator layer (e.g., Liquid Crystal Device)
950 Human viewer of hybrid display
951R and 951L right and left eye of human viewer of hybrid mode display
952 Product beam for right eye
954 Product beam for left eye
958 Phosphor emitter from back light of conventional LC display panel (could also be direct LED, OLED, etc)
960 Distance from phosphor emitter in backlight to the observer
962 Emission angles from hybrid mode display determined by nonlinear phase matching
970 Person holding mobile phone type display device (view from over their right shoulder
972 Mobile phone or tablet type display device based on new approach with apparent depth beyond display
974 NCTE display with apparent depth beyond the physical
976 stereoscopic area viewed by left eye of viewer
978 stereoscopic area viewed by right eye of viewer
982 pattern placed on edges of display device-note that in this image it is periodic but it can be other options (e.g., reflective or even active emitting)
984 chamfered or angled edge of display device
986 edge view of display device
988 representation of out of focus image of the physical display device as would be seen by observer focused at the apparent depth
990 representation of out of focus image of the desired star pattern displayed. Note this is out-of-focus but also the left and right eye stereoscopic vision creates two images—this is the left eye image
992 right eye image as for 990
994 representation of in-focus image of the desired star pattern displayed by the NCTE display when viewer is focused at the apparent depth
1010 transparent substrate material
1012 lower plate electrode
1014 vacuum chamber
1016 heatable boat
1017 organic precursor material
1020 poling voltage supply capable of alternating polarity
1022 electrode structure connected to supply. Note that this is shown as a grid to indicate that material can pass through from the source boat onto the substrate.
1030 conductive polymer layer
1032 organic layer capable of exhibiting second order nonlinearity after poling.
1040 nonlinear structured material with larger period than required
1042 nonlinear structured material after compression by rollers with required period
1044 rollers (heated or not as required depending on the softening properties of the material)
1050 rotating spindle for spin-coater
1052 transparent substrate for mounting on spin-coater
1054 liquid dispenser
1056 UV cross-linking system (or thermal cross-linking)
1058 layers of NLO material with alternating polarity deposited by spin-coating and field alignment
1060 roller for Langmuir Blodgett film approach
1062 tank, trough
1064 monolayer of aligned NLO material floating on water or other fluid
1066 water or other fluid
1068 moveable barriers to control film tension
1070 NLO material made from alternating liquid crystal layers
1072 First direction of LC material
1074 Second direction of LC material
1110 Example input beam pair crossing point
1112 Example input beam pair crossing point
1114 mirrors
1122 Rectangular display panel grid of rows and columns
1124 light ports, temple
1126 light ports, frame, temple side
1128 light ports, frame, nose/bridge side
1142 multi-channel focusing structure
1144 example ray
1146 example ray
1241 output (product beam) light field
1242 non-collinear mixing geometry
1243 target pattern imprinted in output beam
1244 first input beam
1245 second input beam
1246 first phase modulator
1247 second phase modulator
1248 input beam phase function
1249 input beam phase function
1251 beam splitter
1252 camera
1253 output beam pattern
1254 controller

1. A headset in a spectacles or goggles format for displaying synthetic scene images responsive to input of image information, the headset comprising:
a frame accommodating a display panel; and
left and right temples accommodating beam generation optics and amplitude and phase modulators,
wherein the beam generation optics comprises:
a first beam source for providing a first input beam of a first frequency and bandwidth; and
a second beam source for providing a second input beam of a second frequency and bandwidth;
wherein the display panel comprises:
a display area of nonlinear optical (NLO) material with phase matched regions that are phase matched to first and second selected combinations of the frequencies of the first and second input beams, and to a frequency equal to the sum of the selected combinations,
wherein a controller is provided that is operable responsive to the input of the image information to form the synthetic scene images by amplitude modulating at least one of the first and second input beams with the amplitude modulator and by phase modulating at least one of the first and second input beams with the phase modulator to set each of amplitude, wavevector and wavefront radius of curvature of the product beam, and
wherein the frame and temples jointly accommodate:
input beam routing components arranged to introduce the first and second input beams into the display panel so that they traverse the display panel in first and second paths that cross each other in the NLO material in a noncollinear geometry to define an intersection volume where the first and second input beams mix to generate a product beam having the sum frequency, wherein the input beam routing components for each of the first and second input beams are actuatable by a controller to direct each of the first and second input beams so that they cross in an intersection volume that is located at an addressable two-dimensional coordinate in the display area.

2. The headset of claim 1, further comprising:
left and right eye inwardly facing image acquisition devices to capture images of the left and right eyes of the wearer,
wherein the headset has access to computing resource configured to process the captured images to determine whether the wearer's gaze is directed onto the display area and if so which two-dimensional coordinate on the display area the wearer's gaze is directed,
the controller being operable, responsive to determination of the two-dimensional coordinate of the wearer's gaze, to direct the first and second input beams to cross at that two-dimensional coordinate.

3. The headset of claim 1, wherein the input beam routing components are actuatable under control of the controller to direct each of the first and second input beams to any one of a plurality of spatially separated optical channels via which they enter the display panel at different positions to select a vertical coordinate of the display area.

4. The headset of claim 1, further comprising:
a mirror array arranged in each optical channel, the mirror array comprising a plurality of mirrors of different focal lengths, wherein the input beam routing components are actuatable under control of the controller to direct each of the first and second input beams to any one of the mirrors of the mirror array to select a horizontal coordinate of the display area.

5. The headset of claim 1, wherein the first input beam encodes image intensity information that defines the intensity of the product beam generated at each intersection volume of a given synthetic scene image and the second input beam encodes image depth information that defines the wavefront radius of curvature in the product beam generated at all intersection volumes for a given synthetic scene image.

6. The headset of claim 2, wherein the input beam routing components are actuatable under control of the controller to direct each of the first and second input beams to any one of a plurality of spatially separated optical channels via which they enter the display panel at different positions to select a vertical coordinate of the display area.

7. The headset of claim 2, further comprising:
a mirror array arranged in each optical channel, the mirror array comprising a plurality of mirrors of different focal lengths, wherein the input beam routing components are actuatable under control of the controller to direct each of the first and second input beams to any one of the mirrors of the mirror array to select a horizontal coordinate of the display area.

8. The headset of claim 2, wherein the first input beam encodes image intensity information that defines the intensity of the product beam generated at each intersection volume of a given synthetic scene image and the second input beam encodes image depth information that defines the wavefront radius of curvature in the product beam generated at all intersection volumes for a given synthetic scene image.
